(19) United States
(12) Patent Application Publication
(10) Pub. No.: US 2014/0121808 A1
(43) Pub. Date: May 1, 2014

(54) FOOD SUPPLY CHAIN AUTOMATION FARM INTERFACE SYSTEM AND METHOD

(71) Applicant: ELWHA LLC, Bellevue, WA (US)

(72) Inventors: Edward K.Y. Jung, Bellevue, WA (US); Royce A. Levien, Lexington, MA (US); Mark A. Malamud, Seattle, WA (US)

(73) Assignee: ELWHA LLC, Bellevue, WA (US)

(21) Appl. No.: 13/682,939

(22) Filed: Nov. 21, 2012

Related U.S. Application Data
(63) Continuation-in-part of application No. 13/669,018, filed on Nov. 5, 2012.
Application No. 13/669,018 is a continuation of application No. 13/668,977, filed on Nov. 5, 2012.
Application No. 13/668,977 is a continuation-in-part of application No. 13/663,137, filed on Oct. 29, 2012.
Application No. 13/663,137 is a continuation of application No. 13/663,095, filed on Oct. 29, 2012.

(51) Int. Cl. G06Q 10/08

(52) U.S. Cl. CPC G06Q 10/087
USPC 700/115

(57) ABSTRACT

A computationally implemented system and method that is designed to, but is not limited to: electronically transmitting one or more queries regarding at least in part one or more farming related production factors involved with farming related production of one or more ingestible materials; and electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and said one or more tracers as being at least momentarily in physical proximity with said one or more ingestible materials. In addition to the foregoing, other method aspects are described in the claims, drawings, and text forming a part of the present disclosure.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a continuation-in-part of U.S. patent application Ser. No. 13/669,018, entitled FOOD SUPPLY CHAIN AUTOMATION FARM TESTING SYSTEM AND METHOD, naming Edward K. Y. Jung, Royce A. Levien, and Mark A. Malamud as inventors, filed 5 Nov. 2012 with attorney docket no. 0712-003-003-C00001, which is currently co-pending or is an application of which a currently co-pending application is entitled to the benefit of the filing date, and which is a continuation of U.S. patent application Ser. No. 13/668,977, entitled FOOD SUPPLY CHAIN AUTOMATION FARM TESTING SYSTEM AND METHOD, naming Edward K. Y. Jung, Royce A. Levien, and Mark A. Malamud as inventors, filed 5 Nov. 2012 with attorney docket no. 0712-003-003-C00000.

For purposes of the USPTO extra-statutory requirements, the present application constitutes a continuation-in-part of U.S. patent application Ser. No. 13/663,137, entitled FOOD SUPPLY CHAIN AUTOMATION FARM TRACKING SYSTEM AND METHOD, naming Edward K. Y. Jung, Royce A. Levien, and Mark A. Malamud as inventors, filed 29 Oct. 2012 with attorney docket no. 0712-003-002-C00001, which is currently co-pending or is an application of which a currently co-pending application is entitled to the benefit of the filing date, and which is a continuation of U.S. patent application Ser. No. 13/663,095, entitled FOOD SUPPLY CHAIN AUTOMATION FARM TRACKING SYSTEM AND METHOD, naming Edward K. Y. Jung, Royce A. Levien, and Mark A. Malamud as inventors, filed 29 Oct. 2012 with attorney docket no. 0712-003-002-C00000.

### RELATED APPLICATIONS

None

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one aspect, a computationally-implemented method includes, but is not limited to electronically transmitting one or more queries regarding at least in part one or more farming related production factors involved with farming related production of one or more ingestible materials; and electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials. In addition to the foregoing, other method aspects are described in the claims, drawings, and text forming a part of the disclosure set forth herein.

In one or more various aspects, related machines, compositions of matter, or manufactures of systems may include, but are not limited to, circuitry and/or programming for effecting the herein-referenced method aspects; the circuitry and/or programming can be virtually any combination of hardware, software, and/or firmware configured to effect the herein-referenced method aspects depending upon the design choices of the system designer (limited to patentable subject matter under 35 USC 101).

A computationally-implemented system includes, but is not limited to: means for electronically transmitting one or more queries regarding at least in part one or more farming related production factors involved with farming related production of one or more ingestible materials; and means for electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials. In addition to the foregoing, other system aspects are described in the claims, drawings, and text forming a part of the disclosure set forth herein.

A computationally-implemented system includes, but is not limited to a transmitting queries electrical circuitry arrangement for electronically transmitting one or more queries regarding at least in part one or more farming related production factors involved with farming related production of one or more ingestible materials; and a receiving response electrical circuitry arrangement for electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials. In addition to the foregoing, other system aspects are described in the claims, drawings, and text forming a part of the disclosure set forth herein.

A system includes, but is not limited to a transmitting queries module configured to operate in accordance with electronically transmitting one or more queries regarding at least in part one or more farming related production factors involved with farming related production of one or more ingestible materials; and a receiving response module configured to operate in accordance with electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials. In addition to the foregoing, other system aspects are described in the claims, drawings, and text forming a part of the disclosure set forth herein.

An article of manufacture including one or more non-transitory signal-bearing storage medium bearing one or more instructions for electronically transmitting one or more queries regarding at least in part one or more farming related production factors involved with farming related production of one or more ingestible materials; and one or more instructions for electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials. In addition to the foregoing, other computer program product aspects are described in the claims, drawings, and text forming a part of the disclosure set forth herein.

A system including one or more computing devices; and one or more instructions when executed on the one or more computing devices cause the one or more computing devices to perform electronically transmitting one or more queries regarding at least in part one or more farming related production factors involved with farming related production of one or more ingestible materials; and electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials. In addition to the foregoing, other computer program product aspects are described in the claims, drawings, and text forming a part of the disclosure set forth herein.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise.

With reference now to the figures, shown are one or more examples of is an example of farming related ingestible materials production interface system that may provide context, for instance, in introducing one or more processes and/or devices described herein

FIG. 1 is a schematic view depicting farm-test co. info hub aspects as related with a farming related ingestible materials production interface system.

FIG. 2 is a schematic view depicting farm-tracking aspects as related with the farming related ingestible materials production interface system.

FIG. 3 is a schematic view depicting farm-track co. info hub aspects as related with the farming related ingestible materials production interface system.

FIG. 4 is a schematic view depicting farm-tracking aspects as related with the farming related ingestible materials production interface system.

FIG. 5 is a schematic view depicting shipping aspects as related with the farming related ingestible materials production interface system.

FIG. 6 is a schematic view depicting grocery test and track co. info hub aspects as related with the farming related ingestible materials production interface system.

FIG. 7 is a schematic view depicting grocery tracking aspects as related with the farming related ingestible materials production interface system.

FIG. 8 is a schematic view depicting home-test and track co. info hub aspects as related with the farming related ingestible materials production interface system.

FIG. 9 is a schematic view depicting home tracking aspects as related with the farming related ingestible materials production interface system.

FIG. 10 is a schematic view depicting restaurant-test and track co. info hub aspects as related with the farming related ingestible materials production interface system.

FIG. 11 is a schematic view depicting restaurant tracking aspects as related with the farming related ingestible materials production interface system.

FIG. 12 is a block diagram depicting an exemplary implementation of the farming related ingestible materials production interface system 10 of FIG. 1 including exemplary subsystems.

FIG. 13 is a block diagram depicting a control and information processing subsystem s100 of an exemplary implementation of the farming related ingestible materials production interface system 10 of FIG. 1.

FIG. 14 is a block diagram depicting an information storage subsystem s200 of an exemplary implementation of the farming related ingestible materials production interface system 10 of FIG. 1.

FIG. 15 is a block diagram depicting an information user interface subsystem s300 of an exemplary implementation of the farming related ingestible materials production interface system 10 of FIG. 1.

FIG. 16 is a block diagram depicting a sensing subsystem s400 of an exemplary implementation of the farming related ingestible materials production interface system 10 of FIG. 1.

FIG. 17 is a block diagram depicting an electronic communication subsystem s500 of an exemplary implementation of the farming related ingestible materials production interface system 10 of FIG. 1.

FIG. 18 is a block diagram depicting a power subsystem s600 of an exemplary implementation of the farming related ingestible materials production interface system 10 of FIG. 1.

FIG. 19 is a block diagram depicting a material processing subsystem s700 of an exemplary implementation of the farming related ingestible materials production interface system 10 of FIG. 1.

FIG. 20 is a block diagram depicting a preparation subsystem s800 of an exemplary implementation of the farming related ingestible materials production interface system 10 of FIG. 1.

FIG. 21 is a block diagram depicting one or more exemplary electrical circuitry arrangements of the farming related ingestible materials production interface system 10 of FIG. 1.

FIG. 22 is a block diagram depicting one or more exemplary electrical circuitry arrangements of the farming related ingestible materials production interface system 10 of FIG. 1.

FIG. 23 is a block diagram depicting one or more exemplary electrical circuitry arrangements of the farming related ingestible materials production interface system 10 of FIG. 1.

FIG. 24 is a block diagram depicting one or more exemplary electrical circuitry arrangements of the farming related ingestible materials production interface system 10 of FIG. 1.

FIG. 25 is a block diagram depicting one or more exemplary electrical circuitry arrangements of the farming related ingestible materials production interface system 10 of FIG. 1.

FIG. 26 is a block diagram depicting one or more exemplary electrical circuitry arrangements of the farming related ingestible materials production interface system 10 of FIG. 1.

FIG. 27 is a block diagram depicting one or more exemplary electrical circuitry arrangements of the farming related ingestible materials production interface system 10 of FIG. 1.

FIG. 28 is a block diagram depicting one or more exemplary instructions of the information storage subsystem s200 of the farming related ingestible materials production interface system 10 of FIG. 1.

FIG. 29 is a block diagram depicting one or more exemplary instructions of the information storage subsystem s200 of the farming related ingestible materials production interface system 10 of FIG. 1.

FIG. 30 is a block diagram depicting one or more exemplary instructions of the information storage subsystem s200 of the farming related ingestible materials production interface system 10 of FIG. 1.

FIG. 31 is a block diagram depicting one or more exemplary instructions of the information storage subsystem s200 of the farming related ingestible materials production interface system 10 of FIG. 1.

FIG. 32 is a block diagram depicting one or more exemplary instructions of the information storage subsystem s200 of the farming related ingestible materials production interface system 10 of FIG. 1.

FIG. 33 is a block diagram depicting one or more exemplary instructions of the information storage subsystem s200 of the farming related ingestible materials production interface system 10 of FIG. 1.

FIG. 34 is a block diagram depicting one or more exemplary instructions of the information storage subsystem s200 of the farming related ingestible materials production interface system 10 of FIG. 1.

FIG. 35 is a block diagram depicting one or more exemplary modules of the farming related ingestible materials production interface system 10 of FIG. 1.

FIG. 36 is a block diagram depicting one or more exemplary modules of the farming related ingestible materials production interface system 10 of FIG. 1.

FIG. 37 is a block diagram depicting one or more exemplary modules of the farming related ingestible materials production interface system 10 of FIG. 1.

FIG. 38 is a block diagram depicting one or more exemplary modules of the farming related ingestible materials production interface system 10 of FIG. 1.

FIG. 39 is a block diagram depicting one or more exemplary modules of the farming related ingestible materials production interface system 10 of FIG. 1.

FIG. 40 is a block diagram depicting one or more exemplary modules of the farming related ingestible materials production interface system 10 of FIG. 1.

FIG. 41 is a block diagram depicting one or more exemplary modules of the farming related ingestible materials production interface system 10 of FIG. 1.

FIG. 42 is a high-level flowchart illustrating an operational flow o10 representing exemplary operations related to electronically transmitting one or more queries regarding at least in part one or more farming related production factors involved with farming related production of one or more ingestible materials, and electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least associated with the depicted exemplary implementations of the system.

FIG. 43 is a high-level flowchart including exemplary implementations of operation o11 of FIG. 42.

FIG. 44 is a high-level flowchart including exemplary implementations of operation o11 of FIG. 42.

FIG. 45 is a high-level flowchart including exemplary implementations of operation o11 of FIG. 42.

FIG. 46 is a high-level flowchart including exemplary implementations of operation o11 of FIG. 42.

FIG. 47 is a high-level flowchart including exemplary implementations of operation o11 of FIG. 42.

FIG. 48 is a high-level flowchart including exemplary implementations of operation o11 of FIG. 42.

FIG. 49 is a high-level flowchart including exemplary implementations of operation o11 of FIG. 42.

FIG. 50 is a high-level flowchart including exemplary implementations of operation o11 of FIG. 42.

FIG. 51 is a high-level flowchart including exemplary implementations of operation o11 of FIG. 42.

FIG. 52 is a high-level flowchart including exemplary implementations of operation o11 of FIG. 42.

FIG. 53 is a high-level flowchart including exemplary implementations of operation o11 of FIG. 42.

FIG. 54 is a high-level flowchart including exemplary implementations of operation o11 of FIG. 42.

FIG. 55 is a high-level flowchart including exemplary implementations of operation o11 of FIG. 42.

FIG. 56 is a high-level flowchart including exemplary implementations of operation o11 of FIG. 42.

FIG. 57 is a high-level flowchart including exemplary implementations of operation o11 of FIG. 42.

FIG. 58 is a high-level flowchart including exemplary implementations of operation o11 of FIG. 42.

FIG. 59 is a high-level flowchart including exemplary implementations of operation o11 of FIG. 42.

FIG. 60 is a high-level flowchart including exemplary implementations of operation o11 of FIG. 42.

FIG. 61 is a high-level flowchart including exemplary implementations of operation o11 of FIG. 42.

FIG. 62 is a high-level flowchart including exemplary implementations of operation o11 of FIG. 42.

FIG. 63 is a high-level flowchart including exemplary implementations of operation o11 of FIG. 42.

FIG. 64 is a high-level flowchart including exemplary implementations of operation o11 of FIG. 42.

FIG. 65 is a high-level flowchart including exemplary implementations of operation o11 of FIG. 42.

FIG. 66 is a high-level flowchart including exemplary implementations of operation o11 of FIG. 42.

FIG. 67 is a high-level flowchart including exemplary implementations of operation o11 of FIG. 42.

FIG. 68 is a high-level flowchart including exemplary implementations of operation o11 of FIG. 42.

FIG. 69 is a high-level flowchart including exemplary implementations of operation o11 of FIG. 42.

FIG. 70 is a high-level flowchart including exemplary implementations of operation o12 of FIG. 42.

FIG. 71 is a high-level flowchart including exemplary implementations of operation o12 of FIG. 42.

FIG. 72 is a high-level flowchart including exemplary implementations of operation o12 of FIG. 42.

FIG. 73 is a high-level flowchart including exemplary implementations of operation o12 of FIG. 42.

FIG. 74 is a high-level flowchart including exemplary implementations of operation o12 of FIG. 42.

FIG. 75 is a high-level flowchart including exemplary implementations of operation o12 of FIG. 42.

FIG. 76 is a high-level flowchart including exemplary implementations of operation o12 of FIG. 42.

FIG. 77 is a high-level flowchart including exemplary implementations of operation o12 of FIG. 42.

FIG. 78 is a high-level flowchart including exemplary implementations of operation o12 of FIG. 42.

FIG. 79 is a high-level flowchart including exemplary implementations of operation o12 of FIG. 42.

FIG. 80 is a high-level flowchart including exemplary implementations of operation o12 of FIG. 42.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The present application may use formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

Generally, both commercial and consumer interests are becoming more concerned regarding origins of their food and other ingestible materials. Thus, tracking and testing systems to provide in depth information concerning provenance and other data associated with food and other ingestible materials including farming related production and other handling and processing can also be of interest.

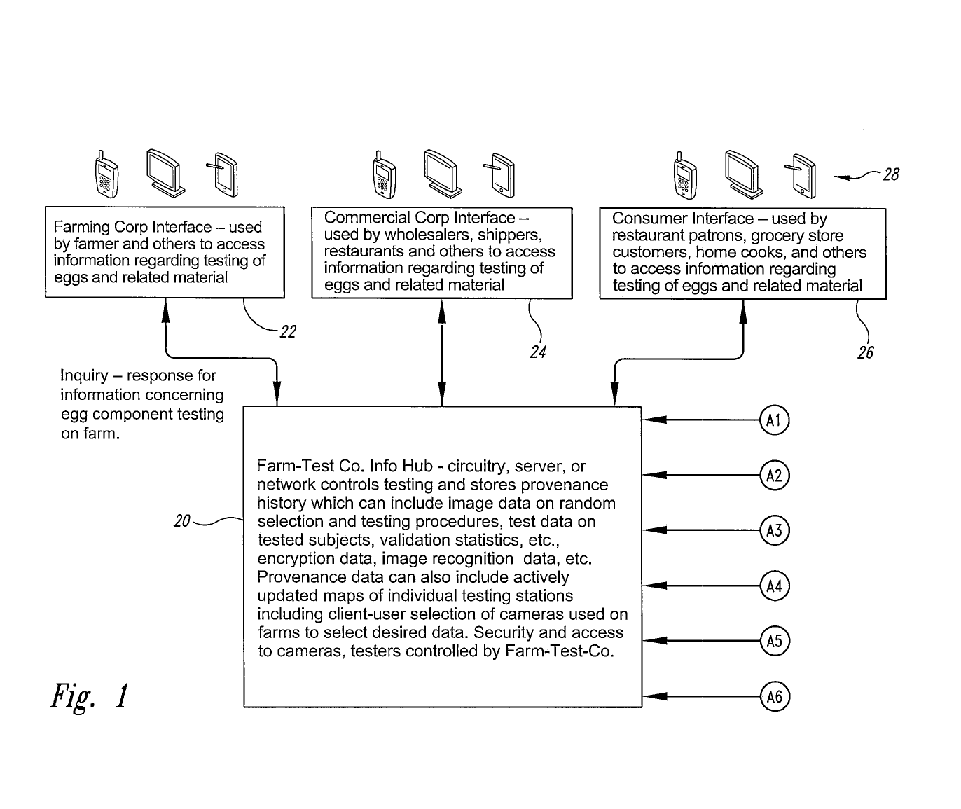

With reference now to the Figures, FIGS. 1-11 depict a schematic diagram of an environment(s) and/or an implementation(s) of technologies described herein. FIGS. 1-11 depict that including physical flows generally including indications as such by use of dashed arrows, the physical flows including that involving handling, testing, worker behavior, animal behavior, and other involvement of items, which can include feed, chicken, egg, carton, containers, transit, grocery store, receiving of containers, unpacking of cartons, shelving of cartons, shopping for cartons, in-store transit of cartons, purchase of carton, transit of carton to home, receiving carton at home, storage of carton at home, removal of egg and preparation of such, etc. Other physical flows are depicted to include transit of container to restaurant, receiving, unpacking, storage, etc. of container at restaurant, unpacking of egg and preparation of in dish, serving and purchasing of dish containing egg, etc. Physical flows are depicted to include testing of grain, chicken, egg, or other items.

FIGS. 1-11 depict that including information flows generally including indications as such by use of solid arrows, the information flows including image data sent from various imaging devices to information hubs, the image data including imaging of various stages of the physical flows. Information flows depicted also include inquiry-responses, initiating of devices, financial data, testing, etc. The information hubs are depicted to include those directed to information flows involving information obtained at farm, transit, restaurant, grocery, home or other locations. The information hubs are depicted to include interchange of information between each other. The information hubs are depicted to communicate with various interfaces to allow for communication therebetween by farming, commercial, restaurant, consumer and other interests. Information in information hubs can allow for research and other activities including determinations of compliance, noncompliance or s made during one or more physical flows. The examples depicted in FIGS. 1-11 are for illustrative purposes but are not intended to limit aspects to only these examples. Rather they serve to exemplify how data on food provenance and other ingestible material and other sorts of source data can be acquired through various tracking and testing for retrieval and inquiry through such as interfaces shown.

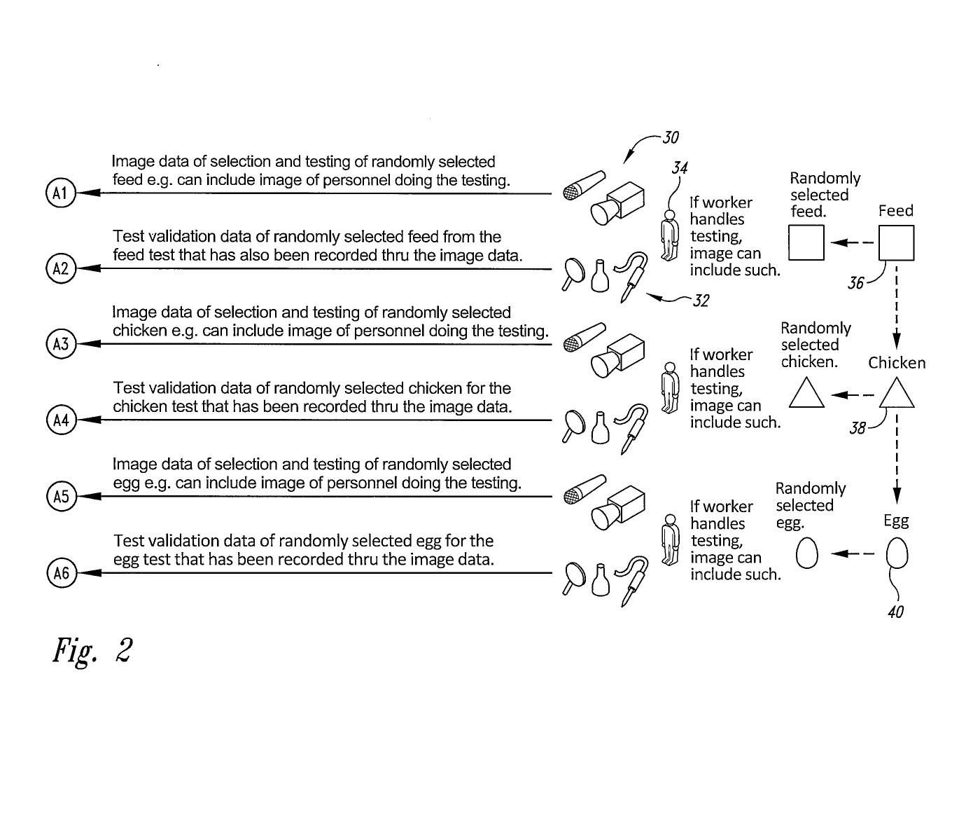

In particular, as shown in FIG. 1, interfaces 22, 24, and 26 are used to interact with Farm-Test Co. Info Hub 20 containing various information related to test of production factors and other items concerning one or more farming related production factors or other items. As shown in FIG. 2, production factors or ingestible material such as feed 36, chicken 38, and egg 40 can be monitored and tested through various sensors 30, 32 further described herein. Behavior of workers 34 can also be monitored.

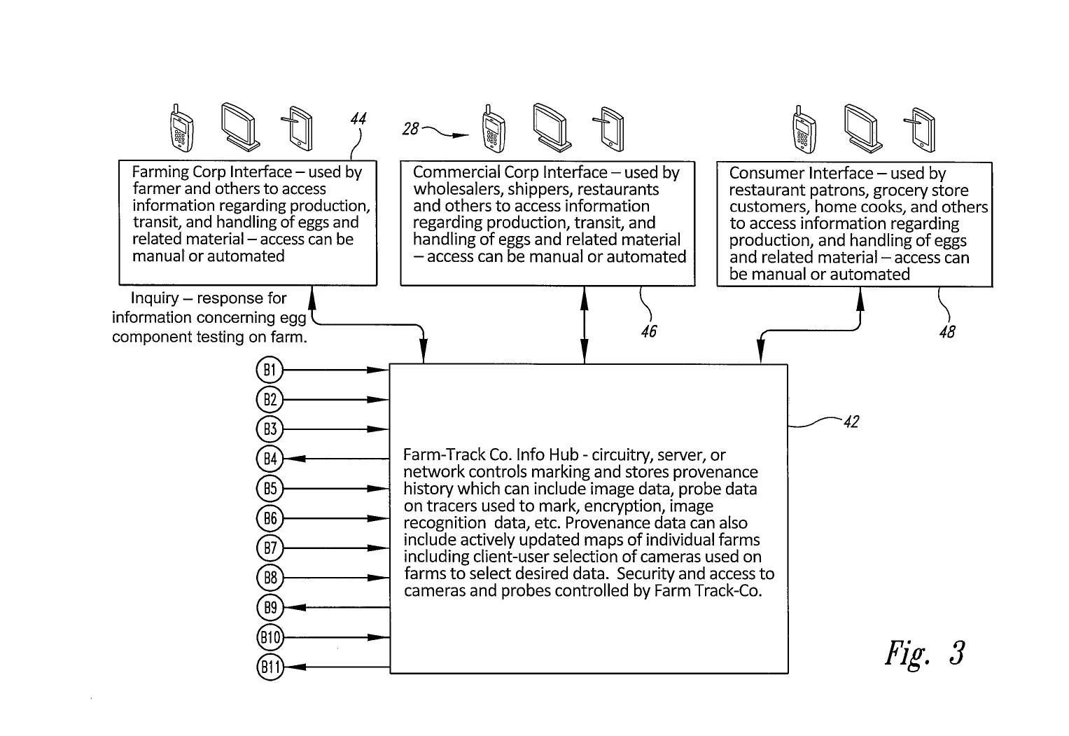

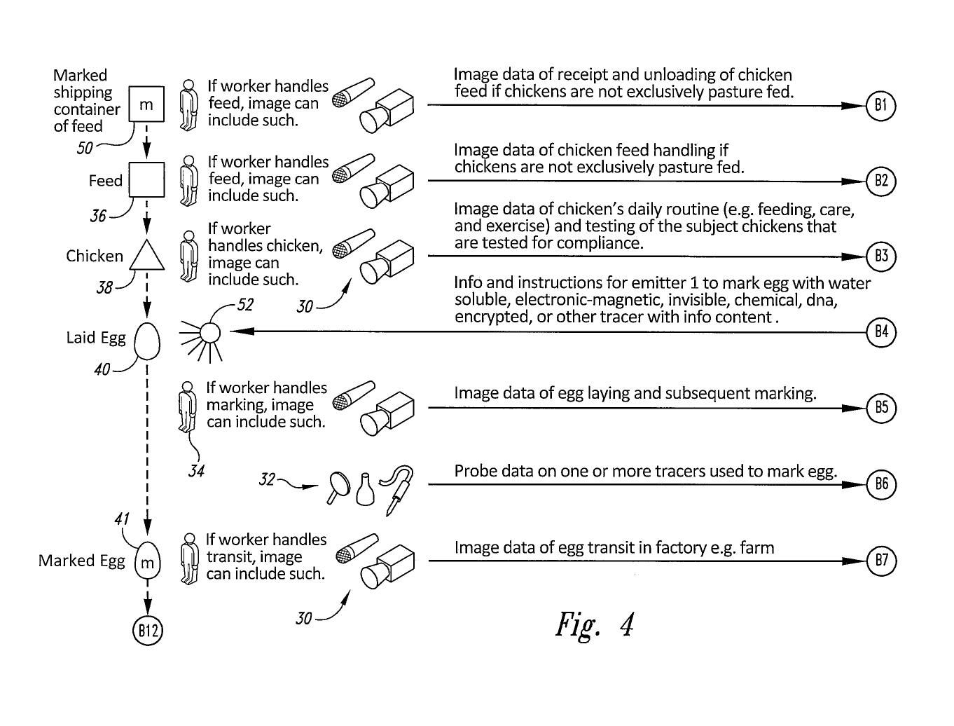

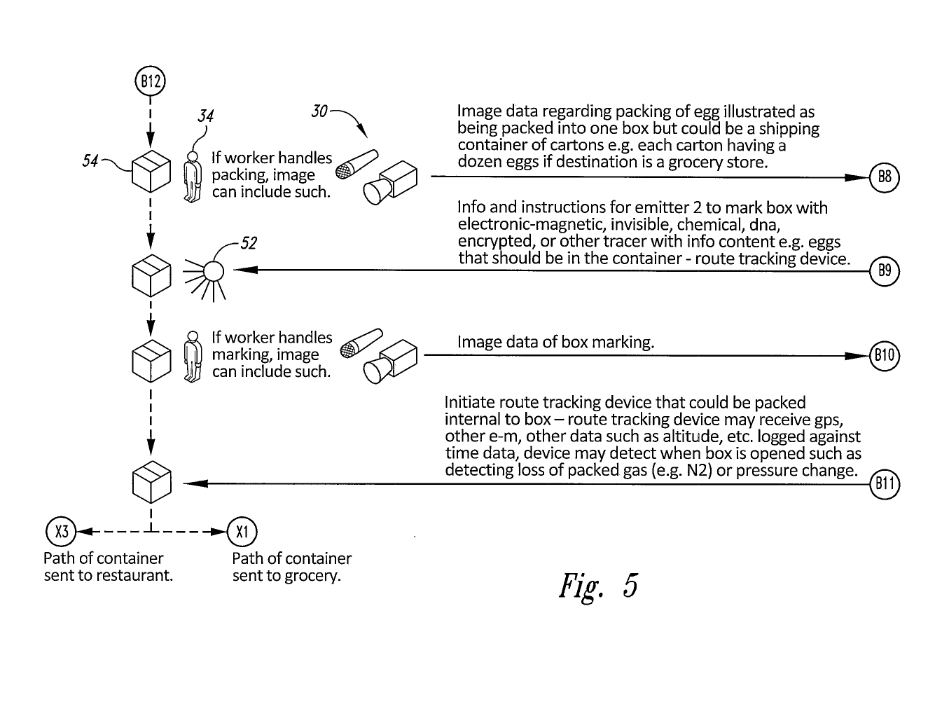

As shown in FIG. 3, interfaces 44, 46, and 48 are used to interact with Farm-Track Co. Info Hub 42 containing various information related to monitoring of production factors and other items concerning one or more farming related production factors or other items. As ingestible material is produced such as egg 40 later becoming marked egg 41 is packed, all such activity involved with such can also be monitored as shown in FIG. 4. The monitoring can be associated with tracers or other labels or marks and also identifiers or other identification information. These associations can be used to access monitoring or testing information through use of tracers and associated identifiers. The tracers can be located at least momentarily in proximity to ingestible material or other production factors to assist in accessing monitoring or testing information. Packing of ingestible material into shipping containers 54 such as shown in FIG. 5 can also be subject to monitoring and labeling of containers through emitters 52.

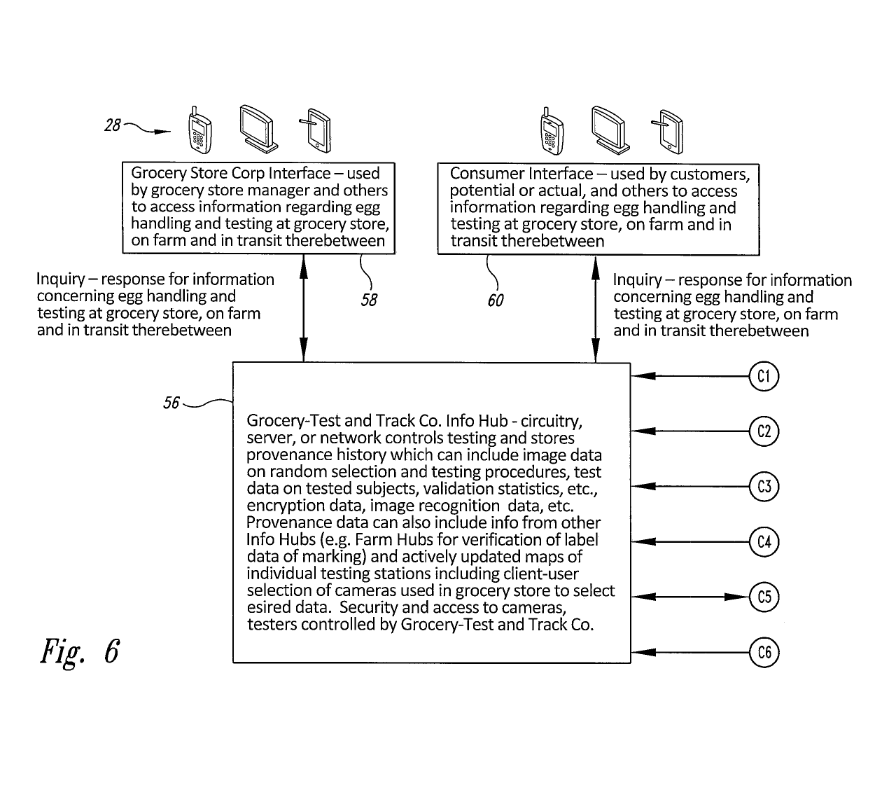

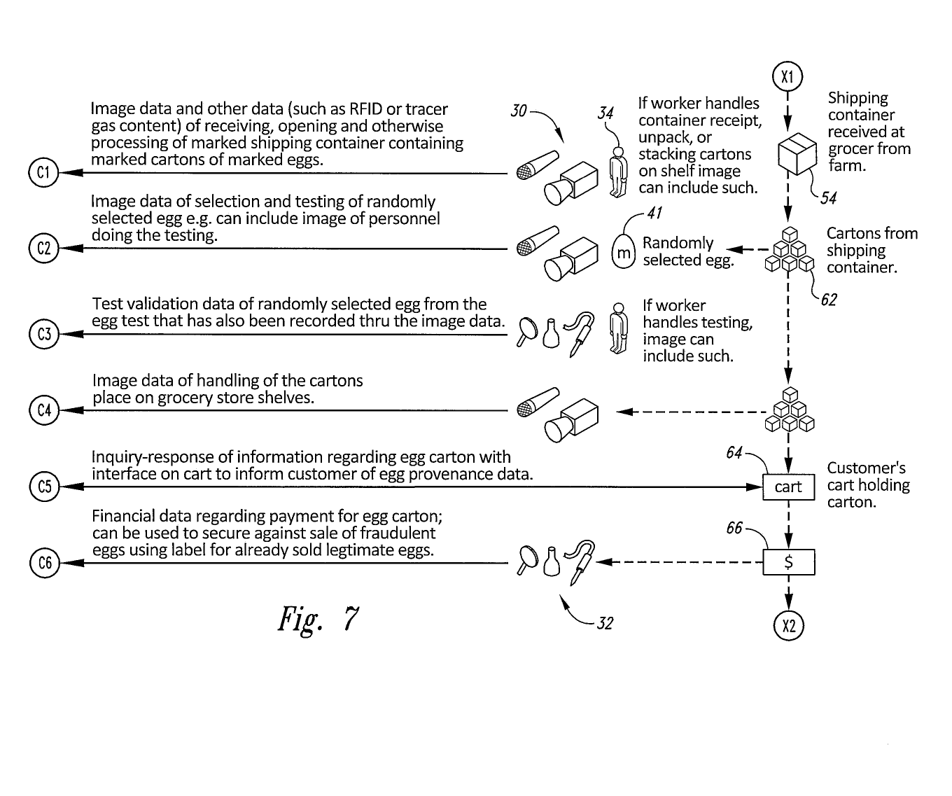

Further monitoring and testing can be performed at commercial locations with information stored on other information hubs such as grocery-test and track co info hub 56 as shown in FIG. 6. Monitoring of grocery activities, such as unpacking cartons 62, use of customer shopping carts 64, and purchase activity 66 shown in FIG. 7, can also be performed.

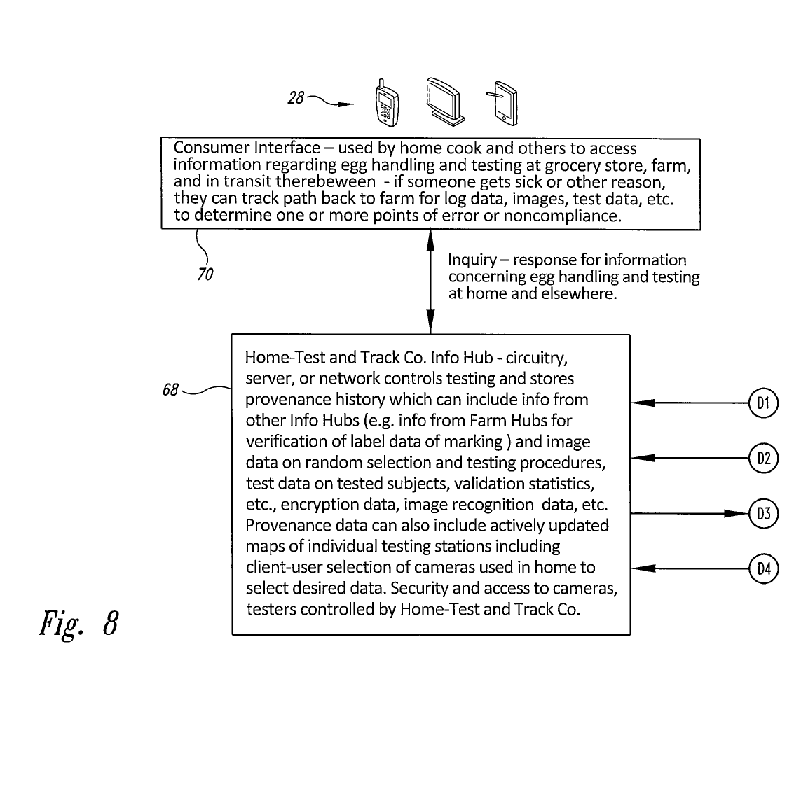

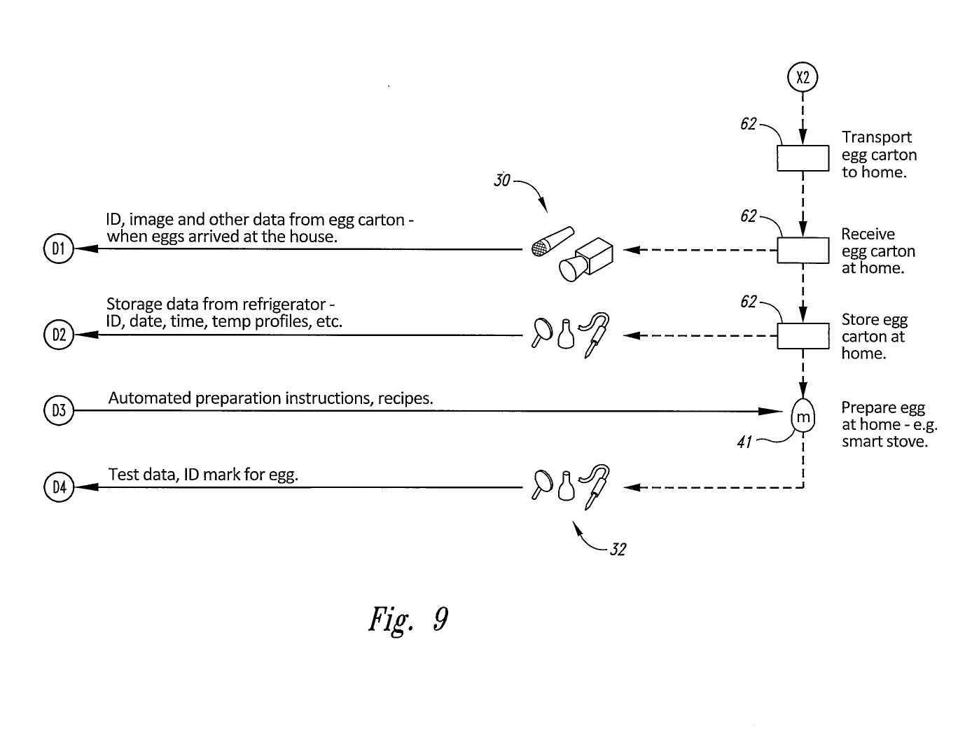

Monitoring, testing and accessing of data can be accomplished at home as well as depicted in FIG. 8 through use of a home-test track co. info hub 68 and consumer interfaces 28. Further illustrative home activities that can be monitored are shown in FIG. 9 to include transporting, receiving, storing and preparing ingestible material.

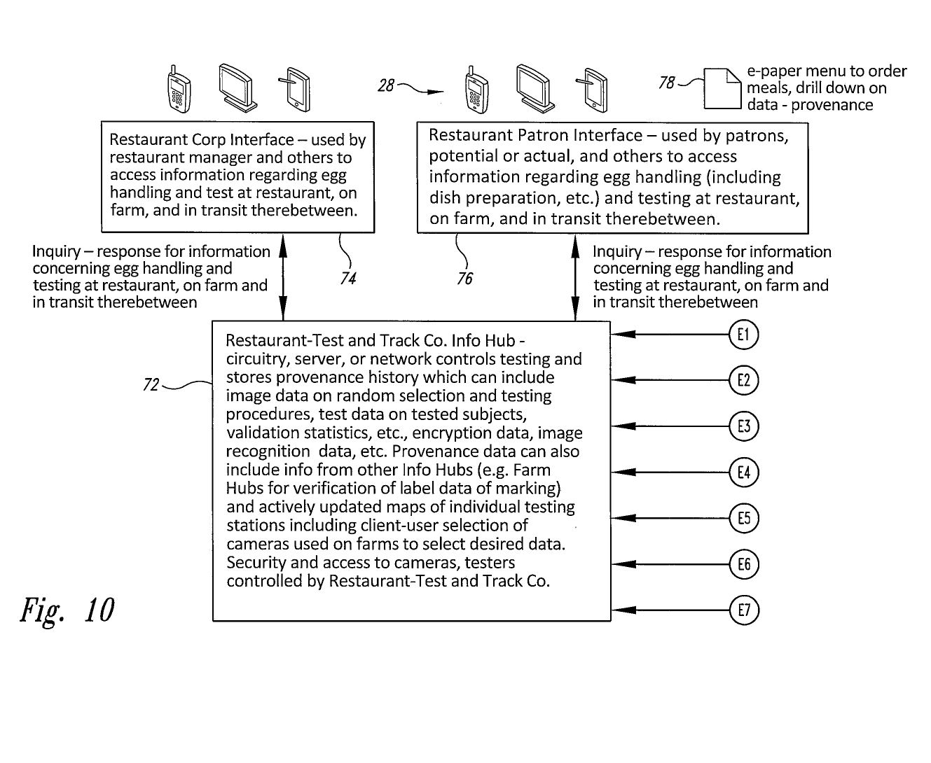

Other commercial venues for monitoring and testing can include restaurants as illustrated in FIG. 10 to include restaurant-test and track co. info hub 72 that can be used for storage and access of provenance data and also monitoring data of activities conducted at a restaurant. This data can be access by both restaurant personnel and restaurant patrons such as through interfaces 74, 76, and 78 to include menuing systems for the patrons.

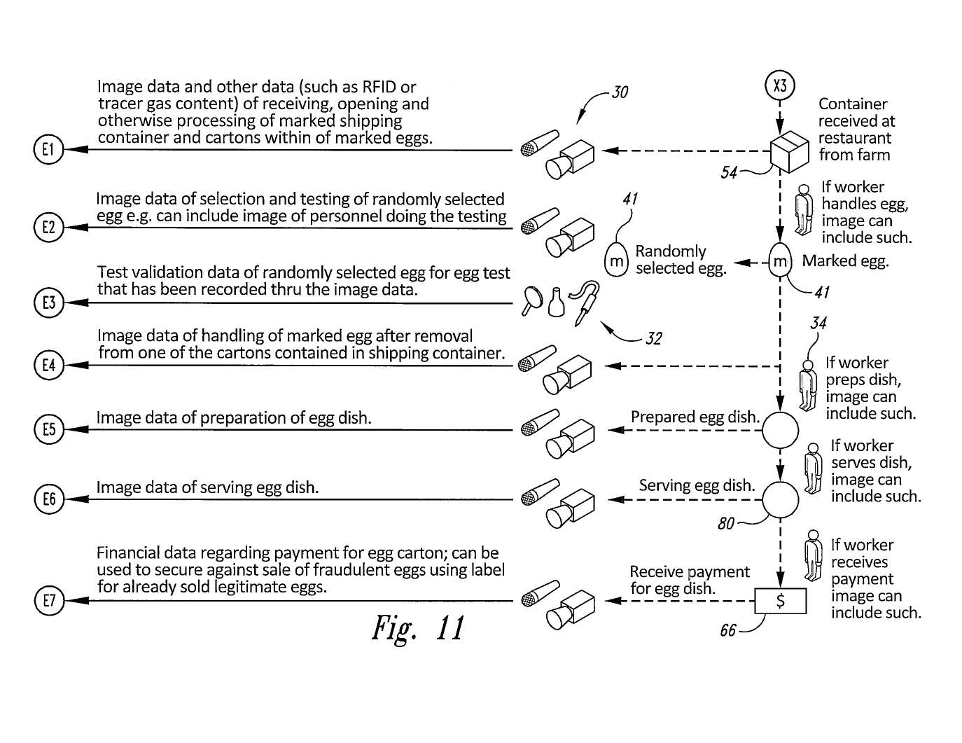

Activities conducted in a restaurant including those depicted in FIG. 11 such as receiving, handling, preparing, serving 80, and transacting payment can be included in monitoring and testing aspects to be stored on the restaurant-test and track co info hub 72 or elsewhere.

Various aspects embodied and illustrated through FIGS. 1-11 can be enumerated below and are provided to provide examples but are not intended to be limiting.

Food Supply Chain Automation
1. Feed (e.g. grain) Farm Track Information Hub
   a. receive fertilizer track and test hub information
   b. receive fertilizer container tracer information or fertilizer tracer information
   c. verify fertilizer container tracer information or fertilizer tracer information with fertilizer track hub information
   d. receive internal fertilizer container tracker information
   e. verify internal fertilizer container tracker information with fertilizer track hub information
   f. receive local fertilizer container handling audio-video and sensor information
   g. scan local fertilizer container handling audio-video and sensor information for error or noncompliance
   h. receive accounting information of production factor use for local fertilizer container handling
   i. correlate local fertilizer container handling audio-video and sensor information with accounting information of production factor use for local fertilizer container handling
   j. associate local fertilizer container handling audio-video and sensor information with fertilizer tracer information
   k. receive local fertilizer handling audio-video and sensor information
   l. scan local fertilizer handling audio-video and sensor information for error or noncompliance
   m. receive accounting information of production factor use for local fertilizer handling
   n. correlate local fertilizer behavior and handling audio-video and sensor information with accounting information of production factor use for local fertilizer handling
   o. associate local fertilizer handling audio-video and sensor information with animal tracer information
   p. receive local feed (grain) handling audio-video and sensor information
   q. associate local feed handling audio-video and sensor information with feed container tracer information or feed tracer information
   r. receive local grain field handling audio-video and sensor information
   s. scan local grain field handling audio-video and sensor information for error or noncompliance
   t. receive accounting information of production factor use for local grain field handling
   u. correlate local grain field handling audio-video and sensor information with accounting information of production factor use for local fertilizer handling
   v. associate local grain field handling audio-video and sensor information with animal tracer information
2. Animal (e.g. chicken) Farm Track and Test Information Hub
   a. receive feed track hub information
   b. receive feed container tracer information or feed tracer information
   c. verify feed container tracer information or feed tracer information with feed track hub information
   d. receive internal feed container tracker information
   e. verify internal feed container tracker information with feed track hub information
   f. receive local feed handling audio-video and sensor information
   g. associate local feed handling audio-video and sensor information with chicken tracer information
   h. scan local feed handling audio-video and sensor information for error or noncompliance
   i. receive accounting information of production factor use for local feed handling
   j. correlate local feed handling audio-video and sensor information with accounting information of production factor use for local feed handling
   k. send alert to initiate feed sample test event
   l. receive feed test sample tracer information
   m. verify feed test sample tracer information with egg track hub information
   n. receive feed test sample handling audio-video and sensor information
   o. associate feed test sample handing audio-video and sensor information with chicken tracer information
   p. scan feed test sample handling audio-video and sensor information for error or noncompliance
   q. receive accounting information of production factor use for feed test sample handling
   r. correlate feed test sample handling audio-video and sensor information with accounting information of production factor use for feed test sample handling
   s. receive test results for feed test sample
   t. associate test results for feed test sample with feed test sample tracer information
   u. update feed (grain) farm track information hub re butchered chicken portion test sample testing
   v. receive local chicken behavior and handling audio-video and sensor information
   w. associate local chicken behavior and handling audio-video and sensor information with chicken tracer information
   x. scan local chicken behavior and handling audio-video and sensor information for error or noncompliance
   y. receive accounting information of production factor use for local chicken behavior and handling
   z. correlate local chicken behavior and handling audio-video and sensor information with accounting information of production factor use for local chicken behavior and handling
   aa. send alert to initiate chicken sample test event
   bb. receive chicken test sample tracer information
   cc. verify chicken test sample tracer information with egg track hub information
   dd. receive chicken test sample handling audio-video and sensor information
   ee. associate chicken test sample handing audio-video and sensor information with chicken tracer information
   ff. scan chicken test sample handling audio-video and sensor information for error or noncompliance
   gg. receive accounting information of production factor use for chicken test sample handling
   hh. correlate chicken test sample handling audio-video and sensor information with accounting information of production factor use for chicken test sample handling
   ii. receive test results for chicken test sample
   jj. associate test results for chicken test sample with chicken test sample tracer information
   kk. update feed (grain) farm track information hub re chicken test sample testing
   ll. scan chicken behavior and handling audio-video and sensor information to determine egg was laid
   mm. instruct emitter to mark laid egg with egg tracer(s) upon determining egg was laid
   nn. receive local egg marking audio-video and sensor information
   oo. scan local egg marking audio-video and sensor information for error or noncompliance
   pp. receive accounting information of production factor use for local egg marking
   qq. correlate local egg marking audio-video and sensor information with accounting information of production factor use for local egg marking
   rr. associate audio-video and sensor information of egg marking with egg tracer information
   ss. associate egg tracer information with tracer information of chicken that laid egg
   tt. receive local egg handling audio-video and sensor information
   uu. scan local egg handling audio-video and sensor information for error or noncompliance
   vv. receive accounting information of production factor use for local egg handling
   ww. correlate local egg handling audio-video and sensor information with accounting information of production factor use for local egg handling
   xx. associate local egg handling audio-video and sensor information with egg tracer information
   yy. send alert to initiate egg sample test event
   zz. receive egg test sample tracer information
   aaa. verify egg test sample tracer information with egg track hub information
   bbb. receive egg test sample handling audio-video and sensor information
   ccc. associate egg test sample handing audio-video and sensor information with chicken tracer information
   ddd. scan egg test sample handling audio-video and sensor information for error or noncompliance
   eee. receive accounting information of production factor use for egg test sample handling
   fff. correlate egg test sample handling audio-video and sensor information with accounting information of production factor use for egg test sample handling
   ggg. receive test results for egg test sample
   hhh. associate test results for egg test sample with egg test sample tracer information
   iii. update feed (grain) farm track information hub re egg test sample testing
   jjj. receive local egg hatching into hatched chicken audio-video and sensor information
   kkk. scan local egg hatching into hatched audio-video and sensor information for error or noncompliance
   lll. receive accounting information of production factor use for local egg hatching into hatched chicken
   mmm. correlate local egg hatching audio-video and sensor information with accounting information of production factor use for local egg hatching into hatched chicken
   nnn. associate local egg hatching into hatched chicken audio-video and sensor information with egg tracer information
   ooo. send alert to initiate hatched chicken sample test event
   ppp. receive hatched chicken test sample tracer information
   qqq. verify hatched chicken test sample tracer information with egg track hub information
   rrr. receive hatched chicken test sample handling audio-video and sensor information
   sss. associate hatched chicken test sample handing audio-video and sensor information with chicken tracer information
   ttt. scan hatched chicken test sample handling audio-video and sensor information for error or noncompliance
   uuu. receive accounting information of production factor use for hatched chicken test sample handling
   vvv. correlate hatched chicken test sample handling audio-video and sensor information with accounting information of production factor use for hatched chicken test sample handling
   www. receive test results for hatched chicken test sample
   xxx. associate test results for hatched chicken test sample with hatched chicken test sample tracer information
   yyy. update feed (grain) farm track information hub re hatched chicken test sample testing
   zzz. instruct emitter to mark local hatched chicken with hatched chicken tracer(s)
   aaaa. receive local hatched chicken marking audio-video and sensor information
   bbbb. scan local hatched chicken marking audio-video and sensor information for error or noncompliance
   cccc. receive accounting information of production factor use for local hatched chicken marking
   dddd. correlate local hatched chicken marking audio-video and sensor information with accounting information of production factor use for local hatched chicken marking
   eeee. associate local hatched chicken audio-video and sensor information with local hatched chicken tracer information
   ffff. receive local hatched chicken behavior audio-video and sensor information
   gggg. scan local hatched chicken behavior audio-video and sensor information for error or noncompliance
   hhhh. receive accounting information of production factor use for local hatched chicken behavior
   iiii. correlate local hatched chicken behavior audio-video and sensor information with accounting information of production factor use for local hatched chicken behavior
   jjjj. associate local hatched chicken behavior audio-video and sensor information with local hatched chicken tracer information
   kkkk. send alert to initiate hatched chicken sample test event
   llll. receive hatched chicken test sample tracer information
   mmmm. verify hatched chicken test sample tracer information with egg track hub information
   nnnn. receive hatched chicken test sample handling audio-video and sensor information
   oooo. associate hatched chicken test sample handing audio-video and sensor information with chicken tracer information
   pppp. scan hatched chicken test sample handling audio-video and sensor information for error or noncompliance
   qqqq. receive accounting information of production factor use for hatched chicken test sample handling
   rrrr. correlate hatched chicken test sample handling audio-video and sensor information with accounting information of production factor use for hatched chicken test sample handling
   ssss. receive test results for hatched chicken test sample
   tttt. associate test results for hatched chicken test sample with hatched chicken test sample tracer information
   uuuu. update feed (grain) farm track information hub re hatched chicken test sample testing
   vvvv. scan handling and behavior of local hatched chicken to determine when slaughter of local hatched chicken occurs
   wwww. scan handling of slaughter of local hatched chicken for error or non-compliance
   xxxx. receive accounting information of production factor use for slaughter of local hatched chicken
   yyyy. correlate slaughter of local hatched chicken behavior audio-video and sensor information with accounting information of production factor use for slaughter of local hatched chicken
   zzzz. associate slaughter of local hatched chicken audio-video and sensor information with local hatched chicken tracer information
   aaaaa. scan handling and behavior of local hatched chicken to determine when butcher of local hatched chicken occurs
   bbbbb. scan handling of butcher of local hatched chicken for error or non-compliance
   ccccc. receive accounting information of production factor use for butcher of local hatched chicken
   ddddd. correlate butcher of local hatched chicken audio-video and sensor information with accounting information of production factor use for butcher of local hatched chicken
   eeeee. associate butcher of local hatched chicken audio-video and sensor information with local hatched chicken tracer
   fffff. instruct emitter to mark each portion of butchered chicken with chicken portion tracer(s)
   ggggg. receive butchered chicken portion marking audio-video and sensor information
   hhhhh. scan butchered chicken portion marking audio-video and sensor information for error or noncompliance
   iiiii. receive accounting information of production factor use for butchered chicken portion marking
   jjjjj. correlate butchered chicken portion marking audio-video and sensor information with accounting information of production factor use for butchered chicken portion marking
   kkkkk. associate butchered chicken portion marking audio-video and sensor information with butchered chicken portion tracer information
   lllll. send alert to initiate butchered chicken portion sample test event
   mmmmm. receive butchered chicken portion test sample tracer information
   nnnnn. verify butchered chicken portion test sample tracer information with egg track hub information
   ooooo. receive butchered chicken portion test sample handling audio-video and sensor information
   ppppp. associate butchered chicken portion test sample handing audio-video and sensor information with chicken tracer information
   qqqqq. scan butchered chicken portion test sample handling audio-video and sensor information for error or noncompliance
   rrrrr. receive accounting information of production factor use for butchered chicken portion test sample handling
   sssss. correlate butchered chicken portion test sample handling audio-video and sensor information with accounting information of production factor use for butchered chicken portion test sample handling
   ttttt. receive test results for butchered chicken portion test sample
   uuuuu. associate test results for butchered chicken portion test sample with butchered chicken portion test sample tracer information
   vvvvv. update feed (grain) farm track information hub re butchered chicken portion test sample testing
   wwwww. receive local packing butchered chicken portion into butchered chicken portion carton audio-video and sensor information
   xxxxx. scan local packing butchered chicken portion into butchered chicken portion carton handling audio-video and sensor information for error or noncompliance
   yyyyy. receive accounting information of production factor use for local packing butchered chicken portion into butchered chicken portion carton
   zzzzz. correlate local packing butchered chicken portion into butchered chicken portion carton handling audio-video and sensor information with accounting information of production factor use for local packing butchered chicken portion into butchered chicken portion carton
   aaaaaa. associate local packing butchered chicken portion into butchered chicken portion carton audio-video and sensor information with butchered chicken portion tracer information
   bbbbbb. instruct emitter to mark butchered chicken portion carton with butchered chicken portion carton tracer(s)
   cccccc. receive local butchered chicken portion carton marking audio-video and sensor information
   dddddd. scan local butchered chicken portion carton marking audio-video and sensor information for error or noncompliance
   eeeeee. receive accounting information of production factor use for local butchered chicken portion carton marking
   ffffff. correlate local butchered chicken portion carton marking audio-video and sensor information with accounting information of production factor use for local butchered chicken portion carton marking
   gggggg. associate butchered chicken portion carton marking audio-video and sensor information with butchered chicken portion carton tracer information
   hhhhhh. receive local packing butchered chicken portion carton into carton container audio-video and sensor information
   iiiiii. scan local packing butchered chicken portion carton into carton container audio-video and sensor information for error or noncompliance
   jjjjjj. receive accounting information of production factor use for local packing butchered chicken portion carton into carton container
   kkkkkk. correlate local packing butchered chicken portion carton into carton container audio-video and sensor information with accounting information of production factor use for local packing butchered chicken portion carton into carton container
   llllll. associate local packing butchered chicken portion carton into carton container audio-video and sensor information with carton container tracer information
   mmmmmm. instruct emitter to mark carton container with carton container tracer(s)
   nnnnnn. receive local carton container marking audio-video and sensor information
   oooooo. scan local carton container marking audio-video and sensor information for error or noncompliance
   pppppp. receive accounting information of production factor use for local carton container marking
   qqqqqq. correlate local carton container marking audio-video and sensor information with accounting information of production factor use for local carton container marking
   rrrrrr. associate local carton container marking audio-video and sensor information with carton container tracer information
3. Egg Farm Track Information Hub
   a. receive feed track hub information
   b. receive feed container tracer information or feed tracer information
   c. verify feed container tracer information or feed tracer information with feed track hub information
   d. receive internal feed container tracker information
   e. verify internal feed container tracker information with feed track hub information
   f. receive local feed handling audio-video and sensor information
   g. associate local feed handling audio-video and sensor information with chicken tracer information
   h. scan local feed handling audio-video and sensor information for error or noncompliance
   i. receive accounting information of production factor use for local feed handling
   j. correlate local feed handling audio-video and sensor information with accounting information of production factor use for local feed handling
   k. receive chicken track hub information
   l. receive chicken container tracer information or chicken tracer information
   m. verify chicken container tracer information or chicken tracer information with chicken track hub information
   n. receive internal chicken container tracker information
   o. verify internal chicken container tracker information with chicken track hub information
   p. receive local chicken behavior and handling audio-video and sensor information
   q. associate local chicken behavior and handling audio-video and sensor information with chicken tracer information
   r. scan local chicken behavior and handling audio-video and sensor information for error or noncompliance
   s. receive accounting information of production factor use for local chicken behavior and handling
   t. correlate local chicken behavior and handling audio-video and sensor information with accounting information of production factor use for local chicken behavior and handling
   u. scan chicken behavior and handling audio-video and sensor information to determine egg was laid
   v. instruct emitter to mark laid egg with egg tracer(s) upon determining egg was laid
   w. receive local egg marking audio-video and sensor information
   x. scan local egg marking audio-video and sensor information for error or noncompliance
   y. receive accounting information of production factor use for local egg marking
   z. correlate local egg marking audio-video and sensor information with accounting information of production factor use for local egg marking
   aa. associate audio-video and sensor information of egg marking with egg tracer information
   bb. associate egg tracer information with tracer information of chicken that laid egg
   cc. receive local egg handling (includes marking) audio-video and sensor information
   dd. scan local egg handling audio-video and sensor information for error or noncompliance
   ee. receive accounting information of production factor use for local egg handling
   ff. correlate local egg handling audio-video and sensor information with accounting information of production factor use for local egg handling
   gg. associate local egg handling audio-video and sensor information with egg tracer information
   hh. receive local packing egg into egg carton audio-video and sensor information
   ii. scan local packing egg into egg carton handling audio-video and sensor information for error or noncompliance
   jj. receive accounting information of production factor use for local packing egg into egg carton
   kk. correlate local packing egg into egg carton handling audio-video and sensor information with accounting information of production factor use for local packing egg into egg carton
   ll. associate local packing egg into egg carton audio-video and sensor information with egg tracer information
   mm. instruct emitter to mark egg carton with egg carton tracer(s)
   nn. receive local egg carton marking audio-video and sensor information
   oo. scan local egg carton marking audio-video and sensor information for error or noncompliance
   pp. receive accounting information of production factor use for local egg carton marking
   qq. correlate local egg carton marking audio-video and sensor information with accounting information of production factor use for local egg carton marking
   rr. associate egg carton marking audio-video and sensor information with egg carton tracer information
   ss. receive local egg carton handling audio-video and sensor handling information
   tt. scan local egg carton handling audio-video and sensor information for error or noncompliance
   uu. receive accounting information of production factor use for local egg carton handling
   vv. correlate local egg carton handling audio-video and sensor information with accounting information of production factor use for local egg carton handling
   ww. associate local egg carton handling audio-video and sensor information with egg carton tracer information
   xx. associate carton tracer information with egg tracer information
   yy. receive local packing egg carton into carton container audio-video and sensor information
   zz. scan local packing egg carton into carton container audio-video and sensor information for error or noncompliance
   aaa. receive accounting information of production factor use for local packing egg carton into carton container
   bbb. correlate local packing egg carton into carton container audio-video and sensor information with accounting information of production factor use for local packing egg carton into carton container
   ccc. associate local packing egg carton into carton container audio-video and sensor information with carton container tracer information
   ddd. instruct emitter to mark carton container with carton container tracer(s)
   eee. receive local carton container marking audio-video and sensor information
   fff. scan local carton container marking audio-video and sensor information for error or noncompliance
   ggg. receive accounting information of production factor use for local carton container marking
   hhh. correlate local carton container marking audio-video and sensor information with accounting information of production factor use for local carton container marking
   iii. associate local carton container marking audio-video and sensor information with carton container tracer information
   jjj. receive local carton container handling audio-video and sensor information
   kkk. scan local carton container handling audio-video and sensor information for error or noncompliance
   lll. receive accounting information of production factor use for local carton container handling
   mmm. correlate local carton container handling audio-video and sensor information with accounting information of production factor use for local carton container handling
   nnn. associate carton container handling audio-video and sensor information with carton container tracer information
   ooo. associate carton container tracer information with egg carton tracer information
   ppp. initiate tracker placed internally in carton container during packing thereof
   qqq. receive egg test hub information
4. Egg Farm Test Information Hub
   a. receive egg track hub information
   b. send alert to initiate local feed sample test event
   c. receive local feed test sample tracer information
   d. verify local feed test sample tracer information with egg track hub information
   e. receive local feed test sample handling audio-video and sensor information
   f. associate local feed test sample handing audio-video and sensor information with local feed test sample tracer information
   g. scan local feed test sample handling audio-video and sensor information for error or noncompliance
   h. receive accounting information of production factor use for local feed test sample handling
   i. correlate local feed test sample handling audio-video and sensor information with accounting information of production factor use for local feed test sample handling
   j. receive test results for local feed test sample
   k. associate test results for local feed test sample with local feed test sample tracer information
   l. update egg farm track information hub re local feed test sample testing
   m. update chicken farm track information hub re local feed test sample testing
   n. update feed (grain) farm track information hub re local feed test sample testing
   o. send alert to initiate local chicken sample test event
   p. receive local chicken test sample tracer information
   q. verify local chicken test sample tracer information with egg track hub information
   r. receive local chicken test sample handling audio-video and sensor information
   s. associate local chicken test sample handing audio-video and sensor information with chicken tracer information
   t. scan local chicken test sample handling audio-video and sensor information for error or noncompliance
   u. receive accounting information of production factor use for local chicken test sample handling
   v. correlate local chicken test sample handling audio-video and sensor information with accounting information of production factor use for local chicken test sample handling
   w. receive test results for local chicken test sample
   x. associate test results for local chicken test sample with local chicken test sample tracer information
   y. update egg farm track information hub re local chicken test sample testing
   z. update chicken farm track information hub re local chicken test sample testing
   aa. update feed (grain) farm track information hub re local chicken test sample testing
   bb. receive local egg test sample tracer information
   cc. verify local egg test sample tracer information with egg track hub information
   dd. receive local egg test sample handling audio-video and sensor information
   ee. associate local egg test sample handing audio-video and sensor information with egg tracer information
   ff. scan local egg test sample handling audio-video and sensor information for error or noncompliance
   gg. receive accounting information of production factor use for local egg test sample handling
   hh. correlate local egg test sample handling audio-video and sensor information with accounting information of production factor use for local egg test sample handling
   ii. receive test results for local egg test sample
   jj. associate test results for local egg test sample with local egg test sample tracer information
   kk. update egg farm track information hub re local egg test sample testing
   ll. update chicken farm track information hub re local egg test sample testing
   mm. update feed (grain) farm track information hub re local egg test sample testing
5. Restaurant Test and Track Information Hub
   a. receive egg farm track hub information
   b. receive egg farm test hub information
   c. receive carton container tracer information
   d. verify carton container tracer information with egg track hub information
   e. receive internal carton container tracker information
   f. verify internal carton container tracker information with egg track hub information
   g. receive local carton container handling audio-video and sensor information
   h. scan local carton container handling audio-video and sensor information for error or noncompliance
   i. receive accounting information of production factor use for local carton container handling
   j. correlate local carton container handling audio-video and sensor information with accounting information of production factor use for local carton container handling
   k. associate local handling of carton container audio-video and sensor information with carton container tracer information
   l. receive local egg carton handling audio-video and sensor information
   m. scan local egg carton handling audio-video and sensor information for error or noncompliance
   n. receive accounting information of production factor use for local egg carton handling
   o. correlate local egg carton handling audio-video and sensor information with accounting information of production factor use for local egg carton handling
   p. associate local egg carton handling audio-video and sensor information with egg carton tracer information
   q. receive local egg handling audio-video and sensor information
   r. scan local egg handling audio-video and sensor information for error or noncompliance
   s. receive accounting information of production factor use for local egg handling
   t. correlate local egg handling audio-video and sensor information with accounting information of production factor use for local egg handling
   u. associate local egg handling audio-video and sensor information with egg tracer information
   v. send alert to initiate local egg sample test event
   w. receive local egg test sample tracer information
   x. verify local egg test sample tracer information with egg track hub information
   y. receive local egg test sample handling audio-video and sensor information
   z. associate local egg test sample handing audio-video and sensor information with egg tracer information
   aa. scan local egg test sample handling audio-video and sensor information for error or noncompliance
   bb. receive accounting information of production factor use for local egg test sample handling
   cc. correlate local egg test sample handling audio-video and sensor information with accounting information of production factor use for local egg test sample handling
   dd. receive test results for local egg test sample
   ee. associate test results for local egg test sample with local egg test sample tracer information
   ff. update egg farm track information hub re local egg test sample testing
   gg. update chicken farm track information hub re local egg test sample testing
   hh. update feed (grain) farm track information hub re local egg test sample testing
   ii. receive local egg dish preparation audio-video and sensor information
   jj. scan local egg dish preparation audio-video and sensor information for error or noncompliance
   kk. receive accounting information of production factor use for local egg dish preparation
   ll. correlate local egg dish preparation audio-video and sensor information with accounting information of production factor use for local egg dish preparation
   mm. associate local egg dish preparation audio-video and sensor information with egg tracer information
   nn. receive local egg dish serving audio-video and sensor information
   oo. scan local egg dish serving audio-video and sensor information for error or noncompliance
   pp. receive accounting information of production factor use for local egg dish serving
   qq. correlate local egg dish serving audio-video and sensor information with accounting information of production factor use for local egg dish serving
   rr. associate local egg dish serving audio-video and sensor information with egg tracer information
   ss. receive local egg dish payment audio-video and sensor information
   tt. scan local egg dish payment audio-video and sensor information for error or noncompliance
   uu. receive accounting information of production factor use for local egg dish payment
   vv. correlate local egg dish payment audio-video and sensor information with accounting information of production factor use for local egg dish payment
   ww. associate local egg dish payment audio-video and sensor information with egg tracer information
6. Grocery Test and Track Information Hub
   a. receive egg farm track hub information
   b. receive egg farm test hub information
   c. receive carton container tracer information
   d. verify carton container tracer information with egg track hub information
   e. receive internal carton container tracker information
   f. verify internal carton container tracker information with egg track hub information
   g. receive local carton container handling audio-video and sensor information
   h. scan local carton container handling audio-video and sensor information for error or noncompliance
   i. receive accounting information of production factor use for local carton container handling
   j. correlate local carton container handling audio-video and sensor information with accounting information of production factor use for local carton container handling
   k. associate local handling of carton container audio-video and sensor information with carton container tracer information
   l. receive local egg carton handling audio-video and sensor information
   m. scan local egg carton handling audio-video and sensor information for error or noncompliance
   n. receive accounting information of production factor use for local egg carton handling
   o. correlate local egg carton handling audio-video and sensor information with accounting information of production factor use for local egg carton handling
   p. associate local egg carton handling audio-video and sensor information with egg carton tracer information
   q. send alert to initiate local egg sample test event
   r. receive local egg test sample tracer information
   s. verify local egg test sample tracer information with egg track hub information
   t. receive local egg test sample handling audio-video and sensor information
   u. associate local egg test sample handing audio-video and sensor information with egg tracer information
   v. scan local egg test sample handling audio-video and sensor information for error or noncompliance
   w. receive accounting information of production factor use for local egg test sample handling
   x. correlate local egg test sample handling audio-video and sensor information with accounting information of production factor use for local egg test sample handling
   y. receive test results for local egg test sample
   z. associate test results for local egg test sample with local egg test sample tracer information
   aa. update egg farm track information hub re local egg test sample testing
   bb. update chicken farm track information hub re local egg test sample testing
   cc. update feed (grain) farm track information hub re local egg test sample testing
   dd. receive local egg carton payment audio-video and sensor information
   ee. scan local egg carton payment audio-video and sensor information for error or noncompliance
   ff. receive accounting information of production factor use for local egg carton payment
   gg. correlate local egg carton payment audio-video and sensor information with accounting information of production factor use for local egg carton payment
   hh. associate local egg carton payment audio-video and sensor information with egg carton tracer information
7. Home Test and Track Information Hub
   a. receive grocery test and track hub information
   b. receive egg carton tracer information
   c. verify egg carton tracer information with egg track hub information
   d. receive internal carton container tracker information
   e. verify internal carton container tracker information with egg track hub information
   f. receive local egg carton handling audio-video and sensor information
   g. scan local egg carton handling audio-video and sensor information for error or noncompliance
   h. receive accounting information of production factor use for local egg carton handling
   i. correlate local egg carton handling audio-video and sensor information with accounting information of production factor use for local egg carton handling
   j. associate local egg carton handling audio-video and sensor information with egg carton tracer information
   k. receive local egg handling audio-video and sensor information
   l. scan local egg handling audio-video and sensor information for error or noncompliance
   m. receive accounting information of production factor use for local egg handling
   n. correlate local egg handling audio-video and sensor information with accounting information of production factor use for local egg handling
   o. associate local egg handling audio-video and sensor information with egg tracer information
   p. send alert to initiate local egg sample test event
   q. receive local egg test sample tracer information
   r. verify local egg test sample tracer information with egg track hub information
   s. receive local egg test sample handling audio-video and sensor information
   t. associate local egg test sample handing audio-video and sensor information with egg tracer information
   u. scan local egg test sample handling audio-video and sensor information for error or noncompliance
   v. receive accounting information of production factor use for local egg test sample handling
   w. correlate local egg test sample handling audio-video and sensor information with accounting information of production factor use for local egg test sample handling
   x. receive test results for local egg test sample
   y. associate test results for local egg test sample with local egg test sample tracer information
   z. update grocery track information hub re local egg test sample testing
   aa. update egg farm track information hub re local egg test sample testing
   bb. update chicken farm track information hub re local egg test sample testing
   cc. update feed (grain) farm track information hub re local egg test sample testing
   dd. receive local egg dish preparation audio-video and sensor information
   ee. scan local egg dish preparation audio-video and sensor information for error or noncompliance
   ff. receive accounting information of production factor use for local egg dish preparation
   gg. correlate local egg dish preparation audio-video and sensor information with accounting information of production factor use for local egg dish preparation
   hh. associate local egg dish preparation audio-video and sensor information with egg tracer information
   ii. receive local egg dish serving audio-video and sensor information
   jj. scan local egg dish serving audio-video and sensor information for or noncompliance
   kk. receive accounting information of production factor use for local egg dish serving
   ll. correlate local egg dish serving audio-video and sensor information with accounting information of production factor use for local egg dish serving
   mm. associate local egg dish serving audio-video and sensor information with egg tracer information

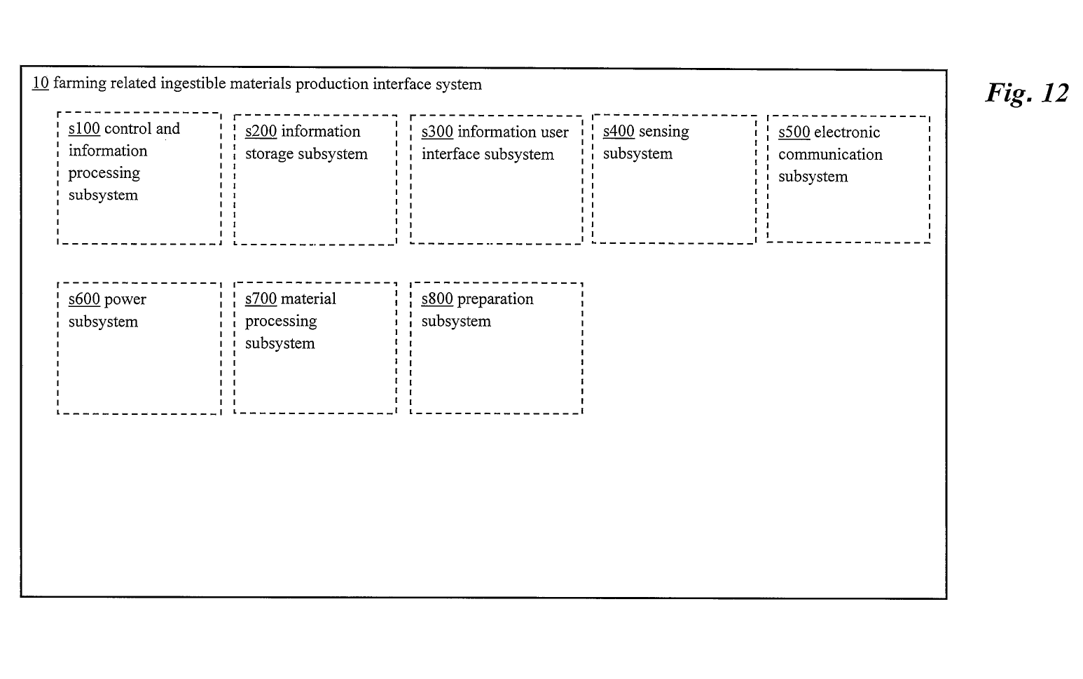

An exemplary version of the farming related ingestible materials production interface system 10 is shown in FIG. 12 to optionally include various subsystems such as control and information processing subsystem s100, information storage subsystem s200, information user interface subsystem s300, sensing subsystem s400, electronic communication subsystem s500, power subsystem s600, material processing subsystem s700, and preparation subsystem s800.

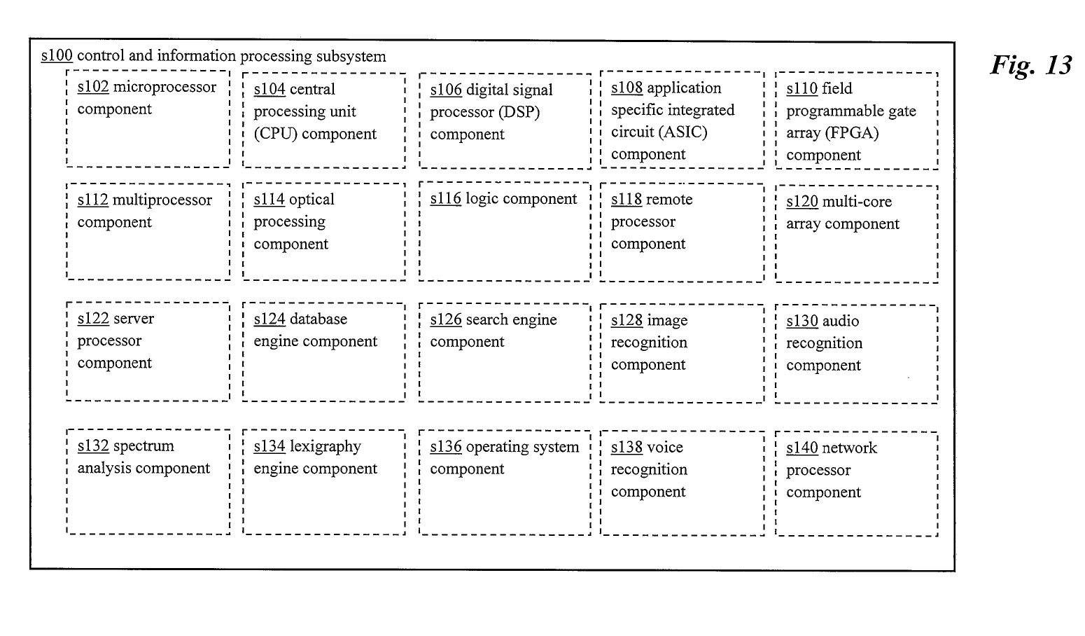

An exemplary implementation of the control and information processing subsystem s100 is shown in FIG. 13 to optionally include various components such as microprocessor component s102, central processing unit (CPU) component s104, digital signal processor (DSP) component s106, application specific integrated circuit (ASIC) component s108, field programmable gate array (FPGA) component s110, multiprocessor component s112, optical processing component s114, logic component s116, remote processor component s118, multi-core array component s120, server processor component s122, database engine component s124, search engine component s126, image recognition component s128, audio recognition component s130, spectrum analysis component s132, lexigraphy engine component s134, operating system component s136, voice recognition component s138, and network processor component s140.

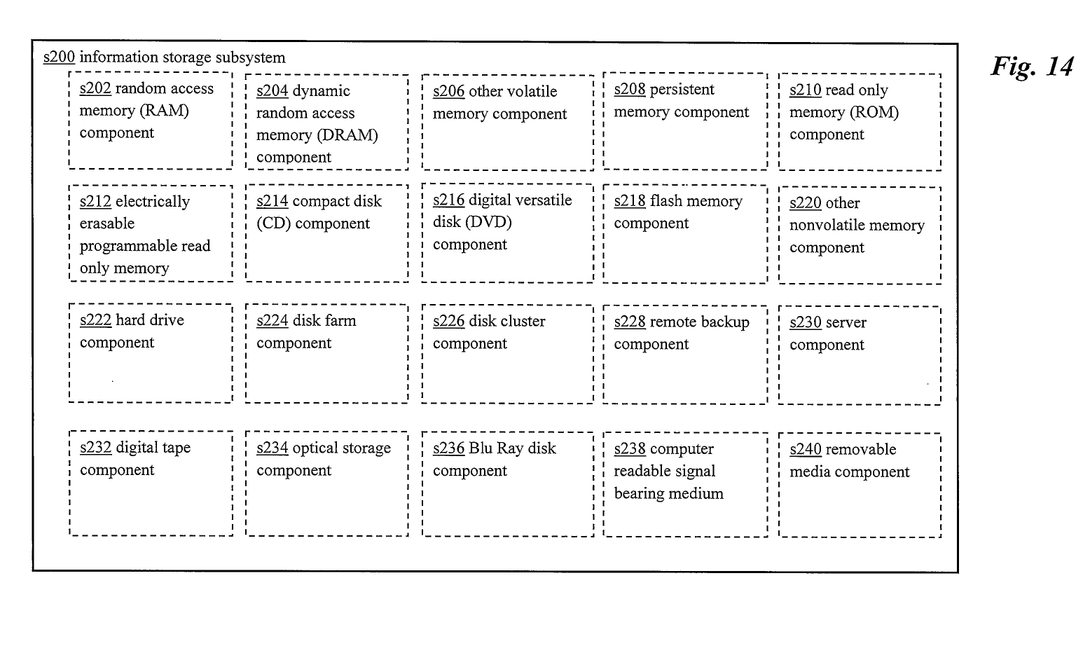

An exemplary implementation of the information storage subsystem s200 is shown in FIG. 14 to optionally include various components such as random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, Blu Ray disk component s236, computer readable signal bearing medium s238, and removable media component s240.

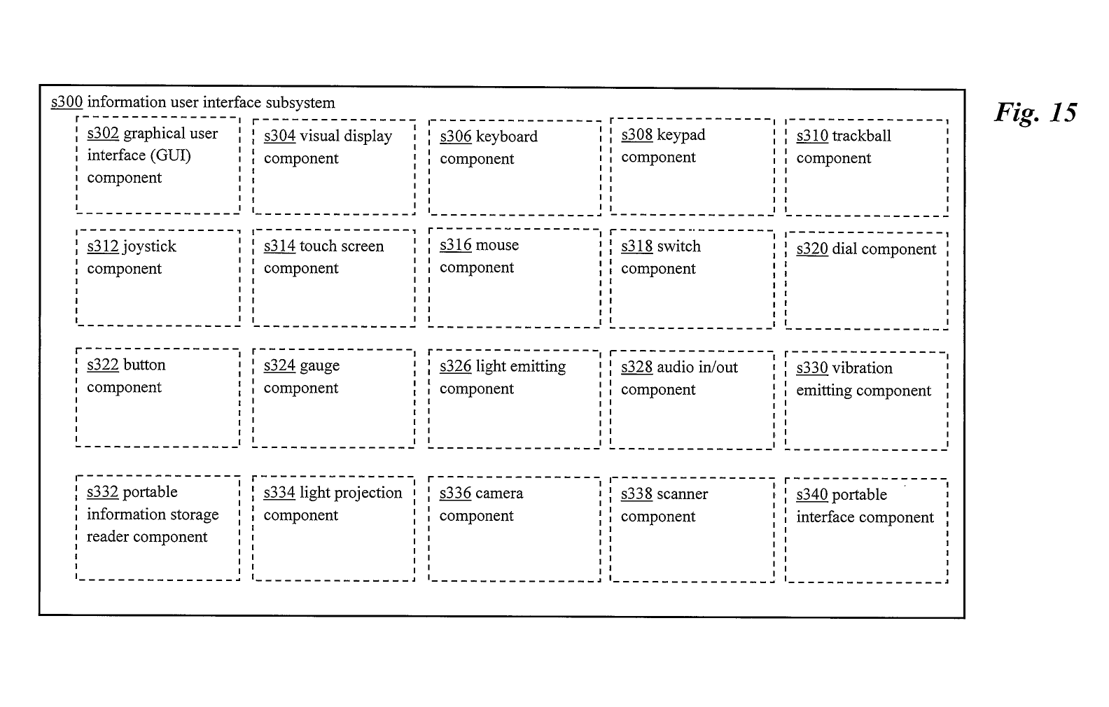

An exemplary implementation of the information user interface subsystem s300 is shown in FIG. 15 to optionally include various components such as graphical user interface (GUI) component s302, visual display component s304, keyboard component s306, keypad component s308, trackball component s310, joystick component s312, touch screen component s314, mouse component s316, switch component s318, dial component s320, button component s322, gauge component s324, light emitting component s326, audio in/out component s328, vibration emitting component s330, portable information storage reader component s332, light projection component s334, camera component s336, scanner component s338, and portable interface component s340.

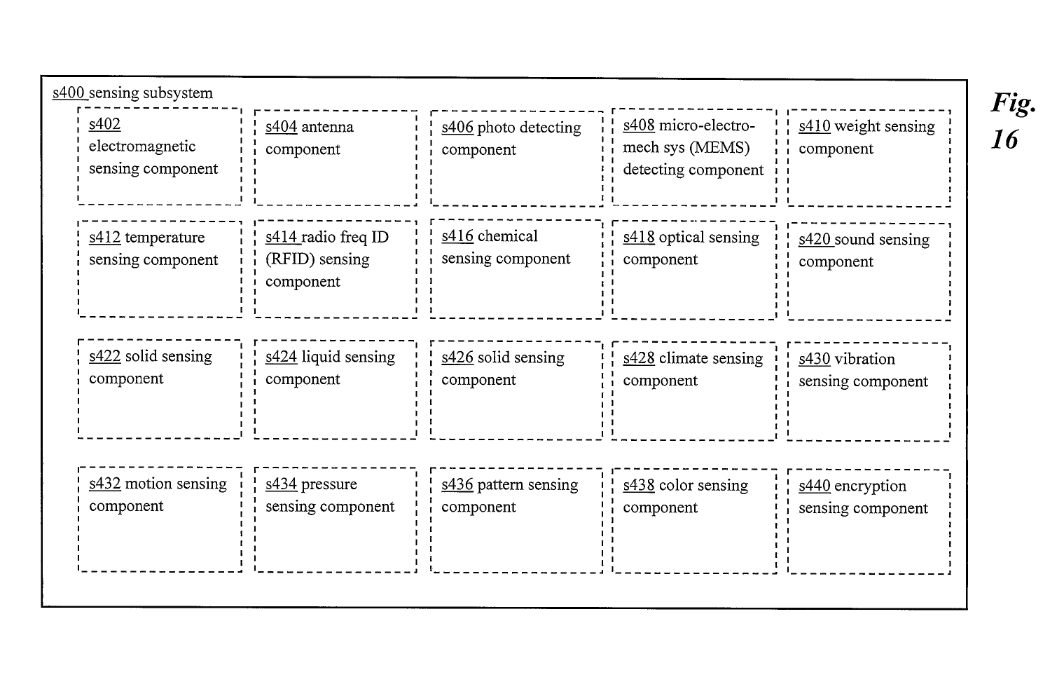

An exemplary implementation of the sensing subsystem s400 is shown in FIG. 16 to optionally include various components such as electromagnetic sensing component s402, antenna component s404, photo detecting component s406, micro-electro-mech sys (MEMS) detecting component s408, weight sensing component s410, temperature sensing component s412, radio freq ID (RFID) sensing component s414, chemical sensing component s416, optical sensing component s418, sound sensing component s420, solid sensing component s422, liquid sensing component s424, solid sensing component s426, climate sensing component s428, vibration sensing component s430, motion sensing component s432, pressure sensing component s434, pattern sensing component s436, color sensing component s438, and encryption sensing component s440.

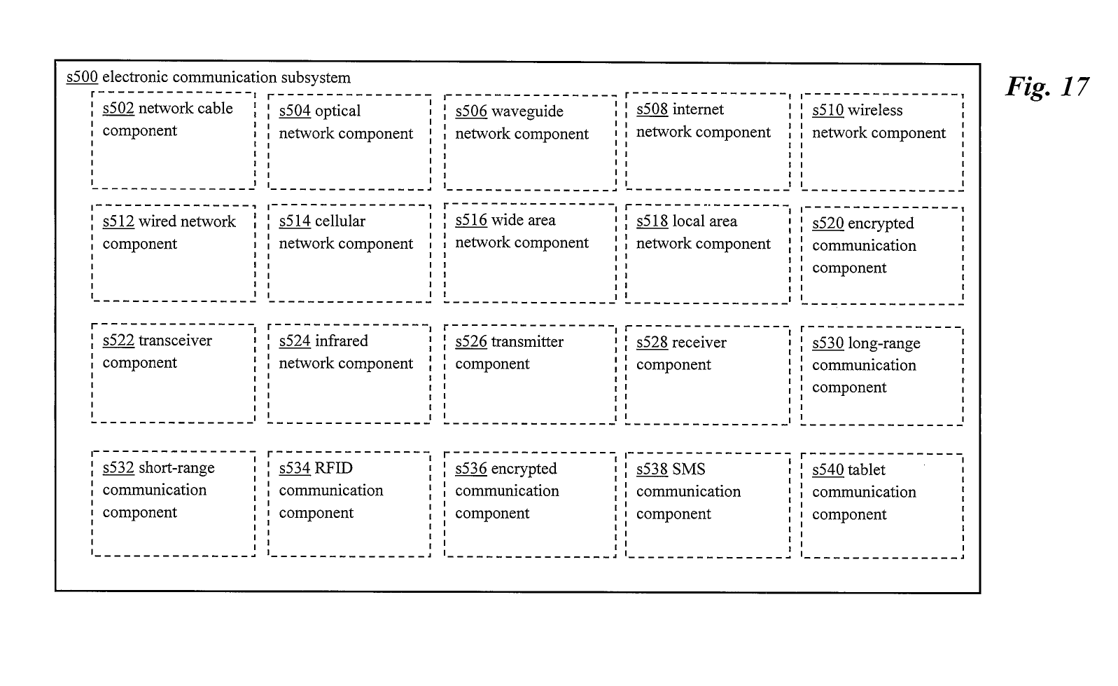

An exemplary implementation of the electronic communication subsystem s500 is shown in FIG. 17 to optionally include various components such as network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, receiver component s528, receiver component s528, long-range communication component s530, short-range communication component s532, RFID communication component s534, encrypted communication component s536, SMS communication component s538, and tablet communication component s540.

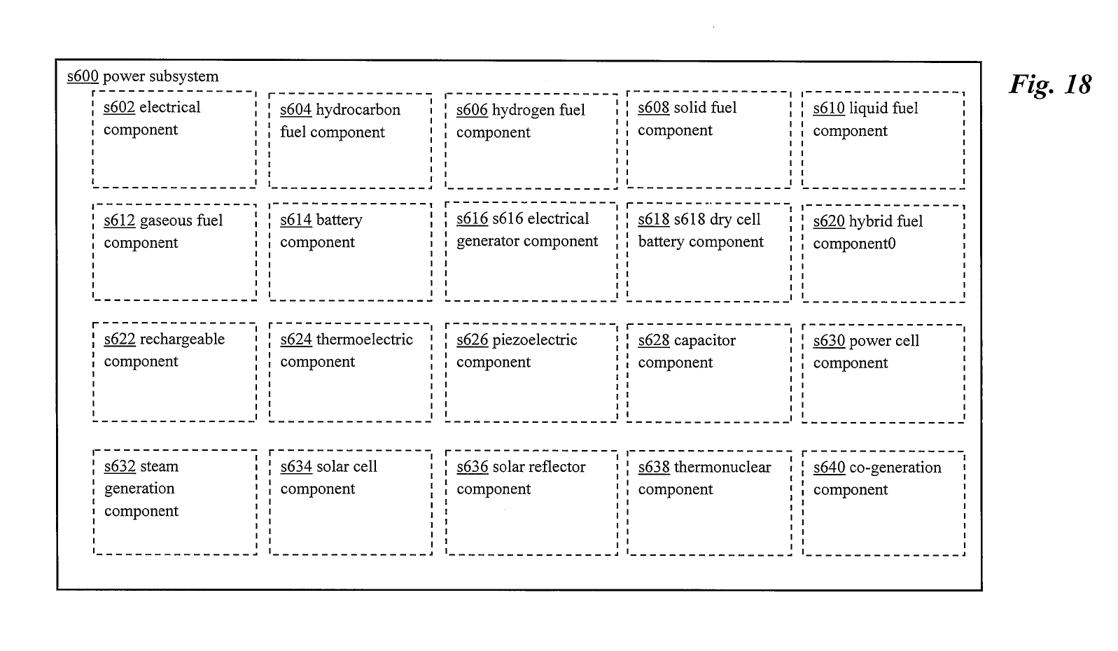

An exemplary implementation of the power subsystem s600 is shown in FIG. 18 to optionally include various components such as electrical component s602, hydrocarbon fuel component s604, hydrogen fuel component s606, solid fuel component s608, liquid fuel component s610, gaseous fuel component s612, battery component s614, battery component s622, battery component s624, battery component s626, battery component s628, power cell component s630, steam generation component s632, solar cell component s634, solar reflector component s636, thermonuclear component s638, and co-generation component s640.

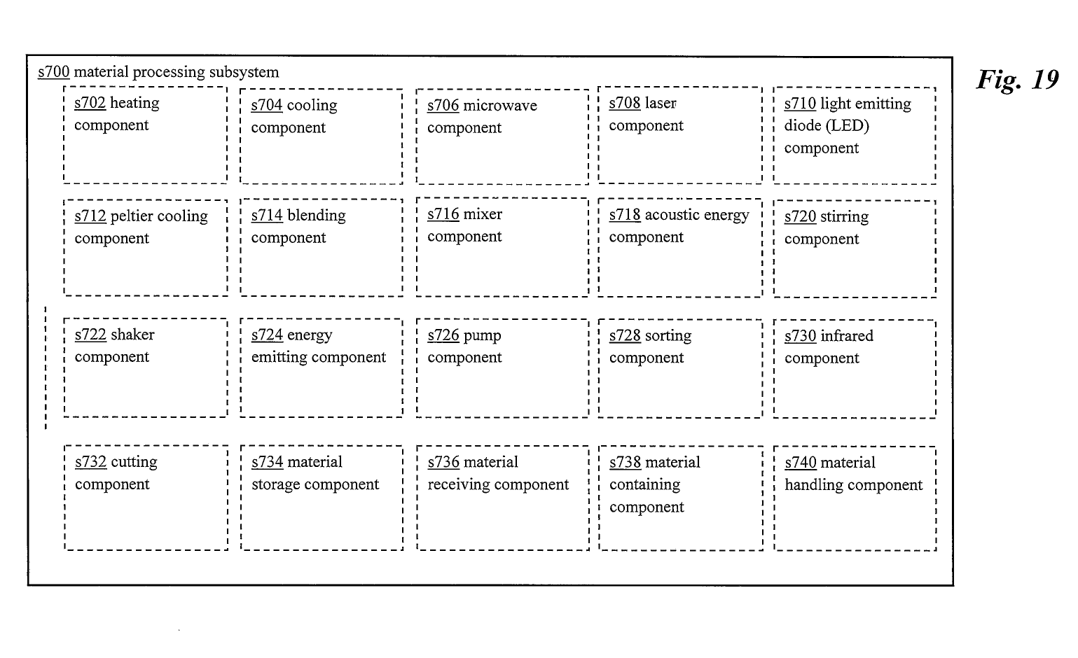

An exemplary implementation of the material processing subsystem s700 is shown in FIG. 19 to optionally include various components such as heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, material receiving component s736, material containing component s738, and material handling component s740.

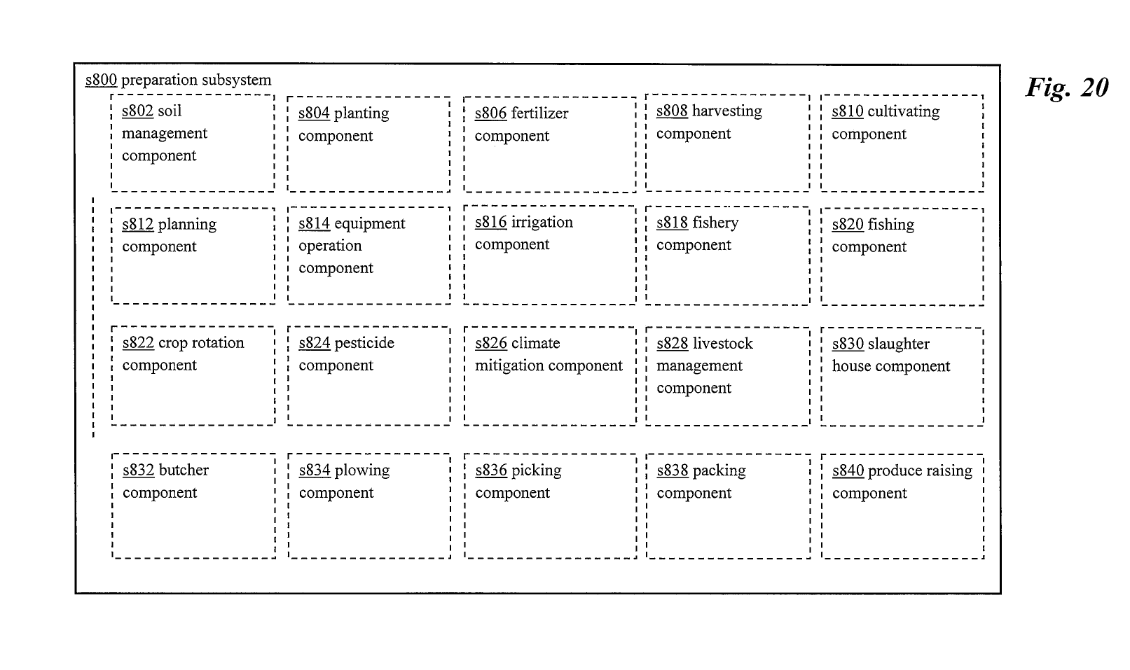

An exemplary implementation of the preparation subsystem s800 is shown in FIG. 20 to optionally include various components such as soil management component s802, planting component s804, fertilizer component s806, harvesting component s808, cultivating component s810, planning component s812, equipment operation component s814, irrigation component s816, fishery component s818, fishing component s820, crop rotation component s822, pesticide component s824, climate mitigation component s826, livestock management component s828, slaughter house component s830, butcher component s832, plowing component s834, picking component s836, packing component s838, and produce raising component s840.

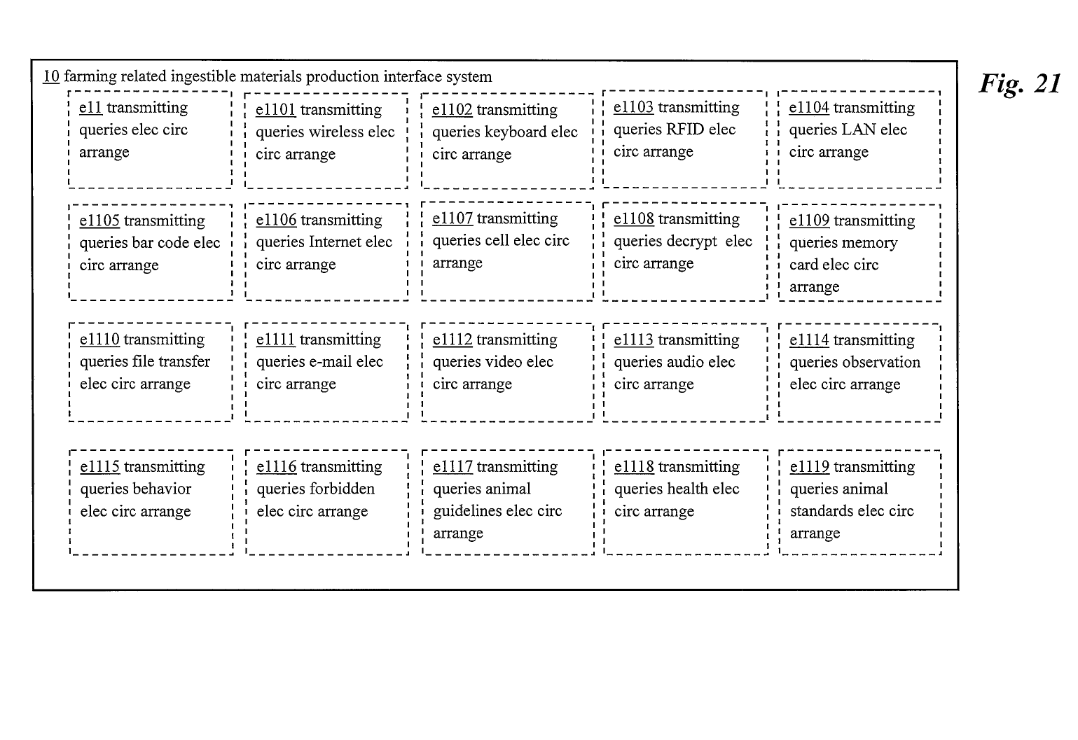

Implementations involve different combinations (otherwise known as “electrical circuitry arrangements”) of components from the subsystems of the farming related ingestible materials production interface system 10. Exemplary depictions of some of these electrical circuitry arrangements are shown in FIG. 21 to include transmitting queries electrical circuitry arrangement e11, transmitting queries wireless electrical circuitry arrangement e1101, transmitting queries keyboard electrical circuitry arrangement e1102, transmitting queries RFID electrical circuitry arrangement e1103, transmitting queries LAN electrical circuitry arrangement e1104, transmitting queries bar code electrical circuitry arrangement e1105, transmitting queries Internet electrical circuitry arrangement e1106, transmitting queries cell electrical circuitry arrangement e1107, transmitting queries decrypt electrical circuitry arrangement e1108, transmitting queries memory card electrical circuitry arrangement e1109, transmitting queries file transfer electrical circuitry arrangement e1110, transmitting queries e-mail electrical circuitry arrangement e1111, transmitting queries video electrical circuitry arrangement e1112, transmitting queries audio electrical circuitry arrangement e1113, transmitting queries observation electrical circuitry arrangement e1114, transmitting queries behavior electrical circuitry arrangement e1115, transmitting queries forbidden electrical circuitry arrangement e1116, transmitting queries animal guidelines electrical circuitry arrangement e1117, transmitting queries health electrical circuitry arrangement e1118, and transmitting queries animal standards electrical circuitry arrangement e1119.

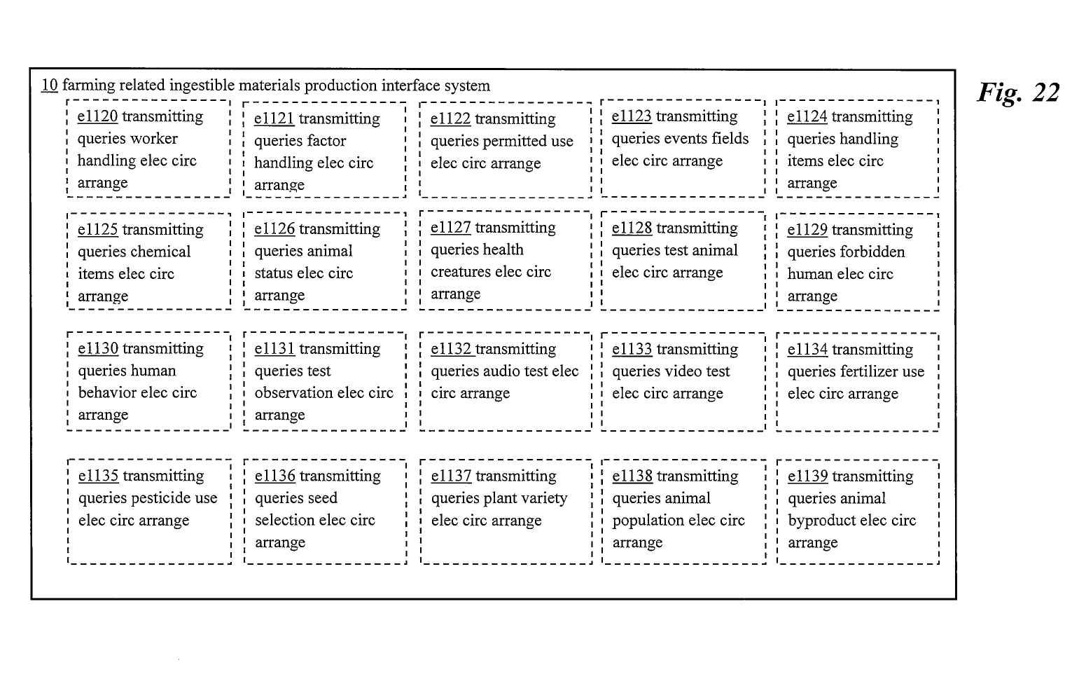

Some of these electrical circuitry arrangements are depicted in FIG. 22 to include transmitting queries worker handling electrical circuitry arrangement e1120, transmitting queries factor handling electrical circuitry arrangement e1121, transmitting queries permitted use electrical circuitry arrangement e1122, transmitting queries events fields electrical circuitry arrangement e1123, transmitting queries handling items electrical circuitry arrangement e1124, transmitting queries chemical items electrical circuitry arrangement e1125, transmitting queries animal status electrical circuitry arrangement e1126, transmitting queries health creatures electrical circuitry arrangement e1127, transmitting queries test animal electrical circuitry arrangement e1128, transmitting queries forbidden human electrical circuitry arrangement e1129, transmitting queries human behavior electrical circuitry arrangement e1130, transmitting queries test observation electrical circuitry arrangement e113, transmitting queries audio test electrical circuitry arrangement e1132, transmitting queries video test electrical circuitry arrangement e1133, transmitting queries fertilizer use electrical circuitry arrangement e1134, transmitting queries pesticide use electrical circuitry arrangement e1135, transmitting queries seed selection electrical circuitry arrangement e1136, transmitting queries plant variety electrical circuitry arrangement e1137, transmitting queries animal population electrical circuitry arrangement e1138, and transmitting queries animal byproduct electrical circuitry arrangement e1139.

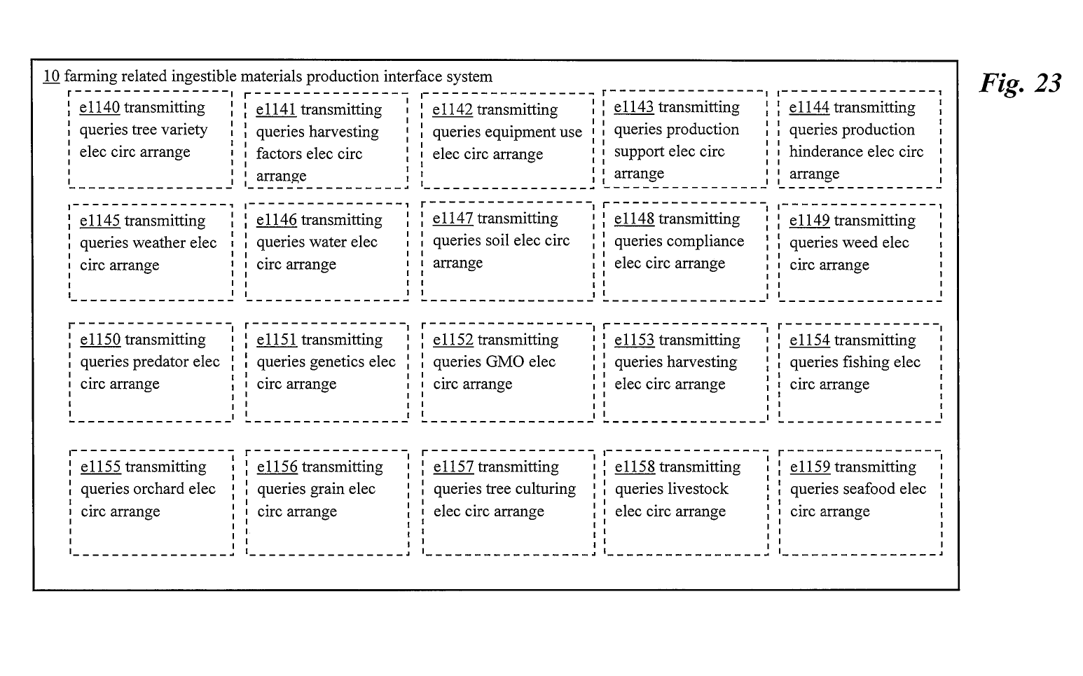

Some of these electrical circuitry arrangements are depicted in FIG. 23 to include transmitting queries tree variety electrical circuitry arrangement e1140, transmitting queries harvesting factors electrical circuitry arrangement e1141, transmitting queries equipment use electrical circuitry arrangement e1142, transmitting queries production support electrical circuitry arrangement e1143, transmitting queries production hindrance electrical circuitry arrangement e1144, transmitting queries weather electrical circuitry arrangement e1145, transmitting queries water electrical circuitry arrangement e1146, transmitting queries soil electrical circuitry arrangement e1147, transmitting queries compliance electrical circuitry arrangement e1148, transmitting queries weed electrical circuitry arrangement e1149, transmitting queries predator electrical circuitry arrangement e1150, transmitting queries genetics electrical circuitry arrangement e1151, transmitting queries GMO electrical circuitry arrangement e1152, transmitting queries harvesting electrical circuitry arrangement e1153, transmitting queries fishing electrical circuitry arrangement e1154, transmitting queries orchard electrical circuitry arrangement e1155, transmitting queries grain electrical circuitry arrangement e1156, transmitting queries tree culturing electrical circuitry arrangement e1157, transmitting queries livestock electrical circuitry arrangement e1158, and transmitting queries seafood electrical circuitry arrangement e1159.

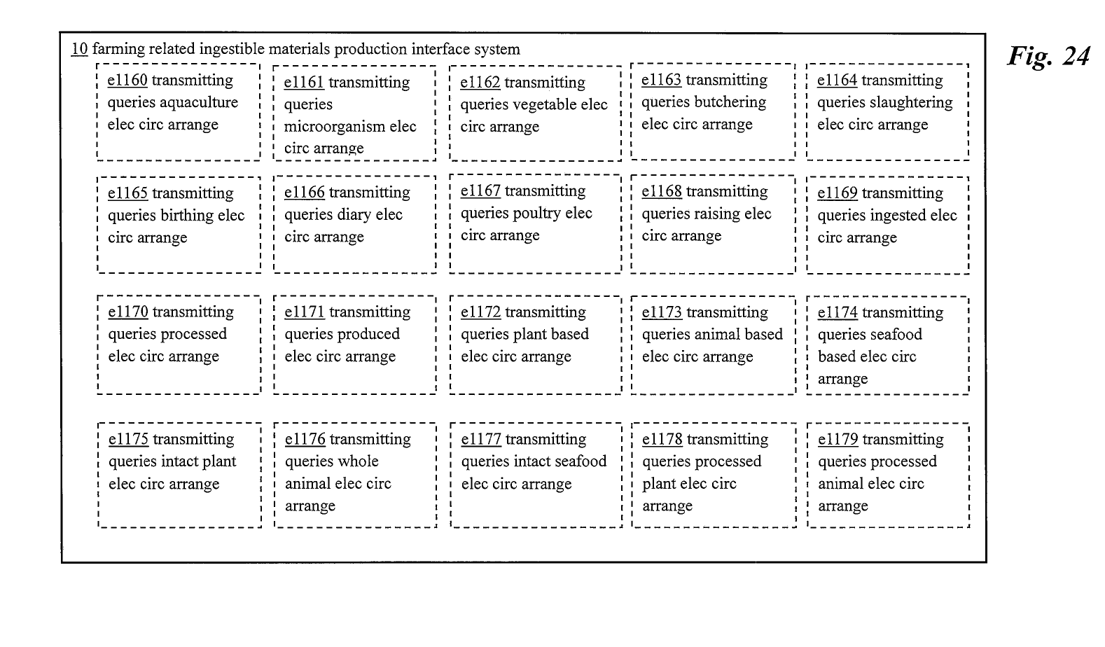

Some of these electrical circuitry arrangements are depicted in FIG. 24 to include transmitting queries aquaculture electrical circuitry arrangement e1160, transmitting queries microorganism electrical circuitry arrangement e1161, transmitting queries vegetable electrical circuitry arrangement e1162, transmitting queries butchering electrical circuitry arrangement e1163, transmitting queries slaughtering electrical circuitry arrangement e1164, transmitting queries birthing electrical circuitry arrangement e1165, and transmitting queries diary electrical circuitry arrangement e1166, transmitting queries poultry electrical circuitry arrangement e1167, transmitting queries raising electrical circuitry arrangement e1168, transmitting queries ingested electrical circuitry arrangement e1169, transmitting queries processed electrical circuitry arrangement e1170, transmitting queries produced electrical circuitry arrangement e1171, transmitting queries plant based electrical circuitry arrangement e1172, transmitting queries animal based electrical circuitry arrangement e1173, transmitting queries seafood based electrical circuitry arrangement e1174, transmitting queries intact plant electrical circuitry arrangement e1175, transmitting queries whole animal electrical circuitry arrangement e1176, transmitting queries intact seafood electrical circuitry arrangement e1177, transmitting queries processed plant electrical circuitry arrangement e1178, and transmitting queries processed animal electrical circuitry arrangement e1179.

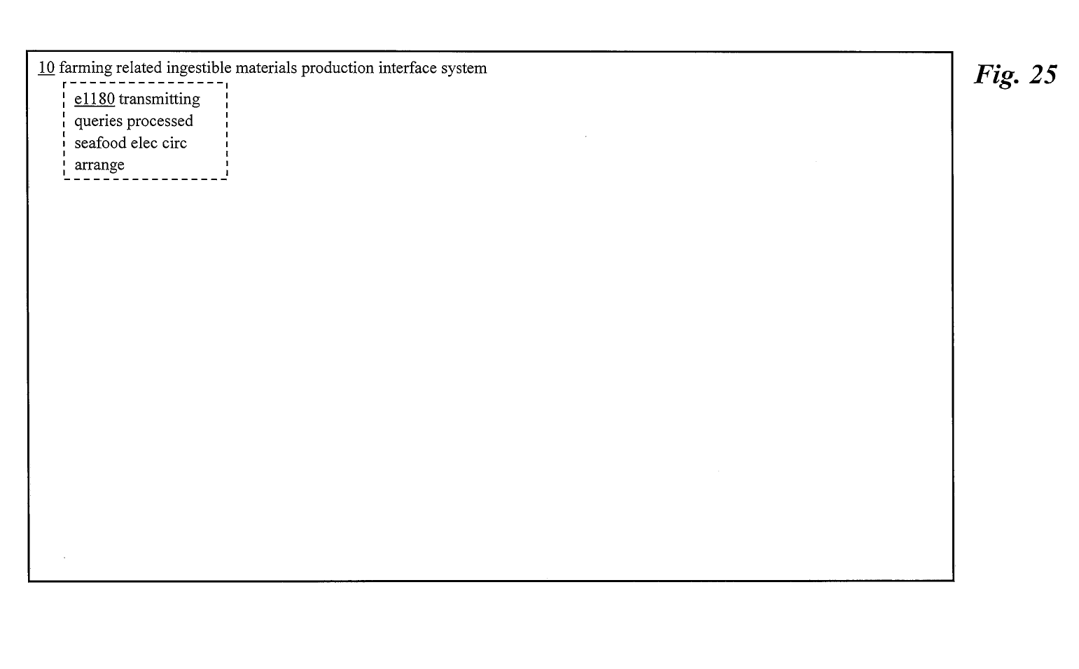

Some of these electrical circuitry arrangements are depicted in FIG. 25 to include transmitting queries processed seafood electrical circuitry arrangement e1180.

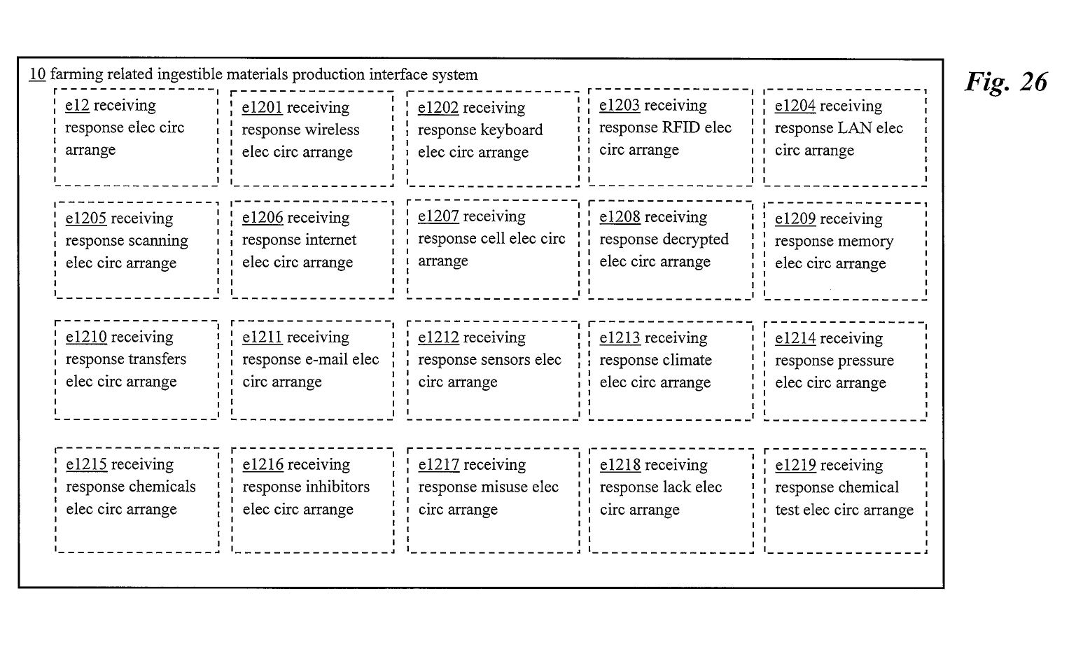

Some of these electrical circuitry arrangements are depicted in FIG. 26 to include receiving response electrical circuitry arrangement e12, receiving response wireless electrical circuitry arrangement e1201, receiving response keyboard electrical circuitry arrangement e1202, receiving response RFID electrical circuitry arrangement e1203, receiving response LAN electrical circuitry arrangement e1204, receiving response scanning electrical circuitry arrangement e1205, receiving response internet electrical circuitry arrangement e1206, receiving response cell electrical circuitry arrangement e1207, receiving response decrypted electrical circuitry arrangement e1208, receiving response memory electrical circuitry arrangement e1209, receiving response transfers electrical circuitry arrangement e1210, receiving response e-mail electrical circuitry arrangement e1211, and receiving response sensors electrical circuitry arrangement e1212, receiving response climate electrical circuitry arrangement e1213, receiving response pressure electrical circuitry arrangement e1214, receiving response chemicals electrical circuitry arrangement e1215, receiving response inhibitors electrical circuitry arrangement e1216, receiving response misuse electrical circuitry arrangement e1217, receiving response lack electrical circuitry arrangement e1218, and receiving response chemical test electrical circuitry arrangement e1219.

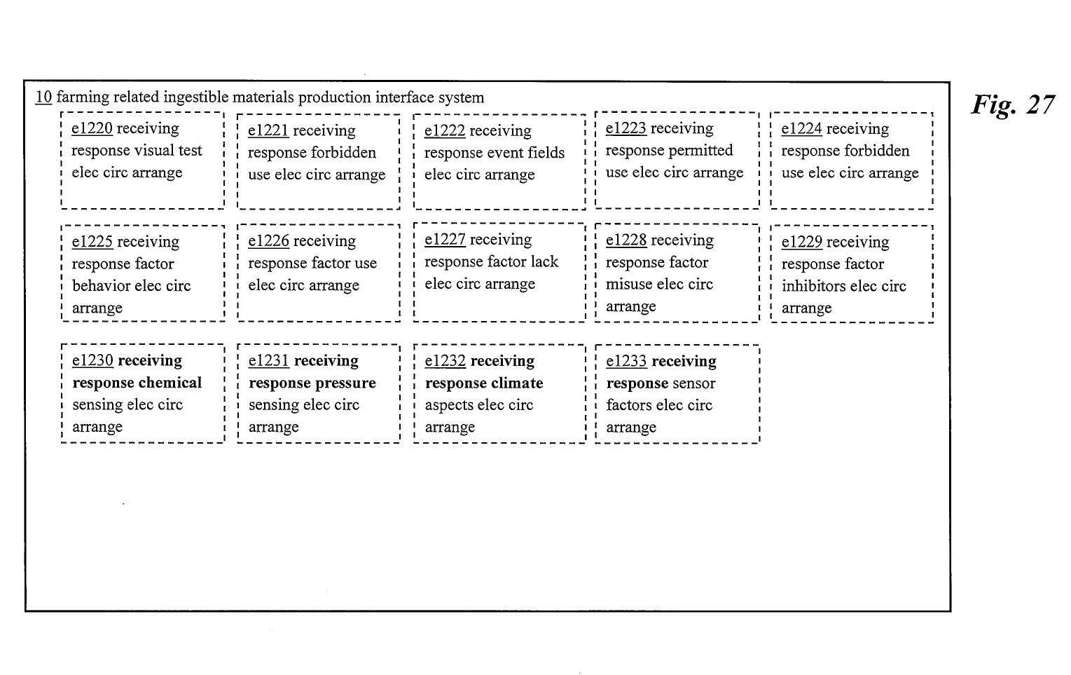

Some of these electrical circuitry arrangements are depicted in FIG. 27 to include receiving response visual test electrical circuitry arrangement e1220, receiving response forbidden use electrical circuitry arrangement e1221, receiving response event fields electrical circuitry arrangement e1222, receiving response permitted use electrical circuitry arrangement e1223, receiving response forbidden use electrical circuitry arrangement e1224, receiving response factor behavior electrical circuitry arrangement e1225, receiving response factor use electrical circuitry arrangement e1226, receiving response factor lack electrical circuitry arrangement e1227, receiving response factor misuse electrical circuitry arrangement e1228, receiving response factor inhibitors electrical circuitry arrangement e1229, receiving response chemical sensing electrical circuitry arrangement e1230, receiving response pressure sensing electrical circuitry arrangement e1231, receiving response climate aspects electrical circuitry arrangement e1232, and receiving response sensor factors electrical circuitry arrangement e1233

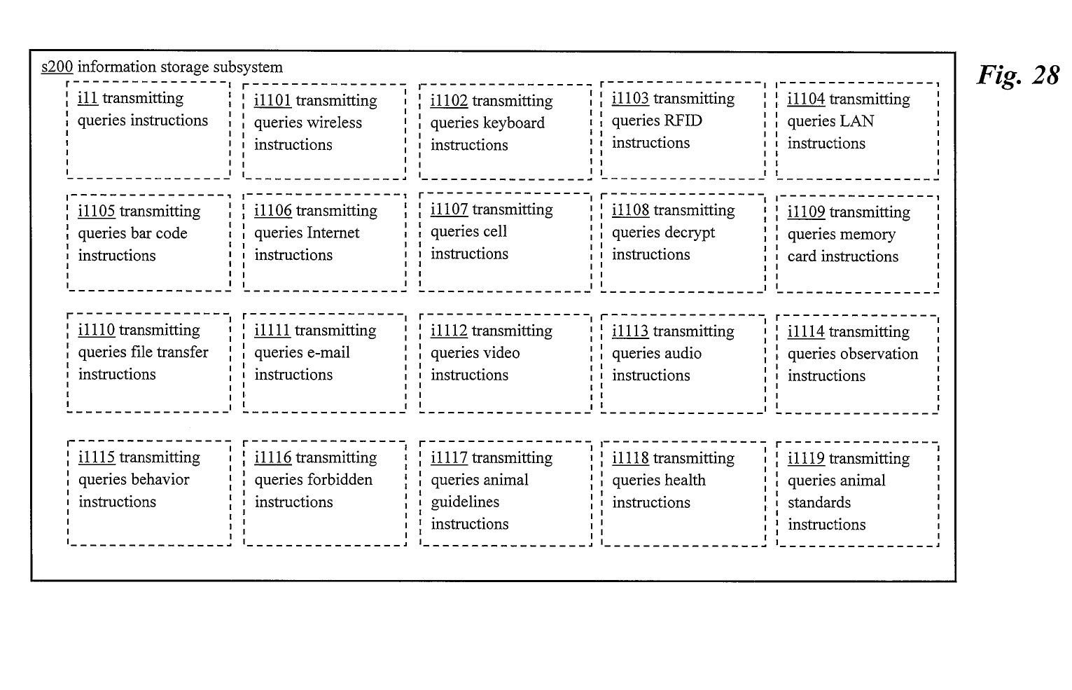

In implementations one or more instructions are stored and/or otherwise borne in various subsystems, components, and/or accessories of the farming related ingestible materials production interface system 10 such as being borne in a non-transitory signal bearing medium of information storage subsystem s200. One or more exemplary instructions depicted in FIG. 28 as being borne in an exemplary version of a non-transitory signal bearing medium of information storage subsystem s200 include one or more transmitting queries instructions ill, one or more transmitting queries wireless instructions i1101, one or more transmitting queries keyboard instructions i1102, one or more transmitting queries RFID instructions i1103, one or more transmitting queries LAN instructions i1104, one or more transmitting queries bar code instructions i1105, one or more transmitting queries Internet instructions i1106, one or more transmitting queries cell instructions i1107, one or more transmitting queries decrypt instructions i1108, one or more transmitting queries memory card instructions i1109, one or more transmitting queries file transfer instructions i1110, one or more transmitting queries e-mail instructions ill 11, one or more transmitting queries video instructions i1112, one or more transmitting queries audio instructions i1113, one or more transmitting queries observation instructions i1114, one or more transmitting queries behavior instructions i1115, one or more transmitting queries forbidden instructions i1116, one or more transmitting queries animal guidelines instructions i1117, one or more transmitting queries health instructions i1118, and one or more transmitting queries animal standards instructions i1119.

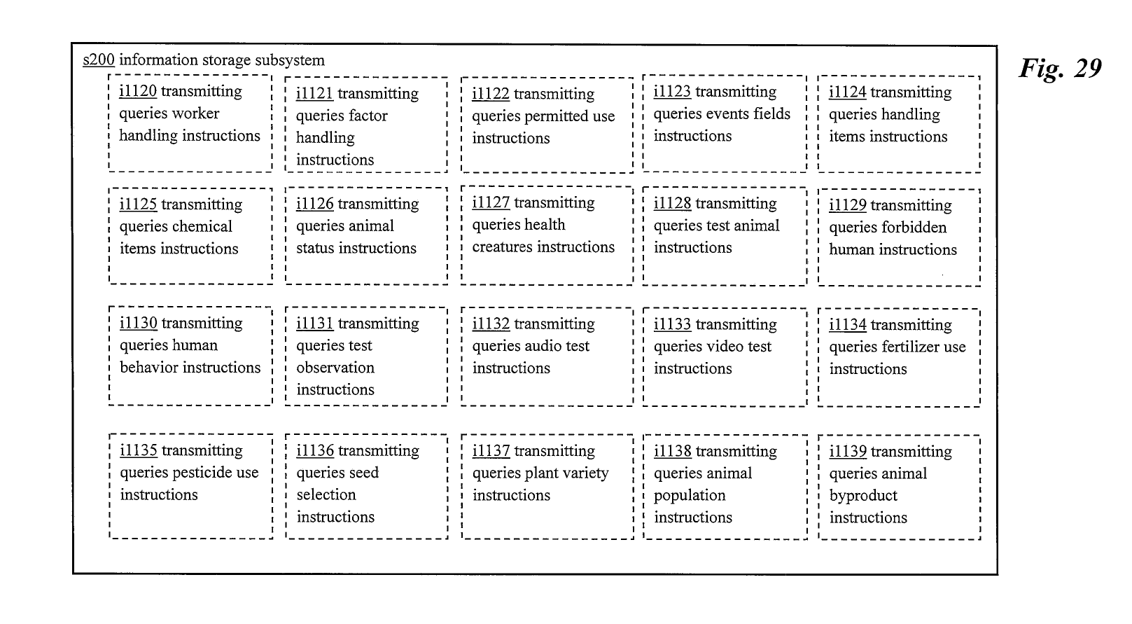

One or more exemplary instructions depicted in FIG. 29 as being borne in an exemplary version of a non-transitory signal bearing medium of information storage subsystem s200 include one or more transmitting queries worker handling instructions i1120, one or more transmitting queries factor handling instructions i1121, one or more transmitting queries permitted use instructions i1122, one or more transmitting queries events fields instructions i1123, one or more transmitting queries handling items instructions i1124, one or more transmitting queries chemical items instructions i1125, one or more transmitting queries animal status instructions i1126, one or more transmitting queries health creatures instructions i1127, one or more transmitting queries test animal instructions i1128, one or more transmitting queries forbidden human instructions i1129, one or more transmitting queries human behavior instructions i1130, one or more transmitting queries test observation instructions i1131, one or more transmitting queries audio test instructions i1132, one or more transmitting queries video test instructions i1133, one or more transmitting queries fertilizer use instructions i1134, one or more transmitting queries pesticide use instructions i1135, one or more transmitting queries seed selection instructions i1136, one or more transmitting queries plant variety instructions i1137, one or more transmitting queries animal population instructions i1138, and one or more transmitting queries animal byproduct instructions i1139.

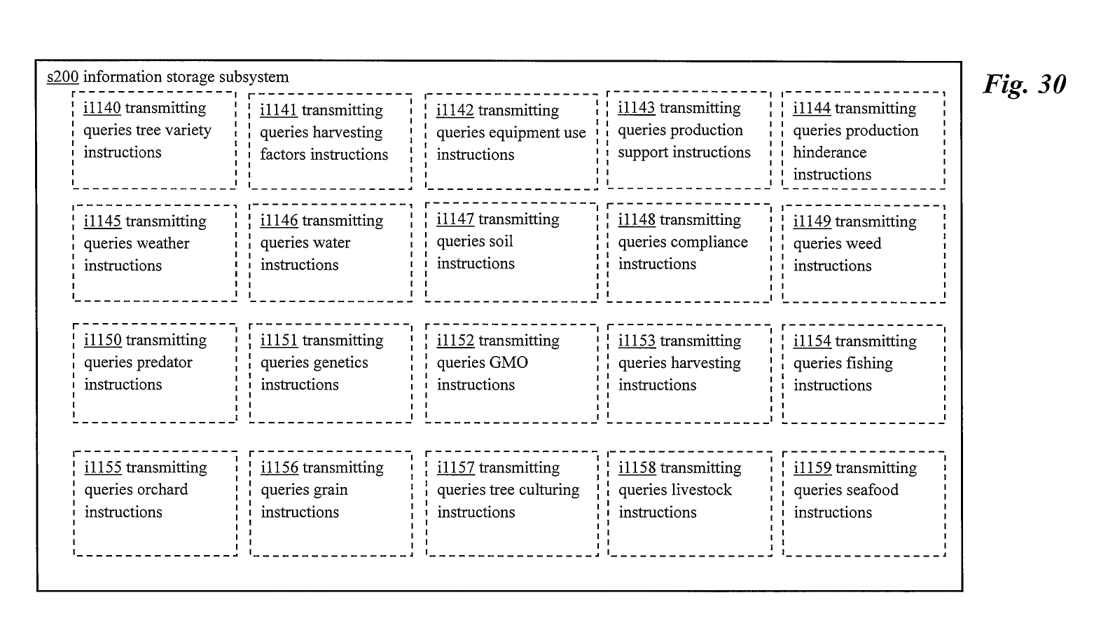

One or more exemplary instructions depicted in FIG. 30 as being borne in an exemplary version of a non-transitory signal bearing medium of information storage subsystem s200 include one or more transmitting queries tree variety instructions i1140, one or more transmitting queries harvesting factors instructions i1141, one or more transmitting queries equipment use instructions i1142, one or more transmitting queries production support instructions i1143, one or more transmitting queries production hindrance instructions i1144, one or more transmitting queries weather instructions i1145, one or more transmitting queries water instructions i1146, one or more transmitting queries soil instructions i1147, one or more transmitting queries compliance instructions i1148, one or more transmitting queries weed instructions i1149, one or more transmitting queries predator instructions i1150, one or more transmitting queries genetics instructions i1151, one or more transmitting queries GMO instructions i1152, one or more transmitting queries harvesting instructions i1153, one or more transmitting queries fishing instructions i1154, one or more transmitting queries orchard instructions i1155, one or more transmitting queries grain instructions i1156, one or more transmitting queries tree culturing instructions i1157, one or more transmitting queries livestock instructions i1158, and one or more transmitting queries seafood instructions i1159.

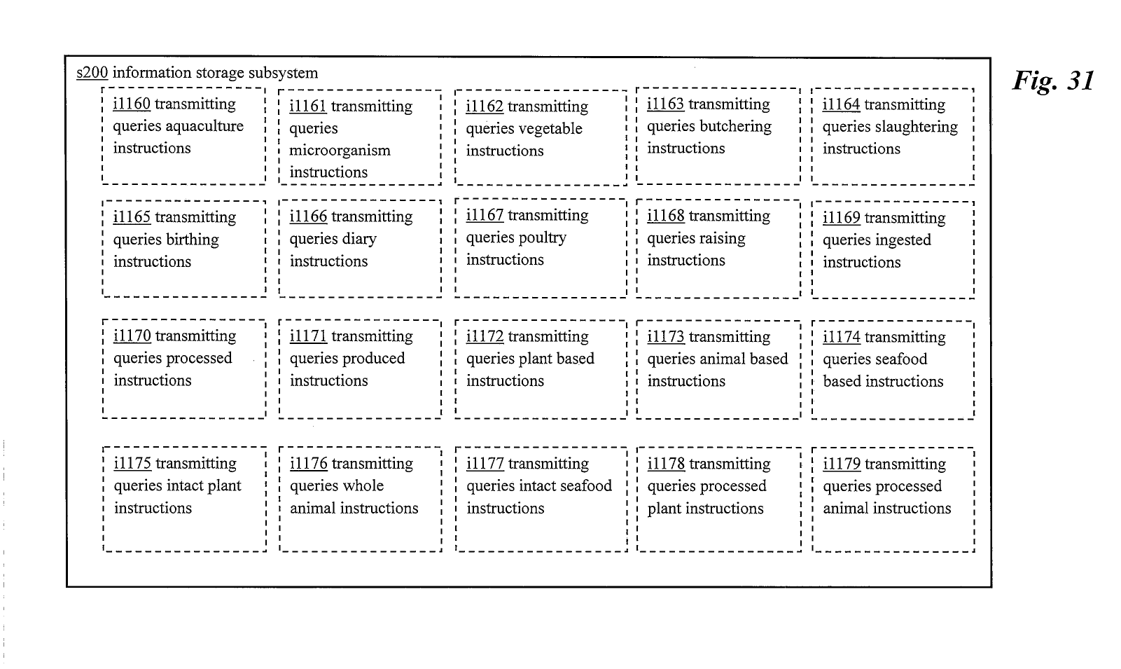

One or more exemplary instructions depicted in FIG. 31 as being borne in an exemplary version of a non-transitory signal bearing medium of information storage subsystem s200 include one or more transmitting queries aquaculture instructions i1160, one or more transmitting queries microorganism instructions i1161, one or more transmitting queries vegetable instructions i1162, one or more transmitting queries butchering instructions i1163, one or more transmitting queries slaughtering instructions i1164, one or more transmitting queries birthing instructions i1165, and one or more transmitting queries diary instructions i1166, one or more transmitting queries poultry instructions i1167, one or more transmitting queries raising instructions i1168, one or more transmitting queries ingested instructions i1169, one or more transmitting queries processed instructions i1170, one or more transmitting queries produced instructions i1171, one or more transmitting queries plant based instructions i1172, one or more transmitting queries animal based instructions i1173, one or more transmitting queries seafood based instructions i1174, one or more transmitting queries intact plant instructions i1175, one or more transmitting queries whole animal instructions i1176, one or more transmitting queries intact seafood instructions i1177, one or more transmitting queries processed plant instructions i1178, and one or more transmitting queries processed animal instructions i1179.

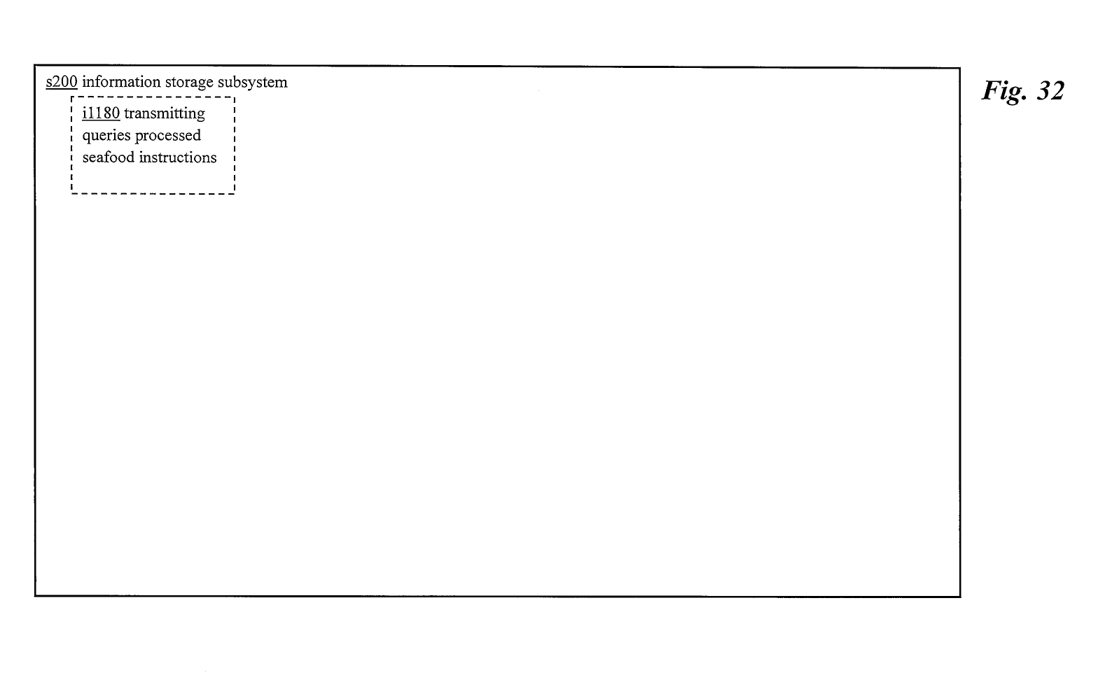

One or more exemplary instructions depicted in FIG. 32 as being borne in an exemplary version of a non-transitory signal bearing medium of information storage subsystem s200 include one or more transmitting queries processed seafood instructions i1180.

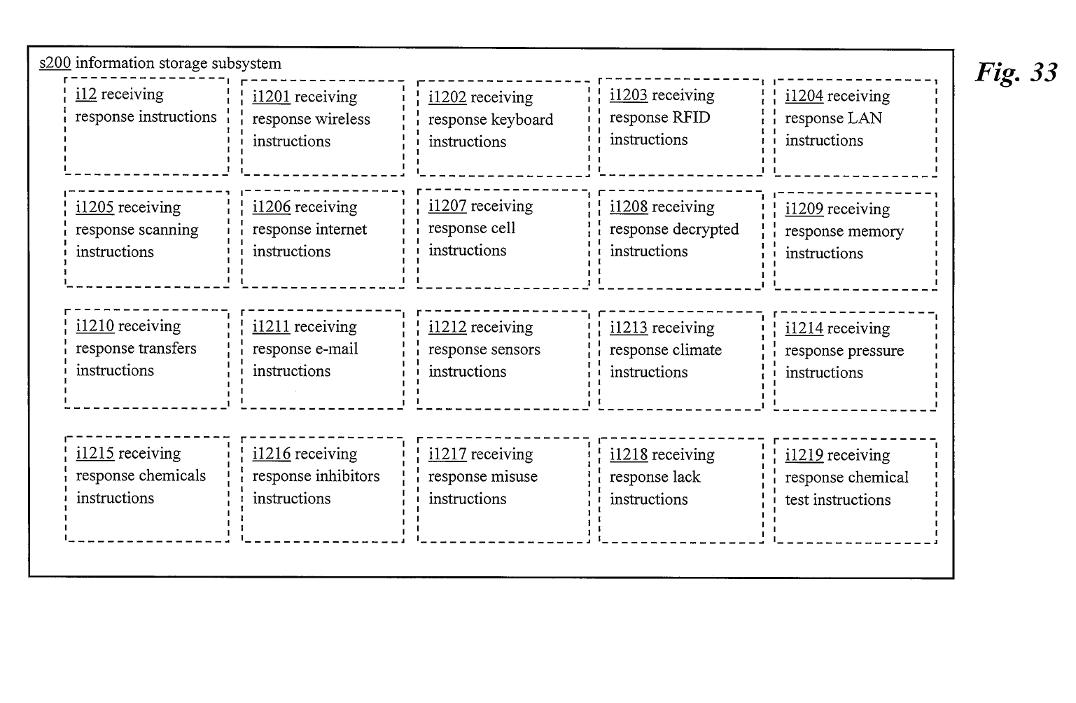

One or more exemplary instructions depicted in FIG. 33 as being borne in an exemplary version of a non-transitory signal bearing medium of information storage subsystem s200 include one or more receiving response instructions i12, one or more receiving response wireless instructions i1201, one or more receiving response keyboard instructions i1202, one or more receiving response RFID instructions i1203, one or more receiving response LAN instructions i1204, one or more receiving response scanning instructions i1205, one or more receiving response internet instructions i1206, one or more receiving response cell instructions i1207, one or more receiving response decrypted instructions i1208, one or more receiving response memory instructions i1209, one or more receiving response transfers instructions i1210, one or more receiving response e-mail instructions i1211, one or more receiving response sensors instructions i1212, one or more receiving response climate instructions i1213, one or more receiving response pressure instructions i1214, one or more receiving response chemicals instructions i1215, one or more receiving response inhibitors instructions i1216, one or more receiving response misuse instructions i1217, one or more receiving response lack instructions i1218, and one or more receiving response chemical test instructions i1219.

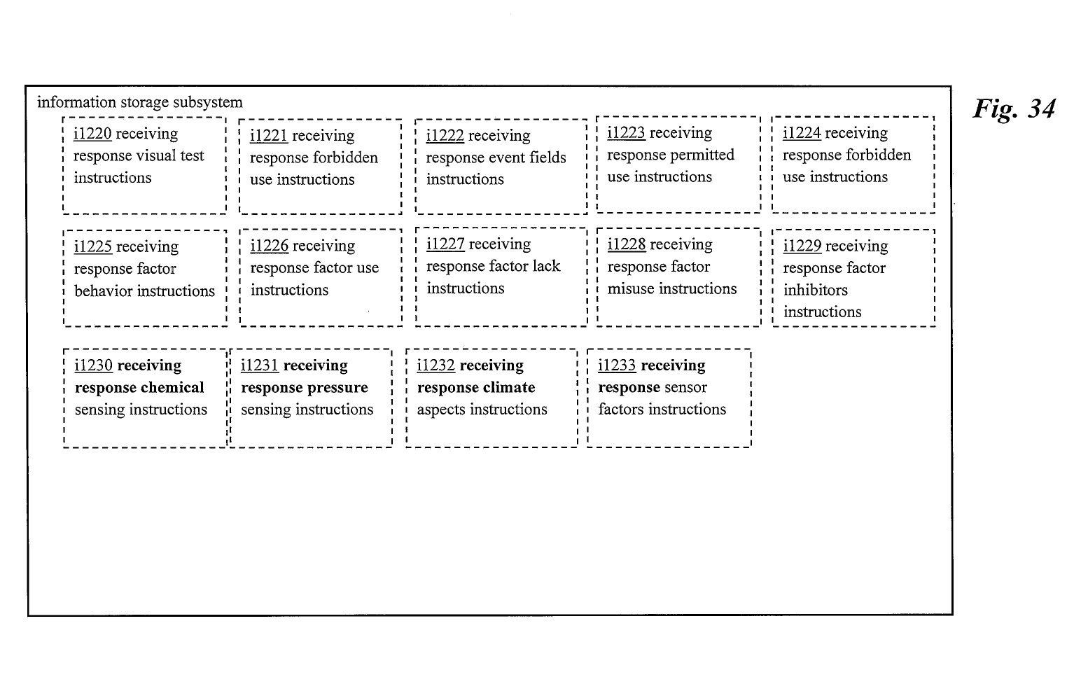

One or more exemplary instructions depicted in FIG. 34 as being borne in an exemplary version of a non-transitory signal bearing medium of information storage subsystem s200 include one or more receiving response visual test instructions i1220, one or more receiving response forbidden use instructions i1221, one or more receiving response event fields instructions i1222, one or more receiving response permitted use instructions i1223, one or more receiving response forbidden use instructions i1224, one or more receiving response factor behavior instructions i1225, one or more receiving response factor use instructions i1226, one or more receiving response factor lack instructions i1227, one or more receiving response factor misuse instructions i1228, one or more receiving response factor inhibitors instructions i1229, one or more receiving response chemical sensing instructions i1230, one or more receiving response pressure sensing instructions i1231, one or more receiving response climate aspects instructions i1232, and one or more receiving response sensor factors instructions i1233.

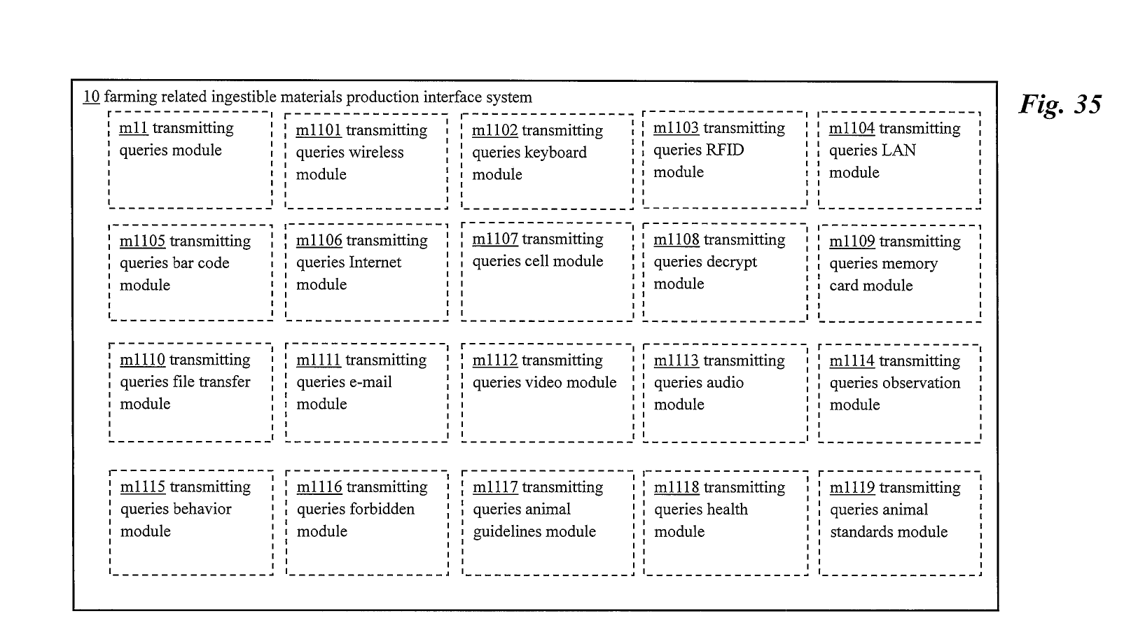

Implementations of modules involve different combinations (limited to patentable subject matter under 35 U.S.C. 101) of one or more aspects from one or more of the electrical circuitry arrangements and/or one or more aspects from one or more of the instructions of the farming related ingestible materials production interface system 10. Exemplary depictions of some of these modules are shown in FIG. 35 to include transmitting queries module m11, transmitting queries wireless module m1101, transmitting queries keyboard module m1102, transmitting queries RFID module m1103, transmitting queries LAN module m1104, transmitting queries bar code module m1105, transmitting queries Internet module m1106, transmitting queries cell module m1107, transmitting queries decrypt module m1108, transmitting queries memory card module m1109, transmitting queries file transfer module m1110, transmitting queries e-mail module m1111, transmitting queries video module m1112, transmitting queries audio module m1113, transmitting queries observation module m1114, transmitting queries behavior module m1115, transmitting queries forbidden module m1116, transmitting queries animal guidelines module m1117, transmitting queries health module m1118, and transmitting queries animal standards module m1119.

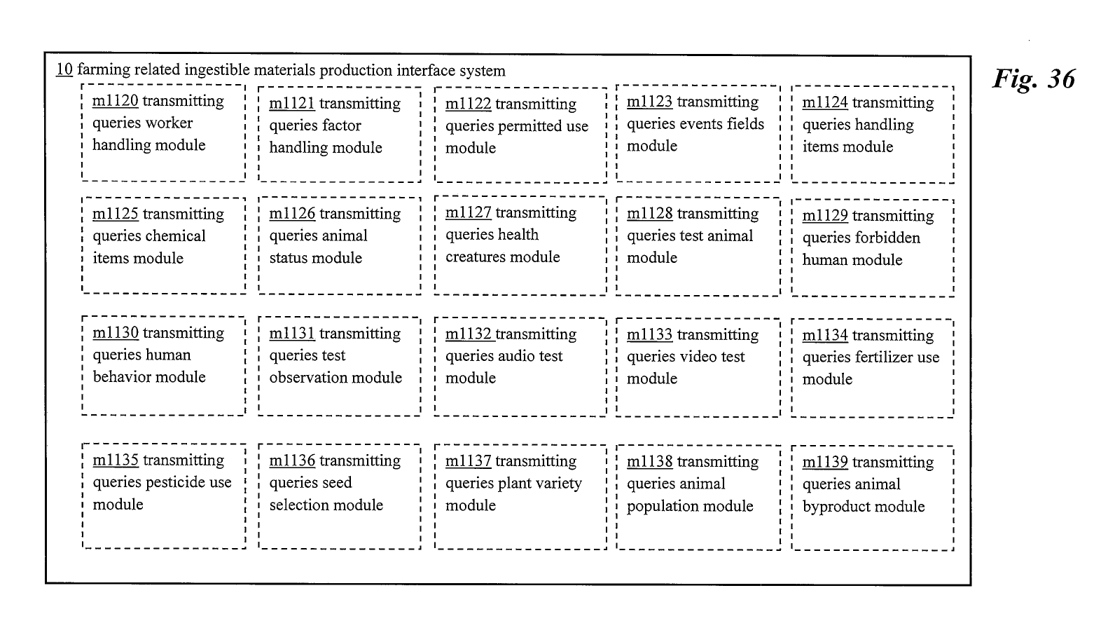

Some of these modules are depicted in FIG. 36 to include transmitting queries worker handling module m1120, transmitting queries factor handling module m1121, transmitting queries permitted use module m1122, transmitting queries events fields module m1123, transmitting queries handling items module m1124, transmitting queries chemical items module m1125, transmitting queries animal status module m1126, transmitting queries health creatures module m1127, transmitting queries test animal module m1128, transmitting queries forbidden human module m1129, transmitting queries human behavior module m1130, transmitting queries test observation module m113, transmitting queries audio test module m1132, transmitting queries video test module m1133, transmitting queries fertilizer use module m1134, transmitting queries pesticide use module m1135, transmitting queries seed selection module m1136, transmitting queries plant variety module m1137, transmitting queries animal population module m1138, and transmitting queries animal byproduct module m1139.

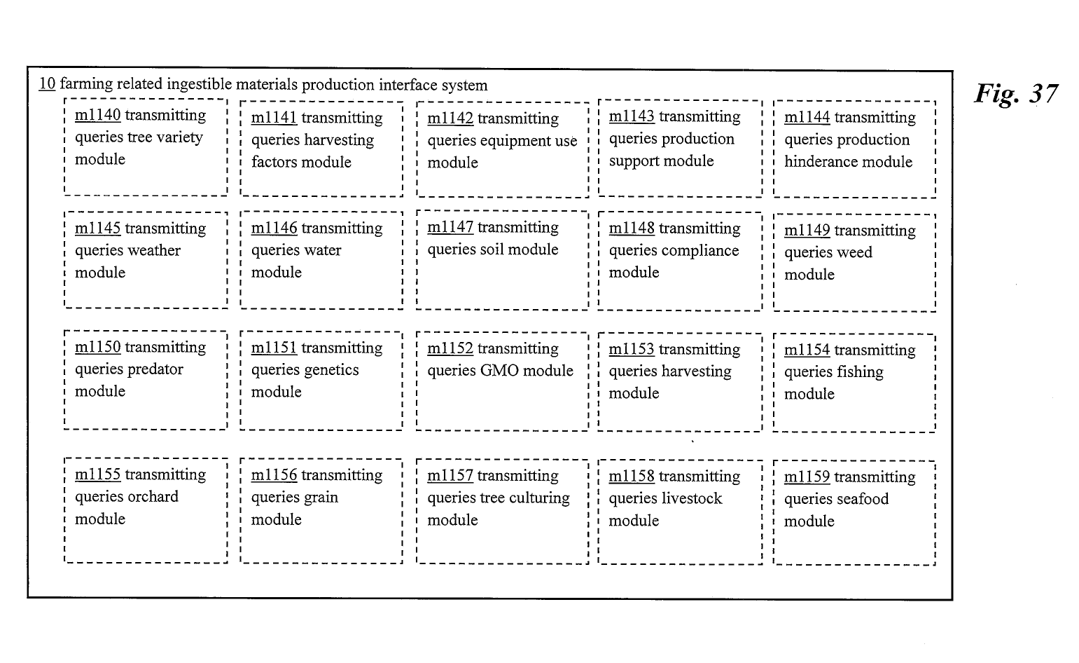

Some of these modules are depicted in FIG. 37 to include transmitting queries tree variety module m1140, transmitting queries harvesting factors module m1141, transmitting queries equipment use module m1142, transmitting queries production support module m1143, transmitting queries production hindrance module m1144, transmitting queries weather module m1145, transmitting queries water module m1146, transmitting queries soil module m1147, transmitting queries compliance module m1148, transmitting queries weed module m1149, transmitting queries predator module m1150, transmitting queries genetics module m1151, transmitting queries GMO module m1152, transmitting queries harvesting module m1153, transmitting queries fishing module m1154, transmitting queries orchard module m1155, transmitting queries grain module m1156, transmitting queries tree culturing module m1157, transmitting queries livestock module m1158, and transmitting queries seafood module m1159.

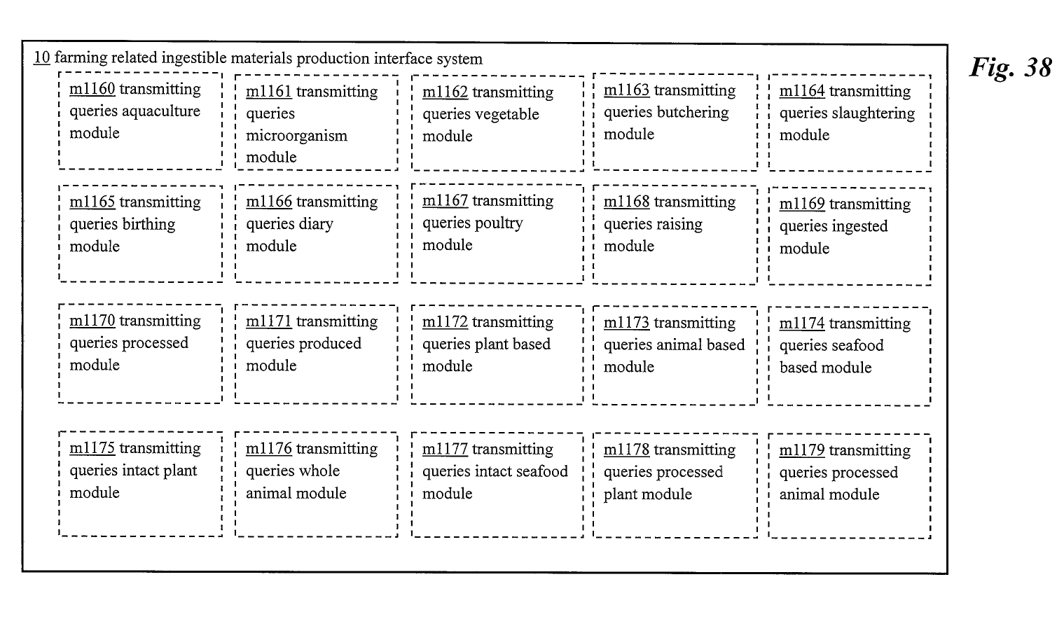

Some of these modules are depicted in FIG. 38 to include transmitting queries aquaculture module m1160, transmitting queries microorganism module m1161, transmitting queries vegetable module m1162, transmitting queries butchering module m1163, transmitting queries slaughtering module m1164, transmitting queries birthing module m1165, and transmitting queries diary module m1166, transmitting queries poultry module m1167, transmitting queries raising module m1168, transmitting queries ingested module m1169, transmitting queries processed module m1170, transmitting queries produced module m1171, transmitting queries plant based module m1172, transmitting queries animal based module m1173, transmitting queries seafood based module m1174, transmitting queries intact plant module m1175, transmitting queries whole animal module m1176, transmitting queries intact seafood module m1177, transmitting queries processed plant module m1178, and transmitting queries processed animal module m1179.

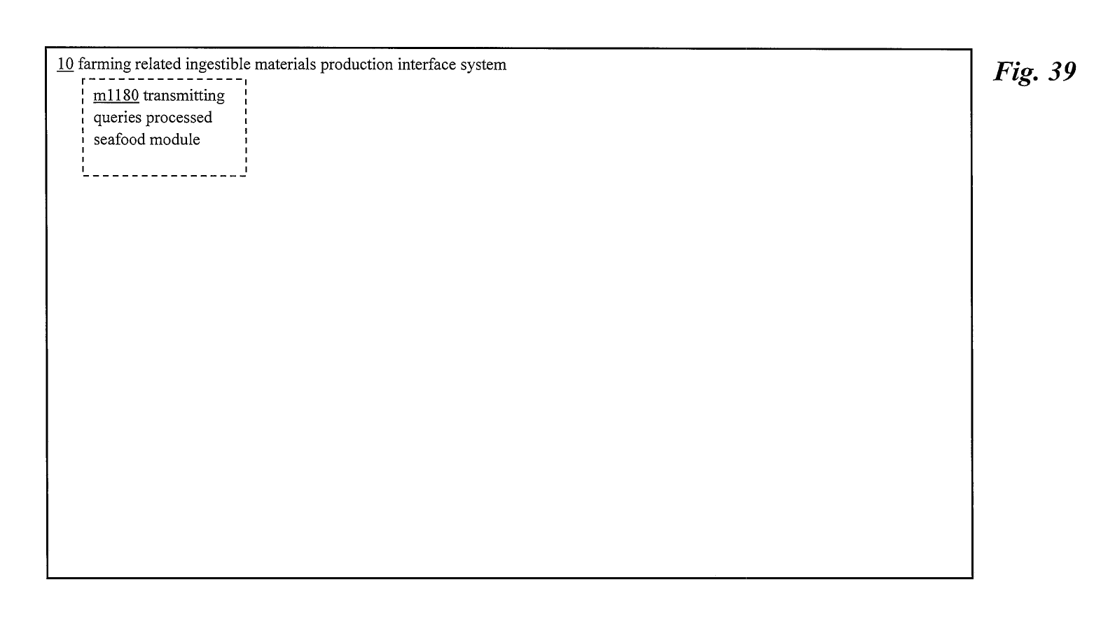

Some of these modules are depicted in FIG. 39 to include transmitting queries processed seafood.

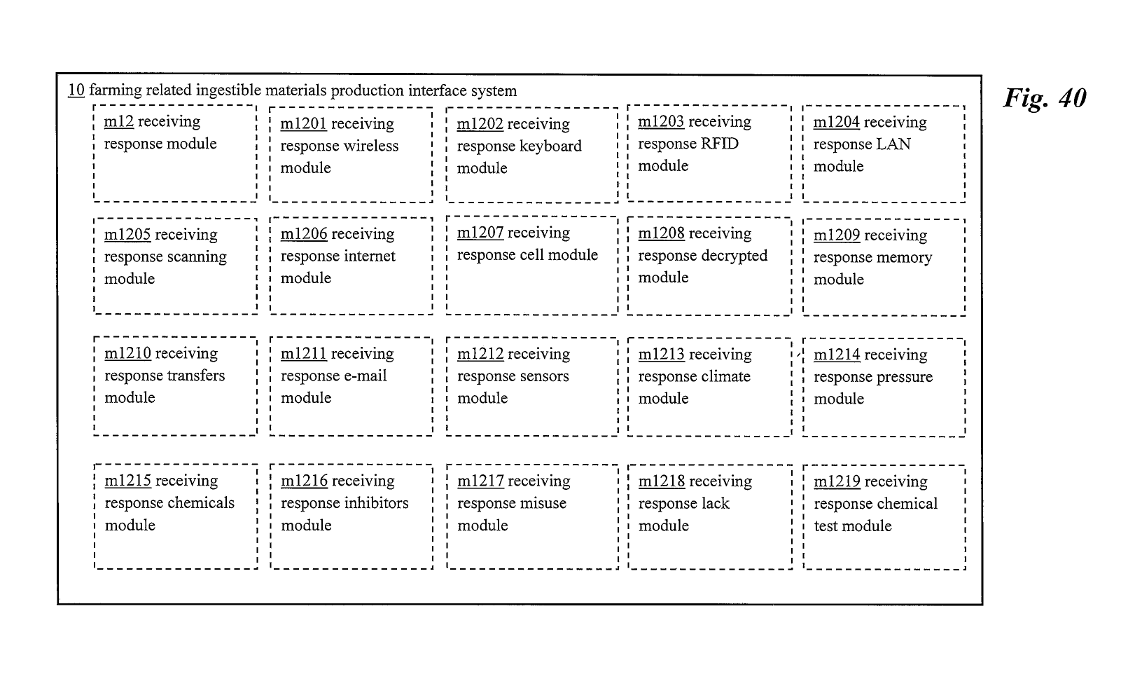

Some of these modules are depicted in FIG. 40 to include receiving response module m12, receiving response wireless module m1201, receiving response keyboard module m1202, receiving response RFID module m1203, receiving response LAN module m1204, receiving response scanning module m1205, receiving response internet module m1206, receiving response cell module m1207, receiving response decrypted module m1208, receiving response memory module m1209, receiving response transfers module m1210, receiving response e-mail module m1211, and receiving response sensors module m1212, receiving response climate module m1213, receiving response pressure module m1214, receiving response chemicals module m1215, receiving response inhibitors module m1216, receiving response misuse module m1217, receiving response lack module m1218, and receiving response chemical test module m1219.

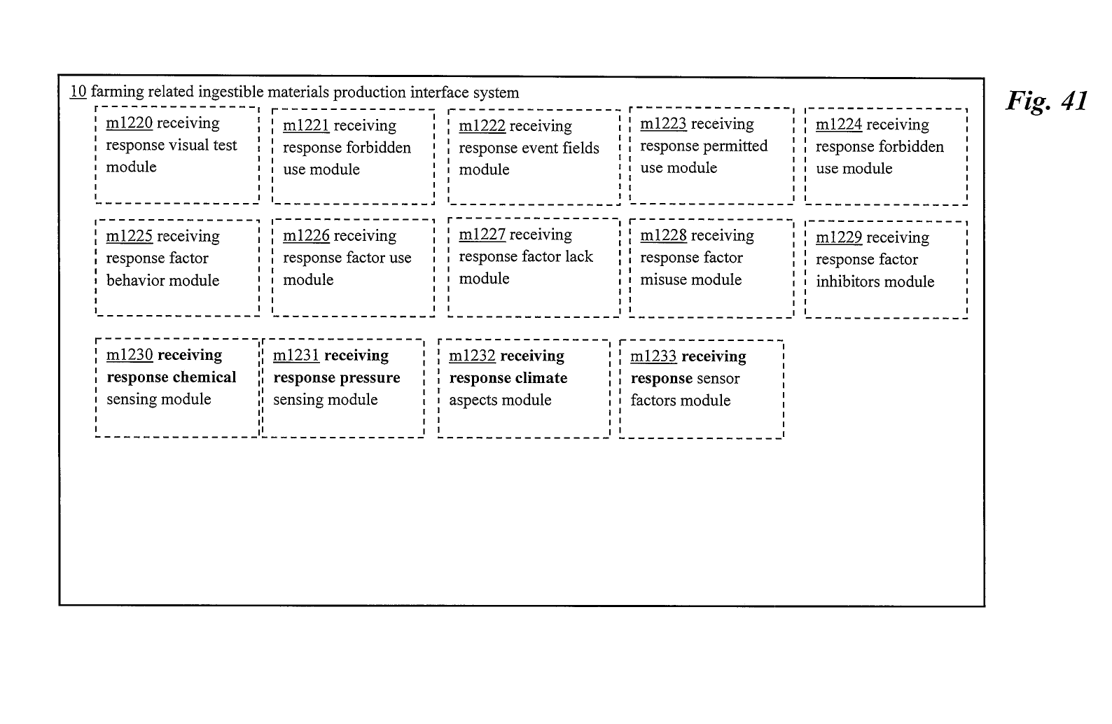

Some of these modules are depicted in FIG. 41 to include receiving response visual test module m12, receiving response forbidden use module m1221, receiving response event fields module m1222, receiving response permitted use module m1223, receiving response forbidden use module m1224, receiving response factor behavior module m1225, receiving response factor use module m1226, receiving response factor lack module m1227, receiving response factor misuse module m1228, receiving response factor inhibitors module m1229, receiving response chemical sensing module m1230, receiving response pressure sensing module m1231, receiving response climate aspects module m1232, and receiving response sensor factors module m1233.

In some implementations, non-transitory signal-bearing medium of information storage subsystem s200 as articles of manufacture may store the one or more exemplary instructions. In some implementations, the non-transitory signal bearing medium may include a computer-readable medium. In some implementations, the non-transitory signal-bearing medium may include a recordable medium. In some implementations, the signal-bearing medium may include a communication medium.

The various subsystems and components of the farming related ingestible materials production interface system s10 such as the control and information processing subsystem s100, the information storage subsystem s200, the information user interface subsystems 300, the sensing subsystem s400 and the electronic communication subsystem s500 and their sub-components and the other exemplary entities depicted may be embodied by hardware, software and/or firmware (limited to patentable subject matter under 35 USC 101). For example, in some implementations of the farming related ingestible materials production interface system s10, aspects may be implemented with a processor (e.g., microprocessor, controller, and so forth) executing computer readable instructions (e.g., computer program product) stored in a storage medium (e.g., volatile or non-volatile memory) such as a signal-bearing medium. Alternatively, hardware such as application specific integrated circuit (ASIC) may be employed in order to implement such modules in some alternative implementations.

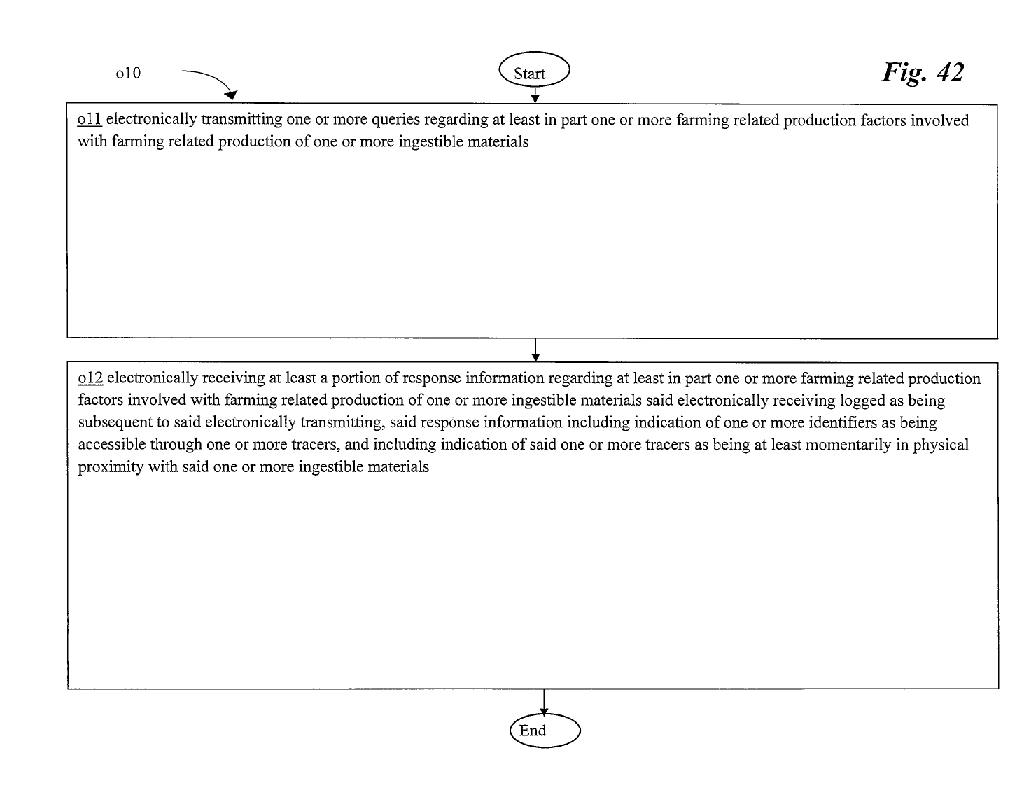

An operational flow o10 as shown in FIG. 42 represents example operations related to electronically transmitting one or more queries regarding at least in part one or more farming related production factors involved with farming related production of one or more ingestible materials and electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials.

FIG. 42 and those figures that follow may have various examples of operational flows, and explanation may be provided with respect to the above-described examples of FIGS. 1-11 and/or with respect to other examples and contexts. Nonetheless, it should be understood that the operational flows may be executed in a number of other environments and contexts, and/or in modified versions of FIGS. 1-11. Furthermore, although the various operational flows are presented in the sequence(s) illustrated, it should be understood that the various operations may be performed in other orders than those which are illustrated, or may be performed concurrently.

In FIG. 42 and those figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

As shown in FIG. 42, the operational flow o10 proceeds to operation o11 for electronically transmitting one or more queries regarding at least in part one or more farming related production factors involved with farming related production of one or more ingestible materials. An exemplary version of a non-transitory signal bearing medium of information storage subsystem s200 is depicted as bearing one or more transmitting queries instructions ill that when executed will direct performance of the operation o11. In an implementation, the one or more transmitting queries instructions ill when executed direct electronically transmitting (e.g. wifi, laptop entry, RFID scan, etc.) one or more queries (e.g. AVI file format, MP3 file format, audio listening, etc.) regarding at least in part (e.g. associated, affected, affecting, etc.) one or more farming related production factors (e.g. fuel delivery schedule, cost of fuel, record keeping methods, etc.) involved with (e.g. associated, affected, affecting, etc.) farming related production of (e.g. blueberry cultivation, raspberry harvesting, corn growing, etc.) one or more ingestible materials (e.g. feed grain, beet pulp, water, etc.). Furthermore, the transmitting queries electrical circuitry arrangement (“elec circ arrange”) e11 when activated will perform the operation o1101. Also, the transmitting queries wireless module m1101, when executed and/or activated, will direct performance of and/or performs the operation o11. In an implementation, the transmitting queries electrical circuitry arrangement e11, when activated performs electronically transmitting (e.g. wifi, laptop entry, RFID scan, etc.) one or more queries (e.g. AVI file format, MP3 file format, audio listening, etc.) regarding at least in part (e.g. associated, affected, affecting, etc.) one or more farming related production factors (e.g. fuel delivery schedule, cost of fuel, record keeping methods, etc.) involved with (e.g. associated, affected, affecting, etc.) farming related production of (e.g. blueberry cultivation, raspberry harvesting, corn growing, etc.) one or more ingestible materials (e.g. feed grain, beet pulp, water, etc.). Also, the transmitting queries module m11, when executed and/or activated, will direct performance of and/or perform the operation o11. In an implementation, the electronically transmitting one or more queries regarding at least in part one or more farming related production factors involved with farming related production of one or more ingestible materials is carried out by electronically transmitting (e.g. wifi, laptop entry, RFID scan, etc.) one or more queries (e.g. AVI file format, MP3 file format, audio listening, etc.) regarding at least in part (e.g. associated, affected, affecting, etc.) one or more farming related production factors (e.g. fuel delivery schedule, cost of fuel, record keeping methods, etc.) involved with (e.g. associated, affected, affecting, etc.) farming related production of (e.g. blueberry cultivation, raspberry harvesting, corn growing, etc.) one or more ingestible materials (e.g. feed grain, beet pulp, water, etc.).

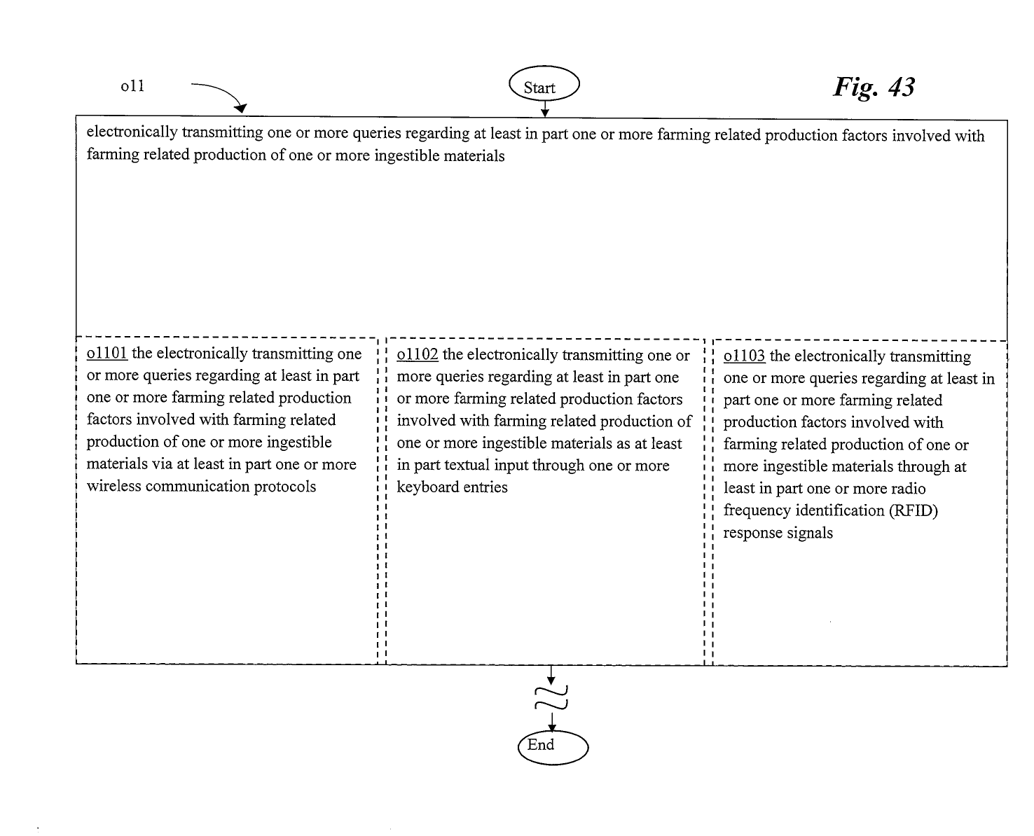

In one or more implementations, as shown in FIG. 43, operation o11 includes an operation o1101 for the electronically transmitting one or more queries regarding at least in part one or more farming related production factors involved with farming related production of one or more ingestible materials via at least in part one or more wireless communication protocols. Origination of an illustratively derived transmitting queries wireless component group can be accomplished through skilled in the art design choice selection of one or more of the above depicted components from one or more of the above depicted subsystems shown in FIG. 12. Components from the transmitting queries wireless component group can be used in implementing execution of the one or more transmitting queries wireless instructions i1101 of FIG. 28, can be used in performance of the transmitting queries wireless electrical circuitry arrangement e1101 of FIG. 21, and/or can be used in otherwise fulfillment of the operation o1101. An exemplary non-transitory signal bearing medium version of the information storage subsystem s200 is depicted in FIG. 28 as bearing the one or more transmitting queries wireless instructions i1101 that when executed will direct performance of the operation o1101. Furthermore, the transmitting queries wireless electrical circuitry arrangement (“elec circ arrange”) e1101, when activated, will perform the operation o1101. Also, the transmitting queries wireless module m1101, when executed and/or activated, will direct performance of and/or perform the operation o1101. For instance, in one or more exemplary implementations, the one or more transmitting queries wireless instructions i1101, when executed, direct performance of the operation o1101 in the illustrative depiction as follows, and/or the transmitting queries wireless electrical circuitry arrangement e1101, when activated, performs the operation o1101 in the illustrative depiction as follows, and/or the transmitting queries wireless module m1101, when executed and/or activated, directs performance of and/or performs the operation o1101 in the illustrative depiction as follows, and/or the operation o1101 is otherwise carried out in the illustrative depiction as follows: the electronically transmitting (e.g. wifi, etc.) one or more queries (e.g. AVI file format, etc.) regarding at least in part (e.g. associated, etc.) one or more farming related production factors (e.g. fuel delivery schedule, etc.) involved with (e.g. associated, etc.) farming related production of (e.g. blueberry cultivation, etc.) one or more ingestible materials (e.g. feed grain, etc.) via at least in part one or more wireless communication protocols (e.g. wifi, etc.).

In one or more implementations, as shown in FIG. 43, operation o11 includes an operation o1102 for the electronically transmitting one or more queries regarding at least in part one or more farming related production factors involved with farming related production of one or more ingestible materials as at least in part textual input through one or more keyboard entries. Origination of an illustratively derived transmitting queries keyboard component group can be accomplished through skilled in the art design choice selection of one or more of the above depicted components from one or more of the above depicted subsystems shown in FIG. 12. Components from the transmitting queries keyboard component group can be used in implementing execution of the one or more transmitting queries keyboard instructions i1102 of FIG. 28, can be used in performance of the transmitting queries keyboard electrical circuitry arrangement e1102 of FIG. 21, and/or can be used in otherwise fulfillment of the operation o1102. An exemplary non-transitory signal bearing medium version of the information storage subsystem s200 is depicted in FIG. 28 as bearing the one or more transmitting queries keyboard instructions i1102 that when executed will direct performance of the operation o1102. Furthermore, the transmitting queries keyboard electrical circuitry arrangement (“elec circ arrange”) e1102, when activated, will perform the operation o1102. Also, the transmitting queries keyboard module m1102, when executed and/or activated, will direct performance of and/or perform the operation o1102. For instance, in one or more exemplary implementations, the one or more transmitting queries keyboard instructions i1102, when executed, direct performance of the operation o1102 in the illustrative depiction as follows, and/or the transmitting queries keyboard electrical circuitry arrangement e1102, when activated, performs the operation o1102 in the illustrative depiction as follows, and/or the transmitting queries keyboard module m1102, when executed and/or activated, directs performance of and/or performs the operation o1102 in the illustrative depiction as follows, and/or the operation o1102 is otherwise carried out in the illustrative depiction as follows: the electronically transmitting (e.g. laptop entry, etc.) one or more queries (e.g. MP3 file format, etc.) regarding at least in part (e.g. affected, etc.) one or more farming related production factors (e.g. cost of fuel, etc.) involved with (e.g. affected, etc.) farming related production of (e.g. raspberry harvesting, etc.) one or more ingestible materials (e.g. beet pulp, etc.) as at least in part textual input through one or more keyboard entries (e.g. laptop entry, etc.).

In one or more implementations, as shown in FIG. 43, operation o11 includes an operation o1103 for the electronically transmitting one or more queries regarding at least in part one or more farming related production factors involved with farming related production of one or more ingestible materials through at least in part one or more radio frequency identification (RFID) response signals. Origination of an illustratively derived transmitting queries RFID component group can be accomplished through skilled in the art design choice selection of one or more of the above depicted components from one or more of the above depicted subsystems shown in FIG. 12. Components from the transmitting queries RFID component group can be used in implementing execution of the one or more transmitting queries RFID instructions i1103 of FIG. 28, can be used in performance of the transmitting queries RFID electrical circuitry arrangement e1103 of FIG. 21, and/or can be used in otherwise fulfillment of the operation o1103. An exemplary non-transitory signal bearing medium version of the information storage subsystem s200 is depicted in FIG. 28 as bearing the one or more transmitting queries RFID instructions i1103 that when executed will direct performance of the operation o1103. Furthermore, the transmitting queries RFID electrical circuitry arrangement (“elec circ arrange”) e1103, when activated, will perform the operation o1103. Also, the transmitting queries RFID module m1103, when executed and/or activated, will direct performance of and/or perform the operation o1103. For instance, in one or more exemplary implementations, the one or more transmitting queries RFID instructions i1103, when executed, direct performance of the operation o1103 in the illustrative depiction as follows, and/or the transmitting queries RFID electrical circuitry arrangement e1103, when activated, performs the operation o1103 in the illustrative depiction as follows, and/or the transmitting queries RFID module m1103, when executed and/or activated, directs performance of and/or performs the operation o1103 in the illustrative depiction as follows, and/or the operation o1103 is otherwise carried out in the illustrative depiction as follows: the electronically transmitting (e.g. RFID scan, etc.) one or more queries (e.g. audio listening, etc.) regarding at least in part (e.g. affecting, etc.) one or more farming related production factors (e.g. record keeping methods, etc.) involved with (e.g. affecting, etc.) farming related production of (e.g. corn growing, etc.) one or more ingestible materials (e.g. water, etc.) through at least in part one or more radio frequency identification (RFID) response signals (e.g. RFID scan, etc.).

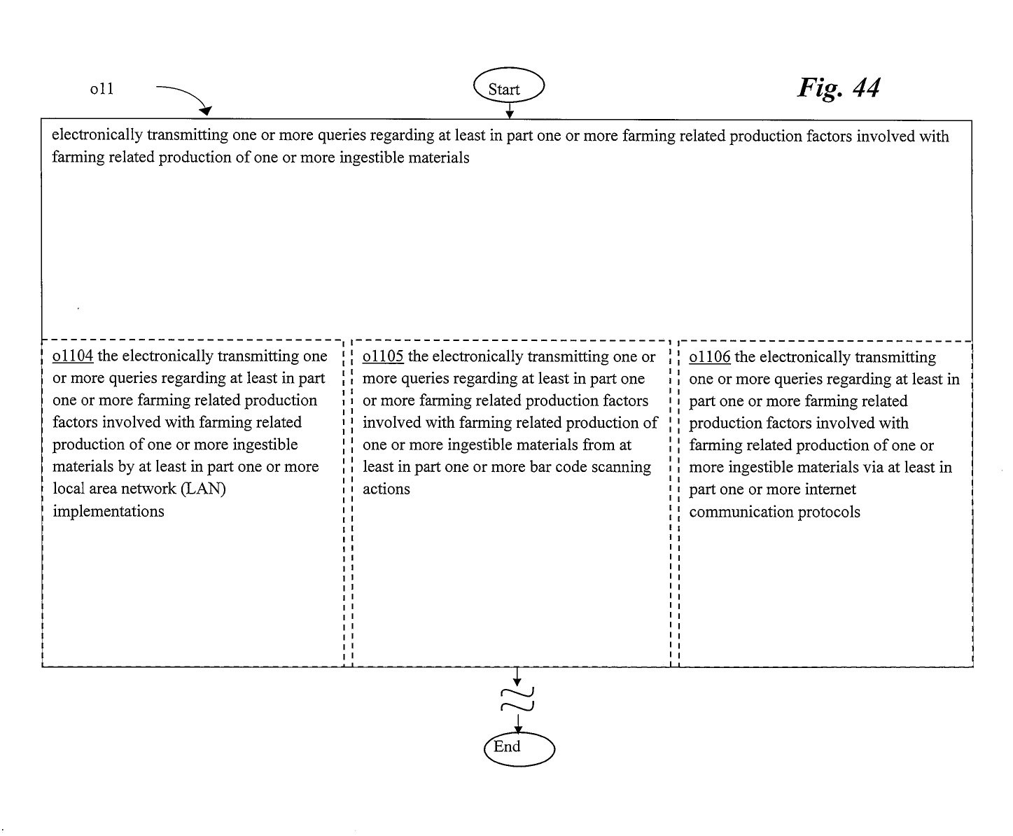

In one or more implementations, as shown in FIG. 44, operation o11 includes an operation o1104 for the electronically transmitting one or more queries regarding at least in part one or more farming related production factors involved with farming related production of one or more ingestible materials by at least in part one or more local area network (LAN) implementations. Origination of an illustratively derived transmitting queries LAN component group can be accomplished through skilled in the art design choice selection of one or more of the above depicted components from one or more of the above depicted subsystems shown in FIG. 12. Components from the transmitting queries LAN component group can be used in implementing execution of the one or more transmitting queries LAN instructions i1104 of FIG. 28, can be used in performance of the transmitting queries LAN electrical circuitry arrangement e1104 of FIG. 21, and/or can be used in otherwise fulfillment of the operation o1104. An exemplary non-transitory signal bearing medium version of the information storage subsystem s200 is depicted in FIG. 28 as bearing the one or more transmitting queries LAN instructions i1104 that when executed will direct performance of the operation o1104. Furthermore, the transmitting queries LAN electrical circuitry arrangement (“elec circ arrange”) e1104, when activated, will perform the operation o1104. Also, the transmitting queries LAN module m1104, when executed and/or activated, will direct performance of and/or perform the operation o1104. For instance, in one or more exemplary implementations, the one or more transmitting queries LAN instructions i1104, when executed, direct performance of the operation o1104 in the illustrative depiction as follows, and/or the transmitting queries LAN electrical circuitry arrangement e1104, when activated, performs the operation o1104 in the illustrative depiction as follows, and/or the transmitting queries LAN module m1104, when executed and/or activated, directs performance of and/or performs the operation o1104 in the illustrative depiction as follows, and/or the operation o1104 is otherwise carried out in the illustrative depiction as follows: the electronically transmitting (e.g. ethernet, etc.) one or more queries (e.g. disobeying safety protocols, etc.) regarding at least in part (e.g. argue, etc.) one or more farming related production factors (e.g. certification deadlines, etc.) involved with (e.g. argue, etc.) farming related production of (e.g. soy bean harvesting, etc.) one or more ingestible materials (e.g. meal worms, etc.) by at least in part one or more local area network (LAN) implementations (e.g. ethernet, etc.).

In one or more implementations, as shown in FIG. 44, operation o11 includes an operation o1105 for the electronically transmitting one or more queries regarding at least in part one or more farming related production factors involved with farming related production of one or more ingestible materials from at least in part one or more bar code scanning actions. Origination of an illustratively derived transmitting queries bar code component group can be accomplished through skilled in the art design choice selection of one or more of the above depicted components from one or more of the above depicted subsystems shown in FIG. 12. Components from the transmitting queries bar code component group can be used in implementing execution of the one or more transmitting queries bar code instructions i1105 of FIG. 28, can be used in performance of the transmitting queries bar code electrical circuitry arrangement e1105 of FIG. 21, and/or can be used in otherwise fulfillment of the operation o1105. An exemplary non-transitory signal bearing medium version of the information storage subsystem s200 is depicted in FIG. 28 as bearing the one or more transmitting queries bar code instructions i1105 that when executed will direct performance of the operation o1105. Furthermore, the transmitting queries bar code electrical circuitry arrangement (“elec circ arrange”) e1105, when activated, will perform the operation o1105. Also, the transmitting queries bar code module m1105, when executed and/or activated, will direct performance of and/or perform the operation o1105. For instance, in one or more exemplary implementations, the one or more transmitting queries bar code instructions i1105, when executed, direct performance of the operation o1105 in the illustrative depiction as follows, and/or the transmitting queries bar code electrical circuitry arrangement e1105, when activated, performs the operation o1105 in the illustrative depiction as follows, and/or the transmitting queries bar code module m1105, when executed and/or activated, directs performance of and/or performs the operation o1105 in the illustrative depiction as follows, and/or the operation o1105 is otherwise carried out in the illustrative depiction as follows: the electronically transmitting (e.g. UPC scan, etc.) one or more queries (e.g. wind speed, etc.) regarding at least in part (e.g. connected, etc.) one or more farming related production factors (e.g. types of fertilizers on order, etc.) involved with (e.g. connected, etc.) farming related production of (e.g. canola harvesting, etc.) one or more ingestible materials (e.g. crawling insects, etc.) from at least in part one or more bar code scanning actions (e.g. UPC scan, etc.).

In one or more implementations, as shown in FIG. 44, operation o11 includes an operation o1106 for the electronically transmitting one or more queries regarding at least in part one or more farming related production factors involved with farming related production of one or more ingestible materials via at least in part one or more internet communication protocols. Origination of an illustratively derived transmitting queries Internet component group can be accomplished through skilled in the art design choice selection of one or more of the above depicted components from one or more of the above depicted subsystems shown in FIG. 12. Components from the transmitting queries Internet component group can be used in implementing execution of the one or more transmitting queries Internet instructions i1106 of FIG. 28, can be used in performance of the transmitting queries Internet electrical circuitry arrangement e1106 of FIG. 21, and/or can be used in otherwise fulfillment of the operation o1106. An exemplary non-transitory signal bearing medium version of the information storage subsystem s200 is depicted in FIG. 28 as bearing the one or more transmitting queries Internet instructions i1106 that when executed will direct performance of the operation o1106. Furthermore, the transmitting queries Internet electrical circuitry arrangement (“elec circ arrange”) e1106, when activated, will perform the operation o1106. Also, the transmitting queries Internet module m1106, when executed and/or activated, will direct performance of and/or perform the operation o1106. For instance, in one or more exemplary implementations, the one or more transmitting queries Internet instructions i1106, when executed, direct performance of the operation o1106 in the illustrative depiction as follows, and/or the transmitting queries Internet electrical circuitry arrangement e1106, when activated, performs the operation o1106 in the illustrative depiction as follows, and/or the transmitting queries Internet module m1106, when executed and/or activated, directs performance of and/or performs the operation o1106 in the illustrative depiction as follows, and/or the operation o1106 is otherwise carried out in the illustrative depiction as follows: the electronically transmitting (e.g. HTML code, etc.) one or more queries (e.g. wind direction, etc.) regarding at least in part (e.g. commit to, etc.) one or more farming related production factors (e.g. banned pesticides, etc.) involved with (e.g. commit to, etc.) farming related production of (e.g. cherry picking, etc.) one or more ingestible materials (e.g. parsnip, etc.) via at least in part one or more internet communication protocols (e.g. HTML code, etc.).

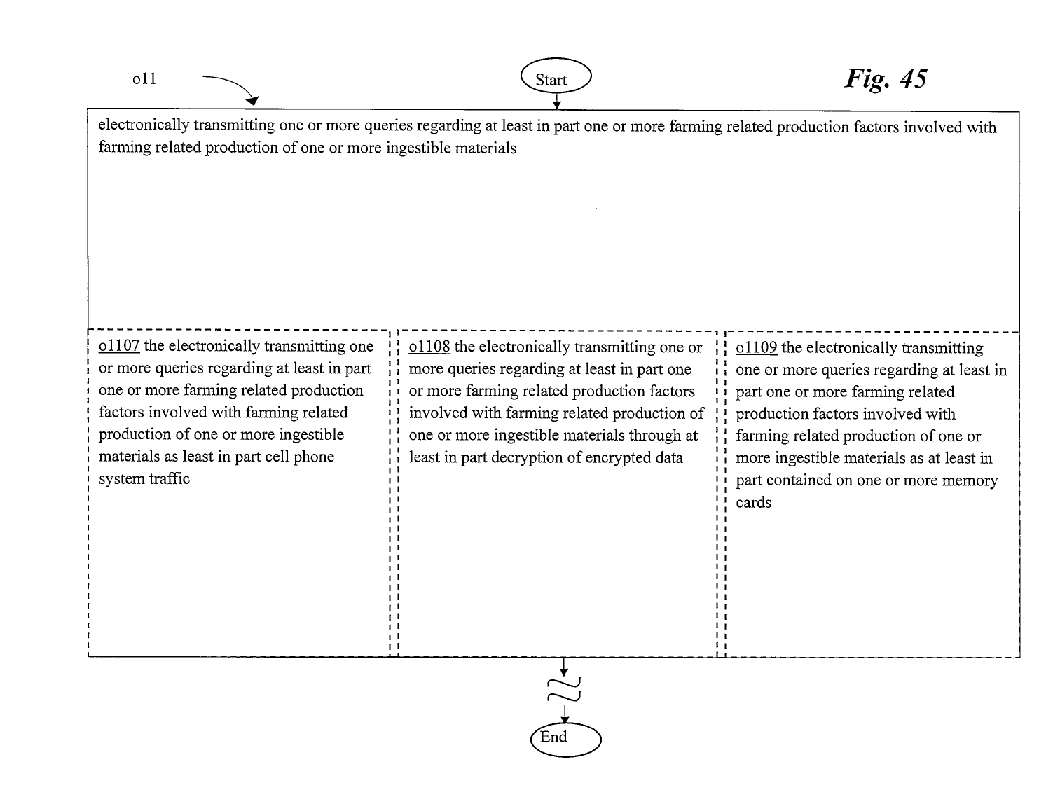

In one or more implementations, as shown in FIG. 45, operation o11 includes an operation o1107 for the electronically transmitting one or more queries regarding at least in part one or more farming related production factors involved with farming related production of one or more ingestible materials as least in part cell phone system traffic. Origination of an illustratively derived transmitting queries cell component group can be accomplished through skilled in the art design choice selection of one or more of the above depicted components from one or more of the above depicted subsystems shown in FIG. 12. Components from the transmitting queries cell component group can be used in implementing execution of the one or more transmitting queries cell instructions i1107 of FIG. 28, can be used in performance of the transmitting queries cell electrical circuitry arrangement e1107 of FIG. 21, and/or can be used in otherwise fulfillment of the operation o1107. An exemplary non-transitory signal bearing medium version of the information storage subsystem s200 is depicted in FIG. 28 as bearing the one or more transmitting queries cell instructions i1107 that when executed will direct performance of the operation o1107. Furthermore, the transmitting queries cell electrical circuitry arrangement (“elec circ arrange”) e1107, when activated, will perform the operation o1107. Also, the transmitting queries cell module m1107, when executed and/or activated, will direct performance of and/or perform the operation o1107. For instance, in one or more exemplary implementations, the one or more transmitting queries cell instructions i1107, when executed, direct performance of the operation o1107 in the illustrative depiction as follows, and/or the transmitting queries cell electrical circuitry arrangement e1107, when activated, performs the operation o1107 in the illustrative depiction as follows, and/or the transmitting queries cell module m1107, when executed and/or activated, directs performance of and/or performs the operation o1107 in the illustrative depiction as follows, and/or the operation o1107 is otherwise carried out in the illustrative depiction as follows: the electronically transmitting (e.g. MMS, etc.) one or more queries (e.g. UV index, etc.) regarding at least in part (e.g. absorbed by, etc.) one or more farming related production factors (e.g. amount of historical rainfall, etc.) involved with (e.g. absorbed by, etc.) farming related production of (e.g. peach picking, etc.) one or more ingestible materials (e.g. chicken feathers, etc.) as least in part cell phone system traffic (e.g. MMS, etc.).

In one or more implementations, as shown in FIG. 45, operation o11 includes an operation o1108 for the electronically transmitting one or more queries regarding at least in part one or more farming related production factors involved with farming related production of one or more ingestible materials through at least in part decryption of encrypted data. Origination of an illustratively derived transmitting queries decrypt component group can be accomplished through skilled in the art design choice selection of one or more of the above depicted components from one or more of the above depicted subsystems shown in FIG. 12. Components from the transmitting queries decrypt component group can be used in implementing execution of the one or more transmitting queries decrypt instructions i1108 of FIG. 28, can be used in performance of the transmitting queries decrypt electrical circuitry arrangement e1108 of FIG. 21, and/or can be used in otherwise fulfillment of the operation o1108. An exemplary non-transitory signal bearing medium version of the information storage subsystem s200 is depicted in FIG. 28 as bearing the one or more transmitting queries decrypt instructions i1108 that when executed will direct performance of the operation o1108. Furthermore, the transmitting queries decrypt electrical circuitry arrangement (“elec circ arrange”) e1108, when activated, will perform the operation o1108. Also, the transmitting queries decrypt module m1108, when executed and/or activated, will direct performance of and/or perform the operation o1108. For instance, in one or more exemplary implementations, the one or more transmitting queries decrypt instructions i1108, when executed, direct performance of the operation o1108 in the illustrative depiction as follows, and/or the transmitting queries decrypt electrical circuitry arrangement e1108, when activated, performs the operation o1108 in the illustrative depiction as follows, and/or the transmitting queries decrypt module m1108, when executed and/or activated, directs performance of and/or performs the operation o1108 in the illustrative depiction as follows, and/or the operation o1108 is otherwise carried out in the illustrative depiction as follows: the electronically transmitting (e.g. 256-bit AES, etc.) one or more queries (e.g. carbon dioxide sensor, etc.) regarding at least in part (e.g. embraced by, etc.) one or more farming related production factors (e.g. amount of predicted rainfall, etc.) involved with (e.g. embraced by, etc.) farming related production of (e.g. chicken egg laying, etc.) one or more ingestible materials (e.g. hoofs, etc.) through at least in part decryption of encrypted data (e.g. 256-bit AES, etc.).

In one or more implementations, as shown in FIG. 45, operation o11 includes an operation o1109 for the electronically transmitting one or more queries regarding at least in part one or more farming related production factors involved with farming related production of one or more ingestible materials as at least in part contained on one or more memory cards. Origination of an illustratively derived transmitting queries memory card component group can be accomplished through skilled in the art design choice selection of one or more of the above depicted components from one or more of the above depicted subsystems shown in FIG. 12. Components from the transmitting queries memory card component group can be used in implementing execution of the one or more transmitting queries memory card instructions i1109 of FIG. 28, can be used in performance of the transmitting queries memory card electrical circuitry arrangement e1109 of FIG. 21, and/or can be used in otherwise fulfillment of the operation o1109. An exemplary non-transitory signal bearing medium version of the information storage subsystem s200 is depicted in FIG. 28 as bearing the one or more transmitting queries memory card instructions i1109 that when executed will direct performance of the operation o1109. Furthermore, the transmitting queries memory card electrical circuitry arrangement (“elec circ arrange”) e1109, when activated, will perform the operation o1109. Also, the transmitting queries memory card module m1109, when executed and/or activated, will direct performance of and/or perform the operation o1109. For instance, in one or more exemplary implementations, the one or more transmitting queries memory card instructions i1109, when executed, direct performance of the operation o1109 in the illustrative depiction as follows, and/or the transmitting queries memory card electrical circuitry arrangement e1109, when activated, performs the operation o1109 in the illustrative depiction as follows, and/or the transmitting queries memory card module m1109, when executed and/or activated, directs performance of and/or performs the operation o1109 in the illustrative depiction as follows, and/or the operation o1109 is otherwise carried out in the illustrative depiction as follows: the electronically transmitting (e.g. compact flash, etc.) one or more queries (e.g. water usage, etc.) regarding at least in part (e.g. containing, etc.) one or more farming related production factors (e.g. size of labor force, etc.) involved with (e.g. containing, etc.) farming related production of (e.g. sheep butchering, etc.) one or more ingestible materials (e.g. leather, etc.) as at least in part contained on one or more memory cards (e.g. compact flash, etc.).

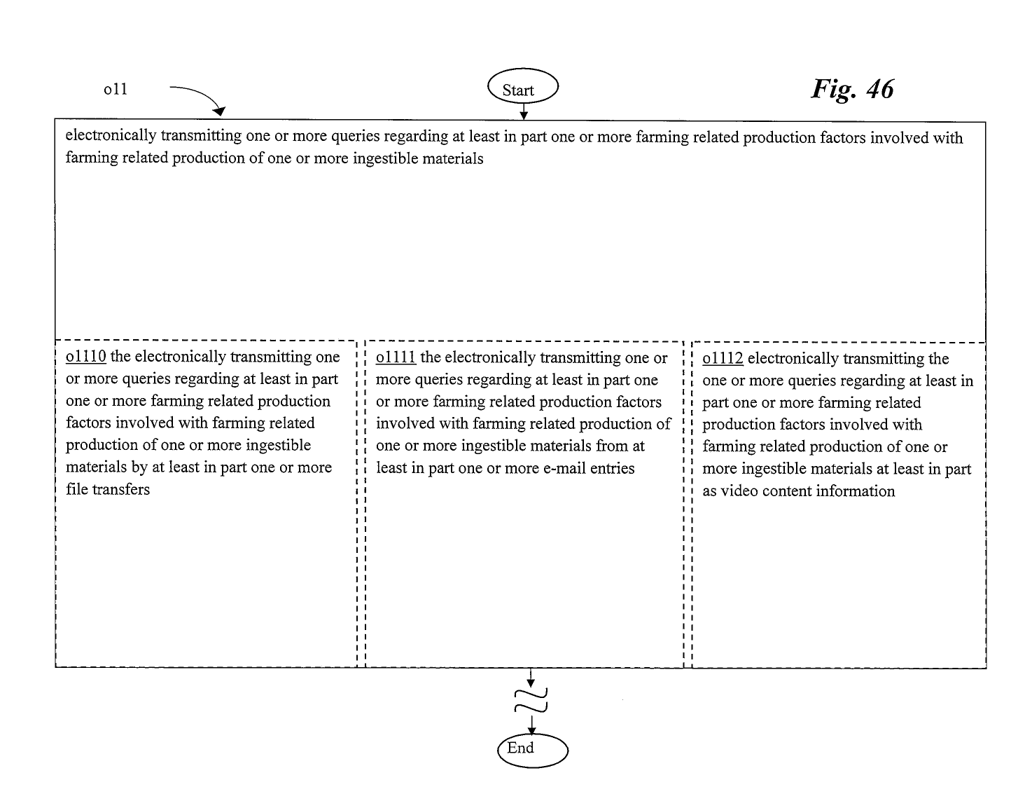

In one or more implementations, as shown in FIG. 46, operation o11 includes an operation o1110 for the electronically transmitting one or more queries regarding at least in part one or more farming related production factors involved with farming related production of one or more ingestible materials by at least in part one or more file transfers. Origination of an illustratively derived transmitting queries file transfer component group can be accomplished through skilled in the art design choice selection of one or more of the above depicted components from one or more of the above depicted subsystems shown in FIG. 12. Components from the transmitting queries file transfer component group can be used in implementing execution of the one or more transmitting queries file transfer instructions i1110 of FIG. 28, can be used in performance of the transmitting queries file transfer electrical circuitry arrangement e1110 of FIG. 21, and/or can be used in otherwise fulfillment of the operation o1110. An exemplary non-transitory signal bearing medium version of the information storage subsystem s200 is depicted in FIG. 28 as bearing the one or more transmitting queries file transfer instructions i1110 that when executed will direct performance of the operation o1110. Furthermore, the transmitting queries file transfer electrical circuitry arrangement (“elec circ arrange”) e1110, when activated, will perform the operation o1110. Also, the transmitting queries file transfer module m1110, when executed and/or activated, will direct performance of and/or perform the operation o1110. For instance, in one or more exemplary implementations, the one or more transmitting queries file transfer instructions i1110, when executed, direct performance of the operation o1110 in the illustrative depiction as follows, and/or the transmitting queries file transfer electrical circuitry arrangement e1110, when activated, performs the operation o1110 in the illustrative depiction as follows, and/or the transmitting queries file transfer module m1110, when executed and/or activated, directs performance of and/or performs the operation o1110 in the illustrative depiction as follows, and/or the operation o1110 is otherwise carried out in the illustrative depiction as follows: the electronically transmitting (e.g. push-based, etc.) one or more queries (e.g. natural gas usage, etc.) regarding at least in part (e.g. engaging, etc.) one or more farming related production factors (e.g. cost of labor, etc.) involved with (e.g. engaging, etc.) farming related production of (e.g. clam digging, etc.) one or more ingestible materials (e.g. fur, etc.) by at least in part one or more file transfers (e.g. push-based, etc.).

In one or more implementations, as shown in FIG. 46, operation o11 includes an operation o1111 for the electronically transmitting one or more queries regarding at least in part one or more farming related production factors involved with farming related production of one or more ingestible materials from at least in part one or more e-mail entries. Origination of an illustratively derived transmitting queries e-mail component group can be accomplished through skilled in the art design choice selection of one or more of the above depicted components from one or more of the above depicted subsystems shown in FIG. 12. Components from the transmitting queries e-mail component group can be used in implementing execution of the one or more transmitting queries e-mail instructions ill 11 of FIG. 28, can be used in performance of the transmitting queries e-mail electrical circuitry arrangement e1111 of FIG. 21, and/or can be used in otherwise fulfillment of the operation o1111. An exemplary non-transitory signal bearing medium version of the information storage subsystem s200 is depicted in FIG. 28 as bearing the one or more transmitting queries e-mail instructions ill 11 that when executed will direct performance of the operation o1111. Furthermore, the transmitting queries e-mail electrical circuitry arrangement (“elec circ arrange”) e1111, when activated, will perform the operation o1111. Also, the transmitting queries e-mail module m1111, when executed and/or activated, will direct performance of and/or perform the operation o1111. For instance, in one or more exemplary implementations, the one or more transmitting queries e-mail instructions ill 11, when executed, direct performance of the operation o1111 in the illustrative depiction as follows, and/or the transmitting queries e-mail electrical circuitry arrangement e1111, when activated, performs the operation o1111 in the illustrative depiction as follows, and/or the transmitting queries e-mail module m1111, when executed and/or activated, directs performance of and/or performs the operation o1111 in the illustrative depiction as follows, and/or the operation o1111 is otherwise carried out in the illustrative depiction as follows: the electronically transmitting (e.g. SMTP server, etc.) one or more queries (e.g. methane gas usage, etc.) regarding at least in part (e.g. engaged by, etc.) one or more farming related production factors (e.g. cost of shipping, etc.) involved with (e.g. engaged by, etc.) farming related production of (e.g. crab trapping, etc.) one or more ingestible materials (e.g. wool, etc.) from at least in part one or more e-mail entries (e.g. SMTP server, etc.).

In one or more implementations, as shown in FIG. 46, operation o11 includes an operation o1112 for electronically transmitting the one or more queries regarding at least in part one or more farming related production factors involved with farming related production of one or more ingestible materials at least in part as video content information. Origination of an illustratively derived transmitting queries video component group can be accomplished through skilled in the art design choice selection of one or more of the above depicted components from one or more of the above depicted subsystems shown in FIG. 12. Components from the transmitting queries video component group can be used in implementing execution of the one or more transmitting queries video instructions i1112 of FIG. 28, can be used in performance of the transmitting queries video electrical circuitry arrangement e1112 of FIG. 21, and/or can be used in otherwise fulfillment of the operation o1112. An exemplary non-transitory signal bearing medium version of the information storage subsystem s200 is depicted in FIG. 28 as bearing the one or more transmitting queries video instructions i1112 that when executed will direct performance of the operation o1112. Furthermore, the transmitting queries video electrical circuitry arrangement (“elec circ arrange”) e1112, when activated, will perform the operation o1112. Also, the transmitting queries video module m1112, when executed and/or activated, will direct performance of and/or perform the operation o1112. For instance, in one or more exemplary implementations, the one or more transmitting queries video instructions i1112, when executed, direct performance of the operation o1112 in the illustrative depiction as follows, and/or the transmitting queries video electrical circuitry arrangement e1112, when activated, performs the operation o1112 in the illustrative depiction as follows, and/or the transmitting queries video module m1112, when executed and/or activated, directs performance of and/or performs the operation o1112 in the illustrative depiction as follows, and/or the operation o1112 is otherwise carried out in the illustrative depiction as follows: electronically transmitting (e.g. radio wave, etc.) the one or more queries (e.g. MPEG file format, etc.) regarding at least in part (e.g. incorporating, etc.) one or more farming related production factors (e.g. shipping schedule, etc.) involved with (e.g. incorporating, etc.) farming related production of (e.g. mushroom cultivation, etc.) one or more ingestible materials (e.g. whole king crab, etc.) at least in part as video content information (e.g. MPEG file format, etc.).

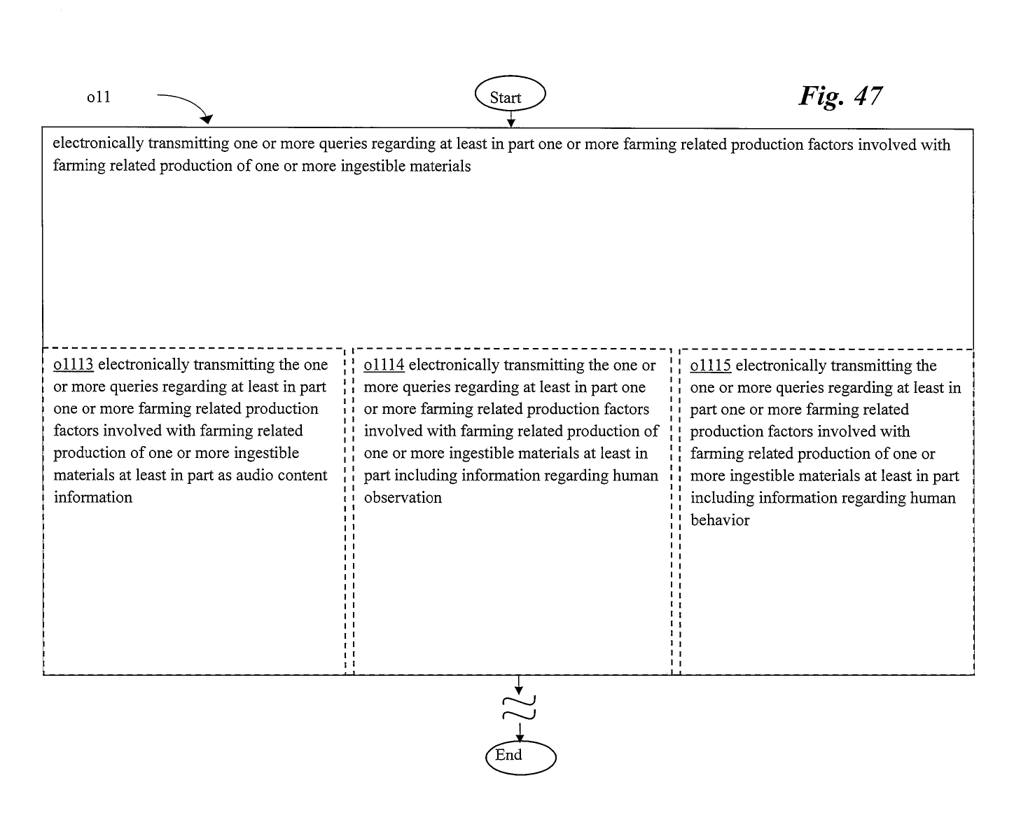

In one or more implementations, as shown in FIG. 47, operation o11 includes an operation o1113 for electronically transmitting the one or more queries regarding at least in part one or more farming related production factors involved with farming related production of one or more ingestible materials at least in part as audio content information. Origination of an illustratively derived transmitting queries audio component group can be accomplished through skilled in the art design choice selection of one or more of the above depicted components from one or more of the above depicted subsystems shown in FIG. 12. Components from the transmitting queries audio component group can be used in implementing execution of the one or more transmitting queries audio instructions i1113 of FIG. 28, can be used in performance of the transmitting queries audio electrical circuitry arrangement e1113 of FIG. 21, and/or can be used in otherwise fulfillment of the operation o1113. An exemplary non-transitory signal bearing medium version of the information storage subsystem s200 is depicted in FIG. 28 as bearing the one or more transmitting queries audio instructions i1113 that when executed will direct performance of the operation o1113. Furthermore, the transmitting queries audio electrical circuitry arrangement (“elec circ arrange”) e1113, when activated, will perform the operation o1113. Also, the transmitting queries audio module m1113, when executed and/or activated, will direct performance of and/or perform the operation o1113. For instance, in one or more exemplary implementations, the one or more transmitting queries audio instructions i1113, when executed, direct performance of the operation o1113 in the illustrative depiction as follows, and/or the transmitting queries audio electrical circuitry arrangement e1113, when activated, performs the operation o1113 in the illustrative depiction as follows, and/or the transmitting queries audio module m1113, when executed and/or activated, directs performance of and/or performs the operation o1113 in the illustrative depiction as follows, and/or the operation o1113 is otherwise carried out in the illustrative depiction as follows: electronically transmitting (e.g. infra-red, etc.) the one or more queries (e.g. WAV file format, etc.) regarding at least in part (e.g. engrossing, etc.) one or more farming related production factors (e.g. known pandemic status, etc.) involved with (e.g. engrossing, etc.) farming related production of (e.g. alfalfa cutting, etc.) one or more ingestible materials (e.g. cellulose, etc.) at least in part as audio content information (e.g. WAV file format, etc.).

In one or more implementations, as shown in FIG. 47, operation o11 includes an operation o1114 for electronically transmitting the one or more queries regarding at least in part one or more farming related production factors involved with farming related production of one or more ingestible materials at least in part including information regarding human observation. Origination of an illustratively derived transmitting queries observation component group can be accomplished through skilled in the art design choice selection of one or more of the above depicted components from one or more of the above depicted subsystems shown in FIG. 12. Components from the transmitting queries observation component group can be used in implementing execution of the one or more transmitting queries observation instructions i1114 of FIG. 28, can be used in performance of the transmitting queries observation electrical circuitry arrangement e1114 of FIG. 21, and/or can be used in otherwise fulfillment of the operation o1114. An exemplary non-transitory signal bearing medium version of the information storage subsystem s200 is depicted in FIG. 28 as bearing the one or more transmitting queries observation instructions i1114 that when executed will direct performance of the operation o1114. Furthermore, the transmitting queries observation electrical circuitry arrangement (“elec circ arrange”) e1114, when activated, will perform the operation o1114. Also, the transmitting queries observation module m1114, when executed and/or activated, will direct performance of and/or perform the operation o1114. For instance, in one or more exemplary implementations, the one or more transmitting queries observation instructions i1114, when executed, direct performance of the operation o1114 in the illustrative depiction as follows, and/or the transmitting queries observation electrical circuitry arrangement e1114, when activated, performs the operation o1114 in the illustrative depiction as follows, and/or the transmitting queries observation module m1114, when executed and/or activated, directs performance of and/or performs the operation o1114 in the illustrative depiction as follows, and/or the operation o1114 is otherwise carried out in the illustrative depiction as follows: electronically transmitting (e.g. bluetooth, etc.) the one or more queries (e.g. visual sight, etc.) regarding at least in part (e.g. implicate, etc.) one or more farming related production factors (e.g. market demands, etc.) involved with (e.g. implicate, etc.) farming related production of (e.g. potato harvesting, etc.) one or more ingestible materials (e.g. wood, etc.) at least in part including information regarding human observation (e.g. visual sight, etc.).

In one or more implementations, as shown in FIG. 47, operation o11 includes an operation o1115 for electronically transmitting the one or more queries regarding at least in part one or more farming related production factors involved with farming related production of one or more ingestible materials at least in part including information regarding human behavior. Origination of an illustratively derived transmitting queries behavior component group can be accomplished through skilled in the art design choice selection of one or more of the above depicted components from one or more of the above depicted subsystems shown in FIG. 12. Components from the transmitting queries behavior component group can be used in implementing execution of the one or more transmitting queries behavior instructions i1115 of FIG. 28, can be used in performance of the transmitting queries behavior electrical circuitry arrangement e1115 of FIG. 21, and/or can be used in otherwise fulfillment of the operation o1115. An exemplary non-transitory signal bearing medium version of the information storage subsystem s200 is depicted in FIG. 28 as bearing the one or more transmitting queries behavior instructions i1115 that when executed will direct performance of the operation o1115. Furthermore, the transmitting queries behavior electrical circuitry arrangement (“elec circ arrange”) e1115, when activated, will perform the operation o1115. Also, the transmitting queries behavior module m1115, when executed and/or activated, will direct performance of and/or perform the operation o1115. For instance, in one or more exemplary implementations, the one or more transmitting queries behavior instructions i1115, when executed, direct performance of the operation o1115 in the illustrative depiction as follows, and/or the transmitting queries behavior electrical circuitry arrangement e1115, when activated, performs the operation o1115 in the illustrative depiction as follows, and/or the transmitting queries behavior module m1115, when executed and/or activated, directs performance of and/or performs the operation o1115 in the illustrative depiction as follows, and/or the operation o1115 is otherwise carried out in the illustrative depiction as follows: electronically transmitting (e.g. webpage, etc.) the one or more queries (e.g. following safety protocols, etc.) regarding at least in part (e.g. necessitate, etc.) one or more farming related production factors (e.g. crop disease status, etc.) involved with (e.g. necessitate, etc.) farming related production of (e.g. beet root harvesting, etc.) one or more ingestible materials (e.g. manure, etc.) at least in part including information regarding human behavior (e.g. following safety protocols, etc.).

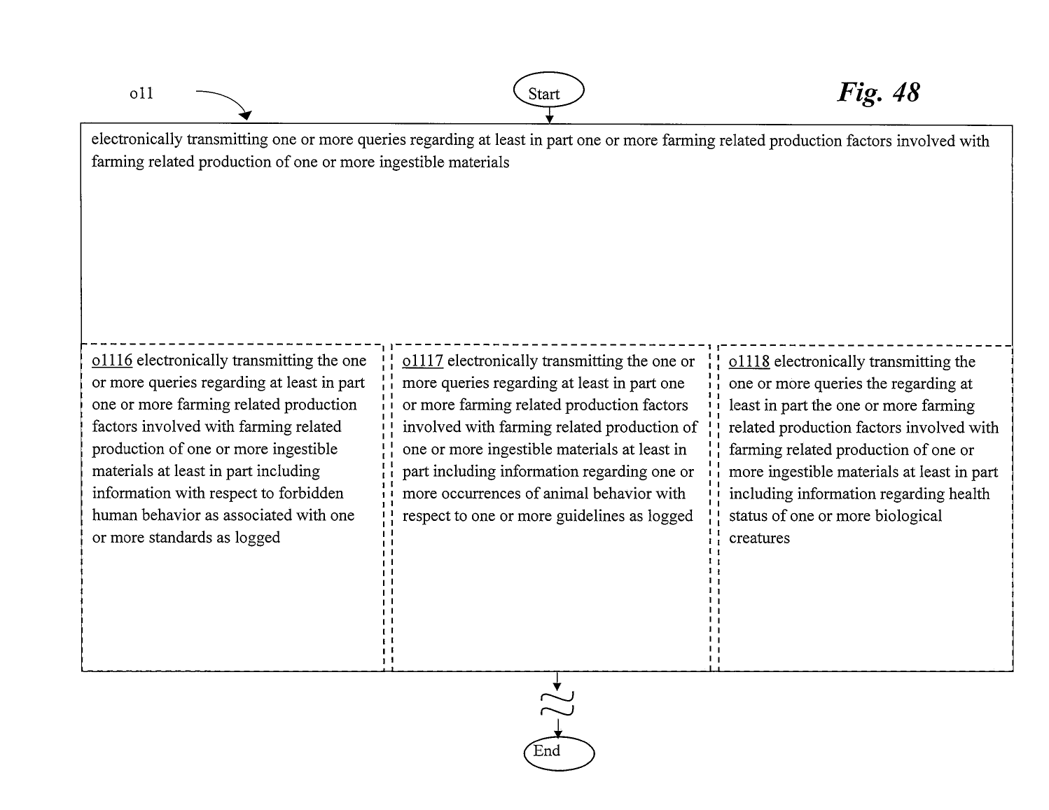

In one or more implementations, as shown in FIG. 48, operation o11 includes an operation o1116 for electronically transmitting the one or more queries regarding at least in part one or more farming related production factors involved with farming related production of one or more ingestible materials at least in part including information with respect to forbidden human behavior as associated with one or more standards as logged. Origination of an illustratively derived transmitting queries forbidden component group can be accomplished through skilled in the art design choice selection of one or more of the above depicted components from one or more of the above depicted subsystems shown in FIG. 12. Components from the transmitting queries forbidden component group can be used in implementing execution of the one or more transmitting queries forbidden instructions i1116 of FIG. 28, can be used in performance of the transmitting queries forbidden electrical circuitry arrangement e1116 of FIG. 21, and/or can be used in otherwise fulfillment of the operation o1116. An exemplary non-transitory signal bearing medium version of the information storage subsystem s200 is depicted in FIG. 28 as bearing the one or more transmitting queries forbidden instructions i1116 that when executed will direct performance of the operation o1116. Furthermore, the transmitting queries forbidden electrical circuitry arrangement (“elec circ arrange”) e1116, when activated, will perform the operation o1116. Also, the transmitting queries forbidden module m1116, when executed and/or activated, will direct performance of and/or perform the operation o1116. For instance, in one or more exemplary implementations, the one or more transmitting queries forbidden instructions i1116, when executed, direct performance of the operation o1116 in the illustrative depiction as follows, and/or the transmitting queries forbidden electrical circuitry arrangement e1116, when activated, performs the operation o1116 in the illustrative depiction as follows, and/or the transmitting queries forbidden module m1116, when executed and/or activated, directs performance of and/or performs the operation o1116 in the illustrative depiction as follows, and/or the operation o1116 is otherwise carried out in the illustrative depiction as follows: electronically transmitting (e.g. website, etc.) the one or more queries (e.g. document forgery, etc.) regarding at least in part (e.g. presuppose, etc.) one or more farming related production factors (e.g. livestock fertility, etc.) involved with (e.g. presuppose, etc.) farming related production of (e.g. oat harvesting, etc.) one or more ingestible materials (e.g. ground chicken, etc.) at least in part including information with respect to forbidden human behavior as associated with one or more standards as logged (e.g. document forgery, etc.).

In one or more implementations, as shown in FIG. 48, operation o11 includes an operation o1117 for electronically transmitting the one or more queries regarding at least in part one or more farming related production factors involved with farming related production of one or more ingestible materials at least in part including information regarding one or more occurrences of animal behavior with respect to one or more guidelines as logged. Origination of an illustratively derived transmitting queries animal guidelines component group can be accomplished through skilled in the art design choice selection of one or more of the above depicted components from one or more of the above depicted subsystems shown in FIG. 12. Components from the transmitting queries animal guidelines component group can be used in implementing execution of the one or more transmitting queries animal guidelines instructions i1117 of FIG. 28, can be used in performance of the transmitting queries animal guidelines electrical circuitry arrangement e1117 of FIG. 21, and/or can be used in otherwise fulfillment of the operation o1117. An exemplary non-transitory signal bearing medium version of the information storage subsystem s200 is depicted in FIG. 28 as bearing the one or more transmitting queries animal guidelines instructions i1117 that when executed will direct performance of the operation o1117. Furthermore, the transmitting queries animal guidelines electrical circuitry arrangement (“elec circ arrange”) e1117, when activated, will perform the operation o1117. Also, the transmitting queries animal guidelines module m1117, when executed and/or activated, will direct performance of and/or perform the operation o1117. For instance, in one or more exemplary implementations, the one or more transmitting queries animal guidelines instructions i1117, when executed, direct performance of the operation o1117 in the illustrative depiction as follows, and/or the transmitting queries animal guidelines electrical circuitry arrangement e1117, when activated, performs the operation o1117 in the illustrative depiction as follows, and/or the transmitting queries animal guidelines module m1117, when executed and/or activated, directs performance of and/or performs the operation o1117 in the illustrative depiction as follows, and/or the operation o1117 is otherwise carried out in the illustrative depiction as follows: electronically transmitting (e.g. cellphone entry, etc.) the one or more queries (e.g. scheduled feeding, etc.) regarding at least in part (e.g. related to, etc.) one or more farming related production factors (e.g. livestock breeding schedule, etc.) involved with (e.g. related to, etc.) farming related production of (e.g. carrot harvesting, etc.) one or more ingestible materials (e.g. goat milk, etc.) at least in part including information regarding one or more occurrences of animal behavior with respect to one or more guidelines as logged (e.g. scheduled feeding, etc.).

In one or more implementations, as shown in FIG. 48, operation o11 includes an operation o1118 for electronically transmitting the one or more queries the regarding at least in part the one or more farming related production factors involved with farming related production of one or more ingestible materials at least in part including information regarding health status of one or more biological creatures. Origination of an illustratively derived transmitting queries health component group can be accomplished through skilled in the art design choice selection of one or more of the above depicted components from one or more of the above depicted subsystems shown in FIG. 12. Components from the transmitting queries health component group can be used in implementing execution of the one or more transmitting queries health instructions i1118 of FIG. 28, can be used in performance of the transmitting queries health electrical circuitry arrangement e1118 of FIG. 21, and/or can be used in otherwise fulfillment of the operation o1118. An exemplary non-transitory signal bearing medium version of the information storage subsystem s200 is depicted in FIG. 28 as bearing the one or more transmitting queries health instructions i1118 that when executed will direct performance of the operation o1118. Furthermore, the transmitting queries health electrical circuitry arrangement (“elec circ arrange”) e1118, when activated, will perform the operation o1118. Also, the transmitting queries health module m1118, when executed and/or activated, will direct performance of and/or perform the operation o1118. For instance, in one or more exemplary implementations, the one or more transmitting queries health instructions i1118, when executed, direct performance of the operation o1118 in the illustrative depiction as follows, and/or the transmitting queries health electrical circuitry arrangement e1118, when activated, performs the operation o1118 in the illustrative depiction as follows, and/or the transmitting queries health module m1118, when executed and/or activated, directs performance of and/or performs the operation o1118 in the illustrative depiction as follows, and/or the operation o1118 is otherwise carried out in the illustrative depiction as follows: electronically transmitting (e.g. satellite transmission, etc.) the one or more queries (e.g. temperature, etc.) regarding at least in part (e.g. relationship, etc.) one or more farming related production factors (e.g. livestock slaughter schedule, etc.) involved with (e.g. relationship, etc.) farming related production of (e.g. silk production, etc.) one or more ingestible materials (e.g. goat cheese, etc.) at least in part including information regarding health status of one or more biological creatures (e.g. temperature, etc.).

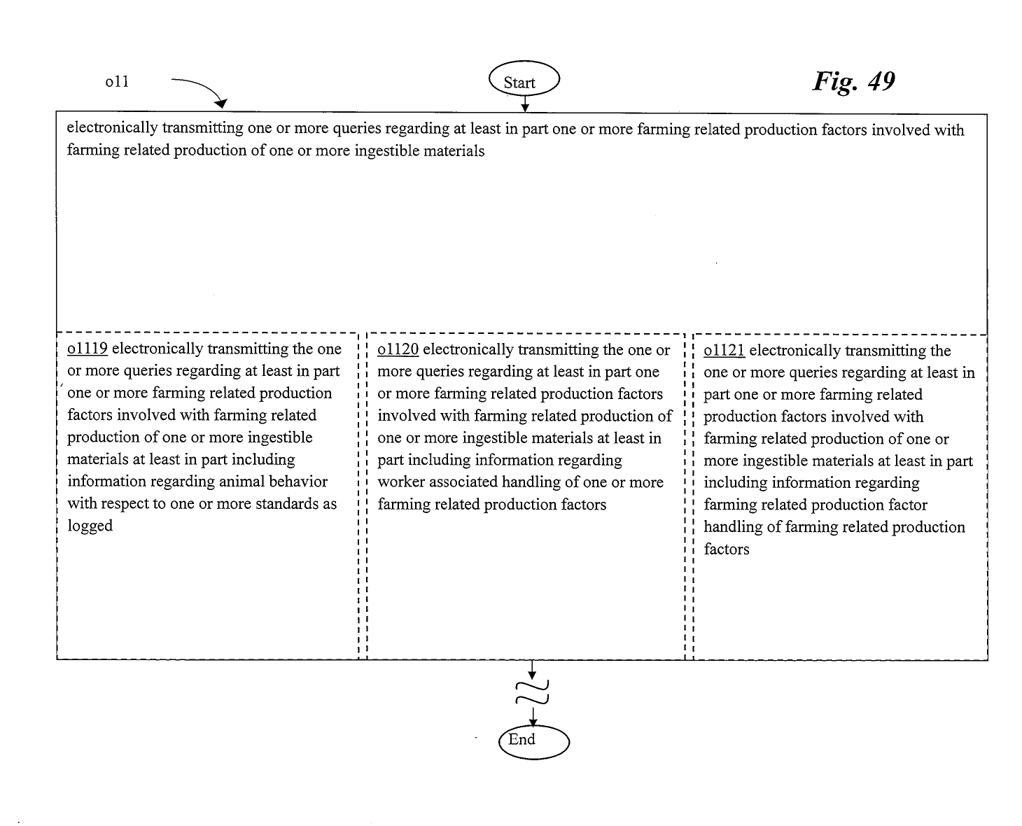

In one or more implementations, as shown in FIG. 49, operation o11 includes an operation o1119 for electronically transmitting the one or more queries regarding at least in part one or more farming related production factors involved with farming related production of one or more ingestible materials at least in part including information regarding animal behavior with respect to one or more standards as logged. Origination of an illustratively derived transmitting queries animal standards component group can be accomplished through skilled in the art design choice selection of one or more of the above depicted components from one or more of the above depicted subsystems shown in FIG. 12. Components from the transmitting queries animal standards component group can be used in implementing execution of the one or more transmitting queries animal standards instructions i1119 of FIG. 28, can be used in performance of the transmitting queries animal standards electrical circuitry arrangement e1119 of FIG. 21, and/or can be used in otherwise fulfillment of the operation o1119. An exemplary non-transitory signal bearing medium version of the information storage subsystem s200 is depicted in FIG. 28 as bearing the one or more transmitting queries animal standards instructions i1119 that when executed will direct performance of the operation o1119. Furthermore, the transmitting queries animal standards electrical circuitry arrangement (“elec circ arrange”) e1119, when activated, will perform the operation o1119. Also, the transmitting queries animal standards module m1119, when executed and/or activated, will direct performance of and/or perform the operation o1119. For instance, in one or more exemplary implementations, the one or more transmitting queries animal standards instructions i1119, when executed, direct performance of the operation o1119 in the illustrative depiction as follows, and/or the transmitting queries animal standards electrical circuitry arrangement e1119, when activated, performs the operation o1119 in the illustrative depiction as follows, and/or the transmitting queries animal standards module m1119, when executed and/or activated, directs performance of and/or performs the operation o1119 in the illustrative depiction as follows, and/or the operation o1119 is otherwise carried out in the illustrative depiction as follows: electronically transmitting (e.g. pull-based, etc.) the one or more queries (e.g. cold packing, etc.) regarding at least in part (e.g. suggest, etc.) one or more farming related production factors (e.g. egg storage temperature, etc.) involved with (e.g. suggest, etc.) farming related production of (e.g. wool production, etc.) one or more ingestible materials (e.g. oyster shell, etc.) at least in part including information regarding animal behavior with respect to one or more standards as logged (e.g. cold packing, etc.).

In one or more implementations, as shown in FIG. 49, operation o11 includes an operation o1120 for electronically transmitting the one or more queries regarding at least in part one or more farming related production factors involved with farming related production of one or more ingestible materials at least in part including information regarding worker associated handling of one or more farming related production factors. Origination of an illustratively derived transmitting queries worker handling component group can be accomplished through skilled in the art design choice selection of one or more of the above depicted components from one or more of the above depicted subsystems shown in FIG. 12. Components from the transmitting queries worker handling component group can be used in implementing execution of the one or more transmitting queries worker handling instructions i1120 of FIG. 29, can be used in performance of the transmitting queries worker handling electrical circuitry arrangement e1120 of FIG. 22, and/or can be used in otherwise fulfillment of the operation o1120. An exemplary non-transitory signal bearing medium version of the information storage subsystem s200 is depicted in FIG. 29 as bearing the one or more transmitting queries worker handling instructions i1120 that when executed will direct performance of the operation o1120. Furthermore, the transmitting queries worker handling electrical circuitry arrangement (“elec circ arrange”) e1120, when activated, will perform the operation o1120. Also, the transmitting queries worker handling module m1120, when executed and/or activated, will direct performance of and/or perform the operation o1120. For instance, in one or more exemplary implementations, the one or more transmitting queries worker handling instructions i1120, when executed, direct performance of the operation o1120 in the illustrative depiction as follows, and/or the transmitting queries worker handling electrical circuitry arrangement e1120, when activated, performs the operation o1120 in the illustrative depiction as follows, and/or the transmitting queries worker handling module m1120, when executed and/or activated, directs performance of and/or performs the operation o1120 in the illustrative depiction as follows, and/or the operation o1120 is otherwise carried out in the illustrative depiction as follows: electronically transmitting (e.g. POP3 server, etc.) the one or more queries (e.g. tractor operation, etc.) regarding at least in part (e.g. tangle, etc.) one or more farming related production factors (e.g. animal byproduct inventory, etc.) involved with (e.g. tangle, etc.) farming related production of (e.g. lentil harvesting, etc.) one or more ingestible materials (e.g. abalone shell, etc.) at least in part including information regarding worker associated handling of one or more farming related production factors (e.g. tractor operation, etc.).

In one or more implementations, as shown in FIG. 49, operation o11 includes an operation o1121 for electronically transmitting the one or more queries regarding at least in part one or more farming related production factors involved with farming related production of one or more ingestible materials at least in part including information regarding farming related production factor handling of farming related production factors. Origination of an illustratively derived transmitting queries factor handling component group can be accomplished through skilled in the art design choice selection of one or more of the above depicted components from one or more of the above depicted subsystems shown in FIG. 12. Components from the transmitting queries factor handling component group can be used in implementing execution of the one or more transmitting queries factor handling instructions i1121 of FIG. 29, can be used in performance of the transmitting queries factor handling electrical circuitry arrangement e1121 of FIG. 22, and/or can be used in otherwise fulfillment of the operation o1121. An exemplary non-transitory signal bearing medium version of the information storage subsystem s200 is depicted in FIG. 29 as bearing the one or more transmitting queries factor handling instructions i1121 that when executed will direct performance of the operation o1121. Furthermore, the transmitting queries factor handling electrical circuitry arrangement (“elec circ arrange”) e1121, when activated, will perform the operation o1121. Also, the transmitting queries factor handling module m1121, when executed and/or activated, will direct performance of and/or perform the operation o1121. For instance, in one or more exemplary implementations, the one or more transmitting queries factor handling instructions i1121, when executed, direct performance of the operation o1121 in the illustrative depiction as follows, and/or the transmitting queries factor handling electrical circuitry arrangement e1121, when activated, performs the operation o1121 in the illustrative depiction as follows, and/or the transmitting queries factor handling module m1121, when executed and/or activated, directs performance of and/or performs the operation o1121 in the illustrative depiction as follows, and/or the operation o1121 is otherwise carried out in the illustrative depiction as follows: electronically transmitting (e.g. hardware based encryption, etc.) the one or more queries (e.g. electricity usage, etc.) regarding at least in part (e.g. exclude, etc.) one or more farming related production factors (e.g. cost of tractor rental, etc.) involved with (e.g. exclude, etc.) farming related production of (e.g. flax growing, etc.) one or more ingestible materials (e.g. lamb meat, etc.) at least in part including information regarding farming related production factor handling of farming related production factors (e.g. electricity usage, etc.).

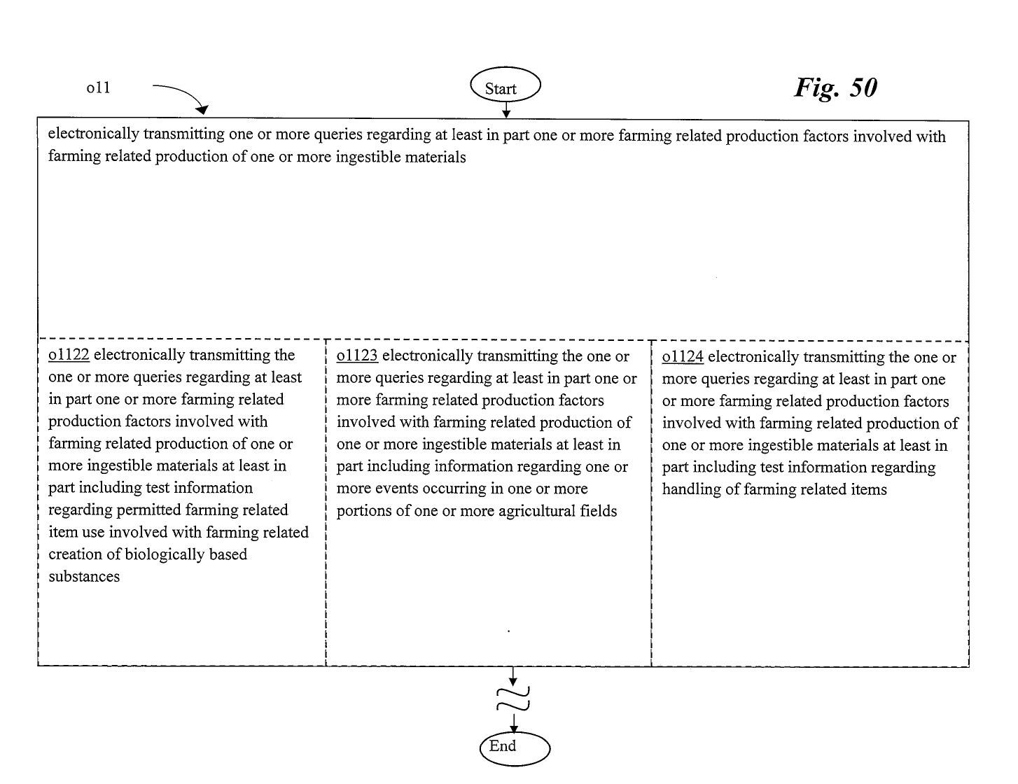

In one or more implementations, as shown in FIG. 50, operation o11 includes an operation o1122 for electronically transmitting the one or more queries regarding at least in part one or more farming related production factors involved with farming related production of one or more ingestible materials at least in part including test information regarding permitted farming related item use involved with farming related creation of biologically based substances. Origination of an illustratively derived transmitting queries permitted use component group can be accomplished through skilled in the art design choice selection of one or more of the above depicted components from one or more of the above depicted subsystems shown in FIG. 12. Components from the transmitting queries permitted use component group can be used in implementing execution of the one or more transmitting queries permitted use instructions i1122 of FIG. 29, can be used in performance of the transmitting queries permitted use electrical circuitry arrangement e1122 of FIG. 22, and/or can be used in otherwise fulfillment of the operation o1122. An exemplary non-transitory signal bearing medium version of the information storage subsystem s200 is depicted in FIG. 29 as bearing the one or more transmitting queries permitted use instructions i1122 that when executed will direct performance of the operation o1122. Furthermore, the transmitting queries permitted use electrical circuitry arrangement (“elec circ arrange”) e1122, when activated, will perform the operation o1122. Also, the transmitting queries permitted use module m1122, when executed and/or activated, will direct performance of and/or perform the operation o1122. For instance, in one or more exemplary implementations, the one or more transmitting queries permitted use instructions i1122, when executed, direct performance of the operation o1122 in the illustrative depiction as follows, and/or the transmitting queries permitted use electrical circuitry arrangement e1122, when activated, performs the operation o1122 in the illustrative depiction as follows, and/or the transmitting queries permitted use module m1122, when executed and/or activated, directs performance of and/or performs the operation o1122 in the illustrative depiction as follows, and/or the operation o1122 is otherwise carried out in the illustrative depiction as follows: electronically transmitting (e.g. software based encryption, etc.) the one or more queries (e.g. irrigation, etc.) regarding at least in part (e.g. bound, etc.) one or more farming related production factors (e.g. equipment maintenance schedule, etc.) involved with (e.g. bound, etc.) farming related production of (e.g. squash cultivation, etc.) one or more ingestible materials (e.g. cow liver, etc.) at least in part including test information regarding permitted farming related item use involved with farming related creation of biologically based substances (e.g. fertilizers authorized for use by a horticulture expert to grow bio-dynamic vegetables, etc.).

In one or more implementations, as shown in FIG. 50, operation o11 includes an operation o1123 for electronically transmitting the one or more queries regarding at least in part one or more farming related production factors involved with farming related production of one or more ingestible materials at least in part including information regarding one or more events occurring in one or more portions of one or more agricultural fields. Origination of an illustratively derived transmitting queries events fields component group can be accomplished through skilled in the art design choice selection of one or more of the above depicted components from one or more of the above depicted subsystems shown in FIG. 12. Components from the transmitting queries events fields component group can be used in implementing execution of the one or more transmitting queries events fields instructions i1123 of FIG. 29, can be used in performance of the transmitting queries events fields electrical circuitry arrangement e1123 of FIG. 22, and/or can be used in otherwise fulfillment of the operation o1123. An exemplary non-transitory signal bearing medium version of the information storage subsystem s200 is depicted in FIG. 29 as bearing the one or more transmitting queries events fields instructions i1123 that when executed will direct performance of the operation o1123. Furthermore, the transmitting queries events fields electrical circuitry arrangement (“elec circ arrange”) e1123, when activated, will perform the operation o1123. Also, the transmitting queries events fields module m1123, when executed and/or activated, will direct performance of and/or perform the operation o1123. For instance, in one or more exemplary implementations, the one or more transmitting queries events fields instructions i1123, when executed, direct performance of the operation o1123 in the illustrative depiction as follows, and/or the transmitting queries events fields electrical circuitry arrangement e1123, when activated, performs the operation o1123 in the illustrative depiction as follows, and/or the transmitting queries events fields module m1123, when executed and/or activated, directs performance of and/or performs the operation o1123 in the illustrative depiction as follows, and/or the operation o1123 is otherwise carried out in the illustrative depiction as follows: electronically transmitting (e.g. SD card, etc.) the one or more queries (e.g. sanitized tongs, etc.) regarding at least in part (e.g. requiring, etc.) one or more farming related production factors (e.g. tool requirement for repairs, etc.) involved with (e.g. requiring, etc.) farming related production of (e.g. strawberry picking, etc.) one or more ingestible materials (e.g. cow heart, etc.) at least in part including information regarding one or more events occurring in one or more portions of one or more agricultural fields (e.g. insecticide spraying schedules for designated fields, etc.).

In one or more implementations, as shown in FIG. 50, operation o11 includes an operation o1124 for electronically transmitting the one or more queries regarding at least in part one or more farming related production factors involved with farming related production of one or more ingestible materials at least in part including test information regarding handling of farming related items. Origination of an illustratively derived transmitting queries handling items component group can be accomplished through skilled in the art design choice selection of one or more of the above depicted components from one or more of the above depicted subsystems shown in FIG. 12. Components from the transmitting queries handling items component group can be used in implementing execution of the one or more transmitting queries handling items instructions i1124 of FIG. 29, can be used in performance of the transmitting queries handling items electrical circuitry arrangement e1124 of FIG. 22, and/or can be used in otherwise fulfillment of the operation o1124. An exemplary non-transitory signal bearing medium version of the information storage subsystem s200 is depicted in FIG. 29 as bearing the one or more transmitting queries handling items instructions i1124 that when executed will direct performance of the operation o1124. Furthermore, the transmitting queries handling items electrical circuitry arrangement (“elec circ arrange”) e1124, when activated, will perform the operation o1124. Also, the transmitting queries handling items module m1124, when executed and/or activated, will direct performance of and/or perform the operation o1124. For instance, in one or more exemplary implementations, the one or more transmitting queries handling items instructions i1124, when executed, direct performance of the operation o1124 in the illustrative depiction as follows, and/or the transmitting queries handling items electrical circuitry arrangement e1124, when activated, performs the operation o1124 in the illustrative depiction as follows, and/or the transmitting queries handling items module m1124, when executed and/or activated, directs performance of and/or performs the operation o1124 in the illustrative depiction as follows, and/or the operation o1124 is otherwise carried out in the illustrative depiction as follows: electronically transmitting (e.g. SIM card, etc.) the one or more queries (e.g. DDT insecticide, etc.) regarding at least in part (e.g. enveloped, etc.) one or more farming related production factors (e.g. local regulations, etc.) involved with (e.g. enveloped, etc.) farming related production of (e.g. rice planting, etc.) one or more ingestible materials (e.g. intestine casing, etc.) at least in part including test information regarding handling of farming related items (e.g. storage times for picked fruit, etc.).

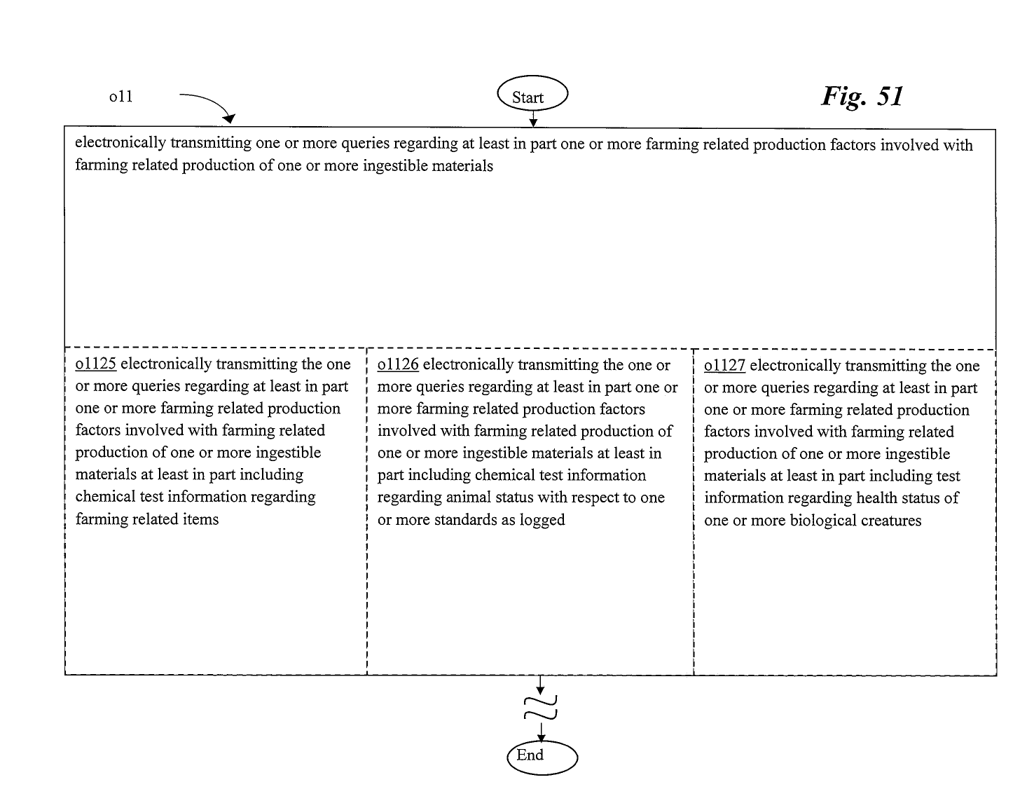

In one or more implementations, as shown in FIG. 51, operation o11 includes an operation o1125 for electronically transmitting the one or more queries regarding at least in part one or more farming related production factors involved with farming related production of one or more ingestible materials at least in part including chemical test information regarding farming related items. Origination of an illustratively derived transmitting queries chemical items component group can be accomplished through skilled in the art design choice selection of one or more of the above depicted components from one or more of the above depicted subsystems shown in FIG. 12. Components from the transmitting queries chemical items component group can be used in implementing execution of the one or more transmitting queries chemical items instructions i1125 of FIG. 29, can be used in performance of the transmitting queries chemical items electrical circuitry arrangement e1125 of FIG. 22, and/or can be used in otherwise fulfillment of the operation o1125. An exemplary non-transitory signal bearing medium version of the information storage subsystem s200 is depicted in FIG. 29 as bearing the one or more transmitting queries chemical items instructions i1125 that when executed will direct performance of the operation o1125. Furthermore, the transmitting queries chemical items electrical circuitry arrangement (“elec circ arrange”) e1125, when activated, will perform the operation o1125. Also, the transmitting queries chemical items module m1125, when executed and/or activated, will direct performance of and/or perform the operation o1125. For instance, in one or more exemplary implementations, the one or more transmitting queries chemical items instructions i1125, when executed, direct performance of the operation o1125 in the illustrative depiction as follows, and/or the transmitting queries chemical items electrical circuitry arrangement e1125, when activated, performs the operation o1125 in the illustrative depiction as follows, and/or the transmitting queries chemical items module m1125, when executed and/or activated, directs performance of and/or performs the operation o1125 in the illustrative depiction as follows, and/or the operation o1125 is otherwise carried out in the illustrative depiction as follows: electronically transmitting (e.g. email, etc.) the one or more queries (e.g. production speed, etc.) regarding at least in part (e.g. envelope, etc.) one or more farming related production factors (e.g. land terrain, etc.) involved with (e.g. envelope, etc.) farming related production of (e.g. rice harvesting, etc.) one or more ingestible materials (e.g. chicken feet, etc.) at least in part including chemical test information regarding farming related items (e.g. heavy metal levels in fish oils, etc.).

In one or more implementations, as shown in FIG. 51, operation o11 includes an operation o1126 for electronically transmitting the one or more queries regarding at least in part one or more farming related production factors involved with farming related production of one or more ingestible materials at least in part including chemical test information regarding animal status with respect to one or more standards as logged. Origination of an illustratively derived transmitting queries animal status component group can be accomplished through skilled in the art design choice selection of one or more of the above depicted components from one or more of the above depicted subsystems shown in FIG. 12. Components from the transmitting queries animal status component group can be used in implementing execution of the one or more transmitting queries animal status instructions i1126 of FIG. 29, can be used in performance of the transmitting queries animal status electrical circuitry arrangement e1126 of FIG. 22, and/or can be used in otherwise fulfillment of the operation o1126. An exemplary non-transitory signal bearing medium version of the information storage subsystem s200 is depicted in FIG. 29 as bearing the one or more transmitting queries animal status instructions i1126 that when executed will direct performance of the operation o1126. Furthermore, the transmitting queries animal status electrical circuitry arrangement (“elec circ arrange”) e1126, when activated, will perform the operation o1126. Also, the transmitting queries animal status module m1126, when executed and/or activated, will direct performance of and/or perform the operation o1126. For instance, in one or more exemplary implementations, the one or more transmitting queries animal status instructions i1126, when executed, direct performance of the operation o1126 in the illustrative depiction as follows, and/or the transmitting queries animal status electrical circuitry arrangement e1126, when activated, performs the operation o1126 in the illustrative depiction as follows, and/or the transmitting queries animal status module m1126, when executed and/or activated, directs performance of and/or performs the operation o1126 in the illustrative depiction as follows, and/or the operation o1126 is otherwise carried out in the illustrative depiction as follows: electronically transmitting (e.g. peer to peer, etc.) the one or more queries (e.g. labor force scheduling, etc.) regarding at least in part (e.g. associate with, etc.) one or more farming related production factors (e.g. range area, etc.) involved with (e.g. associate with, etc.) farming related production of (e.g. pear picking, etc.) one or more ingestible materials (e.g. octopus, etc.) at least in part including chemical test information regarding animal status with respect to one or more standards as logged (e.g. growth hormone levels in cattle, etc.).

In one or more implementations, as shown in FIG. 51, operation o11 includes an operation o1127 for electronically transmitting the one or more queries regarding at least in part one or more farming related production factors involved with farming related production of one or more ingestible materials at least in part including test information regarding health status of one or more biological creatures. Origination of an illustratively derived transmitting queries health creatures component group can be accomplished through skilled in the art design choice selection of one or more of the above depicted components from one or more of the above depicted subsystems shown in FIG. 12. Components from the transmitting queries health creatures component group can be used in implementing execution of the one or more transmitting queries health creatures instructions i1127 of FIG. 29, can be used in performance of the transmitting queries health creatures electrical circuitry arrangement e1127 of FIG. 22, and/or can be used in otherwise fulfillment of the operation o1127. An exemplary non-transitory signal bearing medium version of the information storage subsystem s200 is depicted in FIG. 29 as bearing the one or more transmitting queries health creatures instructions i1127 that when executed will direct performance of the operation o1127. Furthermore, the transmitting queries health creatures electrical circuitry arrangement (“elec circ arrange”) e1127, when activated, will perform the operation o1127. Also, the transmitting queries health creatures module m1127, when executed and/or activated, will direct performance of and/or perform the operation o1127. For instance, in one or more exemplary implementations, the one or more transmitting queries health creatures instructions i1127, when executed, direct performance of the operation o1127 in the illustrative depiction as follows, and/or the transmitting queries health creatures electrical circuitry arrangement e1127, when activated, performs the operation o1127 in the illustrative depiction as follows, and/or the transmitting queries health creatures module m1127, when executed and/or activated, directs performance of and/or performs the operation o1127 in the illustrative depiction as follows, and/or the operation o1127 is otherwise carried out in the illustrative depiction as follows: electronically transmitting (e.g. 10-key, etc.) the one or more queries (e.g. future market demands, etc.) regarding at least in part (e.g. embroil, etc.) one or more farming related production factors (e.g. range schedule, etc.) involved with (e.g. embroil, etc.) farming related production of (e.g. peanut harvesting, etc.) one or more ingestible materials (e.g. squid, etc.) at least in part including test information regarding health status of one or more biological creatures (e.g. basic metabolic profiles of cows, etc.).

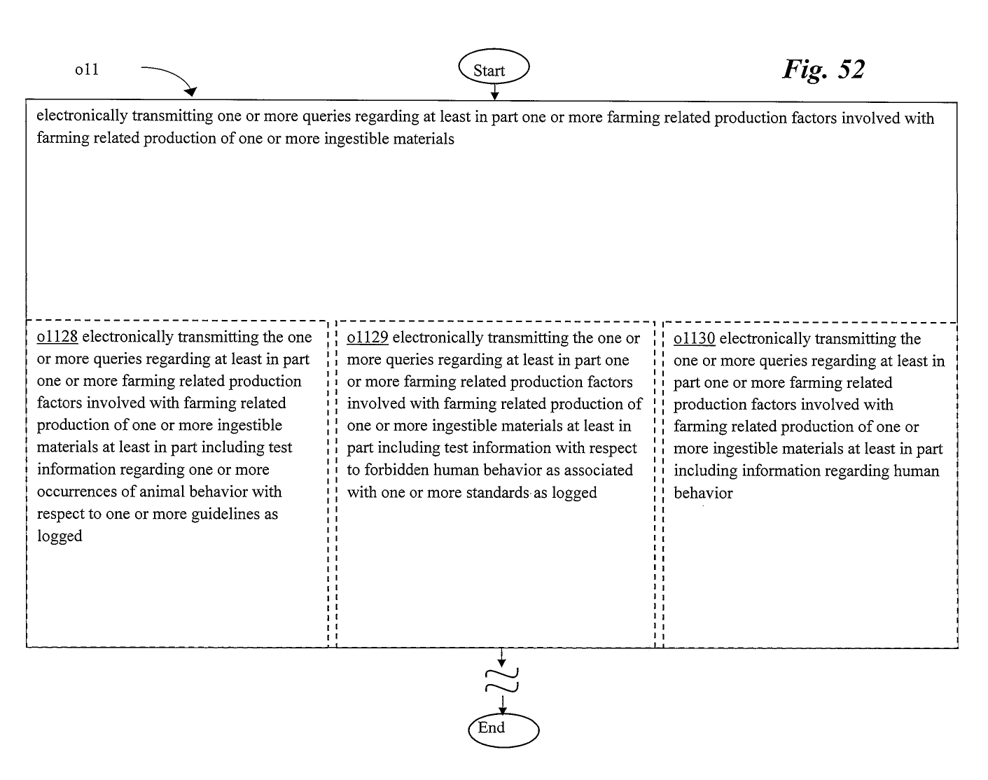

In one or more implementations, as shown in FIG. 52, operation o11 includes an operation o1128 for electronically transmitting the one or more queries regarding at least in part one or more farming related production factors involved with farming related production of one or more ingestible materials at least in part including test information regarding one or more occurrences of animal behavior with respect to one or more guidelines as logged. Origination of an illustratively derived transmitting queries test animal component group can be accomplished through skilled in the art design choice selection of one or more of the above depicted components from one or more of the above depicted subsystems shown in FIG. 12. Components from the transmitting queries test animal component group can be used in implementing execution of the one or more transmitting queries test animal instructions i1128 of FIG. 29, can be used in performance of the transmitting queries test animal electrical circuitry arrangement e1128 of FIG. 22, and/or can be used in otherwise fulfillment of the operation o1128. An exemplary non-transitory signal bearing medium version of the information storage subsystem s200 is depicted in FIG. 29 as bearing the one or more transmitting queries test animal instructions i1128 that when executed will direct performance of the operation o1128. Furthermore, the transmitting queries test animal electrical circuitry arrangement (“elec circ arrange”) e1128, when activated, will perform the operation o1128. Also, the transmitting queries test animal module m1128, when executed and/or activated, will direct performance of and/or perform the operation o1128. For instance, in one or more exemplary implementations, the one or more transmitting queries test animal instructions i1128, when executed, direct performance of the operation o1128 in the illustrative depiction as follows, and/or the transmitting queries test animal electrical circuitry arrangement e1128, when activated, performs the operation o1128 in the illustrative depiction as follows, and/or the transmitting queries test animal module m1128, when executed and/or activated, directs performance of and/or performs the operation o1128 in the illustrative depiction as follows, and/or the operation o1128 is otherwise carried out in the illustrative depiction as follows: electronically transmitting (e.g. USB port, etc.) the one or more queries (e.g. improper data calculation, etc.) regarding at least in part (e.g. take in, etc.) one or more farming related production factors (e.g. livestock inventory, etc.) involved with take in, etc.) farming related production of (e.g. parsnip growing, etc.) one or more ingestible materials (e.g. green algae, etc.) at least in part including test information regarding one or more occurrences of animal behavior with respect to one or more guidelines as logged (e.g. amount of free-range time for poultry according to free-range designation, etc.).

In one or more implementations, as shown in FIG. 52, operation o11 includes an operation o1129 for electronically transmitting the one or more queries regarding at least in part one or more farming related production factors involved with farming related production of one or more ingestible materials at least in part including test information with respect to forbidden human behavior as associated with one or more standards as logged. Origination of an illustratively derived transmitting queries forbidden human component group can be accomplished through skilled in the art design choice selection of one or more of the above depicted components from one or more of the above depicted subsystems shown in FIG. 12. Components from the transmitting queries forbidden human component group can be used in implementing execution of the one or more transmitting queries forbidden human instructions i1129 of FIG. 29, can be used in performance of the transmitting queries forbidden human electrical circuitry arrangement e1129 of FIG. 22, and/or can be used in otherwise fulfillment of the operation o1129. An exemplary non-transitory signal bearing medium version of the information storage subsystem s200 is depicted in FIG. 29 as bearing the one or more transmitting queries forbidden human instructions i1129 that when executed will direct performance of the operation o1129. Furthermore, the transmitting queries forbidden human electrical circuitry arrangement (“elec circ arrange”) e1129, when activated, will perform the operation o1129. Also, the transmitting queries forbidden human module m1129, when executed and/or activated, will direct performance of and/or perform the operation o1129. For instance, in one or more exemplary implementations, the one or more transmitting queries forbidden human instructions i1129, when executed, direct performance of the operation o1129 in the illustrative depiction as follows, and/or the transmitting queries forbidden human electrical circuitry arrangement e1129, when activated, performs the operation o1129 in the illustrative depiction as follows, and/or the transmitting queries forbidden human module m1129, when executed and/or activated, directs performance of and/or performs the operation o1129 in the illustrative depiction as follows, and/or the operation o1129 is otherwise carried out in the illustrative depiction as follows: electronically transmitting (e.g. FTP, etc.) the one or more queries (e.g. infestation, etc.) regarding at least in part (e.g. comprised of, etc.) one or more farming related production factors (e.g. labor laws, etc.) involved with comprised of, etc.) farming related production of (e.g. cow milking, etc.) one or more ingestible materials (e.g. corn on cob, etc.) at least in part including test information with respect to forbidden human behavior as associated with one or more standards as logged (e.g. lack of human supervision required for animal feeding procedures, etc.).

In one or more implementations, as shown in FIG. 52, operation o11 includes an operation o1130 for electronically transmitting the one or more queries regarding at least in part one or more farming related production factors involved with farming related production of one or more ingestible materials at least in part including information regarding human behavior. Origination of an illustratively derived transmitting queries human behavior component group can be accomplished through skilled in the art design choice selection of one or more of the above depicted components from one or more of the above depicted subsystems shown in FIG. 12. Components from the transmitting queries human behavior component group can be used in implementing execution of the one or more transmitting queries human behavior instructions i1130 of FIG. 29, can be used in performance of the transmitting queries human behavior electrical circuitry arrangement e1130 of FIG. 22, and/or can be used in otherwise fulfillment of the operation o1130. An exemplary non-transitory signal bearing medium version of the information storage subsystem s200 is depicted in FIG. 29 as bearing the one or more transmitting queries human behavior instructions i1130 that when executed will direct performance of the operation o1130. Furthermore, the transmitting queries human behavior electrical circuitry arrangement (“elec circ arrange”) e1130, when activated, will perform the operation o1130. Also, the transmitting queries human behavior module m1130, when executed and/or activated, will direct performance of and/or perform the operation o1130. For instance, in one or more exemplary implementations, the one or more transmitting queries human behavior instructions i1130, when executed, direct performance of the operation o1130 in the illustrative depiction as follows, and/or the transmitting queries human behavior electrical circuitry arrangement e1130, when activated, performs the operation o1130 in the illustrative depiction as follows, and/or the transmitting queries human behavior module m1130, when executed and/or activated, directs performance of and/or performs the operation o1130 in the illustrative depiction as follows, and/or the operation o1130 is otherwise carried out in the illustrative depiction as follows: electronically transmitting (e.g. HTTP, etc.) the one or more queries (e.g. sanitizer usage, etc.) regarding at least in part (e.g. comprehend, etc.) one or more farming related production factors (e.g. safety regulations, etc.) involved with (e.g. comprehend, etc.) farming related production of (e.g. cow birthing, etc.) one or more ingestible materials (e.g. bison meat, etc.) at least in part including information regarding human behavior (e.g. presence of human supervisors during testing procedures, etc.).

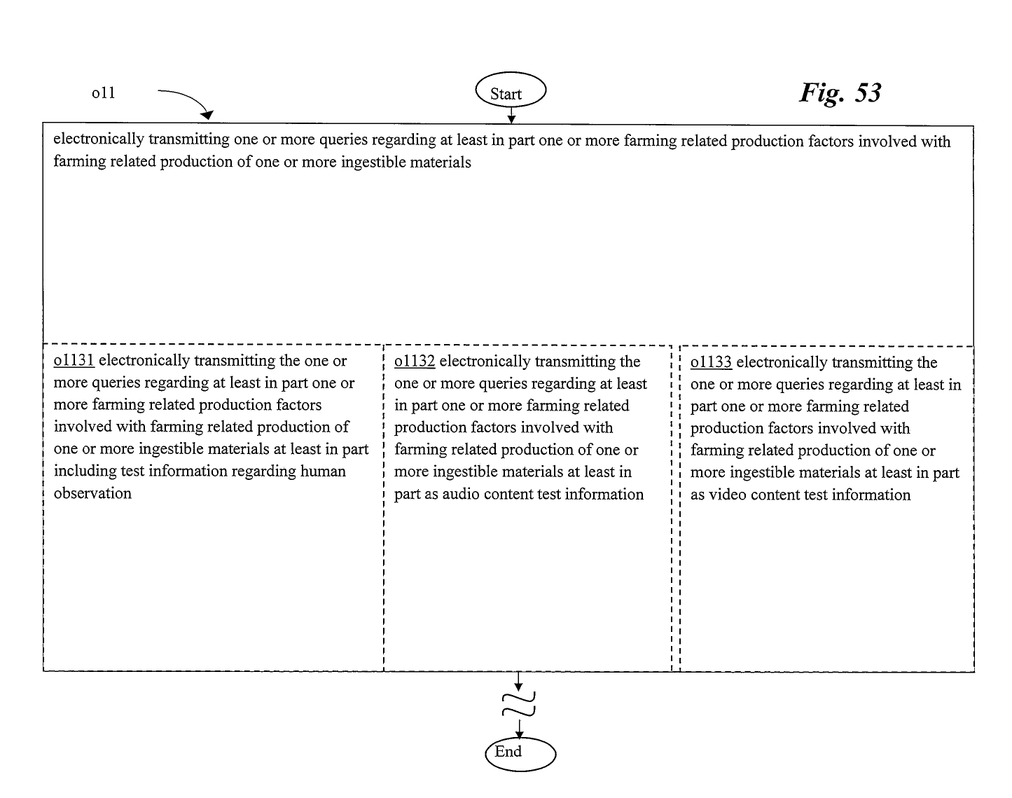

In one or more implementations, as shown in FIG. 53, operation o11 includes an operation o1131 for electronically transmitting the one or more queries regarding at least in part one or more farming related production factors involved with farming related production of one or more ingestible materials at least in part including test information regarding human observation. Origination of an illustratively derived transmitting queries test observation component group can be accomplished through skilled in the art design choice selection of one or more of the above depicted components from one or more of the above depicted subsystems shown in FIG. 12. Components from the transmitting queries test observation component group can be used in implementing execution of the one or more transmitting queries test observation instructions i1131 of FIG. 29, can be used in performance of the transmitting queries test observation electrical circuitry arrangement e1131 of FIG. 22, and/or can be used in otherwise fulfillment of the operation o1131. An exemplary non-transitory signal bearing medium version of the information storage subsystem s200 is depicted in FIG. 29 as bearing the one or more transmitting queries test observation instructions i1131 that when executed will direct performance of the operation o1131. Furthermore, the transmitting queries test observation electrical circuitry arrangement (“elec circ arrange”) e1131, when activated, will perform the operation o1131. Also, the transmitting queries test observation module m1131, when executed and/or activated, will direct performance of and/or perform the operation o1131. For instance, in one or more exemplary implementations, the one or more transmitting queries test observation instructions i1131, when executed, direct performance of the operation o1131 in the illustrative depiction as follows, and/or the transmitting queries test observation electrical circuitry arrangement e1131, when activated, performs the operation o1131 in the illustrative depiction as follows, and/or the transmitting queries test observation module m1131, when executed and/or activated, directs performance of and/or performs the operation o1131 in the illustrative depiction as follows, and/or the operation o1131 is otherwise carried out in the illustrative depiction as follows: electronically transmitting (e.g. bittorent, etc.) the one or more queries (e.g. mbar, etc.) regarding at least in part (e.g. associated, etc.) one or more farming related production factors (e.g. neighbor's crop harvest, etc.) involved with (e.g. associated, etc.) farming related production of (e.g. blueberry cultivation, etc.) one or more ingestible materials (e.g. domestic goose, etc.) at least in part including test information regarding human observation (e.g. percentage of trees that appear healthy, etc.).

In one or more implementations, as shown in FIG. 53, operation o11 includes an operation o1132 for electronically transmitting the one or more queries regarding at least in part one or more farming related production factors involved with farming related production of one or more ingestible materials at least in part as audio content test information. Origination of an illustratively derived transmitting queries audio test component group can be accomplished through skilled in the art design choice selection of one or more of the above depicted components from one or more of the above depicted subsystems shown in FIG. 12. Components from the transmitting queries audio test component group can be used in implementing execution of the one or more transmitting queries audio test instructions i1132 of FIG. 29, can be used in performance of the transmitting queries audio test electrical circuitry arrangement e1132 of FIG. 22, and/or can be used in otherwise fulfillment of the operation o1132. An exemplary non-transitory signal bearing medium version of the information storage subsystem s200 is depicted in FIG. 29 as bearing the one or more transmitting queries audio test instructions i1132 that when executed will direct performance of the operation o1132. Furthermore, the transmitting queries audio test electrical circuitry arrangement (“elec circ arrange”) e1132, when activated, will perform the operation o1132. Also, the transmitting queries audio test module m1132, when executed and/or activated, will direct performance of and/or perform the operation o1132. For instance, in one or more exemplary implementations, the one or more transmitting queries audio test instructions i1132, when executed, direct performance of the operation o1132 in the illustrative depiction as follows, and/or the transmitting queries audio test electrical circuitry arrangement e1132, when activated, performs the operation o1132 in the illustrative depiction as follows, and/or the transmitting queries audio test module m1132, when executed and/or activated, directs performance of and/or performs the operation o1132 in the illustrative depiction as follows, and/or the operation o1132 is otherwise carried out in the illustrative depiction as follows: electronically transmitting (e.g. gnutella, etc.) the one or more queries (e.g. humidity, etc.) regarding at least in part (e.g. affected, etc.) one or more farming related production factors (e.g. crop rotation demands, etc.) involved with (e.g. affected, etc.) farming related production of (e.g. raspberry harvesting, etc.) one or more ingestible materials (e.g. edible frog, etc.) at least in part as audio content test information (e.g. presence of predator animal sounds, etc.).

In one or more implementations, as shown in FIG. 53, operation o11 includes an operation o1133 for electronically transmitting the one or more queries regarding at least in part one or more farming related production factors involved with farming related production of one or more ingestible materials at least in part as video content test information. Origination of an illustratively derived transmitting queries video test component group can be accomplished through skilled in the art design choice selection of one or more of the above depicted components from one or more of the above depicted subsystems shown in FIG. 12. Components from the transmitting queries video test component group can be used in implementing execution of the one or more transmitting queries video test instructions i1133 of FIG. 29, can be used in performance of the transmitting queries video test electrical circuitry arrangement e1133 of FIG. 22, and/or can be used in otherwise fulfillment of the operation o1133. An exemplary non-transitory signal bearing medium version of the information storage subsystem s200 is depicted in FIG. 29 as bearing the one or more transmitting queries video test instructions i1133 that when executed will direct performance of the operation o1133. Furthermore, the transmitting queries video test electrical circuitry arrangement (“elec circ arrange”) e1133, when activated, will perform the operation o1133. Also, the transmitting queries video test module m1133, when executed and/or activated, will direct performance of and/or perform the operation o1133. For instance, in one or more exemplary implementations, the one or more transmitting queries video test instructions i1133, when executed, direct performance of the operation o1133 in the illustrative depiction as follows, and/or the transmitting queries video test electrical circuitry arrangement e1133, when activated, performs the operation o1133 in the illustrative depiction as follows, and/or the transmitting queries video test module m1133, when executed and/or activated, directs performance of and/or performs the operation o1133 in the illustrative depiction as follows, and/or the operation o1133 is otherwise carried out in the illustrative depiction as follows: electronically transmitting (e.g. TCP/IP, etc.) the one or more queries (e.g. oxygen sensor, etc.) regarding at least in part (e.g. affecting, etc.) one or more farming related production factors (e.g. government subsidy status, etc.) involved with affecting, etc.) farming related production of (e.g. corn growing, etc.) one or more ingestible materials (e.g. catfish, etc.) at least in part as video content test information (e.g. presence of forbidden crop damaging human activity in video, etc.).

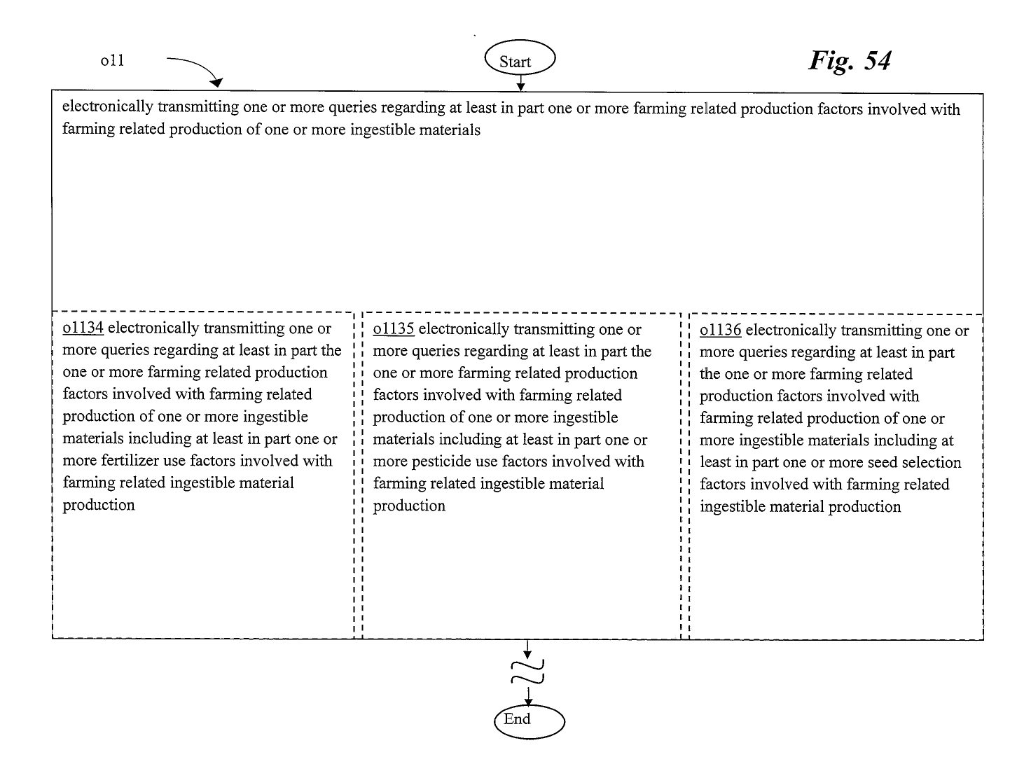

In one or more implementations, as shown in FIG. 54, operation o11 includes an operation o1134 for electronically transmitting one or more queries regarding at least in part the one or more farming related production factors involved with farming related production of one or more ingestible materials including at least in part one or more fertilizer use factors involved with farming related ingestible material production. Origination of an illustratively derived transmitting queries fertilizer use component group can be accomplished through skilled in the art design choice selection of one or more of the above depicted components from one or more of the above depicted subsystems shown in FIG. 12. Components from the transmitting queries fertilizer use component group can be used in implementing execution of the one or more transmitting queries fertilizer use instructions i1134 of FIG. 29, can be used in performance of the transmitting queries fertilizer use electrical circuitry arrangement e1134 of FIG. 22, and/or can be used in otherwise fulfillment of the operation o1134. An exemplary non-transitory signal bearing medium version of the information storage subsystem s200 is depicted in FIG. 29 as bearing the one or more transmitting queries fertilizer use instructions i1134 that when executed will direct performance of the operation o1134. Furthermore, the transmitting queries fertilizer use electrical circuitry arrangement (“elec circ arrange”) e1134, when activated, will perform the operation o1134. Also, the transmitting queries fertilizer use module m1134, when executed and/or activated, will direct performance of and/or perform the operation o1134. For instance, in one or more exemplary implementations, the one or more transmitting queries fertilizer use instructions i1134, when executed, direct performance of the operation o1134 in the illustrative depiction as follows, and/or the transmitting queries fertilizer use electrical circuitry arrangement e1134, when activated, performs the operation o1134 in the illustrative depiction as follows, and/or the transmitting queries fertilizer use module m1134, when executed and/or activated, directs performance of and/or performs the operation o1134 in the illustrative depiction as follows, and/or the operation o1134 is otherwise carried out in the illustrative depiction as follows: electronically transmitting (e.g. RS-232, etc.) one or more queries (e.g. psi, etc.) regarding at least in part (e.g. argue, etc.) the one or more farming related production factors (e.g. type of fertilizer used, etc.) involved with (e.g. argue, etc.) farming related production of (e.g. soy bean harvesting, etc.) one or more ingestible materials (e.g. silkworm, etc.) including at least in part one or more fertilizer use factors involved with farming related ingestible material production (e.g. type of fertilizer used, etc.).

In one or more implementations, as shown in FIG. 54, operation o11 includes an operation o1135 for electronically transmitting one or more queries regarding at least in part the one or more farming related production factors involved with farming related production of one or more ingestible materials including at least in part one or more pesticide use factors involved with farming related ingestible material production. Origination of an illustratively derived transmitting queries pesticide use component group can be accomplished through skilled in the art design choice selection of one or more of the above depicted components from one or more of the above depicted subsystems shown in FIG. 12. Components from the transmitting queries pesticide use component group can be used in implementing execution of the one or more transmitting queries pesticide use instructions i1135 of FIG. 29, can be used in performance of the transmitting queries pesticide use electrical circuitry arrangement e1135 of FIG. 22, and/or can be used in otherwise fulfillment of the operation o1135. An exemplary non-transitory signal bearing medium version of the information storage subsystem s200 is depicted in FIG. 29 as bearing the one or more transmitting queries pesticide use instructions i1135 that when executed will direct performance of the operation o1135. Furthermore, the transmitting queries pesticide use electrical circuitry arrangement (“elec circ arrange”) e1135, when activated, will perform the operation o1135. Also, the transmitting queries pesticide use module m1135, when executed and/or activated, will direct performance of and/or perform the operation o1135. For instance, in one or more exemplary implementations, the one or more transmitting queries pesticide use instructions i1135, when executed, direct performance of the operation o1135 in the illustrative depiction as follows, and/or the transmitting queries pesticide use electrical circuitry arrangement e1135, when activated, performs the operation o1135 in the illustrative depiction as follows, and/or the transmitting queries pesticide use module m1135, when executed and/or activated, directs performance of and/or performs the operation o1135 in the illustrative depiction as follows, and/or the operation o1135 is otherwise carried out in the illustrative depiction as follows: electronically transmitting (e.g. tablet entry, etc.) one or more queries (e.g. in Hg, etc.) regarding at least in part (e.g. connected, etc.) the one or more farming related production factors (e.g. schedule of pesticide application, etc.) involved with (e.g. connected, etc.) farming related production of (e.g. canola harvesting, etc.) one or more ingestible materials (e.g. silk, etc.) including at least in part one or more pesticide use factors involved with farming related ingestible material production (e.g. schedule of pesticide application, etc.).

In one or more implementations, as shown in FIG. 54, operation o11 includes an operation o1136 for electronically transmitting one or more queries regarding at least in part the one or more farming related production factors involved with farming related production of one or more ingestible materials including at least in part one or more seed selection factors involved with farming related ingestible material production. Origination of an illustratively derived transmitting queries seed selection component group can be accomplished through skilled in the art design choice selection of one or more of the above depicted components from one or more of the above depicted subsystems shown in FIG. 12. Components from the transmitting queries seed selection component group can be used in implementing execution of the one or more transmitting queries seed selection instructions i1136 of FIG. 29, can be used in performance of the transmitting queries seed selection electrical circuitry arrangement e1136 of FIG. 22, and/or can be used in otherwise fulfillment of the operation o1136. An exemplary non-transitory signal bearing medium version of the information storage subsystem s200 is depicted in FIG. 29 as bearing the one or more transmitting queries seed selection instructions i1136 that when executed will direct performance of the operation o1136. Furthermore, the transmitting queries seed selection electrical circuitry arrangement (“elec circ arrange”) e1136, when activated, will perform the operation o1136. Also, the transmitting queries seed selection module m1136, when executed and/or activated, will direct performance of and/or perform the operation o1136. For instance, in one or more exemplary implementations, the one or more transmitting queries seed selection instructions i1136, when executed, direct performance of the operation o1136 in the illustrative depiction as follows, and/or the transmitting queries seed selection electrical circuitry arrangement e1136, when activated, performs the operation o1136 in the illustrative depiction as follows, and/or the transmitting queries seed selection module m1136, when executed and/or activated, directs performance of and/or performs the operation o1136 in the illustrative depiction as follows, and/or the operation o1136 is otherwise carried out in the illustrative depiction as follows: electronically transmitting (e.g. PDA entry, etc.) one or more queries (e.g. equipment maintenance, etc.) regarding at least in part (e.g. commit to, etc.) the one or more farming related production factors (e.g. genetic signature of heirloom tomato seeds used, etc.) involved with (e.g. commit to, etc.) farming related production of (e.g. cherry picking, etc.) one or more ingestible materials (e.g. shrimp, etc.) including at least in part one or more seed selection factors involved with farming related ingestible material production (e.g. genetic signature of heirloom tomato seeds used, etc.).

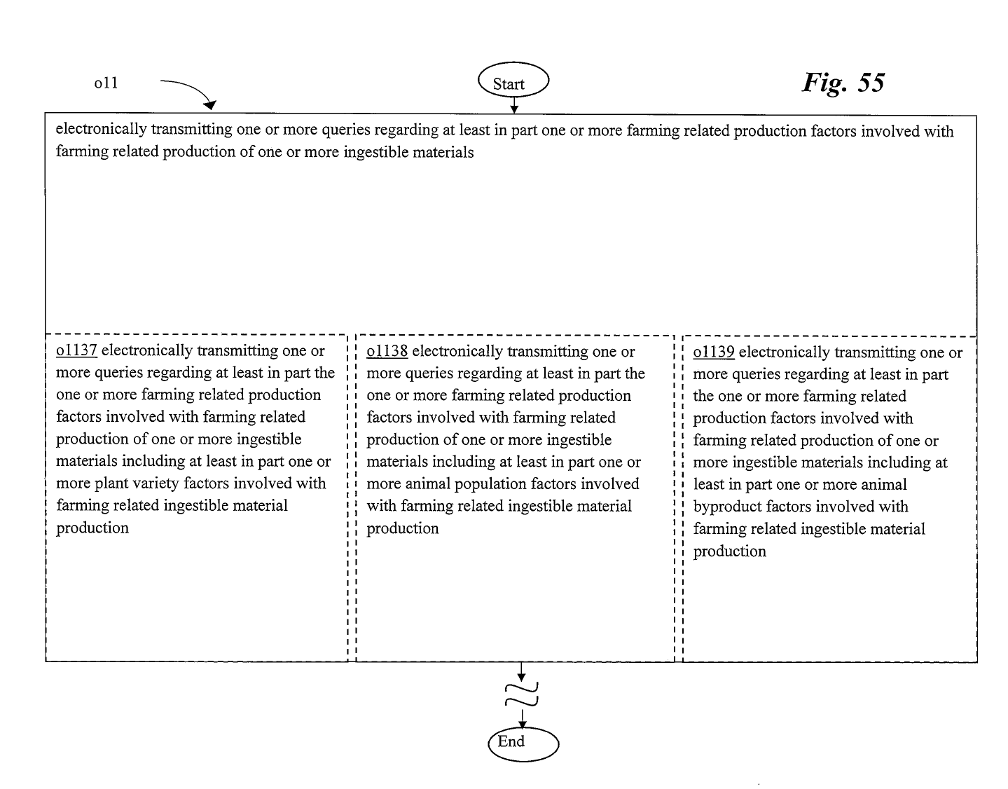

In one or more implementations, as shown in FIG. 55, operation o11 includes an operation o1137 for electronically transmitting one or more queries regarding at least in part the one or more farming related production factors involved with farming related production of one or more ingestible materials including at least in part one or more plant variety factors involved with farming related ingestible material production. Origination of an illustratively derived transmitting queries plant variety component group can be accomplished through skilled in the art design choice selection of one or more of the above depicted components from one or more of the above depicted subsystems shown in FIG. 12. Components from the transmitting queries plant variety component group can be used in implementing execution of the one or more transmitting queries plant variety instructions i1137 of FIG. 29, can be used in performance of the transmitting queries plant variety electrical circuitry arrangement e1137 of FIG. 22, and/or can be used in otherwise fulfillment of the operation o1137. An exemplary non-transitory signal bearing medium version of the information storage subsystem s200 is depicted in FIG. 29 as bearing the one or more transmitting queries plant variety instructions i1137 that when executed will direct performance of the operation o1137. Furthermore, the transmitting queries plant variety electrical circuitry arrangement (“elec circ arrange”) e1137, when activated, will perform the operation o1137. Also, the transmitting queries plant variety module m1137, when executed and/or activated, will direct performance of and/or perform the operation o1137. For instance, in one or more exemplary implementations, the one or more transmitting queries plant variety instructions i1137, when executed, direct performance of the operation o1137 in the illustrative depiction as follows, and/or the transmitting queries plant variety electrical circuitry arrangement e1137, when activated, performs the operation o1137 in the illustrative depiction as follows, and/or the transmitting queries plant variety module m1137, when executed and/or activated, directs performance of and/or performs the operation o1137 in the illustrative depiction as follows, and/or the operation o1137 is otherwise carried out in the illustrative depiction as follows: electronically transmitting (e.g. desktop entry, etc.) one or more queries (e.g. nitrogen levels, etc.) regarding at least in part (e.g. absorbed by, etc.) the one or more farming related production factors (e.g. invasive plant population, etc.) involved with (e.g. absorbed by, etc.) farming related production of (e.g. peach picking, etc.) one or more ingestible materials (e.g. snail, etc.) including at least in part one or more plant variety factors involved with farming related ingestible material production (e.g. invasive plant population, etc.).

In one or more implementations, as shown in FIG. 55, operation o11 includes an operation o1138 for electronically transmitting one or more queries regarding at least in part the one or more farming related production factors involved with farming related production of one or more ingestible materials including at least in part one or more animal population factors involved with farming related ingestible material production. Origination of an illustratively derived transmitting queries animal population component group can be accomplished through skilled in the art design choice selection of one or more of the above depicted components from one or more of the above depicted subsystems shown in FIG. 12. Components from the transmitting queries animal population component group can be used in implementing execution of the one or more transmitting queries animal population instructions i1138 of FIG. 29, can be used in performance of the transmitting queries animal population electrical circuitry arrangement e1138 of FIG. 22, and/or can be used in otherwise fulfillment of the operation o1138. An exemplary non-transitory signal bearing medium version of the information storage subsystem s200 is depicted in FIG. 29 as bearing the one or more transmitting queries animal population instructions i1138 that when executed will direct performance of the operation o1138. Furthermore, the transmitting queries animal population electrical circuitry arrangement (“elec circ arrange”) e1138, when activated, will perform the operation o1138. Also, the transmitting queries animal population module m1138, when executed and/or activated, will direct performance of and/or perform the operation o1138. For instance, in one or more exemplary implementations, the one or more transmitting queries animal population instructions i1138, when executed, direct performance of the operation o1138 in the illustrative depiction as follows, and/or the transmitting queries animal population electrical circuitry arrangement e1138, when activated, performs the operation o1138 in the illustrative depiction as follows, and/or the transmitting queries animal population module m1138, when executed and/or activated, directs performance of and/or performs the operation o1138 in the illustrative depiction as follows, and/or the operation o1138 is otherwise carried out in the illustrative depiction as follows: electronically transmitting (e.g. acoustic energy, etc.) one or more queries (e.g. calcium levels, etc.) regarding at least in part (e.g. embraced by, etc.) the one or more farming related production factors (e.g. rodent population, etc.) involved with (e.g. embraced by, etc.) farming related production of (e.g. chicken egg laying, etc.) one or more ingestible materials (e.g. snail shell, etc.) including at least in part one or more animal population factors involved with farming related ingestible material production (e.g. rodent population, etc.).

In one or more implementations, as shown in FIG. 55, operation o11 includes an operation o1139 for electronically transmitting one or more queries regarding at least in part the one or more farming related production factors involved with farming related production of one or more ingestible materials including at least in part one or more animal byproduct factors involved with farming related ingestible material production. Origination of an illustratively derived transmitting queries animal byproduct component group can be accomplished through skilled in the art design choice selection of one or more of the above depicted components from one or more of the above depicted subsystems shown in FIG. 12. Components from the transmitting queries animal byproduct component group can be used in implementing execution of the one or more transmitting queries animal byproduct instructions i1139 of FIG. 29, can be used in performance of the transmitting queries animal byproduct electrical circuitry arrangement e1139 of FIG. 22, and/or can be used in otherwise fulfillment of the operation o1139. An exemplary non-transitory signal bearing medium version of the information storage subsystem s200 is depicted in FIG. 29 as bearing the one or more transmitting queries animal byproduct instructions i1139 that when executed will direct performance of the operation o1139. Furthermore, the transmitting queries animal byproduct electrical circuitry arrangement (“elec circ arrange”) e1139, when activated, will perform the operation o1139. Also, the transmitting queries animal byproduct module m1139, when executed and/or activated, will direct performance of and/or perform the operation o1139. For instance, in one or more exemplary implementations, the one or more transmitting queries animal byproduct instructions i1139, when executed, direct performance of the operation o1139 in the illustrative depiction as follows, and/or the transmitting queries animal byproduct electrical circuitry arrangement e1139, when activated, performs the operation o1139 in the illustrative depiction as follows, and/or the transmitting queries animal byproduct module m1139, when executed and/or activated, directs performance of and/or performs the operation o1139 in the illustrative depiction as follows, and/or the operation o1139 is otherwise carried out in the illustrative depiction as follows: electronically transmitting (e.g. VHF, etc.) one or more queries (e.g. phosphate levels, etc.) regarding at least in part (e.g. containing, etc.) the one or more farming related production factors (e.g. manure composition, etc.) involved with (e.g. containing, etc.) farming related production of (e.g. sheep butchering, etc.) one or more ingestible materials (e.g. carp, etc.) including at least in part one or more animal byproduct factors involved with farming related ingestible material production (e.g. manure composition, etc.).

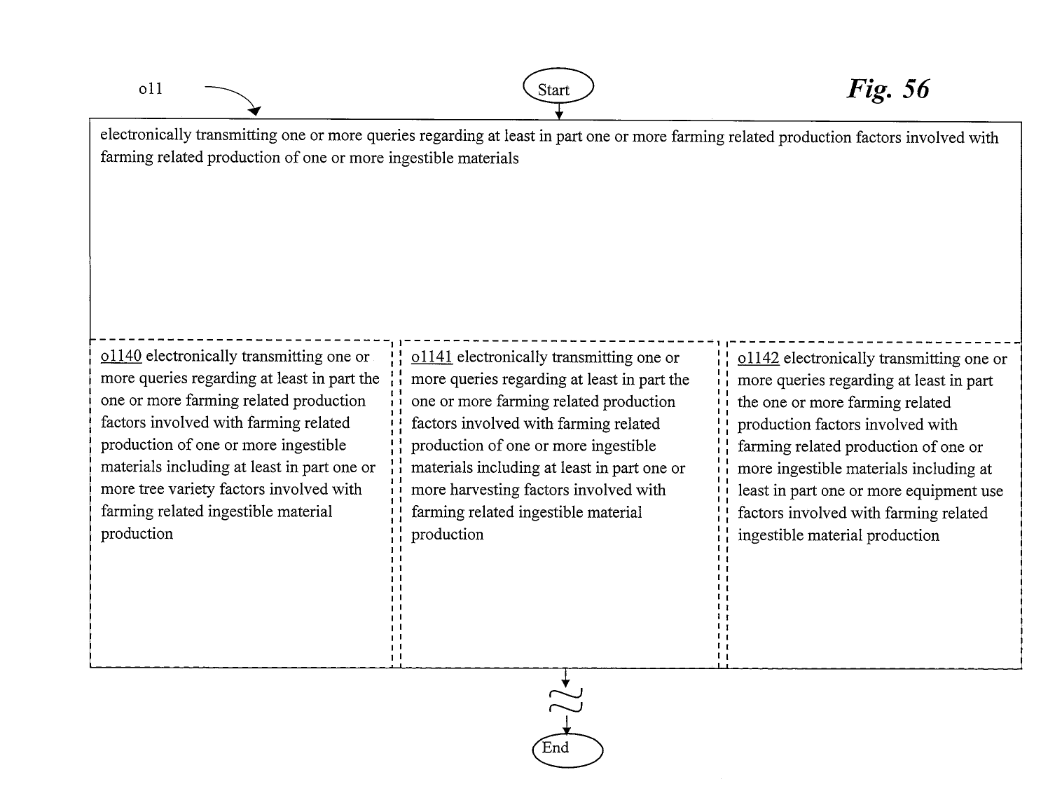

In one or more implementations, as shown in FIG. 56, operation o11 includes an operation o1140 for electronically transmitting one or more queries regarding at least in part the one or more farming related production factors involved with farming related production of one or more ingestible materials including at least in part one or more tree variety factors involved with farming related ingestible material production. Origination of an illustratively derived transmitting queries tree variety component group can be accomplished through skilled in the art design choice selection of one or more of the above depicted components from one or more of the above depicted subsystems shown in FIG. 12. Components from the transmitting queries tree variety component group can be used in implementing execution of the one or more transmitting queries tree variety instructions i1140 of FIG. 30, can be used in performance of the transmitting queries tree variety electrical circuitry arrangement e1140 of FIG. 23, and/or can be used in otherwise fulfillment of the operation o1140. An exemplary non-transitory signal bearing medium version of the information storage subsystem s200 is depicted in FIG. 30 as bearing the one or more transmitting queries tree variety instructions i1140 that when executed will direct performance of the operation o1140. Furthermore, the transmitting queries tree variety electrical circuitry arrangement (“elec circ arrange”) e1140, when activated, will perform the operation o1140. Also, the transmitting queries tree variety module m1140, when executed and/or activated, will direct performance of and/or perform the operation o1140. For instance, in one or more exemplary implementations, the one or more transmitting queries tree variety instructions i1140, when executed, direct performance of the operation o1140 in the illustrative depiction as follows, and/or the transmitting queries tree variety electrical circuitry arrangement e1140, when activated, performs the operation o1140 in the illustrative depiction as follows, and/or the transmitting queries tree variety module m1140, when executed and/or activated, directs performance of and/or performs the operation o1140 in the illustrative depiction as follows, and/or the operation o1140 is otherwise carried out in the illustrative depiction as follows: electronically transmitting (e.g. UFH, etc.) one or more queries (e.g. shovel, etc.) regarding at least in part (e.g. engaging, etc.) the one or more farming related production factors (e.g. shade tree population density, etc.) involved with (e.g. engaging, etc.) farming related production of (e.g. clam digging, etc.) one or more ingestible materials (e.g. sturgeon, etc.) including at least in part one or more tree variety factors involved with farming related ingestible material production (e.g. shade tree population density, etc.).

In one or more implementations, as shown in FIG. 56, operation o11 includes an operation o1141 for electronically transmitting one or more queries regarding at least in part the one or more farming related production factors involved with farming related production of one or more ingestible materials including at least in part one or more harvesting factors involved with farming related ingestible material production. Origination of an illustratively derived transmitting queries harvesting factors component group can be accomplished through skilled in the art design choice selection of one or more of the above depicted components from one or more of the above depicted subsystems shown in FIG. 12. Components from the transmitting queries harvesting factors component group can be used in implementing execution of the one or more transmitting queries harvesting factors instructions i1141 of FIG. 30, can be used in performance of the transmitting queries harvesting factors electrical circuitry arrangement e1141 of FIG. 23, and/or can be used in otherwise fulfillment of the operation o1141. An exemplary non-transitory signal bearing medium version of the information storage subsystem s200 is depicted in FIG. 30 as bearing the one or more transmitting queries harvesting factors instructions i1141 that when executed will direct performance of the operation o1141. Furthermore, the transmitting queries harvesting factors electrical circuitry arrangement (“elec circ arrange”) e1141, when activated, will perform the operation o1141. Also, the transmitting queries harvesting factors module m1141, when executed and/or activated, will direct performance of and/or perform the operation o1141. For instance, in one or more exemplary implementations, the one or more transmitting queries harvesting factors instructions i1141, when executed, direct performance of the operation o1141 in the illustrative depiction as follows, and/or the transmitting queries harvesting factors electrical circuitry arrangement e1141, when activated, performs the operation o1141 in the illustrative depiction as follows, and/or the transmitting queries harvesting factors module m1141, when executed and/or activated, directs performance of and/or performs the operation o1141 in the illustrative depiction as follows, and/or the operation o1141 is otherwise carried out in the illustrative depiction as follows: electronically transmitting (e.g. FRS, etc.) one or more queries (e.g. diesel fuel, etc.) regarding at least in part (e.g. engaged by, etc.) the one or more farming related production factors (e.g. combine run time, etc.) involved with (e.g. engaged by, etc.) farming related production of (e.g. crab trapping, etc.) one or more ingestible materials (e.g. sturgeon eggs, etc.) including at least in part one or more harvesting factors involved with farming related ingestible material production (e.g. combine run time, etc.).

In one or more implementations, as shown in FIG. 56, operation o11 includes an operation o1142 for electronically transmitting one or more queries regarding at least in part the one or more farming related production factors involved with farming related production of one or more ingestible materials including at least in part one or more equipment use factors involved with farming related ingestible material production. Origination of an illustratively derived transmitting queries equipment use component group can be accomplished through skilled in the art design choice selection of one or more of the above depicted components from one or more of the above depicted subsystems shown in FIG. 12. Components from the transmitting queries equipment use component group can be used in implementing execution of the one or more transmitting queries equipment use instructions i1142 of FIG. 30, can be used in performance of the transmitting queries equipment use electrical circuitry arrangement e1142 of FIG. 23, and/or can be used in otherwise fulfillment of the operation o1142. An exemplary non-transitory signal bearing medium version of the information storage subsystem s200 is depicted in FIG. 30 as bearing the one or more transmitting queries equipment use instructions i1142 that when executed will direct performance of the operation o1142. Furthermore, the transmitting queries equipment use electrical circuitry arrangement (“elec circ arrange”) e1142, when activated, will perform the operation o1142. Also, the transmitting queries equipment use module m1142, when executed and/or activated, will direct performance of and/or perform the operation o1142. For instance, in one or more exemplary implementations, the one or more transmitting queries equipment use instructions i1142, when executed, direct performance of the operation o1142 in the illustrative depiction as follows, and/or the transmitting queries equipment use electrical circuitry arrangement e1142, when activated, performs the operation o1142 in the illustrative depiction as follows, and/or the transmitting queries equipment use module m1142, when executed and/or activated, directs performance of and/or performs the operation o1142 in the illustrative depiction as follows, and/or the operation o1142 is otherwise carried out in the illustrative depiction as follows: electronically transmitting (e.g. GMRS, etc.) one or more queries (e.g. combine, etc.) regarding at least in part (e.g. incorporating, etc.) the one or more farming related production factors (e.g. welding machine usage, etc.) involved with (e.g. incorporating, etc.) farming related production of (e.g. mushroom cultivation, etc.) one or more ingestible materials (e.g. venison, etc.) including at least in part one or more equipment use factors involved with farming related ingestible material production (e.g. welding machine usage, etc.).

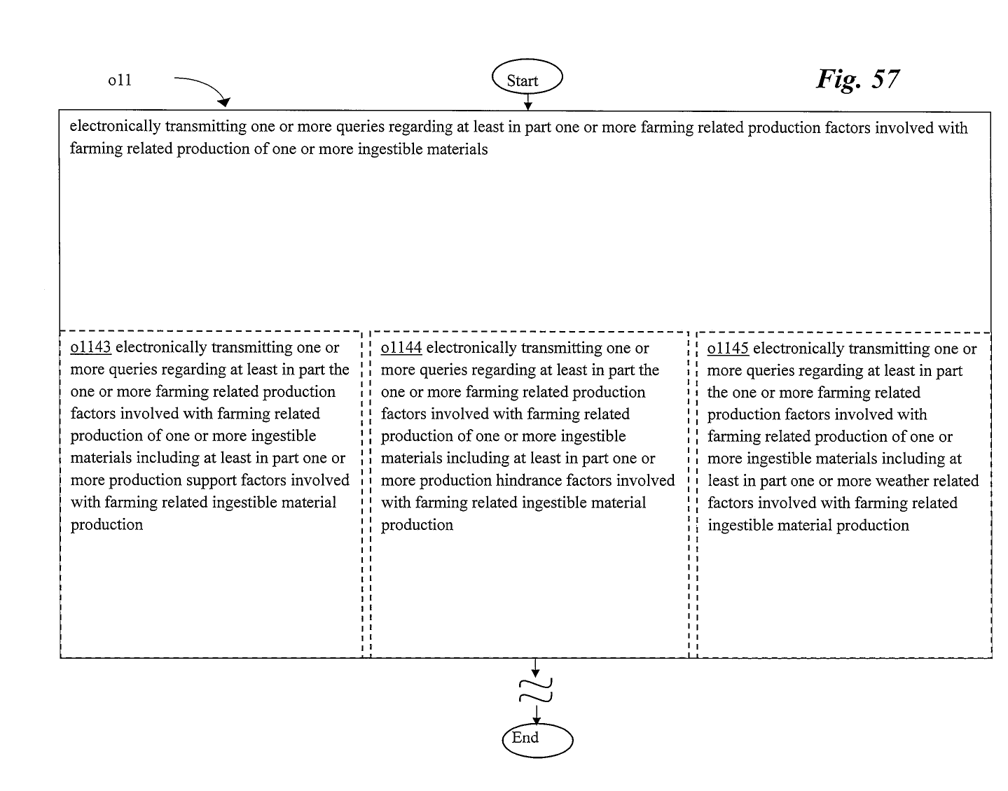

In one or more implementations, as shown in FIG. 57, operation o11 includes an operation o1143 for electronically transmitting one or more queries regarding at least in part the one or more farming related production factors involved with farming related production of one or more ingestible materials including at least in part one or more production support factors involved with farming related ingestible material production. Origination of an illustratively derived transmitting queries production support component group can be accomplished through skilled in the art design choice selection of one or more of the above depicted components from one or more of the above depicted subsystems shown in FIG. 12. Components from the transmitting queries production support component group can be used in implementing execution of the one or more transmitting queries production support instructions i1143 of FIG. 30, can be used in performance of the transmitting queries production support electrical circuitry arrangement e1143 of FIG. 23, and/or can be used in otherwise fulfillment of the operation o1143. An exemplary non-transitory signal bearing medium version of the information storage subsystem s200 is depicted in FIG. 30 as bearing the one or more transmitting queries production support instructions i1143 that when executed will direct performance of the operation o1143. Furthermore, the transmitting queries production support electrical circuitry arrangement (“elec circ arrange”) e1143, when activated, will perform the operation o1143. Also, the transmitting queries production support module m1143, when executed and/or activated, will direct performance of and/or perform the operation o1143. For instance, in one or more exemplary implementations, the one or more transmitting queries production support instructions i1143, when executed, direct performance of the operation o1143 in the illustrative depiction as follows, and/or the transmitting queries production support electrical circuitry arrangement e1143, when activated, performs the operation o1143 in the illustrative depiction as follows, and/or the transmitting queries production support module m1143, when executed and/or activated, directs performance of and/or performs the operation o1143 in the illustrative depiction as follows, and/or the operation o1143 is otherwise carried out in the illustrative depiction as follows: electronically transmitting (e.g. IEEE 802.11, etc.) one or more queries (e.g. plow, etc.) regarding at least in part (e.g. engrossing, etc.) the one or more farming related production factors (e.g. generator fuel type used, etc.) involved with (e.g. engrossing, etc.) farming related production of (e.g. alfalfa cutting, etc.) one or more ingestible materials (e.g. kangaroo meat, etc.) including at least in part one or more production support factors involved with farming related ingestible material production (e.g. generator fuel type used, etc.).

In one or more implementations, as shown in FIG. 57, operation o11 includes an operation o1144 for electronically transmitting one or more queries regarding at least in part the one or more farming related production factors involved with farming related production of one or more ingestible materials including at least in part one or more production hindrance factors involved with farming related ingestible material production. Origination of an illustratively derived transmitting queries production hindrance component group can be accomplished through skilled in the art design choice selection of one or more of the above depicted components from one or more of the above depicted subsystems shown in FIG. 12. Components from the transmitting queries production hindrance component group can be used in implementing execution of the one or more transmitting queries production hindrance instructions i1144 of FIG. 30, can be used in performance of the transmitting queries production hindrance electrical circuitry arrangement e1144 of FIG. 23, and/or can be used in otherwise fulfillment of the operation o1144. An exemplary non-transitory signal bearing medium version of the information storage subsystem s200 is depicted in FIG. 30 as bearing the one or more transmitting queries production hindrance instructions i1144 that when executed will direct performance of the operation o1144. Furthermore, the transmitting queries production hindrance electrical circuitry arrangement (“elec circ arrange”) e1144, when activated, will perform the operation o1144. Also, the transmitting queries production hindrance module m1144, when executed and/or activated, will direct performance of and/or perform the operation o1144. For instance, in one or more exemplary implementations, the one or more transmitting queries production hindrance instructions i1144, when executed, direct performance of the operation o1144 in the illustrative depiction as follows, and/or the transmitting queries production hindrance electrical circuitry arrangement e1144, when activated, performs the operation o1144 in the illustrative depiction as follows, and/or the transmitting queries production hindrance module m1144, when executed and/or activated, directs performance of and/or performs the operation o1144 in the illustrative depiction as follows, and/or the operation o1144 is otherwise carried out in the illustrative depiction as follows: electronically transmitting (e.g. CDMA, etc.) one or more queries (e.g. shipping containers, etc.) regarding at least in part (e.g. implicate, etc.) the one or more farming related production factors (e.g. adequate record keeping of weather patterns, etc.) involved with (e.g. implicate, etc.) farming related production of (e.g. potato harvesting, etc.) one or more ingestible materials (e.g. maguey worm, etc.) including at least in part one or more production hindrance factors involved with farming related ingestible material production (e.g. adequate record keeping of weather patterns, etc.).

In one or more implementations, as shown in FIG. 57, operation o11 includes an operation o1145 for electronically transmitting one or more queries regarding at least in part the one or more farming related production factors involved with farming related production of one or more ingestible materials including at least in part one or more weather related factors involved with farming related ingestible material production. Origination of an illustratively derived transmitting queries weather component group can be accomplished through skilled in the art design choice selection of one or more of the above depicted components from one or more of the above depicted subsystems shown in FIG. 12. Components from the transmitting queries weather component group can be used in implementing execution of the one or more transmitting queries weather instructions i1145 of FIG. 30, can be used in performance of the transmitting queries weather electrical circuitry arrangement e1145 of FIG. 23, and/or can be used in otherwise fulfillment of the operation o1145. An exemplary non-transitory signal bearing medium version of the information storage subsystem s200 is depicted in FIG. 30 as bearing the one or more transmitting queries weather instructions i1145 that when executed will direct performance of the operation o1145. Furthermore, the transmitting queries weather electrical circuitry arrangement (“elec circ arrange”) e1145, when activated, will perform the operation o1145. Also, the transmitting queries weather module m1145, when executed and/or activated, will direct performance of and/or perform the operation o1145. For instance, in one or more exemplary implementations, the one or more transmitting queries weather instructions i1145, when executed, direct performance of the operation o1145 in the illustrative depiction as follows, and/or the transmitting queries weather electrical circuitry arrangement e1145, when activated, performs the operation o1145 in the illustrative depiction as follows, and/or the transmitting queries weather module m1145, when executed and/or activated, directs performance of and/or performs the operation o1145 in the illustrative depiction as follows, and/or the operation o1145 is otherwise carried out in the illustrative depiction as follows: electronically transmitting (e.g. GPRS, etc.) one or more queries (e.g. plowing, etc.) regarding at least in part (e.g. necessitate, etc.) the one or more farming related production factors (e.g. weather forecast, etc.) involved with (e.g. necessitate, etc.) farming related production of (e.g. beet root harvesting, etc.) one or more ingestible materials (e.g. mopane worm, etc.) including at least in part one or more weather related factors involved with farming related ingestible material production (e.g. weather forecast, etc.).

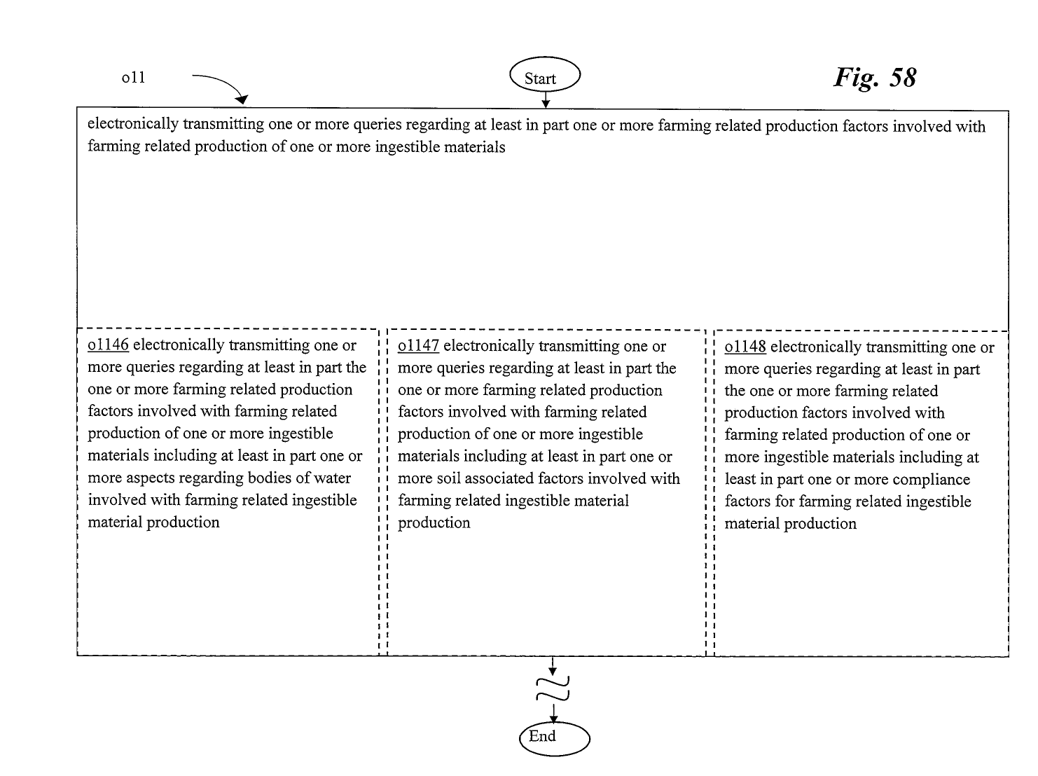

In one or more implementations, as shown in FIG. 58, operation o11 includes an operation o1146 for electronically transmitting one or more queries regarding at least in part the one or more farming related production factors involved with farming related production of one or more ingestible materials including at least in part one or more aspects regarding bodies of water involved with farming related ingestible material production. Origination of an illustratively derived transmitting queries water component group can be accomplished through skilled in the art design choice selection of one or more of the above depicted components from one or more of the above depicted subsystems shown in FIG. 12. Components from the transmitting queries water component group can be used in implementing execution of the one or more transmitting queries water instructions i1146 of FIG. 30, can be used in performance of the transmitting queries water electrical circuitry arrangement e1146 of FIG. 23, and/or can be used in otherwise fulfillment of the operation o1146. An exemplary non-transitory signal bearing medium version of the information storage subsystem s200 is depicted in FIG. 30 as bearing the one or more transmitting queries water instructions i1146 that when executed will direct performance of the operation o1146. Furthermore, the transmitting queries water electrical circuitry arrangement (“elec circ arrange”) e1146, when activated, will perform the operation o1146. Also, the transmitting queries water module m1146, when executed and/or activated, will direct performance of and/or perform the operation o1146. For instance, in one or more exemplary implementations, the one or more transmitting queries water instructions i1146, when executed, direct performance of the operation o1146 in the illustrative depiction as follows, and/or the transmitting queries water electrical circuitry arrangement e1146, when activated, performs the operation o1146 in the illustrative depiction as follows, and/or the transmitting queries water module m1146, when executed and/or activated, directs performance of and/or performs the operation o1146 in the illustrative depiction as follows, and/or the operation o1146 is otherwise carried out in the illustrative depiction as follows: electronically transmitting (e.g. G, etc.) one or more queries (e.g. AVI file format, etc.) regarding at least in part (e.g. presuppose, etc.) the one or more farming related production factors (e.g. tide height, etc.) involved with (e.g. presuppose, etc.) farming related production of (e.g. oat harvesting, etc.) one or more ingestible materials (e.g. chapuline, etc.) including at least in part one or more aspects regarding bodies of water involved with farming related ingestible material production (e.g. tide height, etc.).

In one or more implementations, as shown in FIG. 58, operation o11 includes an operation o1147 for electronically transmitting one or more queries regarding at least in part the one or more farming related production factors involved with farming related production of one or more ingestible materials including at least in part one or more soil associated factors involved with farming related ingestible material production. Origination of an illustratively derived transmitting queries soil component group can be accomplished through skilled in the art design choice selection of one or more of the above depicted components from one or more of the above depicted subsystems shown in FIG. 12. Components from the transmitting queries soil component group can be used in implementing execution of the one or more transmitting queries soil instructions i1147 of FIG. 30, can be used in performance of the transmitting queries soil electrical circuitry arrangement e1147 of FIG. 23, and/or can be used in otherwise fulfillment of the operation o1147. An exemplary non-transitory signal bearing medium version of the information storage subsystem s200 is depicted in FIG. 30 as bearing the one or more transmitting queries soil instructions i1147 that when executed will direct performance of the operation o1147. Furthermore, the transmitting queries soil electrical circuitry arrangement (“elec circ arrange”) e1147, when activated, will perform the operation o1147. Also, the transmitting queries soil module m1147, when executed and/or activated, will direct performance of and/or perform the operation o1147. For instance, in one or more exemplary implementations, the one or more transmitting queries soil instructions i1147, when executed, direct performance of the operation o1147 in the illustrative depiction as follows, and/or the transmitting queries soil electrical circuitry arrangement e1147, when activated, performs the operation o1147 in the illustrative depiction as follows, and/or the transmitting queries soil module m1147, when executed and/or activated, directs performance of and/or performs the operation o1147 in the illustrative depiction as follows, and/or the operation o1147 is otherwise carried out in the illustrative depiction as follows: electronically transmitting (e.g. G4, etc.) one or more queries (e.g. MP3 file format, etc.) regarding at least in part (e.g. related to, etc.) the one or more farming related production factors (e.g. soil composition, etc.) involved with (e.g. related to, etc.) farming related production of (e.g. carrot harvesting, etc.) one or more ingestible materials (e.g. ostrich meat, etc.) including at least in part one or more soil associated factors involved with farming related ingestible material production (e.g. soil composition, etc.).

In one or more implementations, as shown in FIG. 58, operation o11 includes an operation o1148 for electronically transmitting one or more queries regarding at least in part the one or more farming related production factors involved with farming related production of one or more ingestible materials including at least in part one or more compliance factors for farming related ingestible material production. Origination of an illustratively derived transmitting queries compliance component group can be accomplished through skilled in the art design choice selection of one or more of the above depicted components from one or more of the above depicted subsystems shown in FIG. 12. Components from the transmitting queries compliance component group can be used in implementing execution of the one or more transmitting queries compliance instructions i1148 of FIG. 30, can be used in performance of the transmitting queries compliance electrical circuitry arrangement e1148 of FIG. 23, and/or can be used in otherwise fulfillment of the operation o1148. An exemplary non-transitory signal bearing medium version of the information storage subsystem s200 is depicted in FIG. 30 as bearing the one or more transmitting queries compliance instructions i1148 that when executed will direct performance of the operation o1148. Furthermore, the transmitting queries compliance electrical circuitry arrangement (“elec circ arrange”) e1148, when activated, will perform the operation o1148. Also, the transmitting queries compliance module m1148, when executed and/or activated, will direct performance of and/or perform the operation o1148. For instance, in one or more exemplary implementations, the one or more transmitting queries compliance instructions i1148, when executed, direct performance of the operation o1148 in the illustrative depiction as follows, and/or the transmitting queries compliance electrical circuitry arrangement e1148, when activated, performs the operation o1148 in the illustrative depiction as follows, and/or the transmitting queries compliance module m1148, when executed and/or activated, directs performance of and/or performs the operation o1148 in the illustrative depiction as follows, and/or the operation o1148 is otherwise carried out in the illustrative depiction as follows: electronically transmitting (e.g. CD-ROM, etc.) one or more queries (e.g. audio listening, etc.) regarding at least in part (e.g. relationship, etc.) the one or more farming related production factors (e.g. lack of record keeping, etc.) involved with (e.g. relationship, etc.) farming related production of (e.g. silk production, etc.) one or more ingestible materials (e.g. emu meat, etc.) including at least in part one or more compliance factors for farming related ingestible material production (e.g. lack of record keeping, etc.).

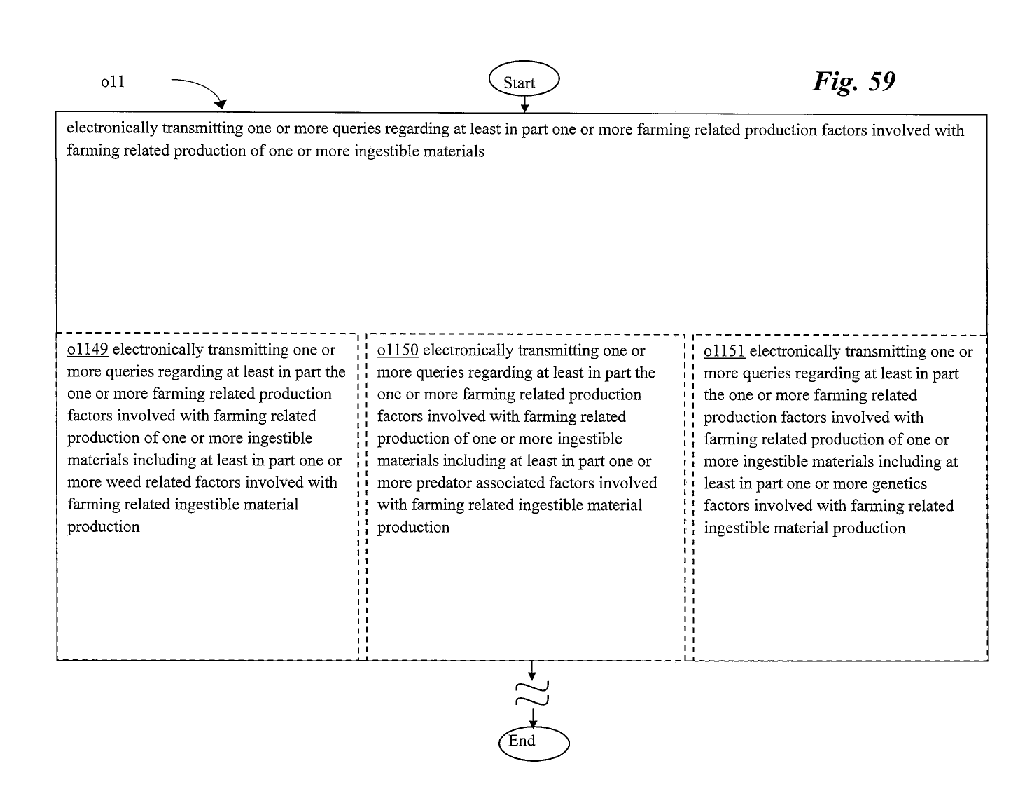

In one or more implementations, as shown in FIG. 59, operation o11 includes an operation o1149 for electronically transmitting one or more queries regarding at least in part the one or more farming related production factors involved with farming related production of one or more ingestible materials including at least in part one or more weed related factors involved with farming related ingestible material production. Origination of an illustratively derived transmitting queries weed component group can be accomplished through skilled in the art design choice selection of one or more of the above depicted components from one or more of the above depicted subsystems shown in FIG. 12. Components from the transmitting queries weed component group can be used in implementing execution of the one or more transmitting queries weed instructions i1149 of FIG. 30, can be used in performance of the transmitting queries weed electrical circuitry arrangement e1149 of FIG. 23, and/or can be used in otherwise fulfillment of the operation o1149. An exemplary non-transitory signal bearing medium version of the information storage subsystem s200 is depicted in FIG. 30 as bearing the one or more transmitting queries weed instructions i1149 that when executed will direct performance of the operation o1149. Furthermore, the transmitting queries weed electrical circuitry arrangement (“elec circ arrange”) e1149, when activated, will perform the operation o1149. Also, the transmitting queries weed module m1149, when executed and/or activated, will direct performance of and/or perform the operation o1149. For instance, in one or more exemplary implementations, the one or more transmitting queries weed instructions i1149, when executed, direct performance of the operation o1149 in the illustrative depiction as follows, and/or the transmitting queries weed electrical circuitry arrangement e1149, when activated, performs the operation o1149 in the illustrative depiction as follows, and/or the transmitting queries weed module m1149, when executed and/or activated, directs performance of and/or performs the operation o1149 in the illustrative depiction as follows, and/or the operation o1149 is otherwise carried out in the illustrative depiction as follows: electronically transmitting (e.g. DVD, etc.) one or more queries (e.g. disobeying safety protocols, etc.) regarding at least in part (e.g. suggest, etc.) the one or more farming related production factors (e.g. known weed species population, etc.) involved with (e.g. suggest, etc.) farming related production of (e.g. wool production, etc.) one or more ingestible materials (e.g. ostrich feathers, etc.) including at least in part one or more weed related factors involved with farming related ingestible material production (e.g. known weed species population, etc.).

In one or more implementations, as shown in FIG. 59, operation o11 includes an operation o1150 for electronically transmitting one or more queries regarding at least in part the one or more farming related production factors involved with farming related production of one or more ingestible materials including at least in part one or more predator associated factors involved with farming related ingestible material production. Origination of an illustratively derived transmitting queries predator component group can be accomplished through skilled in the art design choice selection of one or more of the above depicted components from one or more of the above depicted subsystems shown in FIG. 12. Components from the transmitting queries predator component group can be used in implementing execution of the one or more transmitting queries predator instructions i1150 of FIG. 30, can be used in performance of the transmitting queries predator electrical circuitry arrangement e1150 of FIG. 23, and/or can be used in otherwise fulfillment of the operation o1150. An exemplary non-transitory signal bearing medium version of the information storage subsystem s200 is depicted in FIG. 30 as bearing the one or more transmitting queries predator instructions i1150 that when executed will direct performance of the operation o1150. Furthermore, the transmitting queries predator electrical circuitry arrangement (“elec circ arrange”) e1150, when activated, will perform the operation o1150. Also, the transmitting queries predator module m1150, when executed and/or activated, will direct performance of and/or perform the operation o1150. For instance, in one or more exemplary implementations, the one or more transmitting queries predator instructions i1150, when executed, direct performance of the operation o1150 in the illustrative depiction as follows, and/or the transmitting queries predator electrical circuitry arrangement e1150, when activated, performs the operation o1150 in the illustrative depiction as follows, and/or the transmitting queries predator module m1150, when executed and/or activated, directs performance of and/or performs the operation o1150 in the illustrative depiction as follows, and/or the operation o1150 is otherwise carried out in the illustrative depiction as follows: electronically transmitting (e.g. hard drive, etc.) one or more queries (e.g. wind speed, etc.) regarding at least in part (e.g. tangle, etc.) the one or more farming related production factors (e.g. estimated rat population, etc.) involved with (e.g. tangle, etc.) farming related production of (e.g. lentil harvesting, etc.) one or more ingestible materials (e.g. sheep cheese, etc.) including at least in part one or more predator associated factors involved with farming related ingestible material production (e.g. estimated rat population, etc.).

In one or more implementations, as shown in FIG. 59, operation o11 includes an operation o1151 for electronically transmitting one or more queries regarding at least in part the one or more farming related production factors involved with farming related production of one or more ingestible materials including at least in part one or more genetics factors involved with farming related ingestible material production. Origination of an illustratively derived transmitting queries genetics component group can be accomplished through skilled in the art design choice selection of one or more of the above depicted components from one or more of the above depicted subsystems shown in FIG. 12. Components from the transmitting queries genetics component group can be used in implementing execution of the one or more transmitting queries genetics instructions i1151 of FIG. 30, can be used in performance of the transmitting queries genetics electrical circuitry arrangement e1151 of FIG. 23, and/or can be used in otherwise fulfillment of the operation o1151. An exemplary non-transitory signal bearing medium version of the information storage subsystem s200 is depicted in FIG. 30 as bearing the one or more transmitting queries genetics instructions i1151 that when executed will direct performance of the operation o1151. Furthermore, the transmitting queries genetics electrical circuitry arrangement (“elec circ arrange”) e1151, when activated, will perform the operation o1151. Also, the transmitting queries genetics module m1151, when executed and/or activated, will direct performance of and/or perform the operation o1151. For instance, in one or more exemplary implementations, the one or more transmitting queries genetics instructions i1151, when executed, direct performance of the operation o1151 in the illustrative depiction as follows, and/or the transmitting queries genetics electrical circuitry arrangement e1151, when activated, performs the operation o1151 in the illustrative depiction as follows, and/or the transmitting queries genetics module m1151, when executed and/or activated, directs performance of and/or performs the operation o1151 in the illustrative depiction as follows, and/or the operation o1151 is otherwise carried out in the illustrative depiction as follows: electronically transmitting (e.g. wifi, etc.) one or more queries (e.g. wind direction, etc.) regarding at least in part (e.g. exclude, etc.) the one or more farming related production factors (e.g. genetic code of current crop, etc.) involved with (e.g. exclude, etc.) farming related production of (e.g. flax growing, etc.) one or more ingestible materials (e.g. feed grain, etc.) including at least in part one or more genetics factors involved with farming related ingestible material production (e.g. genetic code of current crop, etc.).

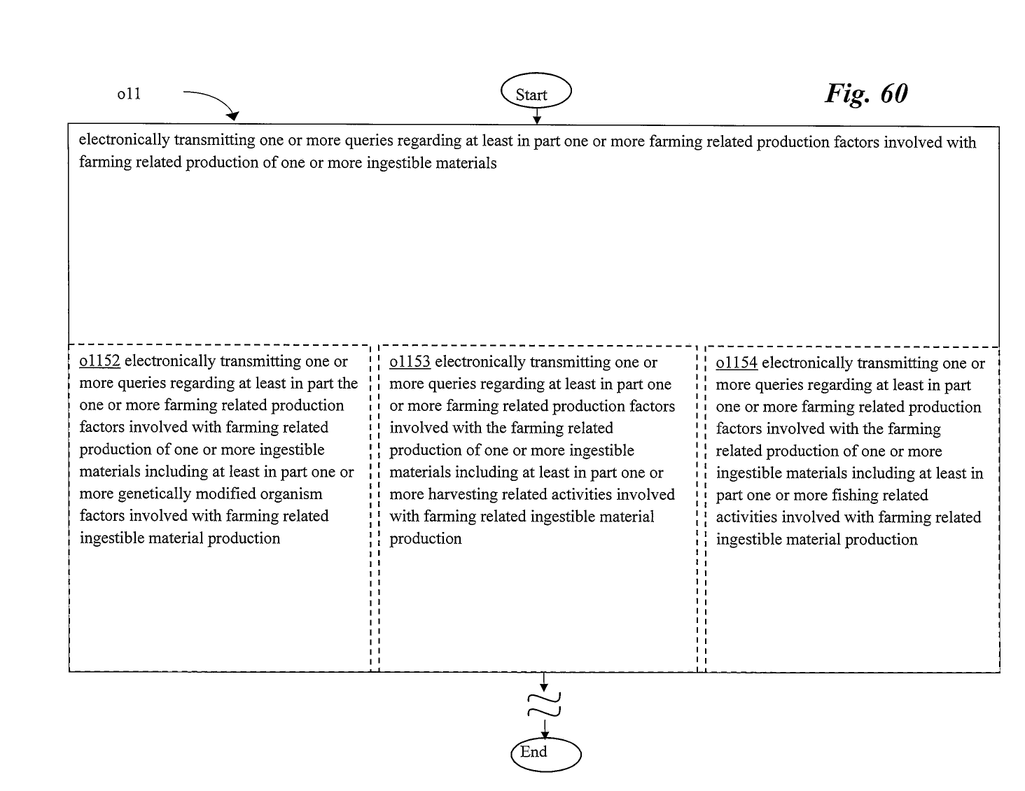

In one or more implementations, as shown in FIG. 60, operation o11 includes an operation o1152 for electronically transmitting one or more queries regarding at least in part the one or more farming related production factors involved with farming related production of one or more ingestible materials including at least in part one or more genetically modified organism factors involved with farming related ingestible material production. Origination of an illustratively derived transmitting queries GMO component group can be accomplished through skilled in the art design choice selection of one or more of the above depicted components from one or more of the above depicted subsystems shown in FIG. 12. Components from the transmitting queries GMO component group can be used in implementing execution of the one or more transmitting queries GMO instructions i1152 of FIG. 30, can be used in performance of the transmitting queries GMO electrical circuitry arrangement e1152 of FIG. 23, and/or can be used in otherwise fulfillment of the operation o1152. An exemplary non-transitory signal bearing medium version of the information storage subsystem s200 is depicted in FIG. 30 as bearing the one or more transmitting queries GMO instructions i1152 that when executed will direct performance of the operation o1152. Furthermore, the transmitting queries GMO electrical circuitry arrangement (“elec circ arrange”) e1152, when activated, will perform the operation o1152. Also, the transmitting queries GMO module m1152, when executed and/or activated, will direct performance of and/or perform the operation o1152. For instance, in one or more exemplary implementations, the one or more transmitting queries GMO instructions i1152, when executed, direct performance of the operation o1152 in the illustrative depiction as follows, and/or the transmitting queries GMO electrical circuitry arrangement e1152, when activated, performs the operation o1152 in the illustrative depiction as follows, and/or the transmitting queries GMO module m1152, when executed and/or activated, directs performance of and/or performs the operation o1152 in the illustrative depiction as follows, and/or the operation o1152 is otherwise carried out in the illustrative depiction as follows: electronically transmitting (e.g. laptop entry, etc.) one or more queries (e.g. UV index, etc.) regarding at least in part (e.g. bound, etc.) the one or more farming related production factors (e.g. family tree of heirloom seeds used, etc.) involved with (e.g. bound, etc.) farming related production of (e.g. squash cultivation, etc.) one or more ingestible materials (e.g. beet pulp, etc.) including at least in part one or more genetically modified organism factors involved with farming related ingestible material production (e.g. family tree of heirloom seeds used, etc.).

In one or more implementations, as shown in FIG. 60, operation o11 includes an operation o1153 for electronically transmitting one or more queries regarding at least in part one or more farming related production factors involved with the farming related production of one or more ingestible materials including at least in part one or more harvesting related activities involved with farming related ingestible material production. Origination of an illustratively derived transmitting queries harvesting component group can be accomplished through skilled in the art design choice selection of one or more of the above depicted components from one or more of the above depicted subsystems shown in FIG. 12. Components from the transmitting queries harvesting component group can be used in implementing execution of the one or more transmitting queries harvesting instructions i1153 of FIG. 30, can be used in performance of the transmitting queries harvesting electrical circuitry arrangement e1153 of FIG. 23, and/or can be used in otherwise fulfillment of the operation o1153. An exemplary non-transitory signal bearing medium version of the information storage subsystem s200 is depicted in FIG. 30 as bearing the one or more transmitting queries harvesting instructions i1153 that when executed will direct performance of the operation o1153. Furthermore, the transmitting queries harvesting electrical circuitry arrangement (“elec circ arrange”) e1153, when activated, will perform the operation o1153. Also, the transmitting queries harvesting module m1153, when executed and/or activated, will direct performance of and/or perform the operation o1153. For instance, in one or more exemplary implementations, the one or more transmitting queries harvesting instructions i1153, when executed, direct performance of the operation o1153 in the illustrative depiction as follows, and/or the transmitting queries harvesting electrical circuitry arrangement e1153, when activated, performs the operation o1153 in the illustrative depiction as follows, and/or the transmitting queries harvesting module m1153, when executed and/or activated, directs performance of and/or performs the operation o1153 in the illustrative depiction as follows, and/or the operation o1153 is otherwise carried out in the illustrative depiction as follows: electronically transmitting (e.g. RFID scan, etc.) one or more queries (e.g. carbon dioxide sensor, etc.) regarding at least in part (e.g. requiring, etc.) one or more farming related production factors (e.g. quality of feed water, etc.) involved with (e.g. requiring, etc.) the farming related production of (e.g. grain harvesting, etc.) one or more ingestible materials (e.g. water, etc.) including at least in part one or more harvesting related activities involved with farming related ingestible material production (e.g. grain harvesting, etc.).

In one or more implementations, as shown in FIG. 60, operation o11 includes an operation o1154 for electronically transmitting one or more queries regarding at least in part one or more farming related production factors involved with the farming related production of one or more ingestible materials including at least in part one or more fishing related activities involved with farming related ingestible material production. Origination of an illustratively derived transmitting queries fishing component group can be accomplished through skilled in the art design choice selection of one or more of the above depicted components from one or more of the above depicted subsystems shown in FIG. 12. Components from the transmitting queries fishing component group can be used in implementing execution of the one or more transmitting queries fishing instructions i1154 of FIG. 30, can be used in performance of the transmitting queries fishing electrical circuitry arrangement e1154 of FIG. 23, and/or can be used in otherwise fulfillment of the operation o1154. An exemplary non-transitory signal bearing medium version of the information storage subsystem s200 is depicted in FIG. 30 as bearing the one or more transmitting queries fishing instructions i1154 that when executed will direct performance of the operation o1154. Furthermore, the transmitting queries fishing electrical circuitry arrangement (“elec circ arrange”) e1154, when activated, will perform the operation o1154. Also, the transmitting queries fishing module m1154, when executed and/or activated, will direct performance of and/or perform the operation o1154. For instance, in one or more exemplary implementations, the one or more transmitting queries fishing instructions i1154, when executed, direct performance of the operation o1154 in the illustrative depiction as follows, and/or the transmitting queries fishing electrical circuitry arrangement e1154, when activated, performs the operation o1154 in the illustrative depiction as follows, and/or the transmitting queries fishing module m1154, when executed and/or activated, directs performance of and/or performs the operation o1154 in the illustrative depiction as follows, and/or the operation o1154 is otherwise carried out in the illustrative depiction as follows: electronically transmitting (e.g. ethernet, etc.) one or more queries (e.g. water usage, etc.) regarding at least in part (e.g. enveloped, etc.) one or more farming related production factors (e.g. total cost of harvest, etc.) involved with (e.g. enveloped, etc.) the farming related production of (e.g. salmon fishing, etc.) one or more ingestible materials (e.g. meal worms, etc.) including at least in part one or more fishing related activities involved with farming related ingestible material production (e.g. salmon fishing, etc.).

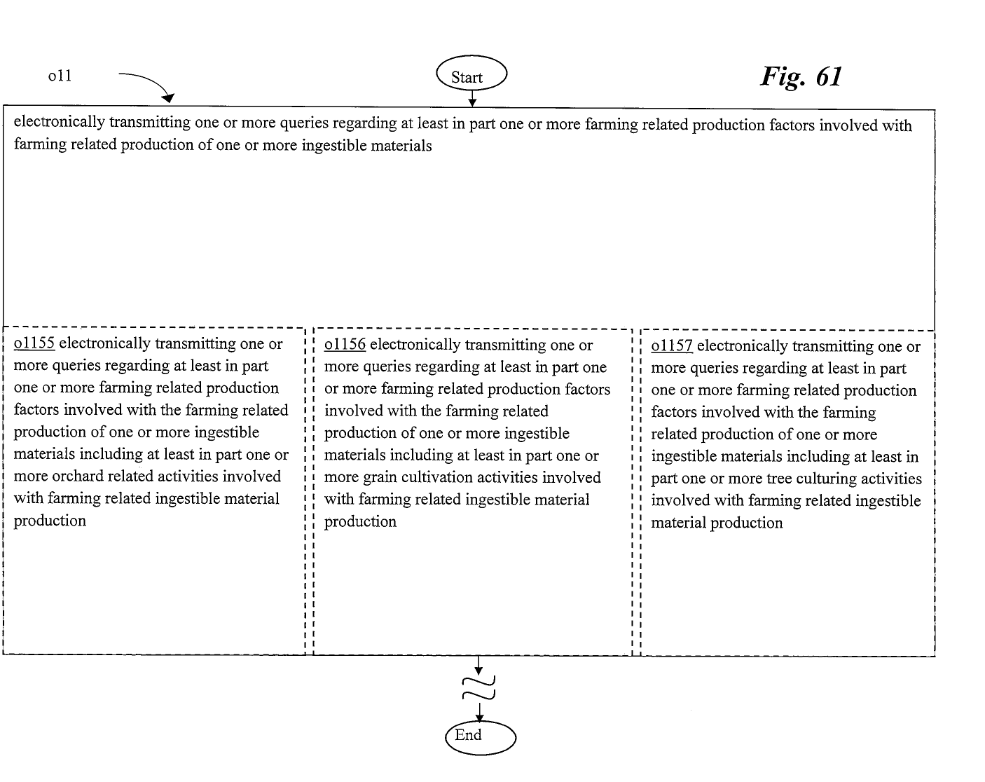

In one or more implementations, as shown in FIG. 61, operation o11 includes an operation o1155 for electronically transmitting one or more queries regarding at least in part one or more farming related production factors involved with the farming related production of one or more ingestible materials including at least in part one or more orchard related activities involved with farming related ingestible material production. Origination of an illustratively derived transmitting queries orchard component group can be accomplished through skilled in the art design choice selection of one or more of the above depicted components from one or more of the above depicted subsystems shown in FIG. 12. Components from the transmitting queries orchard component group can be used in implementing execution of the one or more transmitting queries orchard instructions i1155 of FIG. 30, can be used in performance of the transmitting queries orchard electrical circuitry arrangement e1155 of FIG. 23, and/or can be used in otherwise fulfillment of the operation o1155. An exemplary non-transitory signal bearing medium version of the information storage subsystem s200 is depicted in FIG. 30 as bearing the one or more transmitting queries orchard instructions i1155 that when executed will direct performance of the operation o1155. Furthermore, the transmitting queries orchard electrical circuitry arrangement (“elec circ arrange”) e1155, when activated, will perform the operation o1155. Also, the transmitting queries orchard module m1155, when executed and/or activated, will direct performance of and/or perform the operation o1155. For instance, in one or more exemplary implementations, the one or more transmitting queries orchard instructions i1155, when executed, direct performance of the operation o1155 in the illustrative depiction as follows, and/or the transmitting queries orchard electrical circuitry arrangement e1155, when activated, performs the operation o1155 in the illustrative depiction as follows, and/or the transmitting queries orchard module m1155, when executed and/or activated, directs performance of and/or performs the operation o1155 in the illustrative depiction as follows, and/or the operation o1155 is otherwise carried out in the illustrative depiction as follows: electronically transmitting (e.g. UPC scan, etc.) one or more queries (e.g. natural gas usage, etc.) regarding at least in part (e.g. envelope, etc.) one or more farming related production factors (e.g. shade tree type, etc.) involved with (e.g. envelope, etc.) the farming related production of (e.g. apple harvesting, etc.) one or more ingestible materials (e.g. parsnip, etc.) including at least in part one or more orchard related activities involved with farming related ingestible material production (e.g. apple harvesting, etc.).

In one or more implementations, as shown in FIG. 61, operation o11 includes an operation o1156 for electronically transmitting one or more queries regarding at least in part one or more farming related production factors involved with the farming related production of one or more ingestible materials including at least in part one or more grain cultivation activities involved with farming related ingestible material production. Origination of an illustratively derived transmitting queries grain component group can be accomplished through skilled in the art design choice selection of one or more of the above depicted components from one or more of the above depicted subsystems shown in FIG. 12. Components from the transmitting queries grain component group can be used in implementing execution of the one or more transmitting queries grain instructions i1156 of FIG. 30, can be used in performance of the transmitting queries grain electrical circuitry arrangement e1156 of FIG. 23, and/or can be used in otherwise fulfillment of the operation o1156. An exemplary non-transitory signal bearing medium version of the information storage subsystem s200 is depicted in FIG. 30 as bearing the one or more transmitting queries grain instructions i1156 that when executed will direct performance of the operation o1156. Furthermore, the transmitting queries grain electrical circuitry arrangement (“elec circ arrange”) e1156, when activated, will perform the operation o1156. Also, the transmitting queries grain module m1156, when executed and/or activated, will direct performance of and/or perform the operation o1156. For instance, in one or more exemplary implementations, the one or more transmitting queries grain instructions i1156, when executed, direct performance of the operation o1156 in the illustrative depiction as follows, and/or the transmitting queries grain electrical circuitry arrangement e1156, when activated, performs the operation o1156 in the illustrative depiction as follows, and/or the transmitting queries grain module m1156, when executed and/or activated, directs performance of and/or performs the operation o1156 in the illustrative depiction as follows, and/or the operation o1156 is otherwise carried out in the illustrative depiction as follows: electronically transmitting (e.g. HTML code, etc.) one or more queries (e.g. methane gas usage, etc.) regarding at least in part (e.g. associate with, etc.) one or more farming related production factors (e.g. acreage available, etc.) involved with (e.g. associate with, etc.) the farming related production of (e.g. wheat threshing, etc.) one or more ingestible materials (e.g. chicken feathers, etc.) including at least in part one or more grain cultivation activities involved with farming related ingestible material production (e.g. wheat threshing, etc.).

In one or more implementations, as shown in FIG. 61, operation o11 includes an operation o1157 for electronically transmitting one or more queries regarding at least in part one or more farming related production factors involved with the farming related production of one or more ingestible materials including at least in part one or more tree culturing activities involved with farming related ingestible material production. Origination of an illustratively derived transmitting queries tree culturing component group can be accomplished through skilled in the art design choice selection of one or more of the above depicted components from one or more of the above depicted subsystems shown in FIG. 12. Components from the transmitting queries tree culturing component group can be used in implementing execution of the one or more transmitting queries tree culturing instructions i1157 of FIG. 30, can be used in performance of the transmitting queries tree culturing electrical circuitry arrangement e1157 of FIG. 23, and/or can be used in otherwise fulfillment of the operation o1157. An exemplary non-transitory signal bearing medium version of the information storage subsystem s200 is depicted in FIG. 30 as bearing the one or more transmitting queries tree culturing instructions i1157 that when executed will direct performance of the operation o1157. Furthermore, the transmitting queries tree culturing electrical circuitry arrangement (“elec circ arrange”) e1157, when activated, will perform the operation o1157. Also, the transmitting queries tree culturing module m1157, when executed and/or activated, will direct performance of and/or perform the operation o1157. For instance, in one or more exemplary implementations, the one or more transmitting queries tree culturing instructions i1157, when executed, direct performance of the operation o1157 in the illustrative depiction as follows, and/or the transmitting queries tree culturing electrical circuitry arrangement e1157, when activated, performs the operation o1157 in the illustrative depiction as follows, and/or the transmitting queries tree culturing module m1157, when executed and/or activated, directs performance of and/or performs the operation o1157 in the illustrative depiction as follows, and/or the operation o1157 is otherwise carried out in the illustrative depiction as follows: electronically transmitting (e.g. MMS, etc.) one or more queries (e.g. MPEG file format, etc.) regarding at least in part (e.g. embroil, etc.) one or more farming related production factors (e.g. corral dimensions, etc.) involved with (e.g. embroil, etc.) the farming related production of (e.g. almond harvesting, etc.) one or more ingestible materials (e.g. hoofs, etc.) including at least in part one or more tree culturing activities involved with farming related ingestible material production (e.g. almond harvesting, etc.).

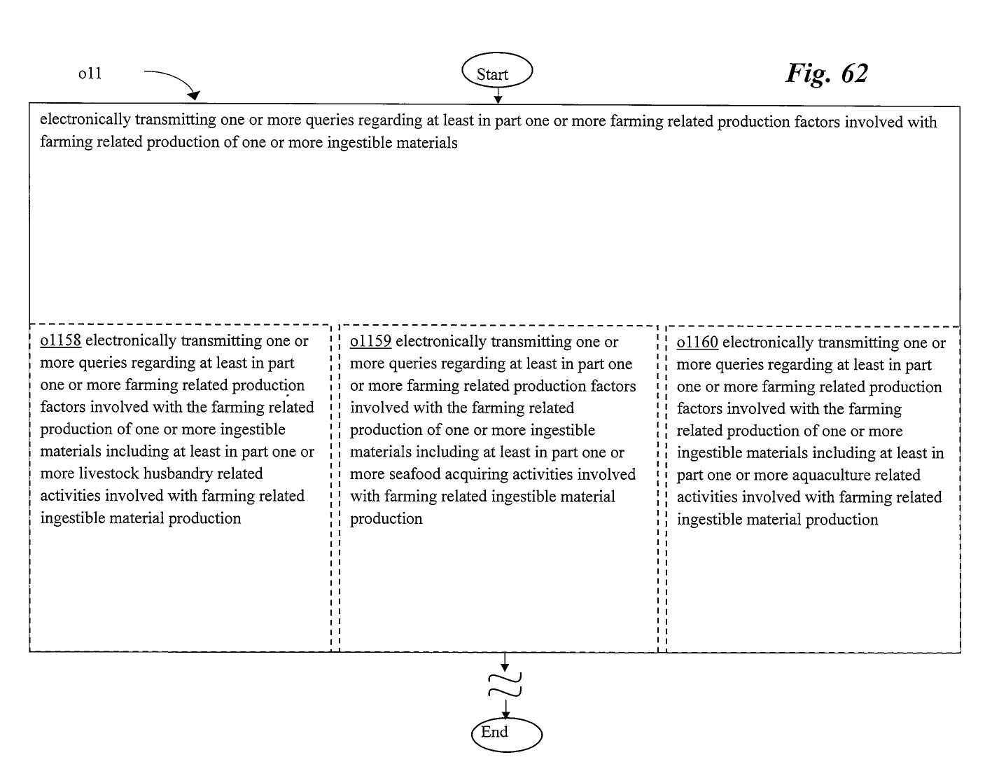

In one or more implementations, as shown in FIG. 62, operation o11 includes an operation o1158 for electronically transmitting one or more queries regarding at least in part one or more farming related production factors involved with the farming related production of one or more ingestible materials including at least in part one or more livestock husbandry related activities involved with farming related ingestible material production. Origination of an illustratively derived transmitting queries livestock component group can be accomplished through skilled in the art design choice selection of one or more of the above depicted components from one or more of the above depicted subsystems shown in FIG. 12. Components from the transmitting queries livestock component group can be used in implementing execution of the one or more transmitting queries livestock instructions i1158 of FIG. 30, can be used in performance of the transmitting queries livestock electrical circuitry arrangement e1158 of FIG. 23, and/or can be used in otherwise fulfillment of the operation o1158. An exemplary non-transitory signal bearing medium version of the information storage subsystem s200 is depicted in FIG. 30 as bearing the one or more transmitting queries livestock instructions i1158 that when executed will direct performance of the operation o1158. Furthermore, the transmitting queries livestock electrical circuitry arrangement (“elec circ arrange”) e1158, when activated, will perform the operation o1158. Also, the transmitting queries livestock module m1158, when executed and/or activated, will direct performance of and/or perform the operation o1158. For instance, in one or more exemplary implementations, the one or more transmitting queries livestock instructions i1158, when executed, direct performance of the operation o1158 in the illustrative depiction as follows, and/or the transmitting queries livestock electrical circuitry arrangement e1158, when activated, performs the operation o1158 in the illustrative depiction as follows, and/or the transmitting queries livestock module m1158, when executed and/or activated, directs performance of and/or performs the operation o1158 in the illustrative depiction as follows, and/or the operation o1158 is otherwise carried out in the illustrative depiction as follows: electronically transmitting (e.g. 256-bit AES, etc.) one or more queries (e.g. WAV file format, etc.) regarding at least in part (e.g. take in, etc.) one or more farming related production factors (e.g. lease duration of equipment, etc.) involved with (e.g. take in, etc.) the farming related production of (e.g. cow butchering, etc.) one or more ingestible materials (e.g. leather, etc.) including at least in part one or more livestock husbandry related activities involved with farming related ingestible material production (e.g. cow butchering, etc.).

In one or more implementations, as shown in FIG. 62, operation o11 includes an operation o1159 for electronically transmitting one or more queries regarding at least in part one or more farming related production factors involved with the farming related production of one or more ingestible materials including at least in part one or more seafood acquiring activities involved with farming related ingestible material production. Origination of an illustratively derived transmitting queries seafood component group can be accomplished through skilled in the art design choice selection of one or more of the above depicted components from one or more of the above depicted subsystems shown in FIG. 12. Components from the transmitting queries seafood component group can be used in implementing execution of the one or more transmitting queries seafood instructions i1159 of FIG. 30, can be used in performance of the transmitting queries seafood electrical circuitry arrangement e1159 of FIG. 23, and/or can be used in otherwise fulfillment of the operation o1159. An exemplary non-transitory signal bearing medium version of the information storage subsystem s200 is depicted in FIG. 30 as bearing the one or more transmitting queries seafood instructions i1159 that when executed will direct performance of the operation o1159. Furthermore, the transmitting queries seafood electrical circuitry arrangement (“elec circ arrange”) e1159, when activated, will perform the operation o1159. Also, the transmitting queries seafood module m1159, when executed and/or activated, will direct performance of and/or perform the operation o1159. For instance, in one or more exemplary implementations, the one or more transmitting queries seafood instructions i1159, when executed, direct performance of the operation o1159 in the illustrative depiction as follows, and/or the transmitting queries seafood electrical circuitry arrangement e1159, when activated, performs the operation o1159 in the illustrative depiction as follows, and/or the transmitting queries seafood module m1159, when executed and/or activated, directs performance of and/or performs the operation o1159 in the illustrative depiction as follows, and/or the operation o1159 is otherwise carried out in the illustrative depiction as follows: electronically transmitting (e.g. compact flash, etc.) one or more queries (e.g. visual sight, etc.) regarding at least in part (e.g. comprised of, etc.) one or more farming related production factors (e.g. efficiency of tilling, etc.) involved with (e.g. comprised of, etc.) the farming related production of (e.g. tuna canning, etc.) one or more ingestible materials (e.g. fur, etc.) including at least in part one or more seafood acquiring activities involved with farming related ingestible material production (e.g. tuna canning, etc.).

In one or more implementations, as shown in FIG. 62, operation o11 includes an operation o1160 for electronically transmitting one or more queries regarding at least in part one or more farming related production factors involved with the farming related production of one or more ingestible materials including at least in part one or more aquaculture related activities involved with farming related ingestible material production. Origination of an illustratively derived transmitting queries aquaculture component group can be accomplished through skilled in the art design choice selection of one or more of the above depicted components from one or more of the above depicted subsystems shown in FIG. 12. Components from the transmitting queries aquaculture component group can be used in implementing execution of the one or more transmitting queries aquaculture instructions i1160 of FIG. 31, can be used in performance of the transmitting queries aquaculture electrical circuitry arrangement e1160 of FIG. 24, and/or can be used in otherwise fulfillment of the operation o1160. An exemplary non-transitory signal bearing medium version of the information storage subsystem s200 is depicted in FIG. 31 as bearing the one or more transmitting queries aquaculture instructions i1160 that when executed will direct performance of the operation o1160. Furthermore, the transmitting queries aquaculture electrical circuitry arrangement (“elec circ arrange”) e1160, when activated, will perform the operation o1160. Also, the transmitting queries aquaculture module m1160, when executed and/or activated, will direct performance of and/or perform the operation o1160. For instance, in one or more exemplary implementations, the one or more transmitting queries aquaculture instructions i1160, when executed, direct performance of the operation o1160 in the illustrative depiction as follows, and/or the transmitting queries aquaculture electrical circuitry arrangement e1160, when activated, performs the operation o1160 in the illustrative depiction as follows, and/or the transmitting queries aquaculture module m1160, when executed and/or activated, directs performance of and/or performs the operation o1160 in the illustrative depiction as follows, and/or the operation o1160 is otherwise carried out in the illustrative depiction as follows: electronically transmitting (e.g. push-based, etc.) one or more queries (e.g. following safety protocols, etc.) regarding at least in part (e.g. comprehend, etc.) one or more farming related production factors (e.g. land terrain, etc.) involved with (e.g. comprehend, etc.) the farming related production of (e.g. oyster harvesting, etc.) one or more ingestible materials (e.g. wool, etc.) including at least in part one or more aquaculture related activities involved with farming related ingestible material production (e.g. oyster harvesting, etc.).

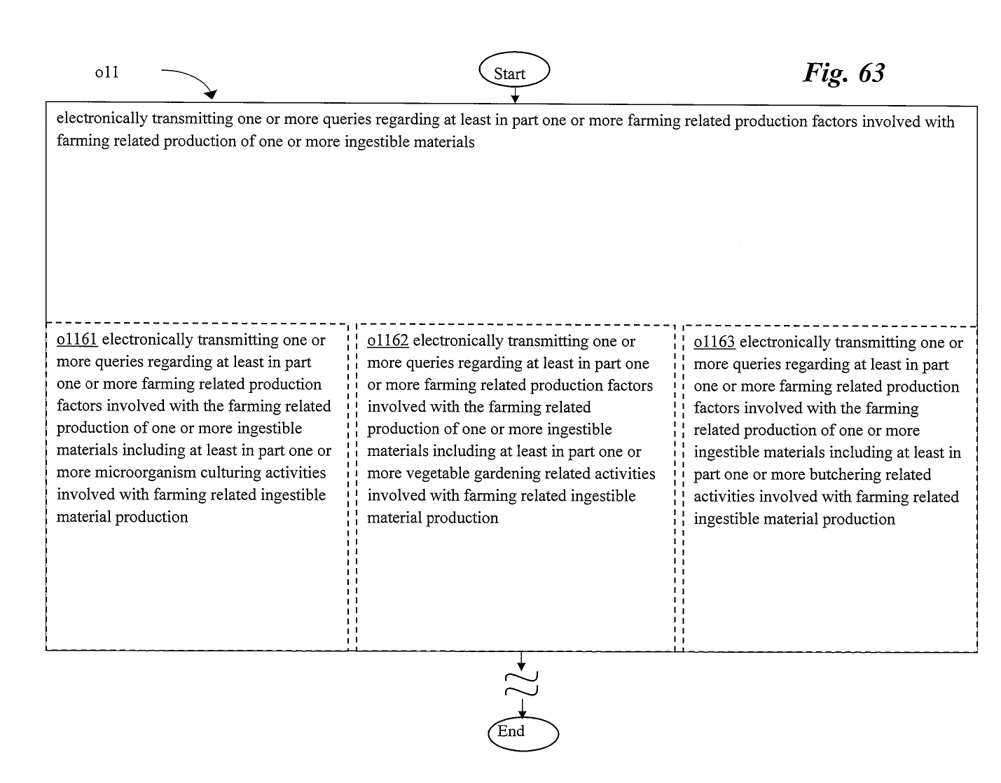

In one or more implementations, as shown in FIG. 63, operation o11 includes an operation o1161 for electronically transmitting one or more queries regarding at least in part one or more farming related production factors involved with the farming related production of one or more ingestible materials including at least in part one or more microorganism culturing activities involved with farming related ingestible material production. Origination of an illustratively derived transmitting queries microorganism component group can be accomplished through skilled in the art design choice selection of one or more of the above depicted components from one or more of the above depicted subsystems shown in FIG. 12. Components from the transmitting queries microorganism component group can be used in implementing execution of the one or more transmitting queries microorganism instructions i1161 of FIG. 31, can be used in performance of the transmitting queries microorganism electrical circuitry arrangement e1161 of FIG. 24, and/or can be used in otherwise fulfillment of the operation o1161. An exemplary non-transitory signal bearing medium version of the information storage subsystem s200 is depicted in FIG. 31 as bearing the one or more transmitting queries microorganism instructions i1161 that when executed will direct performance of the operation o1161. Furthermore, the transmitting queries microorganism electrical circuitry arrangement (“elec circ arrange”) e1161, when activated, will perform the operation o1161. Also, the transmitting queries microorganism module m1161, when executed and/or activated, will direct performance of and/or perform the operation o1161. For instance, in one or more exemplary implementations, the one or more transmitting queries microorganism instructions i1161, when executed, direct performance of the operation o1161 in the illustrative depiction as follows, and/or the transmitting queries microorganism electrical circuitry arrangement e1161, when activated, performs the operation o1161 in the illustrative depiction as follows, and/or the transmitting queries microorganism module m1161, when executed and/or activated, directs performance of and/or performs the operation o1161 in the illustrative depiction as follows, and/or the operation o1161 is otherwise carried out in the illustrative depiction as follows: electronically transmitting (e.g. SMTP server, etc.) one or more queries (e.g. document forgery, etc.) regarding at least in part (e.g. calculate, etc.) one or more farming related production factors (e.g. range area, etc.) involved with (e.g. calculate, etc.) the farming related production of (e.g. chanterelle foraging, etc.) one or more ingestible materials (e.g. whole king crab, etc.) including at least in part one or more microorganism culturing activities involved with farming related ingestible material production (e.g. chanterelle foraging, etc.).

In one or more implementations, as shown in FIG. 63, operation o11 includes an operation o1162 for electronically transmitting one or more queries regarding at least in part one or more farming related production factors involved with the farming related production of one or more ingestible materials including at least in part one or more vegetable gardening related activities involved with farming related ingestible material production. Origination of an illustratively derived transmitting queries vegetable component group can be accomplished through skilled in the art design choice selection of one or more of the above depicted components from one or more of the above depicted subsystems shown in FIG. 12. Components from the transmitting queries vegetable component group can be used in implementing execution of the one or more transmitting queries vegetable instructions i1162 of FIG. 31, can be used in performance of the transmitting queries vegetable electrical circuitry arrangement e1162 of FIG. 24, and/or can be used in otherwise fulfillment of the operation o1162. An exemplary non-transitory signal bearing medium version of the information storage subsystem s200 is depicted in FIG. 31 as bearing the one or more transmitting queries vegetable instructions i1162 that when executed will direct performance of the operation o1162. Furthermore, the transmitting queries vegetable electrical circuitry arrangement (“elec circ arrange”) e1162, when activated, will perform the operation o1162. Also, the transmitting queries vegetable module m1162, when executed and/or activated, will direct performance of and/or perform the operation o1162. For instance, in one or more exemplary implementations, the one or more transmitting queries vegetable instructions i1162, when executed, direct performance of the operation o1162 in the illustrative depiction as follows, and/or the transmitting queries vegetable electrical circuitry arrangement e1162, when activated, performs the operation o1162 in the illustrative depiction as follows, and/or the transmitting queries vegetable module m1162, when executed and/or activated, directs performance of and/or performs the operation o1162 in the illustrative depiction as follows, and/or the operation o1162 is otherwise carried out in the illustrative depiction as follows: electronically transmitting (e.g. radio wave, etc.) one or more queries (e.g. scheduled feeding, etc.) regarding at least in part (e.g. affected, etc.) one or more farming related production factors (e.g. range schedule, etc.) involved with (e.g. affected, etc.) the farming related production of (e.g. broccoli harvesting, etc.) one or more ingestible materials (e.g. cellulose, etc.) including at least in part one or more vegetable gardening related activities involved with farming related ingestible material production (e.g. broccoli harvesting, etc.).

In one or more implementations, as shown in FIG. 63, operation o11 includes an operation o1163 for electronically transmitting one or more queries regarding at least in part one or more farming related production factors involved with the farming related production of one or more ingestible materials including at least in part one or more butchering related activities involved with farming related ingestible material production. Origination of an illustratively derived transmitting queries butchering component group can be accomplished through skilled in the art design choice selection of one or more of the above depicted components from one or more of the above depicted subsystems shown in FIG. 12. Components from the transmitting queries butchering component group can be used in implementing execution of the one or more transmitting queries butchering instructions i1163 of FIG. 31, can be used in performance of the transmitting queries butchering electrical circuitry arrangement e1163 of FIG. 24, and/or can be used in otherwise fulfillment of the operation o1163. An exemplary non-transitory signal bearing medium version of the information storage subsystem s200 is depicted in FIG. 31 as bearing the one or more transmitting queries butchering instructions i1163 that when executed will direct performance of the operation o1163. Furthermore, the transmitting queries butchering electrical circuitry arrangement (“elec circ arrange”) e1163, when activated, will perform the operation o1163. Also, the transmitting queries butchering module m1163, when executed and/or activated, will direct performance of and/or perform the operation o1163. For instance, in one or more exemplary implementations, the one or more transmitting queries butchering instructions i1163, when executed, direct performance of the operation o1163 in the illustrative depiction as follows, and/or the transmitting queries butchering electrical circuitry arrangement e1163, when activated, performs the operation o1163 in the illustrative depiction as follows, and/or the transmitting queries butchering module m1163, when executed and/or activated, directs performance of and/or performs the operation o1163 in the illustrative depiction as follows, and/or the operation o1163 is otherwise carried out in the illustrative depiction as follows: electronically transmitting (e.g. infra-red, etc.) one or more queries (e.g. temperature, etc.) regarding at least in part (e.g. affecting, etc.) one or more farming related production factors (e.g. livestock inventory, etc.) involved with (e.g. affecting, etc.) the farming related production of (e.g. swine butchering, etc.) one or more ingestible materials (e.g. wood, etc.) including at least in part one or more butchering related activities involved with farming related ingestible material production (e.g. swine butchering, etc.).

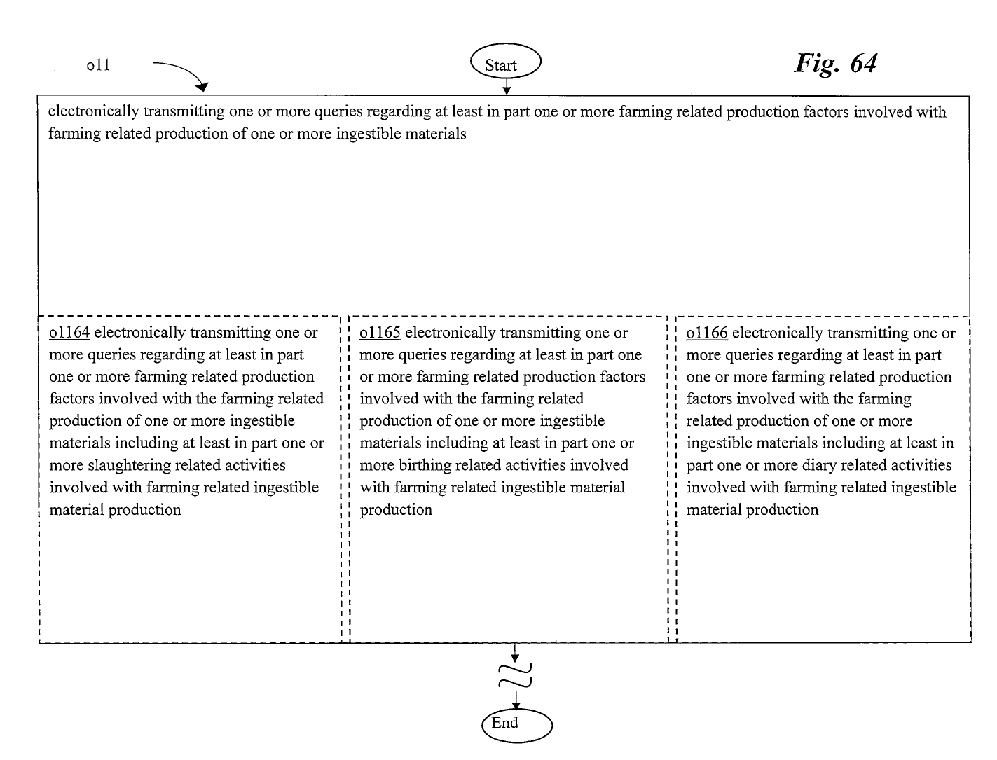

In one or more implementations, as shown in FIG. 64, operation o11 includes an operation o1164 for electronically transmitting one or more queries regarding at least in part one or more farming related production factors involved with the farming related production of one or more ingestible materials including at least in part one or more slaughtering related activities involved with farming related ingestible material production. Origination of an illustratively derived transmitting queries slaughtering component group can be accomplished through skilled in the art design choice selection of one or more of the above depicted components from one or more of the above depicted subsystems shown in FIG. 12. Components from the transmitting queries slaughtering component group can be used in implementing execution of the one or more transmitting queries slaughtering instructions i1164 of FIG. 31, can be used in performance of the transmitting queries slaughtering electrical circuitry arrangement e1164 of FIG. 24, and/or can be used in otherwise fulfillment of the operation o1164. An exemplary non-transitory signal bearing medium version of the information storage subsystem s200 is depicted in FIG. 31 as bearing the one or more transmitting queries slaughtering instructions i1164 that when executed will direct performance of the operation o1164. Furthermore, the transmitting queries slaughtering electrical circuitry arrangement (“elec circ arrange”) e1164, when activated, will perform the operation o1164. Also, the transmitting queries slaughtering module m1164, when executed and/or activated, will direct performance of and/or perform the operation o1164. For instance, in one or more exemplary implementations, the one or more transmitting queries slaughtering instructions i1164, when executed, direct performance of the operation o1164 in the illustrative depiction as follows, and/or the transmitting queries slaughtering electrical circuitry arrangement e1164, when activated, performs the operation o1164 in the illustrative depiction as follows, and/or the transmitting queries slaughtering module m1164, when executed and/or activated, directs performance of and/or performs the operation o1164 in the illustrative depiction as follows, and/or the operation o1164 is otherwise carried out in the illustrative depiction as follows: electronically transmitting (e.g. bluetooth, etc.) one or more queries (e.g. cold packing, etc.) regarding at least in part (e.g. argue, etc.) one or more farming related production factors (e.g. labor laws, etc.) involved with (e.g. argue, etc.) the farming related production of (e.g. turkey slaughtering, etc.) one or more ingestible materials (e.g. manure, etc.) including at least in part one or more slaughtering related activities involved with farming related ingestible material production (e.g. turkey slaughtering, etc.).

In one or more implementations, as shown in FIG. 64, operation o11 includes an operation o1165 for electronically transmitting one or more queries regarding at least in part one or more farming related production factors involved with the farming related production of one or more ingestible materials including at least in part one or more birthing related activities involved with farming related ingestible material production. Origination of an illustratively derived transmitting queries birthing component group can be accomplished through skilled in the art design choice selection of one or more of the above depicted components from one or more of the above depicted subsystems shown in FIG. 12. Components from the transmitting queries birthing component group can be used in implementing execution of the one or more transmitting queries birthing instructions i1165 of FIG. 31, can be used in performance of the transmitting queries birthing electrical circuitry arrangement e1165 of FIG. 24, and/or can be used in otherwise fulfillment of the operation o1165. An exemplary non-transitory signal bearing medium version of the information storage subsystem s200 is depicted in FIG. 31 as bearing the one or more transmitting queries birthing instructions i1165 that when executed will direct performance of the operation o1165. Furthermore, the transmitting queries birthing electrical circuitry arrangement (“elec circ arrange”) e1165, when activated, will perform the operation o1165. Also, the transmitting queries birthing module m1165, when executed and/or activated, will direct performance of and/or perform the operation o1165. For instance, in one or more exemplary implementations, the one or more transmitting queries birthing instructions i1165, when executed, direct performance of the operation o1165 in the illustrative depiction as follows, and/or the transmitting queries birthing electrical circuitry arrangement e1165, when activated, performs the operation o1165 in the illustrative depiction as follows, and/or the transmitting queries birthing module m1165, when executed and/or activated, directs performance of and/or performs the operation o1165 in the illustrative depiction as follows, and/or the operation o1165 is otherwise carried out in the illustrative depiction as follows: electronically transmitting (e.g. webpage, etc.) one or more queries (e.g. tractor operation, etc.) regarding at least in part (e.g. connected, etc.) one or more farming related production factors (e.g. safety regulations, etc.) involved with (e.g. connected, etc.) the farming related production of (e.g. buffalo birthing, etc.) one or more ingestible materials (e.g. ground chicken, etc.) including at least in part one or more birthing related activities involved with farming related ingestible material production (e.g. buffalo birthing, etc.).

In one or more implementations, as shown in FIG. 64, operation o11 includes an operation o1166 for electronically transmitting one or more queries regarding at least in part one or more farming related production factors involved with the farming related production of one or more ingestible materials including at least in part one or more diary related activities involved with farming related ingestible material production. Origination of an illustratively derived transmitting queries diary component group can be accomplished through skilled in the art design choice selection of one or more of the above depicted components from one or more of the above depicted subsystems shown in FIG. 12. Components from the transmitting queries diary component group can be used in implementing execution of the one or more transmitting queries diary instructions i1166 of FIG. 31, can be used in performance of the transmitting queries diary electrical circuitry arrangement e1166 of FIG. 24, and/or can be used in otherwise fulfillment of the operation o1166. An exemplary non-transitory signal bearing medium version of the information storage subsystem s200 is depicted in FIG. 31 as bearing the one or more transmitting queries diary instructions i1166 that when executed will direct performance of the operation o1166. Furthermore, the transmitting queries diary electrical circuitry arrangement (“elec circ arrange”) e1166, when activated, will perform the operation o1166. Also, the transmitting queries diary module m1166, when executed and/or activated, will direct performance of and/or perform the operation o1166. For instance, in one or more exemplary implementations, the one or more transmitting queries diary instructions i1166, when executed, direct performance of the operation o1166 in the illustrative depiction as follows, and/or the transmitting queries diary electrical circuitry arrangement e1166, when activated, performs the operation o1166 in the illustrative depiction as follows, and/or the transmitting queries diary module m1166, when executed and/or activated, directs performance of and/or performs the operation o1166 in the illustrative depiction as follows, and/or the operation o1166 is otherwise carried out in the illustrative depiction as follows: electronically transmitting (e.g. website, etc.) one or more queries (e.g. electricity usage, etc.) regarding at least in part (e.g. commit to, etc.) one or more farming related production factors (e.g. livestock fertility, etc.) involved with (e.g. commit to, etc.) the farming related production of (e.g. goat milking, etc.) one or more ingestible materials (e.g. goat milk, etc.) including at least in part one or more diary related activities involved with farming related ingestible material production (e.g. goat milking, etc.).

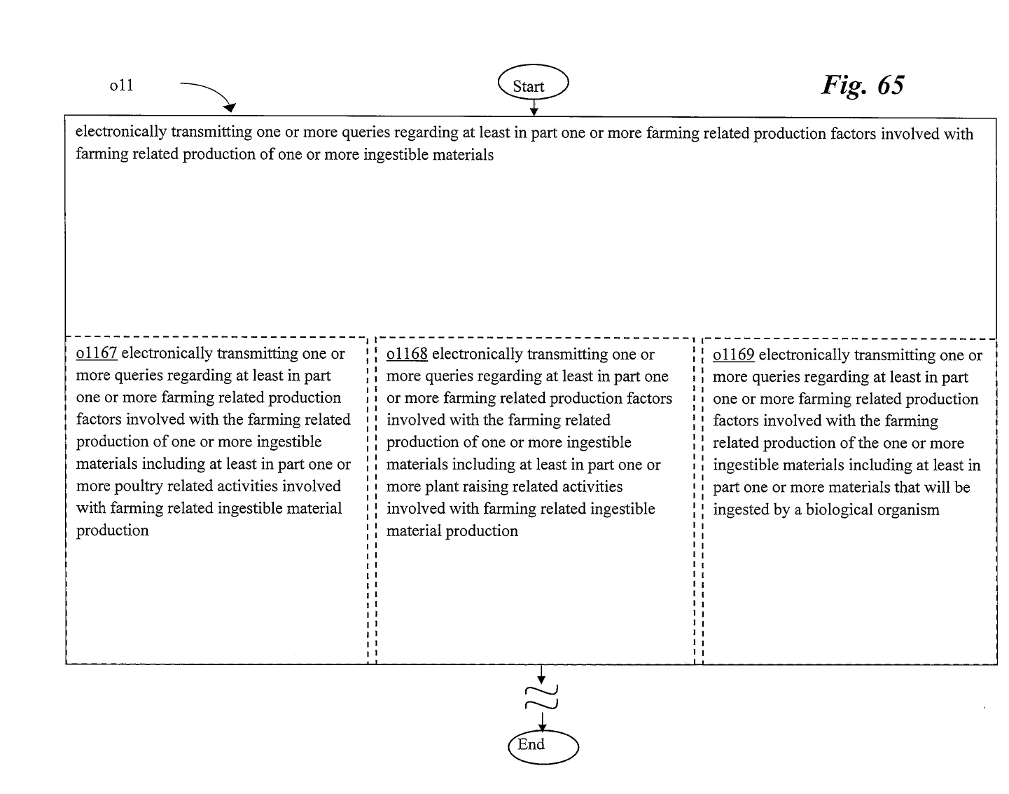

In one or more implementations, as shown in FIG. 65, operation o11 includes an operation o1167 for electronically transmitting one or more queries regarding at least in part one or more farming related production factors involved with the farming related production of one or more ingestible materials including at least in part one or more poultry related activities involved with farming related ingestible material production. Origination of an illustratively derived transmitting queries poultry component group can be accomplished through skilled in the art design choice selection of one or more of the above depicted components from one or more of the above depicted subsystems shown in FIG. 12. Components from the transmitting queries poultry component group can be used in implementing execution of the one or more transmitting queries poultry instructions i1167 of FIG. 31, can be used in performance of the transmitting queries poultry electrical circuitry arrangement e1167 of FIG. 24, and/or can be used in otherwise fulfillment of the operation o1167. An exemplary non-transitory signal bearing medium version of the information storage subsystem s200 is depicted in FIG. 31 as bearing the one or more transmitting queries poultry instructions i1167 that when executed will direct performance of the operation o1167. Furthermore, the transmitting queries poultry electrical circuitry arrangement (“elec circ arrange”) e1167, when activated, will perform the operation o1167. Also, the transmitting queries poultry module m1167, when executed and/or activated, will direct performance of and/or perform the operation o1167. For instance, in one or more exemplary implementations, the one or more transmitting queries poultry instructions i1167, when executed, direct performance of the operation o1167 in the illustrative depiction as follows, and/or the transmitting queries poultry electrical circuitry arrangement e1167, when activated, performs the operation o1167 in the illustrative depiction as follows, and/or the transmitting queries poultry module m1167, when executed and/or activated, directs performance of and/or performs the operation o1167 in the illustrative depiction as follows, and/or the operation o1167 is otherwise carried out in the illustrative depiction as follows: electronically transmitting (e.g. cellphone entry, etc.) one or more queries (e.g. irrigation, etc.) regarding at least in part (e.g. absorbed by, etc.) one or more farming related production factors (e.g. bee pollination schedule, etc.) involved with (e.g. absorbed by, etc.) the farming related production of (e.g. duck egg laying, etc.) one or more ingestible materials (e.g. goat cheese, etc.) including at least in part one or more poultry related activities involved with farming related ingestible material production (e.g. duck egg laying, etc.).

In one or more implementations, as shown in FIG. 65, operation o11 includes an operation o1168 for electronically transmitting one or more queries regarding at least in part one or more farming related production factors involved with the farming related production of one or more ingestible materials including at least in part one or more plant raising related activities involved with farming related ingestible material production. Origination of an illustratively derived transmitting queries raising component group can be accomplished through skilled in the art design choice selection of one or more of the above depicted components from one or more of the above depicted subsystems shown in FIG. 12. Components from the transmitting queries raising component group can be used in implementing execution of the one or more transmitting queries raising instructions i1168 of FIG. 31, can be used in performance of the transmitting queries raising electrical circuitry arrangement e1168 of FIG. 24, and/or can be used in otherwise fulfillment of the operation o1168. An exemplary non-transitory signal bearing medium version of the information storage subsystem s200 is depicted in FIG. 31 as bearing the one or more transmitting queries raising instructions i1168 that when executed will direct performance of the operation o1168. Furthermore, the transmitting queries raising electrical circuitry arrangement (“elec circ arrange”) e1168, when activated, will perform the operation o1168. Also, the transmitting queries raising module m1168, when executed and/or activated, will direct performance of and/or perform the operation o1168. For instance, in one or more exemplary implementations, the one or more transmitting queries raising instructions i1168, when executed, direct performance of the operation o1168 in the illustrative depiction as follows, and/or the transmitting queries raising electrical circuitry arrangement e1168, when activated, performs the operation o1168 in the illustrative depiction as follows, and/or the transmitting queries raising module m1168, when executed and/or activated, directs performance of and/or performs the operation o1168 in the illustrative depiction as follows, and/or the operation o1168 is otherwise carried out in the illustrative depiction as follows: electronically transmitting (e.g. satellite transmission, etc.) one or more queries (e.g. sanitized tongs, etc.) regarding at least in part (e.g. embraced, etc.) one or more farming related production factors (e.g. cost of pollination, etc.) involved with (e.g. embraced, etc.) the farming related production of (e.g. bell pepper growing, etc.) one or more ingestible materials (e.g. oyster shell, etc.) including at least in part one or more plant raising related activities involved with farming related ingestible material production (e.g. bell pepper growing, etc.).

In one or more implementations, as shown in FIG. 65, operation o11 includes an operation o1169 for electronically transmitting one or more queries regarding at least in part one or more farming related production factors involved with the farming related production of the one or more ingestible materials including at least in part one or more materials that will be ingested by a biological organism. Origination of an illustratively derived transmitting queries ingested component group can be accomplished through skilled in the art design choice selection of one or more of the above depicted components from one or more of the above depicted subsystems shown in FIG. 12. Components from the transmitting queries ingested component group can be used in implementing execution of the one or more transmitting queries ingested instructions i1169 of FIG. 31, can be used in performance of the transmitting queries ingested electrical circuitry arrangement e1169 of FIG. 24, and/or can be used in otherwise fulfillment of the operation o1169. An exemplary non-transitory signal bearing medium version of the information storage subsystem s200 is depicted in FIG. 31 as bearing the one or more transmitting queries ingested instructions i1169 that when executed will direct performance of the operation o1169. Furthermore, the transmitting queries ingested electrical circuitry arrangement (“elec circ arrange”) e1169, when activated, will perform the operation o1169. Also, the transmitting queries ingested module m1169, when executed and/or activated, will direct performance of and/or perform the operation o1169. For instance, in one or more exemplary implementations, the one or more transmitting queries ingested instructions i1169, when executed, direct performance of the operation o1169 in the illustrative depiction as follows, and/or the transmitting queries ingested electrical circuitry arrangement e1169, when activated, performs the operation o1169 in the illustrative depiction as follows, and/or the transmitting queries ingested module m1169, when executed and/or activated, directs performance of and/or performs the operation o1169 in the illustrative depiction as follows, and/or the operation o1169 is otherwise carried out in the illustrative depiction as follows: electronically transmitting (e.g. pull-based, etc.) one or more queries (e.g. DDT insecticide, etc.) regarding at least in part (e.g. contain, etc.) one or more farming related production factors (e.g. duration of pollination, etc.) involved with (e.g. contain, etc.) farming related production of (e.g. wool production, etc.) the one or more ingestible materials (e.g. barley, etc.) including at least in part one or more materials that will be ingested by a biological organism (e.g. barley, etc.).

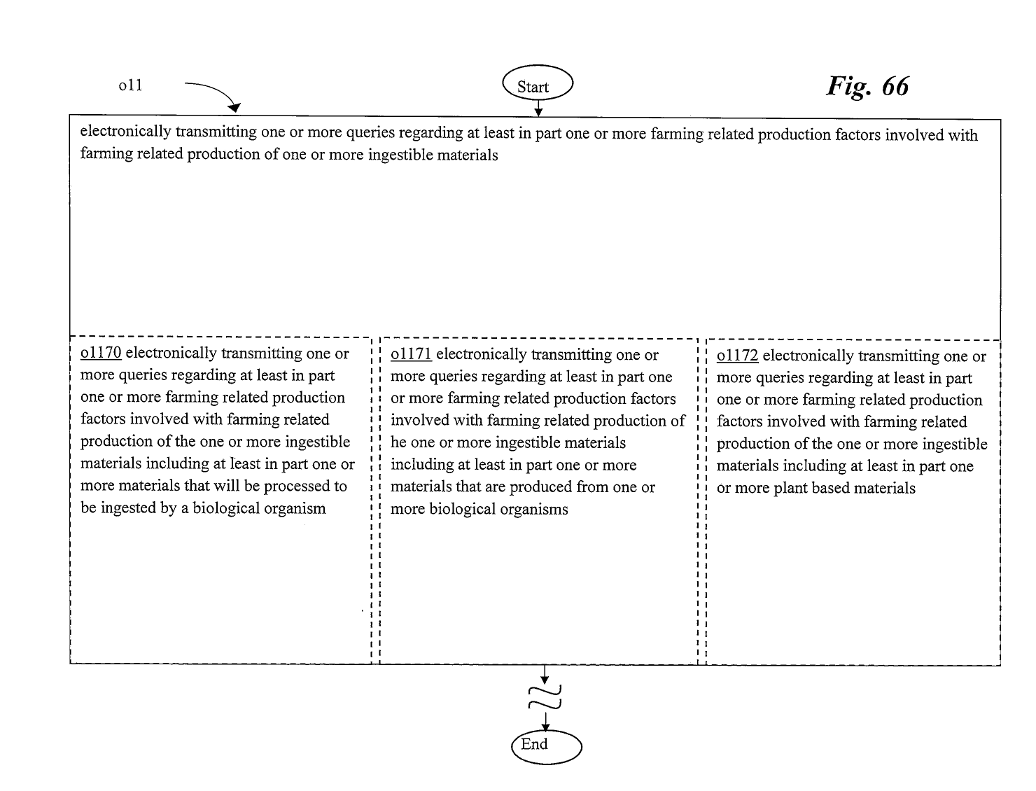

In one or more implementations, as shown in FIG. 66, operation o11 includes an operation o1170 for electronically transmitting one or more queries regarding at least in part one or more farming related production factors involved with farming related production of the one or more ingestible materials including at least in part one or more materials that will be processed to be ingested by a biological organism. Origination of an illustratively derived transmitting queries processed component group can be accomplished through skilled in the art design choice selection of one or more of the above depicted components from one or more of the above depicted subsystems shown in FIG. 12. Components from the transmitting queries processed component group can be used in implementing execution of the one or more transmitting queries processed instructions i1170 of FIG. 31, can be used in performance of the transmitting queries processed electrical circuitry arrangement e1170 of FIG. 24, and/or can be used in otherwise fulfillment of the operation o1170. An exemplary non-transitory signal bearing medium version of the information storage subsystem s200 is depicted in FIG. 31 as bearing the one or more transmitting queries processed instructions i1170 that when executed will direct performance of the operation o1170. Furthermore, the transmitting queries processed electrical circuitry arrangement (“elec circ arrange”) e1170, when activated, will perform the operation o1170. Also, the transmitting queries processed module m1170, when executed and/or activated, will direct performance of and/or perform the operation o1170. For instance, in one or more exemplary implementations, the one or more transmitting queries processed instructions i1170, when executed, direct performance of the operation o1170 in the illustrative depiction as follows, and/or the transmitting queries processed electrical circuitry arrangement e1170, when activated, performs the operation o1170 in the illustrative depiction as follows, and/or the transmitting queries processed module m1170, when executed and/or activated, directs performance of and/or performs the operation o1170 in the illustrative depiction as follows, and/or the operation o1170 is otherwise carried out in the illustrative depiction as follows: electronically transmitting (e.g. POP3 server, etc.) one or more queries (e.g. production speed, etc.) regarding at least in part (e.g. engage, etc.) one or more farming related production factors (e.g. type of pollination required, etc.) involved with (e.g. engage, etc.) farming related production of (e.g. lentil harvesting, etc.) the one or more ingestible materials (e.g. wheat, etc.) including at least in part one or more materials that will be processed to be ingested by a biological organism (e.g. wheat, etc.).

In one or more implementations, as shown in FIG. 66, operation o11 includes an operation o1171 for electronically transmitting one or more queries regarding at least in part one or more farming related production factors involved with farming related production of the one or more ingestible materials including at least in part one or more materials that are produced from one or more biological organisms. Origination of an illustratively derived transmitting queries produced component group can be accomplished through skilled in the art design choice selection of one or more of the above depicted components from one or more of the above depicted subsystems shown in FIG. 12. Components from the transmitting queries produced component group can be used in implementing execution of the one or more transmitting queries produced instructions i1171 of FIG. 31, can be used in performance of the transmitting queries produced electrical circuitry arrangement e1171 of FIG. 24, and/or can be used in otherwise fulfillment of the operation o1171. An exemplary non-transitory signal bearing medium version of the information storage subsystem s200 is depicted in FIG. 31 as bearing the one or more transmitting queries produced instructions i1171 that when executed will direct performance of the operation o1171. Furthermore, the transmitting queries produced electrical circuitry arrangement (“elec circ arrange”) e1171, when activated, will perform the operation o1171. Also, the transmitting queries produced module m1171, when executed and/or activated, will direct performance of and/or perform the operation o1171. For instance, in one or more exemplary implementations, the one or more transmitting queries produced instructions i1171, when executed, direct performance of the operation o1171 in the illustrative depiction as follows, and/or the transmitting queries produced electrical circuitry arrangement e1171, when activated, performs the operation o1171 in the illustrative depiction as follows, and/or the transmitting queries produced module m1171, when executed and/or activated, directs performance of and/or performs the operation o1171 in the illustrative depiction as follows, and/or the operation o1171 is otherwise carried out in the illustrative depiction as follows: electronically transmitting (e.g. hardware based encryption, etc.) one or more queries (e.g. labor force scheduling, etc.) regarding at least in part (e.g. engaged by, etc.) one or more farming related production factors (e.g. nutrient additive to diet, etc.) involved with (e.g. engaged by, etc.) farming related production of (e.g. flax growing, etc.) the one or more ingestible materials (e.g. bone, etc.) including at least in part one or more materials that are produced from one or more biological organisms (e.g. bone, etc.).

In one or more implementations, as shown in FIG. 66, operation o11 includes an operation o1172 for electronically transmitting one or more queries regarding at least in part one or more farming related production factors involved with farming related production of the one or more ingestible materials including at least in part one or more plant based materials. Origination of an illustratively derived transmitting queries plant based component group can be accomplished through skilled in the art design choice selection of one or more of the above depicted components from one or more of the above depicted subsystems shown in FIG. 12. Components from the transmitting queries plant based component group can be used in implementing execution of the one or more transmitting queries plant based instructions i1172 of FIG. 31, can be used in performance of the transmitting queries plant based electrical circuitry arrangement e1172 of FIG. 24, and/or can be used in otherwise fulfillment of the operation o1172. An exemplary non-transitory signal bearing medium version of the information storage subsystem s200 is depicted in FIG. 31 as bearing the one or more transmitting queries plant based instructions i1172 that when executed will direct performance of the operation o1172. Furthermore, the transmitting queries plant based electrical circuitry arrangement (“elec circ arrange”) e1172, when activated, will perform the operation o1172. Also, the transmitting queries plant based module m1172, when executed and/or activated, will direct performance of and/or perform the operation o1172. For instance, in one or more exemplary implementations, the one or more transmitting queries plant based instructions i1172, when executed, direct performance of the operation o1172 in the illustrative depiction as follows, and/or the transmitting queries plant based electrical circuitry arrangement e1172, when activated, performs the operation o1172 in the illustrative depiction as follows, and/or the transmitting queries plant based module m1172, when executed and/or activated, directs performance of and/or performs the operation o1172 in the illustrative depiction as follows, and/or the operation o1172 is otherwise carried out in the illustrative depiction as follows: electronically transmitting (e.g. software based encryption, etc.) one or more queries (e.g. future market demands, etc.) regarding at least in part (e.g. incorporate, etc.) one or more farming related production factors (e.g. feeding schedule, etc.) involved with (e.g. incorporate, etc.) farming related production of (e.g. squash cultivation, etc.) the one or more ingestible materials (e.g. potato, etc.) including at least in part one or more plant based materials (e.g. potato, etc.).

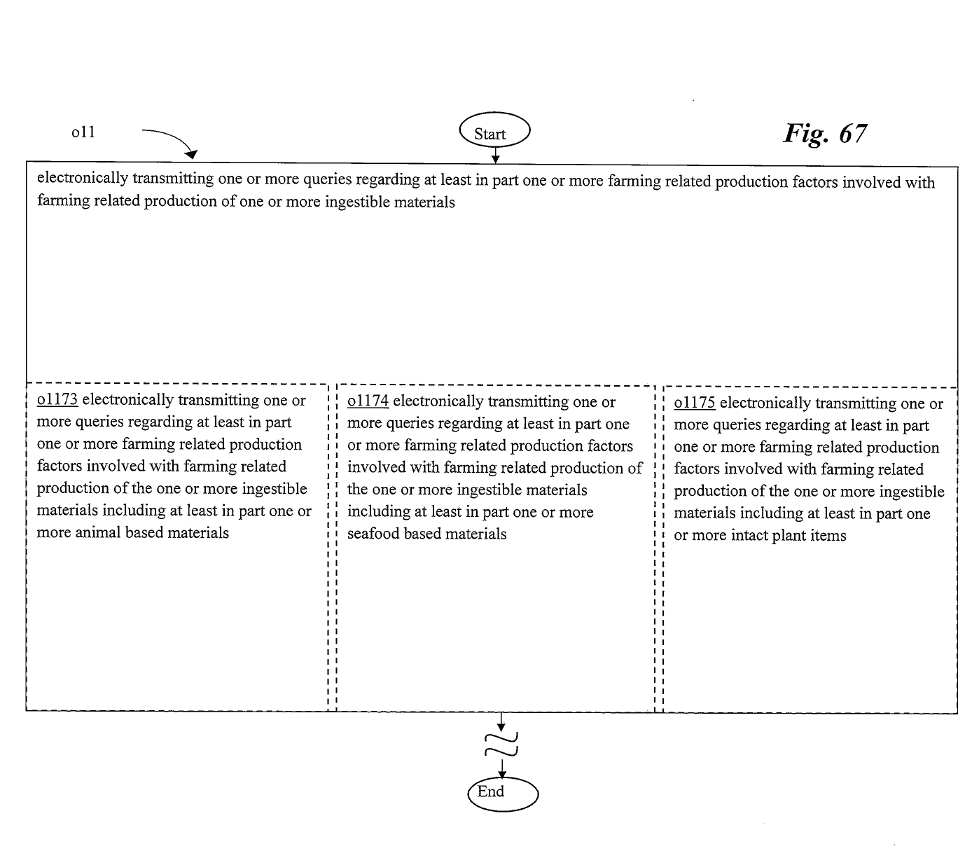

In one or more implementations, as shown in FIG. 67, operation o11 includes an operation o1173 for electronically transmitting one or more queries regarding at least in part one or more farming related production factors involved with farming related production of the one or more ingestible materials including at least in part one or more animal based materials. Origination of an illustratively derived transmitting queries animal based component group can be accomplished through skilled in the art design choice selection of one or more of the above depicted components from one or more of the above depicted subsystems shown in FIG. 12. Components from the transmitting queries animal based component group can be used in implementing execution of the one or more transmitting queries animal based instructions i1173 of FIG. 31, can be used in performance of the transmitting queries animal based electrical circuitry arrangement e1173 of FIG. 24, and/or can be used in otherwise fulfillment of the operation o1173. An exemplary non-transitory signal bearing medium version of the information storage subsystem s200 is depicted in FIG. 31 as bearing the one or more transmitting queries animal based instructions i1173 that when executed will direct performance of the operation o1173. Furthermore, the transmitting queries animal based electrical circuitry arrangement (“elec circ arrange”) e1173, when activated, will perform the operation o1173. Also, the transmitting queries animal based module m1173, when executed and/or activated, will direct performance of and/or perform the operation o1173. For instance, in one or more exemplary implementations, the one or more transmitting queries animal based instructions i1173, when executed, direct performance of the operation o1173 in the illustrative depiction as follows, and/or the transmitting queries animal based electrical circuitry arrangement e1173, when activated, performs the operation o1173 in the illustrative depiction as follows, and/or the transmitting queries animal based module m1173, when executed and/or activated, directs performance of and/or performs the operation o1173 in the illustrative depiction as follows, and/or the operation o1173 is otherwise carried out in the illustrative depiction as follows: electronically transmitting (e.g. SD card, etc.) one or more queries (e.g. improper data calculation, etc.) regarding at least in part (e.g. engross, etc.) one or more farming related production factors (e.g. lighting schedule, etc.) involved with (e.g. engross, etc.) farming related production of (e.g. grain harvesting, etc.) the one or more ingestible materials (e.g. pork meat, etc.) including at least in part one or more animal based materials (e.g. pork meat, etc.).

In one or more implementations, as shown in FIG. 67, operation o11 includes an operation o1174 for electronically transmitting one or more queries regarding at least in part one or more farming related production factors involved with farming related production of the one or more ingestible materials including at least in part one or more seafood based materials. Origination of an illustratively derived transmitting queries seafood based component group can be accomplished through skilled in the art design choice selection of one or more of the above depicted components from one or more of the above depicted subsystems shown in FIG. 12. Components from the transmitting queries seafood based component group can be used in implementing execution of the one or more transmitting queries seafood based instructions i1174 of FIG. 31, can be used in performance of the transmitting queries seafood based electrical circuitry arrangement e1174 of FIG. 24, and/or can be used in otherwise fulfillment of the operation o1174. An exemplary non-transitory signal bearing medium version of the information storage subsystem s200 is depicted in FIG. 31 as bearing the one or more transmitting queries seafood based instructions i1174 that when executed will direct performance of the operation o1174. Furthermore, the transmitting queries seafood based electrical circuitry arrangement (“elec circ arrange”) e1174, when activated, will perform the operation o1174. Also, the transmitting queries seafood based module m1174, when executed and/or activated, will direct performance of and/or perform the operation o1174. For instance, in one or more exemplary implementations, the one or more transmitting queries seafood based instructions i1174, when executed, direct performance of the operation o1174 in the illustrative depiction as follows, and/or the transmitting queries seafood based electrical circuitry arrangement e1174, when activated, performs the operation o1174 in the illustrative depiction as follows, and/or the transmitting queries seafood based module m1174, when executed and/or activated, directs performance of and/or performs the operation o1174 in the illustrative depiction as follows, and/or the operation o1174 is otherwise carried out in the illustrative depiction as follows: electronically transmitting (e.g. SIM card, etc.) one or more queries (e.g. infestation, etc.) regarding at least in part (e.g. implicated, etc.) one or more farming related production factors (e.g. invasive plant type, etc.) involved with (e.g. implicated, etc.) farming related production of (e.g. salmon fishing, etc.) one or more ingestible materials (e.g. cod fish, etc.) including at least in part one or more seafood based materials (e.g. cod fish, etc.).

In one or more implementations, as shown in FIG. 67, operation o11 includes an operation o1175 for electronically transmitting one or more queries regarding at least in part one or more farming related production factors involved with farming related production of the one or more ingestible materials including at least in part one or more intact plant items. Origination of an illustratively derived transmitting queries intact plant component group can be accomplished through skilled in the art design choice selection of one or more of the above depicted components from one or more of the above depicted subsystems shown in FIG. 12. Components from the transmitting queries intact plant component group can be used in implementing execution of the one or more transmitting queries intact plant instructions i1175 of FIG. 31, can be used in performance of the transmitting queries intact plant electrical circuitry arrangement e1175 of FIG. 24, and/or can be used in otherwise fulfillment of the operation o1175. An exemplary non-transitory signal bearing medium version of the information storage subsystem s200 is depicted in FIG. 31 as bearing the one or more transmitting queries intact plant instructions i1175 that when executed will direct performance of the operation o1175. Furthermore, the transmitting queries intact plant electrical circuitry arrangement (“elec circ arrange”) e1175, when activated, will perform the operation o1175. Also, the transmitting queries intact plant module m1175, when executed and/or activated, will direct performance of and/or perform the operation o1175. For instance, in one or more exemplary implementations, the one or more transmitting queries intact plant instructions i1175, when executed, direct performance of the operation o1175 in the illustrative depiction as follows, and/or the transmitting queries intact plant electrical circuitry arrangement e1175, when activated, performs the operation o1175 in the illustrative depiction as follows, and/or the transmitting queries intact plant module m1175, when executed and/or activated, directs performance of and/or performs the operation o1175 in the illustrative depiction as follows, and/or the operation o1175 is otherwise carried out in the illustrative depiction as follows: electronically transmitting (e.g. email, etc.) one or more queries (e.g. sanitizer usage, etc.) regarding at least in part (e.g. necessitate, etc.) one or more farming related production factors (e.g. herbicide type, etc.) involved with (e.g. necessitate, etc.) farming related production of (e.g. apple harvesting, etc.) the one or more ingestible materials (e.g. carrot, etc.) including at least in part one or more intact plant items (e.g. carrot, etc.).

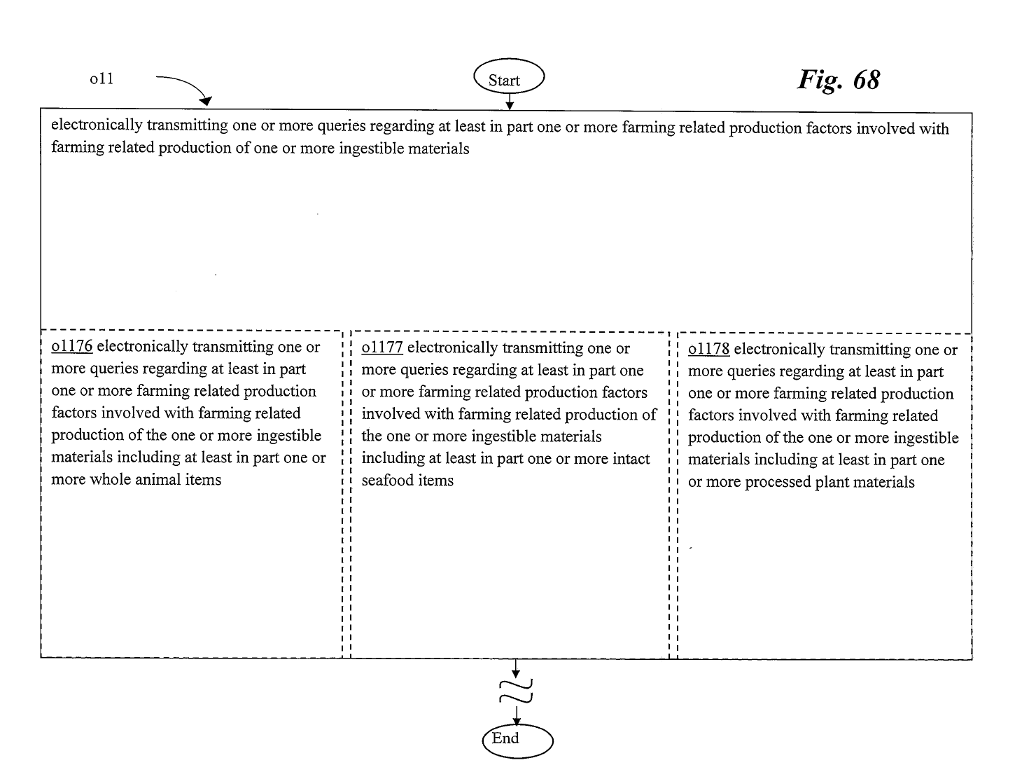

In one or more implementations, as shown in FIG. 68, operation o11 includes an operation o1176 for electronically transmitting one or more queries regarding at least in part one or more farming related production factors involved with farming related production of the one or more ingestible materials including at least in part one or more whole animal items. Origination of an illustratively derived transmitting queries whole animal component group can be accomplished through skilled in the art design choice selection of one or more of the above depicted components from one or more of the above depicted subsystems shown in FIG. 12. Components from the transmitting queries whole animal component group can be used in implementing execution of the one or more transmitting queries whole animal instructions i1176 of FIG. 31, can be used in performance of the transmitting queries whole animal electrical circuitry arrangement e1176 of FIG. 24, and/or can be used in otherwise fulfillment of the operation o1176. An exemplary non-transitory signal bearing medium version of the information storage subsystem s200 is depicted in FIG. 31 as bearing the one or more transmitting queries whole animal instructions i1176 that when executed will direct performance of the operation o1176. Furthermore, the transmitting queries whole animal electrical circuitry arrangement (“elec circ arrange”) e1176, when activated, will perform the operation o1176. Also, the transmitting queries whole animal module m1176, when executed and/or activated, will direct performance of and/or perform the operation o1176. For instance, in one or more exemplary implementations, the one or more transmitting queries whole animal instructions i1176, when executed, direct performance of the operation o1176 in the illustrative depiction as follows, and/or the transmitting queries whole animal electrical circuitry arrangement e1176, when activated, performs the operation o1176 in the illustrative depiction as follows, and/or the transmitting queries whole animal module m1176, when executed and/or activated, directs performance of and/or performs the operation o1176 in the illustrative depiction as follows, and/or the operation o1176 is otherwise carried out in the illustrative depiction as follows: electronically transmitting (e.g. peer to peer, etc.) one or more queries (e.g. mbar, etc.) regarding at least in part (e.g. presuppose, etc.) one or more farming related production factors (e.g. tide schedule, etc.) involved with (e.g. presuppose, etc.) farming related production of (e.g. wheat threshing, etc.) the one or more ingestible materials (e.g. whole chicken, etc.) including at least in part one or more whole animal items (e.g. whole chicken, etc.).

In one or more implementations, as shown in FIG. 68, operation o11 includes an operation o1177 for electronically transmitting one or more queries regarding at least in part one or more farming related production factors involved with farming related production of the one or more ingestible materials including at least in part one or more intact seafood items. Origination of an illustratively derived transmitting queries intact seafood component group can be accomplished through skilled in the art design choice selection of one or more of the above depicted components from one or more of the above depicted subsystems shown in FIG. 12. Components from the transmitting queries intact seafood component group can be used in implementing execution of the one or more transmitting queries intact seafood instructions i1177 of FIG. 31, can be used in performance of the transmitting queries intact seafood electrical circuitry arrangement e1177 of FIG. 24, and/or can be used in otherwise fulfillment of the operation o1177. An exemplary non-transitory signal bearing medium version of the information storage subsystem s200 is depicted in FIG. 31 as bearing the one or more transmitting queries intact seafood instructions i1177 that when executed will direct performance of the operation o1177. Furthermore, the transmitting queries intact seafood electrical circuitry arrangement (“elec circ arrange”) e1177, when activated, will perform the operation o1177. Also, the transmitting queries intact seafood module m1177, when executed and/or activated, will direct performance of and/or perform the operation o1177. For instance, in one or more exemplary implementations, the one or more transmitting queries intact seafood instructions i1177, when executed, direct performance of the operation o1177 in the illustrative depiction as follows, and/or the transmitting queries intact seafood electrical circuitry arrangement e1177, when activated, performs the operation o1177 in the illustrative depiction as follows, and/or the transmitting queries intact seafood module m1177, when executed and/or activated, directs performance of and/or performs the operation o1177 in the illustrative depiction as follows, and/or the operation o1177 is otherwise carried out in the illustrative depiction as follows: electronically transmitting (e.g. 10-key, etc.) one or more queries (e.g. humidity, etc.) regarding at least in part (e.g. related to, etc.) one or more farming related production factors (e.g. time of sunrise, etc.) involved with (e.g. related to, etc.) farming related production of (e.g. almond harvesting, etc.) the one or more ingestible materials (e.g. whole lobster, etc.) including at least in part one or more intact seafood items (e.g. whole lobster, etc.).

In one or more implementations, as shown in FIG. 68, operation o11 includes an operation o1178 for electronically transmitting one or more queries regarding at least in part one or more farming related production factors involved with farming related production of the one or more ingestible materials including at least in part one or more processed plant materials. Origination of an illustratively derived transmitting queries processed plant component group can be accomplished through skilled in the art design choice selection of one or more of the above depicted components from one or more of the above depicted subsystems shown in FIG. 12. Components from the transmitting queries processed plant component group can be used in implementing execution of the one or more transmitting queries processed plant instructions i1178 of FIG. 31, can be used in performance of the transmitting queries processed plant electrical circuitry arrangement e1178 of FIG. 24, and/or can be used in otherwise fulfillment of the operation o1178. An exemplary non-transitory signal bearing medium version of the information storage subsystem s200 is depicted in FIG. 31 as bearing the one or more transmitting queries processed plant instructions i1178 that when executed will direct performance of the operation o1178. Furthermore, the transmitting queries processed plant electrical circuitry arrangement (“elec circ arrange”) e1178, when activated, will perform the operation o1178. Also, the transmitting queries processed plant module m1178, when executed and/or activated, will direct performance of and/or perform the operation o1178. For instance, in one or more exemplary implementations, the one or more transmitting queries processed plant instructions i1178, when executed, direct performance of the operation o1178 in the illustrative depiction as follows, and/or the transmitting queries processed plant electrical circuitry arrangement e1178, when activated, performs the operation o1178 in the illustrative depiction as follows, and/or the transmitting queries processed plant module m1178, when executed and/or activated, directs performance of and/or performs the operation o1178 in the illustrative depiction as follows, and/or the operation o1178 is otherwise carried out in the illustrative depiction as follows: electronically transmitting (e.g. USB port, etc.) one or more queries (e.g. oxygen sensor, etc.) regarding at least in part (e.g. relationship, etc.) one or more farming related production factors (e.g. gross capacity of vessel, etc.) involved with (e.g. relationship, etc.) farming related production of (e.g. cow butchering, etc.) the one or more ingestible materials (e.g. wheat flour, etc.) including at least in part one or more processed plant materials (e.g. wheat flour, etc.).

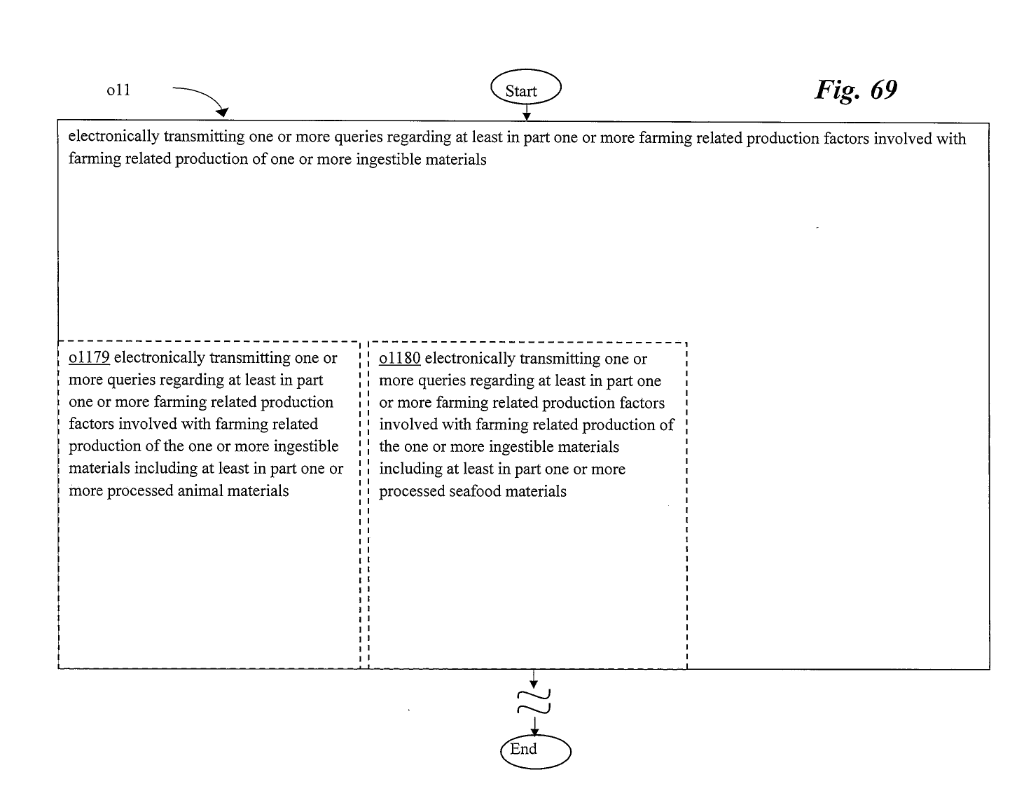

In one or more implementations, as shown in FIG. 69, operation o11 includes an operation o1179 for electronically transmitting one or more queries regarding at least in part one or more farming related production factors involved with farming related production of the one or more ingestible materials including at least in part one or more processed animal materials. Origination of an illustratively derived transmitting queries processed animal component group can be accomplished through skilled in the art design choice selection of one or more of the above depicted components from one or more of the above depicted subsystems shown in FIG. 12. Components from the transmitting queries processed animal component group can be used in implementing execution of the one or more transmitting queries processed animal instructions i1179 of FIG. 31, can be used in performance of the transmitting queries processed animal electrical circuitry arrangement e1179 of FIG. 24, and/or can be used in otherwise fulfillment of the operation o1179. An exemplary non-transitory signal bearing medium version of the information storage subsystem s200 is depicted in FIG. 31 as bearing the one or more transmitting queries processed animal instructions i1179 that when executed will direct performance of the operation o1179. Furthermore, the transmitting queries processed animal electrical circuitry arrangement (“elec circ arrange”) e1179, when activated, will perform the operation o1179. Also, the transmitting queries processed animal module m1179, when executed and/or activated, will direct performance of and/or perform the operation o1179. For instance, in one or more exemplary implementations, the one or more transmitting queries processed animal instructions i1179, when executed, direct performance of the operation o1179 in the illustrative depiction as follows, and/or the transmitting queries processed animal electrical circuitry arrangement e1179, when activated, performs the operation o1179 in the illustrative depiction as follows, and/or the transmitting queries processed animal module m1179, when executed and/or activated, directs performance of and/or performs the operation o1179 in the illustrative depiction as follows, and/or the operation o1179 is otherwise carried out in the illustrative depiction as follows: electronically transmitting (e.g. FTP, etc.) one or more queries (e.g. psi, etc.) regarding at least in part (e.g. suggest, etc.) one or more farming related production factors (e.g. shipping container dimensions, etc.) involved with (e.g. suggest, etc.) farming related production of (e.g. tuna canning, etc.) the one or more ingestible materials (e.g. ground beef, etc.) including at least in part one or more processed animal materials (e.g. ground beef, etc.).

In one or more implementations, as shown in FIG. 69, operation o11 includes an operation o1180 for electronically transmitting one or more queries regarding at least in part one or more farming related production factors involved with farming related production of the one or more ingestible materials including at least in part one or more processed seafood materials. Origination of an illustratively derived transmitting queries processed seafood component group can be accomplished through skilled in the art design choice selection of one or more of the above depicted components from one or more of the above depicted subsystems shown in FIG. 12. Components from the transmitting queries processed seafood component group can be used in implementing execution of the one or more transmitting queries processed seafood instructions i1180 of FIG. 32, can be used in performance of the transmitting queries processed seafood electrical circuitry arrangement e1180 of FIG. 25, and/or can be used in otherwise fulfillment of the operation o1180. An exemplary non-transitory signal bearing medium version of the information storage subsystem s200 is depicted in FIG. 32 as bearing the one or more transmitting queries processed seafood instructions i1180 that when executed will direct performance of the operation o1180. Furthermore, the transmitting queries processed seafood electrical circuitry arrangement (“elec circ arrange”) e1180, when activated, will perform the operation o1180. Also, the transmitting queries processed seafood module m1180, when executed and/or activated, will direct performance of and/or perform the operation o1180. For instance, in one or more exemplary implementations, the one or more transmitting queries processed seafood instructions i1180, when executed, direct performance of the operation o1180 in the illustrative depiction as follows, and/or the transmitting queries processed seafood electrical circuitry arrangement e1180, when activated, performs the operation o1180 in the illustrative depiction as follows, and/or the transmitting queries processed seafood module m1180, when executed and/or activated, directs performance of and/or performs the operation o1180 in the illustrative depiction as follows, and/or the operation o1180 is otherwise carried out in the illustrative depiction as follows: electronically transmitting (e.g. HTTP, etc.) one or more queries (e.g. inHg, etc.) regarding at least in part (e.g. entangle, etc.) one or more farming related production factors (e.g. cost of vessel maintenance, etc.) involved with (e.g. entangle, etc.) farming related production of (e.g. oyster harvesting, etc.) the one or more ingestible materials (e.g. filleted salmon, etc.) including at least in part one or more processed seafood materials (e.g. filleted salmon, etc.).

As shown in FIG. 42, the operational flow o10 proceeds to operation o12 for electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials. An exemplary version of a non-transitory signal bearing medium of information storage subsystem s200 is depicted as bearing one or more receiving response instructions i12 that when executed will direct performance of the operation o12. In an implementation, the one or more receiving response instructions i12 when executed direct electronically receiving (e.g. wifi, laptop entry, RFID scan, etc.) at least a portion of response information (e.g. AVI file format, MP3 file format, audio listening, etc.) regarding at least in part (e.g. associated, affected, affecting, etc.) (e.g. fuel delivery schedule, cost of fuel, record keeping methods, etc.) involved with (e.g. associated, affected, affecting, etc.) farming related production of (e.g. blueberry cultivation, raspberry harvesting, corn growing, etc.) one or more ingestible materials (e.g. feed grain, beet pulp, water, etc.) said electronically receiving logged as being subsequent to said electronically transmitting, (e.g. via database records, via computer clock, via network protocol time indicator, etc.) said response information including indication of one or more identifiers (e.g. protocol header, security data, phonetic alphabet, etc.) as being accessible through (e.g. through electromagnetic reception, through search terms, through storage retrieval, etc.) one or more tracers, (e.g. high frequency RFID, UHF emitter, ISM band emitter, etc.) and including indication of said one or more tracers (e.g. via hard drive storage, via database object information, via database table information, etc.) as being at least momentarily (e.g. shipping time from farm to restaurant, time in storage and display after unpacking, shipping time across Pacific Ocean, etc.) in physical proximity (e.g. tied to container, stamped onto container, magnetically attached to container, etc.) with said one or more ingestible materials (e.g. ground beef, lamb meat, octopus, etc.). Furthermore, the receiving response electrical circuitry arrangement e12 when activated will perform the operation o12. Also, the receiving response module m12, when executed and/or activated, will direct performance of and/or perform the operation o12. In an implementation, the receiving response electrical circuitry arrangement e12, when activated performs the operation o12 in the illustrative depiction as follows, and/or the receiving response module m12, when executed and/or activated, directs performance of and/or performs electronically receiving (e.g. wifi, laptop entry, RFID scan, etc.) at least a portion of response information (e.g. AVI file format, MP3 file format, audio listening, etc.) regarding at least in part (e.g. associated, affected, affecting, etc.) (e.g. fuel delivery schedule, cost of fuel, record keeping methods, etc.) involved with (e.g. associated, affected, affecting, etc.) farming related production of (e.g. blueberry cultivation, raspberry harvesting, corn growing, etc.) one or more ingestible materials (e.g. feed grain, beet pulp, water, etc.) said electronically receiving logged as being subsequent to said electronically transmitting, (e.g. via database records, via computer clock, via network protocol time indicator, etc.) said response information including indication of one or more identifiers (e.g. protocol header, security data, phonetic alphabet, etc.) as being accessible through (e.g. through electromagnetic reception, through search terms, through storage retrieval, etc.) one or more tracers, (e.g. high frequency RFID, UHF emitter, ISM band emitter, etc.) and including indication of said one or more tracers (e.g. via hard drive storage, via database object information, via database table information, etc.) as being at least momentarily (e.g. shipping time from farm to restaurant, time in storage and display after unpacking, shipping time across Pacific Ocean, etc.) in physical proximity (e.g. tied to container, stamped onto container, magnetically attached to container, etc.) with said one or more ingestible materials (e.g. ground beef, lamb meat, octopus, etc.). In an implementation, the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials is carried out by electronically receiving (e.g. wifi, laptop entry, RFID scan, etc.) at least a portion of response information (e.g. AVI file format, MP3 file format, audio listening, etc.) regarding at least in part (e.g. associated, affected, affecting, etc.) (e.g. fuel delivery schedule, cost of fuel, record keeping methods, etc.) involved with (e.g. associated, affected, affecting, etc.) farming related production of (e.g. blueberry cultivation, raspberry harvesting, corn growing, etc.) one or more ingestible materials (e.g. feed grain, beet pulp, water, etc.) said electronically receiving logged as being subsequent to said electronically transmitting, (e.g. via database records, via computer clock, via network protocol time indicator, etc.) said response information including indication of one or more identifiers (e.g. protocol header, security data, phonetic alphabet, etc.) as being accessible through (e.g. through electromagnetic reception, through search terms, through storage retrieval, etc.) one or more tracers, (e.g. high frequency RFID, UHF emitter, ISM band emitter, etc.) and including indication of said one or more tracers (e.g. via hard drive storage, via database object information, via database table information, etc.) as being at least momentarily (e.g. shipping time from farm to restaurant, time in storage and display after unpacking, shipping time across Pacific Ocean, etc.) in physical proximity (e.g. tied to container, stamped onto container, magnetically attached to container, etc.) with said one or more ingestible materials (e.g. ground beef, lamb meat, octopus, etc.).

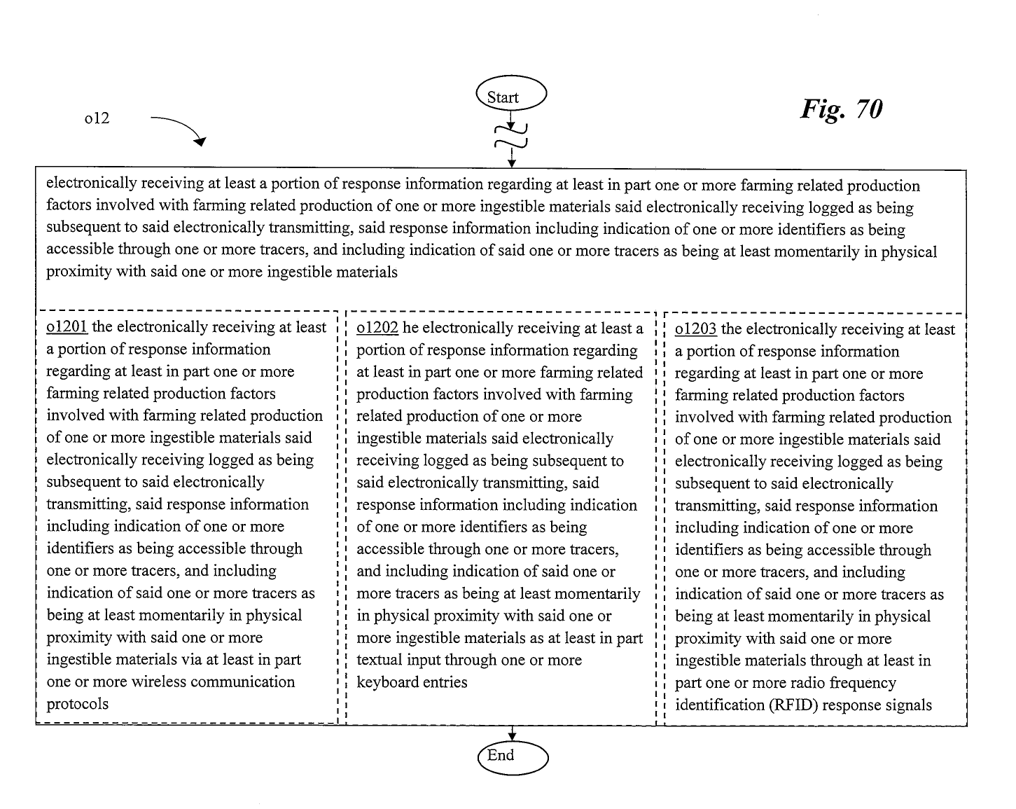

In one or more implementations, as shown in FIG. 70, operation o12 includes an operation o1201 for the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials via at least in part one or more wireless communication protocols. Origination of an illustratively derived receiving response wireless component group can be accomplished through skilled in the art design choice selection of one or more of the above depicted components from one or more of the above depicted subsystems shown in FIG. 12. Components from the receiving response wireless component group can be used in implementing execution of the one or more receiving response wireless instructions i1201 of FIG. 33, can be used in performance of the receiving response wireless electrical circuitry arrangement e1201 of FIG. 26, and/or can be used in otherwise fulfillment of the operation o1201. An exemplary non-transitory signal bearing medium version of the information storage subsystem s200 is depicted in FIG. 33 as bearing the one or more receiving response wireless instructions i1201 that when executed will direct performance of the operation o1201. Furthermore, the receiving response wireless electrical circuitry arrangement (“elec circ arrange”) e1201, when activated, will perform the operation o1201. Also, the receiving response wireless module m1201, when executed and/or activated, will direct performance of and/or perform the operation o1201. For instance, in one or more exemplary implementations, the one or more receiving response wireless instructions i1201, when executed, direct performance of the operation o1201 in the illustrative depiction as follows, and/or the receiving response wireless electrical circuitry arrangement e1201, when activated, performs the operation o1201 in the illustrative depiction as follows, and/or the receiving response wireless module m1201, when executed and/or activated, directs performance of and/or performs the operation o1201 in the illustrative depiction as follows, and/or the operation o1201 is otherwise carried out in the illustrative depiction as follows: the electronically receiving (e.g. wifi, etc.) at least a portion of response information (e.g. testing of methane presence, etc.) regarding at least in part (e.g. associated, etc.) one or more farming related production factors (e.g. fuel delivery schedule, etc.) involved with (e.g. associated, etc.) farming related production of (e.g. blueberry cultivation, etc.) one or more ingestible materials (e.g. feed grain, etc.) said electronically receiving logged as being subsequent to said electronically transmitting, (e.g. via database records, etc.) said response information including indication of one or more identifiers (e.g. protocol header, etc.) as being accessible through (e.g. through electromagnetic reception, etc.) one or more tracers, (e.g. high frequency RFID, etc.) and including indication of said one or more tracers (e.g. via hard drive storage, etc.) as being at least momentarily (e.g. shipping time from farm to restaurant, etc.) in physical proximity (e.g. tied to container, etc.) with said one or more ingestible materials (e.g. ground beef, etc.) via at least in part one or more wireless communication protocols (e.g. wifi, etc.).

In one or more implementations, as shown in FIG. 70, operation o12 includes an operation o1202 for he electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials as at least in part textual input through one or more keyboard entries. Origination of an illustratively derived receiving response keyboard component group can be accomplished through skilled in the art design choice selection of one or more of the above depicted components from one or more of the above depicted subsystems shown in FIG. 12. Components from the receiving response keyboard component group can be used in implementing execution of the one or more receiving response keyboard instructions i1202 of FIG. 33, can be used in performance of the receiving response keyboard electrical circuitry arrangement e1202 of FIG. 26, and/or can be used in otherwise fulfillment of the operation o1202. An exemplary non-transitory signal bearing medium version of the information storage subsystem s200 is depicted in FIG. 33 as bearing the one or more receiving response keyboard instructions i1202 that when executed will direct performance of the operation o1202. Furthermore, the receiving response keyboard electrical circuitry arrangement (“elec circ arrange”) e1202, when activated, will perform the operation o1202. Also, the receiving response keyboard module m1202, when executed and/or activated, will direct performance of and/or perform the operation o1202. For instance, in one or more exemplary implementations, the one or more receiving response keyboard instructions i1202, when executed, direct performance of the operation o1202 in the illustrative depiction as follows, and/or the receiving response keyboard electrical circuitry arrangement e1202, when activated, performs the operation o1202 in the illustrative depiction as follows, and/or the receiving response keyboard module m1202, when executed and/or activated, directs performance of and/or performs the operation o1202 in the illustrative depiction as follows, and/or the operation o1202 is otherwise carried out in the illustrative depiction as follows: the electronically receiving (e.g. laptop entry, etc.) at least a portion of response information (e.g. monitoring of long-term effects of calcium on alfalfa, etc.) regarding at least in part (e.g. affected, etc.) one or more farming related production factors (e.g. cost of fuel, etc.) involved with (e.g. affected, etc.) farming related production of (e.g. raspberry harvesting, etc.) one or more ingestible materials (e.g. beet pulp, etc.) said electronically receiving logged as being subsequent to said electronically transmitting, (e.g. via computer clock, etc.) said response information including indication of one or more identifiers (e.g. security data, etc.) as being accessible through (e.g. through search terms, etc.) one or more tracers, (e.g. UHF emitter, etc.) and including indication of said one or more tracers (e.g. via database object information, etc.) as being at least momentarily (e.g. time in storage and display after unpacking, etc.) in physical proximity (e.g. stamped onto container, etc.) with said one or more ingestible materials (e.g. lamb meat, etc.) as at least in part textual input through one or more keyboard entries (e.g. laptop entry, etc.).

In one or more implementations, as shown in FIG. 70, operation o12 includes an operation o1203 for the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials through at least in part one or more radio frequency identification (RFID) response signals. Origination of an illustratively derived receiving response RFID component group can be accomplished through skilled in the art design choice selection of one or more of the above depicted components from one or more of the above depicted subsystems shown in FIG. 12. Components from the receiving response RFID component group can be used in implementing execution of the one or more receiving response RFID instructions i1203 of FIG. 33, can be used in performance of the receiving response RFID electrical circuitry arrangement e1203 of FIG. 26, and/or can be used in otherwise fulfillment of the operation o1203. An exemplary non-transitory signal bearing medium version of the information storage subsystem s200 is depicted in FIG. 33 as bearing the one or more receiving response RFID instructions i1203 that when executed will direct performance of the operation o1203. Furthermore, the receiving response RFID electrical circuitry arrangement (“elec circ arrange”) e1203, when activated, will perform the operation o1203. Also, the receiving response RFID module m1203, when executed and/or activated, will direct performance of and/or perform the operation o1203. For instance, in one or more exemplary implementations, the one or more receiving response RFID instructions i1203, when executed, direct performance of the operation o1203 in the illustrative depiction as follows, and/or the receiving response RFID electrical circuitry arrangement e1203, when activated, performs the operation o1203 in the illustrative depiction as follows, and/or the receiving response RFID module m1203, when executed and/or activated, directs performance of and/or performs the operation o1203 in the illustrative depiction as follows, and/or the operation o1203 is otherwise carried out in the illustrative depiction as follows: the electronically receiving (e.g. RFID scan, etc.) at least a portion of response information (e.g. testing of polyphenol levels in grape seed, etc.) regarding at least in part (e.g. affecting, etc.) one or more farming related production factors (e.g. record keeping methods, etc.) involved with (e.g. affecting, etc.) farming related production of (e.g. corn growing, etc.) one or more ingestible materials (e.g. water, etc.) said electronically receiving logged as being subsequent to said electronically transmitting, (e.g. via network protocol time indicator, etc.) said response information including indication of one or more identifiers (e.g. phonetic alphabet, etc.) as being accessible through (e.g. through storage retrieval, etc.) one or more tracers, (e.g. ISM band emitter, etc.) and including indication of said one or more tracers (e.g. via database table information, etc.) as being at least momentarily (e.g. shipping time across Pacific Ocean, etc.) in physical proximity (e.g. magnetically attached to container, etc.) with said one or more ingestible materials (e.g. octopus, etc.) through at least in part one or more radio frequency identification (RFID) response signals (e.g. RFID scan, etc.).

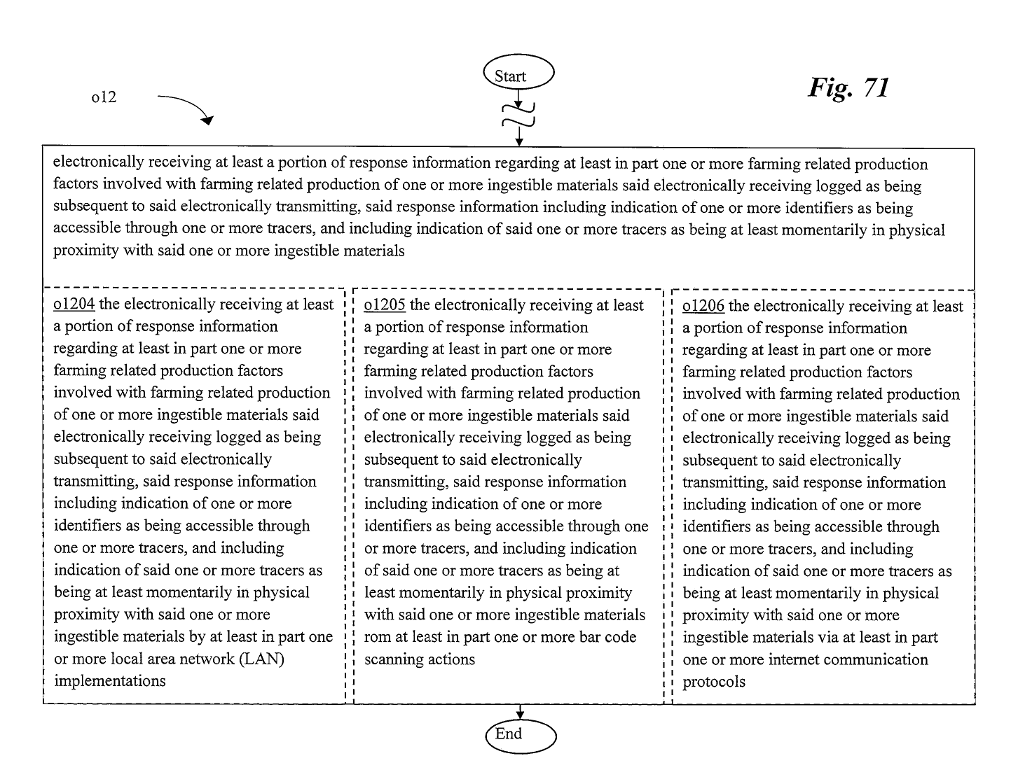

In one or more implementations, as shown in FIG. 71, operation o12 includes an operation o1204 for the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials by at least in part one or more local area network (LAN) implementations. Origination of an illustratively derived receiving response LAN component group can be accomplished through skilled in the art design choice selection of one or more of the above depicted components from one or more of the above depicted subsystems shown in FIG. 12. Components from the receiving response LAN component group can be used in implementing execution of the one or more receiving response LAN instructions i1204 of FIG. 33, can be used in performance of the receiving response LAN electrical circuitry arrangement e1204 of FIG. 26, and/or can be used in otherwise fulfillment of the operation o1204. An exemplary non-transitory signal bearing medium version of the information storage subsystem s200 is depicted in FIG. 33 as bearing the one or more receiving response LAN instructions i1204 that when executed will direct performance of the operation o1204. Furthermore, the receiving response LAN electrical circuitry arrangement (“elec circ arrange”) e1204, when activated, will perform the operation o1204. Also, the receiving response LAN module m1204, when executed and/or activated, will direct performance of and/or perform the operation o1204. For instance, in one or more exemplary implementations, the one or more receiving response LAN instructions i1204, when executed, direct performance of the operation o1204 in the illustrative depiction as follows, and/or the receiving response LAN electrical circuitry arrangement e1204, when activated, performs the operation o1204 in the illustrative depiction as follows, and/or the receiving response LAN module m1204, when executed and/or activated, directs performance of and/or performs the operation o1204 in the illustrative depiction as follows, and/or the operation o1204 is otherwise carried out in the illustrative depiction as follows: the electronically receiving (e.g. ethernet, etc.) at least a portion of response information (e.g. monitoring of glycosylation of plant matter, etc.) regarding at least in part (e.g. argue, etc.) one or more farming related production factors (e.g. ethernet, etc.) involved with (e.g. argue, etc.) farming related production of (e.g. ethernet, etc.) one or more ingestible materials (e.g. ethernet, etc.) said electronically receiving logged as being subsequent to said electronically transmitting, (e.g. via server clock, etc.) said response information including indication of one or more identifiers (e.g. Arabic alphabet, etc.) as being accessible through (e.g. through barcode scanning, etc.) one or more tracers, (e.g. microwave emitter, etc.) and including indication of said one or more tracers (e.g. via index information, etc.) as being at least momentarily (e.g. time in holding bay, etc.) in physical proximity (e.g. snapped onto container, etc.) with said one or more ingestible materials (e.g. domestic goose, etc.) by at least in part one or more local area network (LAN) implementations (e.g. ethernet, etc.).

In one or more implementations, as shown in FIG. 71, operation o12 includes an operation o1205 for the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials from at least in part one or more bar code scanning actions. Origination of an illustratively derived receiving response scanning component group can be accomplished through skilled in the art design choice selection of one or more of the above depicted components from one or more of the above depicted subsystems shown in FIG. 12. Components from the receiving response scanning component group can be used in implementing execution of the one or more receiving response scanning instructions i1205 of FIG. 33, can be used in performance of the receiving response scanning electrical circuitry arrangement e1205 of FIG. 26, and/or can be used in otherwise fulfillment of the operation o1205. An exemplary non-transitory signal bearing medium version of the information storage subsystem s200 is depicted in FIG. 33 as bearing the one or more receiving response scanning instructions i1205 that when executed will direct performance of the operation o1205. Furthermore, the receiving response scanning electrical circuitry arrangement (“elec circ arrange”) e1205, when activated, will perform the operation o1205. Also, the receiving response scanning module m1205, when executed and/or activated, will direct performance of and/or perform the operation o1205. For instance, in one or more exemplary implementations, the one or more receiving response scanning instructions i1205, when executed, direct performance of the operation o1205 in the illustrative depiction as follows, and/or the receiving response scanning electrical circuitry arrangement e1205, when activated, performs the operation o1205 in the illustrative depiction as follows, and/or the receiving response scanning module m1205, when executed and/or activated, directs performance of and/or performs the operation o1205 in the illustrative depiction as follows, and/or the operation o1205 is otherwise carried out in the illustrative depiction as follows: the electronically receiving (e.g. UPC scan, etc.) at least a portion of response information (e.g. monitoring effects of rhizobia inoculation, etc.) regarding at least in part (e.g. connected, etc.) one or more farming related production factors (e.g. types of fertilizers on order, etc.) involved with (e.g. connected, etc.) farming related production of (e.g. canola harvesting, etc.) one or more ingestible materials (e.g. crawling insects, etc.) said electronically receiving logged as being subsequent to said electronically transmitting, (e.g. via operating system time, etc.) said response information including indication of one or more identifiers (e.g. Morse code, etc.) as being accessible through (e.g. through radiation detection, etc.) one or more tracers, (e.g. laser ranging tracker, etc.) and including indication of said one or more tracers (e.g. via hard disk drive storage, etc.) as being at least momentarily (e.g. time held in port for inspection period, etc.) in physical proximity (e.g. stapled to container, etc.) with said one or more ingestible materials (e.g. shrimp, etc.) rom at least in part one or more bar code scanning actions (e.g. UPC scan, etc.).

In one or more implementations, as shown in FIG. 71, operation o12 includes an operation o1206 for the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials via at least in part one or more internet communication protocols. Origination of an illustratively derived receiving response internet component group can be accomplished through skilled in the art design choice selection of one or more of the above depicted components from one or more of the above depicted subsystems shown in FIG. 12. Components from the receiving response internet component group can be used in implementing execution of the one or more receiving response internet instructions i1206 of FIG. 33, can be used in performance of the receiving response internet electrical circuitry arrangement e1206 of FIG. 26, and/or can be used in otherwise fulfillment of the operation o1206. An exemplary non-transitory signal bearing medium version of the information storage subsystem s200 is depicted in FIG. 33 as bearing the one or more receiving response internet instructions i1206 that when executed will direct performance of the operation o1206. Furthermore, the receiving response internet electrical circuitry arrangement (“elec circ arrange”) e1206, when activated, will perform the operation o1206. Also, the receiving response internet module m1206, when executed and/or activated, will direct performance of and/or perform the operation o1206. For instance, in one or more exemplary implementations, the one or more receiving response internet instructions i1206, when executed, direct performance of the operation o1206 in the illustrative depiction as follows, and/or the receiving response internet electrical circuitry arrangement e1206, when activated, performs the operation o1206 in the illustrative depiction as follows, and/or the receiving response internet module m1206, when executed and/or activated, directs performance of and/or performs the operation o1206 in the illustrative depiction as follows, and/or the operation o1206 is otherwise carried out in the illustrative depiction as follows: the electronically receiving (e.g. HTML code, etc.) at least a portion of response information (e.g. monitoring cultivation management decisions, etc.) regarding at least in part (e.g. commit to, etc.) one or more farming related production factors (e.g. banned pesticides, etc.) involved with (e.g. commit to, etc.) farming related production of (e.g. cherry picking, etc.) one or more ingestible materials (e.g. parsnip, etc.) said electronically receiving logged as being subsequent to said electronically transmitting, (e.g. indicating electronically receiving sent as response to electronically transmitting, etc.) said response information including indication of one or more identifiers (e.g. binary sequence, etc.) as being accessible through (e.g. through isotope identification, etc.) one or more tracers, (e.g. ultrasonic emitter, etc.) and including indication of said one or more tracers (e.g. via digital linear tape storage, etc.) as being at least momentarily (e.g. time on train between two terminals, etc.) in physical proximity (e.g. bolted to container, etc.) with said one or more ingestible materials (e.g. sturgeon eggs, etc.) via at least in part one or more internet communication protocols (e.g. HTML code, etc.).

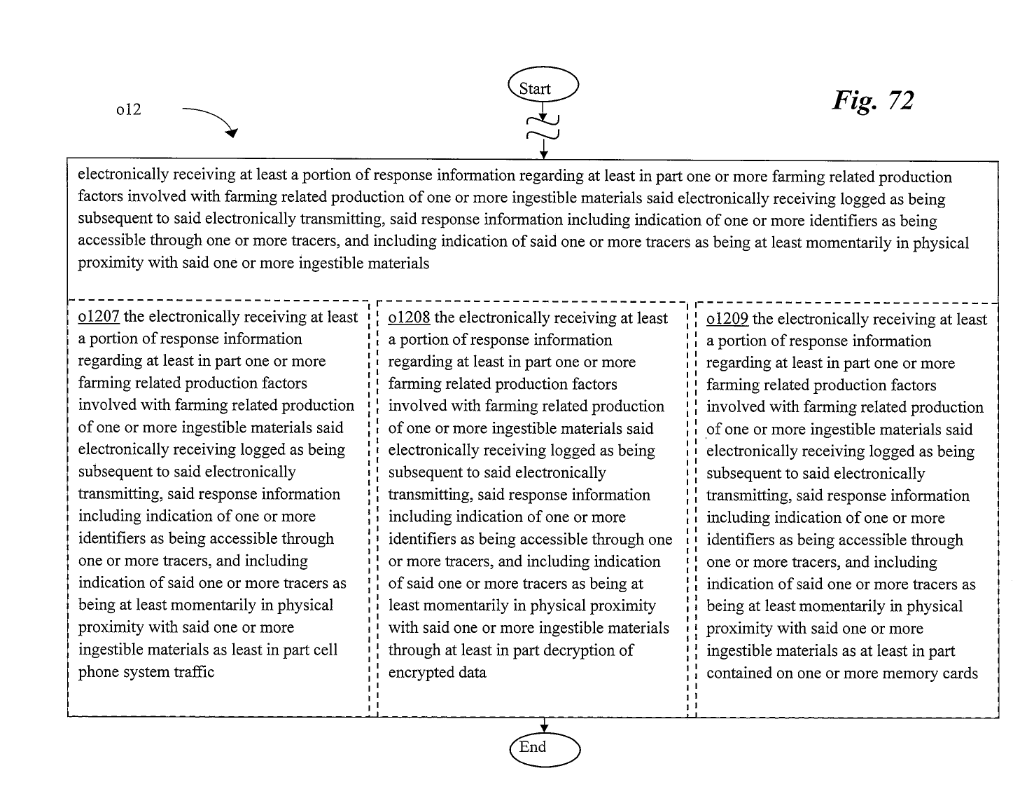

In one or more implementations, as shown in FIG. 72, operation o12 includes an operation o1207 for the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials as least in part cell phone system traffic. Origination of an illustratively derived receiving response cell component group can be accomplished through skilled in the art design choice selection of one or more of the above depicted components from one or more of the above depicted subsystems shown in FIG. 12. Components from the receiving response cell component group can be used in implementing execution of the one or more receiving response cell instructions i1207 of FIG. 33, can be used in performance of the receiving response cell electrical circuitry arrangement e1207 of FIG. 26, and/or can be used in otherwise fulfillment of the operation o1207. An exemplary non-transitory signal bearing medium version of the information storage subsystem s200 is depicted in FIG. 33 as bearing the one or more receiving response cell instructions i1207 that when executed will direct performance of the operation o1207. Furthermore, the receiving response cell electrical circuitry arrangement (“elec circ arrange”) e1207, when activated, will perform the operation o1207. Also, the receiving response cell module m1207, when executed and/or activated, will direct performance of and/or perform the operation o1207. For instance, in one or more exemplary implementations, the one or more receiving response cell instructions i1207, when executed, direct performance of the operation o1207 in the illustrative depiction as follows, and/or the receiving response cell electrical circuitry arrangement e1207, when activated, performs the operation o1207 in the illustrative depiction as follows, and/or the receiving response cell module m1207, when executed and/or activated, directs performance of and/or performs the operation o1207 in the illustrative depiction as follows, and/or the operation o1207 is otherwise carried out in the illustrative depiction as follows: the electronically receiving (e.g. MMS, etc.) at least a portion of response information (e.g. testing boron levels, etc.) regarding at least in part (e.g. absorbed by, etc.) one or more farming related production factors (e.g. amount of historical rainfall, etc.) involved with (e.g. absorbed by, etc.) farming related production of (e.g. peach picking, etc.) one or more ingestible materials (e.g. chicken feathers, etc.) said electronically receiving logged as being subsequent to said electronically transmitting, (e.g. via textual input, etc.) said response information including indication of one or more identifiers (e.g. ASCII string, etc.) as being accessible through (e.g. through beacon signal reception, etc.) one or more tracers, (e.g. gyroscope, etc.) and including indication of said one or more tracers (e.g. via CD-ROM storage, etc.) as being at least momentarily (e.g. partial time spent on retail display, etc.) in physical proximity (e.g. microwave emitter, etc.) with said one or more ingestible materials (e.g. feed grain, etc.) as least in part cell phone system traffic (e.g. MMS, etc.).

In one or more implementations, as shown in FIG. 72, operation o12 includes an operation o1208 for the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials through at least in part decryption of encrypted data. Origination of an illustratively derived receiving response decrypted component group can be accomplished through skilled in the art design choice selection of one or more of the above depicted components from one or more of the above depicted subsystems shown in FIG. 12. Components from the receiving response decrypted component group can be used in implementing execution of the one or more receiving response decrypted instructions i1208 of FIG. 33, can be used in performance of the receiving response decrypted electrical circuitry arrangement e1208 of FIG. 26, and/or can be used in otherwise fulfillment of the operation o1208. An exemplary non-transitory signal bearing medium version of the information storage subsystem s200 is depicted in FIG. 33 as bearing the one or more receiving response decrypted instructions i1208 that when executed will direct performance of the operation o1208. Furthermore, the receiving response decrypted electrical circuitry arrangement (“elec circ arrange”) e1208, when activated, will perform the operation o1208. Also, the receiving response decrypted module m1208, when executed and/or activated, will direct performance of and/or perform the operation o1208. For instance, in one or more exemplary implementations, the one or more receiving response decrypted instructions i1208, when executed, direct performance of the operation o1208 in the illustrative depiction as follows, and/or the receiving response decrypted electrical circuitry arrangement e1208, when activated, performs the operation o1208 in the illustrative depiction as follows, and/or the receiving response decrypted module m1208, when executed and/or activated, directs performance of and/or performs the operation o1208 in the illustrative depiction as follows, and/or the operation o1208 is otherwise carried out in the illustrative depiction as follows: the electronically receiving (e.g. 256-bit AES, etc.) at least a portion of response information (e.g. testing for presence of bovine spongiform encephalopathy, etc.) regarding at least in part (e.g. embraced by, etc.) one or more farming related production factors (e.g. amount of predicted rainfall, etc.) involved with (e.g. embraced by, etc.) farming related production of (e.g. chicken egg laying, etc.) one or more ingestible materials (e.g. hoofs, etc.) said electronically receiving logged as being subsequent to said electronically transmitting, (e.g. via audio input, etc.) said response information including indication of one or more identifiers (e.g. alpha-numeric, etc.) as being accessible through (e.g. through image scanning, etc.) one or more tracers, (e.g. inertial sensor, etc.) and including indication of said one or more tracers (e.g. via flat database, etc.) as being at least momentarily (e.g. time spent in laboratory for testing, etc.) in physical proximity (e.g. embossed on material, etc.) with said one or more ingestible materials (e.g. whole king crab, etc.) through at least in part decryption of encrypted data (e.g. 256-bit AES, etc.).

In one or more implementations, as shown in FIG. 72, operation o12 includes an operation o1209 for the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials as at least in part contained on one or more memory cards. Origination of an illustratively derived receiving response memory component group can be accomplished through skilled in the art design choice selection of one or more of the above depicted components from one or more of the above depicted subsystems shown in FIG. 12. Components from the receiving response memory component group can be used in implementing execution of the one or more receiving response memory instructions i1209 of FIG. 33, can be used in performance of the receiving response memory electrical circuitry arrangement e1209 of FIG. 26, and/or can be used in otherwise fulfillment of the operation o1209. An exemplary non-transitory signal bearing medium version of the information storage subsystem s200 is depicted in FIG. 33 as bearing the one or more receiving response memory instructions i1209 that when executed will direct performance of the operation o1209. Furthermore, the receiving response memory electrical circuitry arrangement (“elec circ arrange”) e1209, when activated, will perform the operation o1209. Also, the receiving response memory module m1209, when executed and/or activated, will direct performance of and/or perform the operation o1209. For instance, in one or more exemplary implementations, the one or more receiving response memory instructions i1209, when executed, direct performance of the operation o1209 in the illustrative depiction as follows, and/or the receiving response memory electrical circuitry arrangement e1209, when activated, performs the operation o1209 in the illustrative depiction as follows, and/or the receiving response memory module m1209, when executed and/or activated, directs performance of and/or performs the operation o1209 in the illustrative depiction as follows, and/or the operation o1209 is otherwise carried out in the illustrative depiction as follows: the electronically receiving (e.g. compact flash, etc.) at least a portion of response information (e.g. monitoring root depth, etc.) regarding at least in part (e.g. containing, etc.) one or more farming related production factors (e.g. size of labor force, etc.) involved with (e.g. containing, etc.) farming related production of (e.g. sheep butchering, etc.) one or more ingestible materials (e.g. leather, etc.) said electronically receiving logged as being subsequent to said electronically transmitting, (e.g. via e-mail record, etc.) said response information including indication of one or more identifiers (e.g. ISO basic Latin alphabet, etc.) as being accessible through (e.g. through audio reception, etc.) one or more tracers, (e.g. accelerometer, etc.) and including indication of said one or more tracers (e.g. via database management layer, etc.) as being at least momentarily (e.g. shipping time from grocery store to home, etc.) in physical proximity (e.g. debossed on material, etc.) with said one or more ingestible materials (e.g. goat milk, etc.) as at least in part contained on one or more memory cards (e.g. compact flash, etc.).

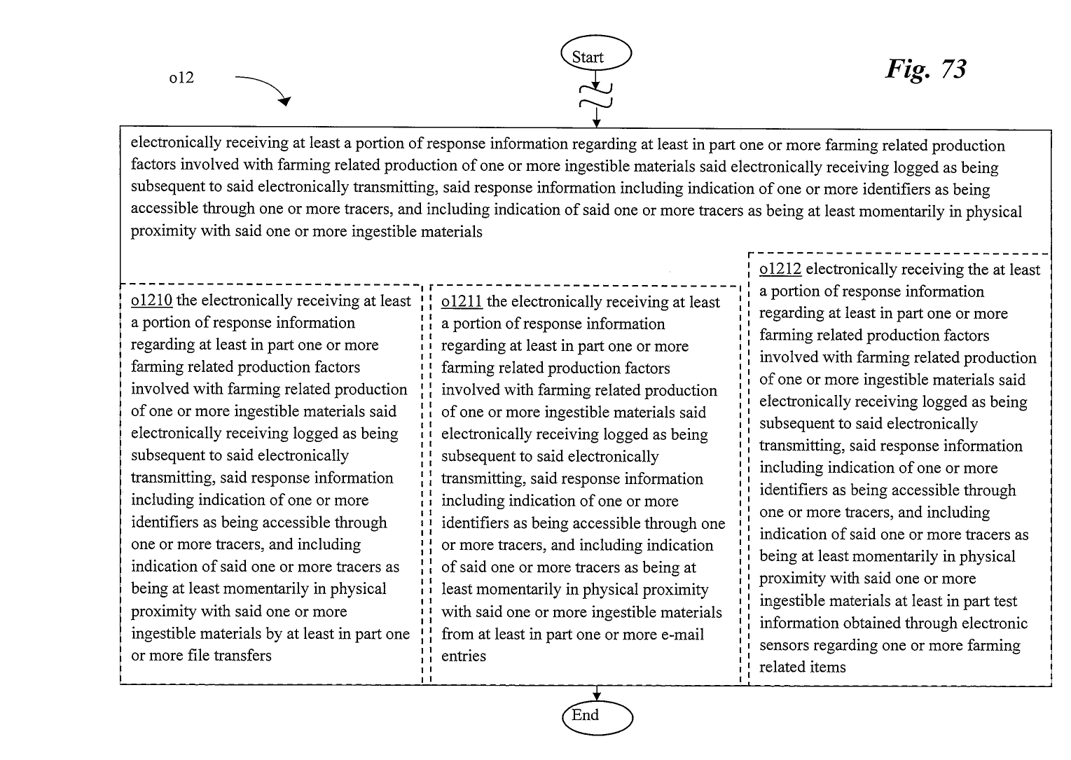

In one or more implementations, as shown in FIG. 73, operation o12 includes an operation o1210 for the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials by at least in part one or more file transfers. Origination of an illustratively derived receiving response transfers component group can be accomplished through skilled in the art design choice selection of one or more of the above depicted components from one or more of the above depicted subsystems shown in FIG. 12. Components from the receiving response transfers component group can be used in implementing execution of the one or more receiving response transfers instructions i1210 of FIG. 33, can be used in performance of the receiving response transfers electrical circuitry arrangement e1210 of FIG. 26, and/or can be used in otherwise fulfillment of the operation o1210. An exemplary non-transitory signal bearing medium version of the information storage subsystem s200 is depicted in FIG. 33 as bearing the one or more receiving response transfers instructions i1210 that when executed will direct performance of the operation o1210. Furthermore, the receiving response transfers electrical circuitry arrangement (“elec circ arrange”) e1210, when activated, will perform the operation o1210. Also, the receiving response transfers module m1210, when executed and/or activated, will direct performance of and/or perform the operation o1210. For instance, in one or more exemplary implementations, the one or more receiving response transfers instructions i1210, when executed, direct performance of the operation o1210 in the illustrative depiction as follows, and/or the receiving response transfers electrical circuitry arrangement e1210, when activated, performs the operation o1210 in the illustrative depiction as follows, and/or the receiving response transfers module m1210, when executed and/or activated, directs performance of and/or performs the operation o1210 in the illustrative depiction as follows, and/or the operation o1210 is otherwise carried out in the illustrative depiction as follows: the electronically receiving (e.g. push-based, etc.) at least a portion of response information monitoring (e.g. UV index, etc.) regarding at least in part engaging, etc.) one or more farming related production factors (e.g. cost of labor, etc.) involved with (e.g. engaging, etc.) farming related production of clam digging, etc.) one or more ingestible materials fur, etc.) said electronically receiving logged as being subsequent to said electronically transmitting, via communication time codes, etc.) said response information including indication of one or more identifiers symmetrically encrypted data packet, etc.) as being accessible through visual identification, etc.) one or more tracers, phase difference sensor, etc.) and including indication of said one or more tracers via relational database, etc.) as being at least momentarily (e.g. portion of time spent in ice bath, etc.) in physical proximity embossed on container, etc.) with said one or more ingestible materials cow liver by at least in part one or more file transfers (e.g. push-based, etc.).

In one or more implementations, as shown in FIG. 73, operation o12 includes an operation o1211 for the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials from at least in part one or more e-mail entries. Origination of an illustratively derived receiving response e-mail component group can be accomplished through skilled in the art design choice selection of one or more of the above depicted components from one or more of the above depicted subsystems shown in FIG. 12. Components from the receiving response e-mail component group can be used in implementing execution of the one or more receiving response e-mail instructions i1211 of FIG. 33, can be used in performance of the receiving response e-mail electrical circuitry arrangement e1211 of FIG. 26, and/or can be used in otherwise fulfillment of the operation o1211. An exemplary non-transitory signal bearing medium version of the information storage subsystem s200 is depicted in FIG. 33 as bearing the one or more receiving response e-mail instructions i1211 that when executed will direct performance of the operation o1211. Furthermore, the receiving response e-mail electrical circuitry arrangement (“elec circ arrange”) e1211, when activated, will perform the operation o1211. Also, the receiving response e-mail module m1211, when executed and/or activated, will direct performance of and/or perform the operation o1211. For instance, in one or more exemplary implementations, the one or more receiving response e-mail instructions i1211, when executed, direct performance of the operation o1211 in the illustrative depiction as follows, and/or the receiving response e-mail electrical circuitry arrangement e1211, when activated, performs the operation o1211 in the illustrative depiction as follows, and/or the receiving response e-mail module m1211, when executed and/or activated, directs performance of and/or performs the operation o1211 in the illustrative depiction as follows, and/or the operation o1211 is otherwise carried out in the illustrative depiction as follows: the electronically receiving (e.g. SMTP server, etc.) at least a portion of response information (e.g. testing pecan levels in plant matter, etc.) regarding at least in part (e.g. engaged by, etc.) one or more farming related production factors (e.g. cost of shipping, etc.) involved with (e.g. engaged by, etc.) farming related production of (e.g. crab trapping, etc.) one or more ingestible materials (e.g. wool, etc.) said electronically receiving logged as being subsequent to said electronically transmitting, (e.g. as being immediately thereafter, etc.) said response information including indication of one or more identifiers (e.g. serial number, etc.) as being accessible through (e.g. through light reception, etc.) one or more tracers, (e.g. magnetic field sensor, etc.) and including indication of said one or more tracers (e.g. via hard drive storage, etc.) as being at least momentarily (e.g. time spent exposed to air before packaging, etc.) in physical proximity (e.g. debossed on container, etc.) with said one or more ingestible materials (e.g. squid, etc.) from at least in part one or more e-mail entries (e.g. SMTP server, etc.).

In one or more implementations, as shown in FIG. 73, operation o12 includes an operation o1212 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part test information obtained through electronic sensors regarding one or more farming related items. Origination of an illustratively derived receiving response sensors component group can be accomplished through skilled in the art design choice selection of one or more of the above depicted components from one or more of the above depicted subsystems shown in FIG. 12. Components from the receiving response sensors component group can be used in implementing execution of the one or more receiving response sensors instructions i1212 of FIG. 33, can be used in performance of the receiving response sensors electrical circuitry arrangement e1212 of FIG. 26, and/or can be used in otherwise fulfillment of the operation o1212. An exemplary non-transitory signal bearing medium version of the information storage subsystem s200 is depicted in FIG. 33 as bearing the one or more receiving response sensors instructions i1212 that when executed will direct performance of the operation o1212. Furthermore, the receiving response sensors electrical circuitry arrangement (“elec circ arrange”) e1212, when activated, will perform the operation o1212. Also, the receiving response sensors module m1212, when executed and/or activated, will direct performance of and/or perform the operation o1212. For instance, in one or more exemplary implementations, the one or more receiving response sensors instructions i1212, when executed, direct performance of the operation o1212 in the illustrative depiction as follows, and/or the receiving response sensors electrical circuitry arrangement e1212, when activated, performs the operation o1212 in the illustrative depiction as follows, and/or the receiving response sensors module m1212, when executed and/or activated, directs performance of and/or performs the operation o1212 in the illustrative depiction as follows, and/or the operation o1212 is otherwise carried out in the illustrative depiction as follows: electronically receiving (e.g. radio wave, etc.) the at least a portion of response information (e.g. testing nitrogen levels, etc.) regarding at least in part (e.g. incorporating, etc.) one or more farming related production factors (e.g. shipping schedule, etc.) involved with (e.g. incorporating, etc.) farming related production of (e.g. mushroom cultivation, etc.) one or more ingestible materials (e.g. whole king crab, etc.) said electronically receiving logged as being subsequent to said electronically transmitting, (e.g. as being thereafter due to server delay, etc.) said response information including indication of one or more identifiers (e.g. barcode, etc.) as being accessible through (e.g. through color spectrum identification, etc.) one or more tracers, (e.g. compass, etc.) and including indication of said one or more tracers (e.g. via database object information, etc.) as being at least momentarily (e.g. time spent in cold storage, etc.) in physical proximity (e.g. placed inside container, etc.) with said one or more ingestible materials (e.g. edible frog, etc.) at least in part test information obtained through electronic sensors regarding one or more farming related items (e.g. obtained through electronic air detectors regarding pesticide levels, etc.).

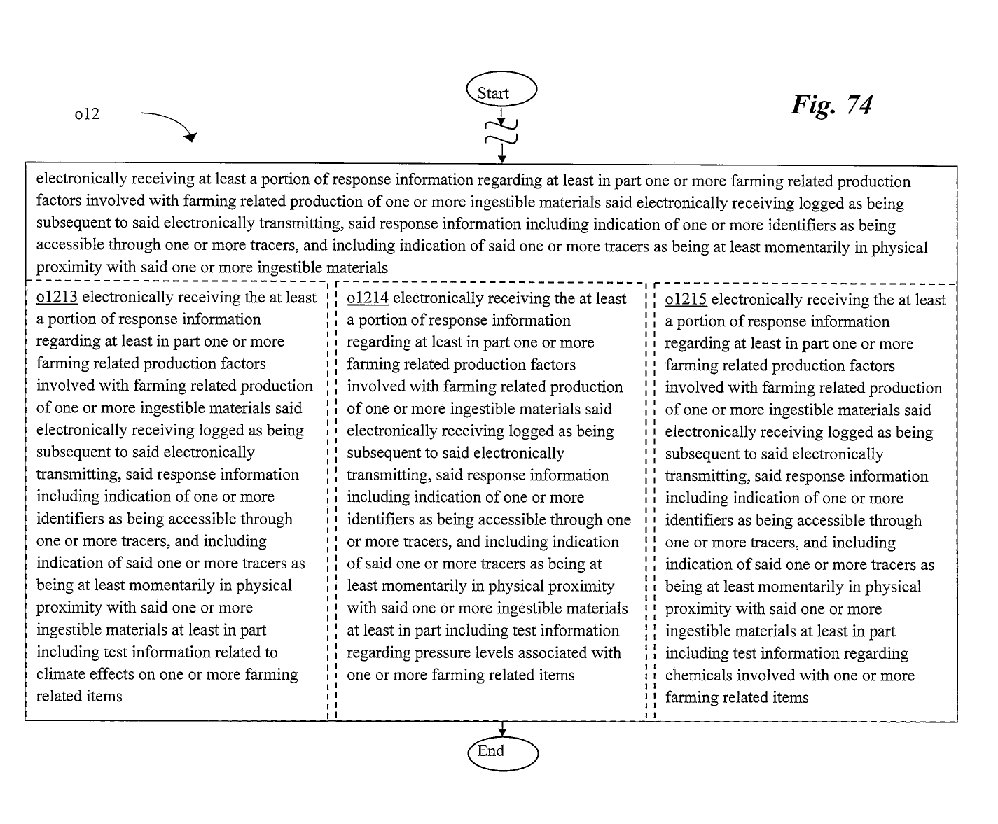

In one or more implementations, as shown in FIG. 74, operation o12 includes an operation o1213 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including test information related to climate effects on one or more farming related items. Origination of an illustratively derived receiving response climate component group can be accomplished through skilled in the art design choice selection of one or more of the above depicted components from one or more of the above depicted subsystems shown in FIG. 12. Components from the receiving response climate component group can be used in implementing execution of the one or more receiving response climate instructions i1213 of FIG. 33, can be used in performance of the receiving response climate electrical circuitry arrangement e1213 of FIG. 26, and/or can be used in otherwise fulfillment of the operation o1213. An exemplary non-transitory signal bearing medium version of the information storage subsystem s200 is depicted in FIG. 33 as bearing the one or more receiving response climate instructions i1213 that when executed will direct performance of the operation o1213. Furthermore, the receiving response climate electrical circuitry arrangement (“elec circ arrange”) e1213, when activated, will perform the operation o1213. Also, the receiving response climate module m1213, when executed and/or activated, will direct performance of and/or perform the operation o1213. For instance, in one or more exemplary implementations, the one or more receiving response climate instructions i1213, when executed, direct performance of the operation o1213 in the illustrative depiction as follows, and/or the receiving response climate electrical circuitry arrangement e1213, when activated, performs the operation o1213 in the illustrative depiction as follows, and/or the receiving response climate module m1213, when executed and/or activated, directs performance of and/or performs the operation o1213 in the illustrative depiction as follows, and/or the operation o1213 is otherwise carried out in the illustrative depiction as follows: electronically receiving (e.g. infra-red, etc.) the at least a portion of response information (e.g. monitoring rainfall, etc.) regarding at least in part (e.g. engrossing, etc.) one or more farming related production factors (e.g. known pandemic status, etc.) involved with (e.g. engrossing, etc.) farming related production of (e.g. alfalfa cutting, etc.) one or more ingestible materials (e.g. cellulose, etc.) said electronically receiving logged as being subsequent to said electronically transmitting, (e.g. as being thereafter due in part to database retrieval times, etc.) said response information including indication of one or more identifiers (e.g. kanji character set, etc.) as being accessible through (e.g. through RF reception, etc.) one or more tracers, (e.g. inclinometer, etc.) and including indication of said one or more tracers (e.g. via database table information, etc.) as being at least momentarily (e.g. time spent in flight, etc.) in physical proximity (e.g. placed inside material, etc.) with said one or more ingestible materials (e.g. venison, etc.) at least in part including test information related to climate effects on one or more farming related items (e.g. temperature profiles versus growth rates, etc.).

In one or more implementations, as shown in FIG. 74, operation o12 includes an operation o1214 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including test information regarding pressure levels associated with one or more farming related items. Origination of an illustratively derived receiving response pressure component group can be accomplished through skilled in the art design choice selection of one or more of the above depicted components from one or more of the above depicted subsystems shown in FIG. 12. Components from the receiving response pressure component group can be used in implementing execution of the one or more receiving response pressure instructions i1214 of FIG. 33, can be used in performance of the receiving response pressure electrical circuitry arrangement e1214 of FIG. 26, and/or can be used in otherwise fulfillment of the operation o1214. An exemplary non-transitory signal bearing medium version of the information storage subsystem s200 is depicted in FIG. 33 as bearing the one or more receiving response pressure instructions i1214 that when executed will direct performance of the operation o1214. Furthermore, the receiving response pressure electrical circuitry arrangement (“elec circ arrange”) e1214, when activated, will perform the operation o1214. Also, the receiving response pressure module m1214, when executed and/or activated, will direct performance of and/or perform the operation o1214. For instance, in one or more exemplary implementations, the one or more receiving response pressure instructions i1214, when executed, direct performance of the operation o1214 in the illustrative depiction as follows, and/or the receiving response pressure electrical circuitry arrangement e1214, when activated, performs the operation o1214 in the illustrative depiction as follows, and/or the receiving response pressure module m1214, when executed and/or activated, directs performance of and/or performs the operation o1214 in the illustrative depiction as follows, and/or the operation o1214 is otherwise carried out in the illustrative depiction as follows: electronically receiving (e.g. bluetooth, etc.) the at least a portion of response information (e.g. monitoring sealed carton pressure, etc.) regarding at least in part (e.g. implicate, etc.) one or more farming related production factors (e.g. market demands, etc.) involved with (e.g. implicate, etc.) farming related production of (e.g. potato harvesting, etc.) one or more ingestible materials (e.g. wood, etc.) said electronically receiving logged as being subsequent to said electronically transmitting, (e.g. due in part to application response delay, etc.) said response information including indication of one or more identifiers (e.g. matrix code, etc.) as being accessible through (e.g. through scanning, etc.) one or more tracers, (e.g. hybrid positioning system, etc.) and including indication of said one or more tracers (e.g. via ROM storage, etc.) as being at least momentarily (e.g. portion of time spent on shipping vessel, etc.) in physical proximity (e.g. enveloping material, etc.) with said one or more ingestible materials (e.g. ostrich meat, etc.) at least in part including test information regarding pressure levels associated with one or more farming related items (e.g. pressure levels of automated fruit pickers, etc.).

In one or more implementations, as shown in FIG. 74, operation o12 includes an operation o1215 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including test information regarding chemicals involved with one or more farming related items. Origination of an illustratively derived receiving response chemicals component group can be accomplished through skilled in the art design choice selection of one or more of the above depicted components from one or more of the above depicted subsystems shown in FIG. 12. Components from the receiving response chemicals component group can be used in implementing execution of the one or more receiving response chemicals instructions i1215 of FIG. 33, can be used in performance of the receiving response chemicals electrical circuitry arrangement e1215 of FIG. 26, and/or can be used in otherwise fulfillment of the operation o1215. An exemplary non-transitory signal bearing medium version of the information storage subsystem s200 is depicted in FIG. 33 as bearing the one or more receiving response chemicals instructions i1215 that when executed will direct performance of the operation o1215. Furthermore, the receiving response chemicals electrical circuitry arrangement (“elec circ arrange”) e1215, when activated, will perform the operation o1215. Also, the receiving response chemicals module m1215, when executed and/or activated, will direct performance of and/or perform the operation o1215. For instance, in one or more exemplary implementations, the one or more receiving response chemicals instructions i1215, when executed, direct performance of the operation o1215 in the illustrative depiction as follows, and/or the receiving response chemicals electrical circuitry arrangement e1215, when activated, performs the operation o1215 in the illustrative depiction as follows, and/or the receiving response chemicals module m1215, when executed and/or activated, directs performance of and/or performs the operation o1215 in the illustrative depiction as follows, and/or the operation o1215 is otherwise carried out in the illustrative depiction as follows: electronically receiving (e.g. webpage, etc.) the at least a portion of response information (e.g. testing for presence of pesticides, etc.) regarding at least in part (e.g. necessitate, etc.) one or more farming related production factors (e.g. crop disease status, etc.) involved with (e.g. necessitate, etc.) farming related production of (e.g. beet root harvesting, etc.) one or more ingestible materials (e.g. manure, etc.) said electronically receiving logged as being subsequent to said electronically transmitting, (e.g. due in part to network transmission delays, etc.) said response information including indication of one or more identifiers (e.g. SPARQCode, etc.) as being accessible through (e.g. through database query, etc.) one or more tracers, (e.g. high frequency RFID, etc.) and including indication of said one or more tracers (e.g. via floppy disk storage, etc.) as being at least momentarily (e.g. portion of time spent packaged with similar material, etc.) in physical proximity (e.g. enveloping container, etc.) with said one or more ingestible materials (e.g. beet pulp, etc.) at least in part including test information regarding chemicals involved with one or more farming related items (e.g. gasoline residue content of organic apples, etc.).

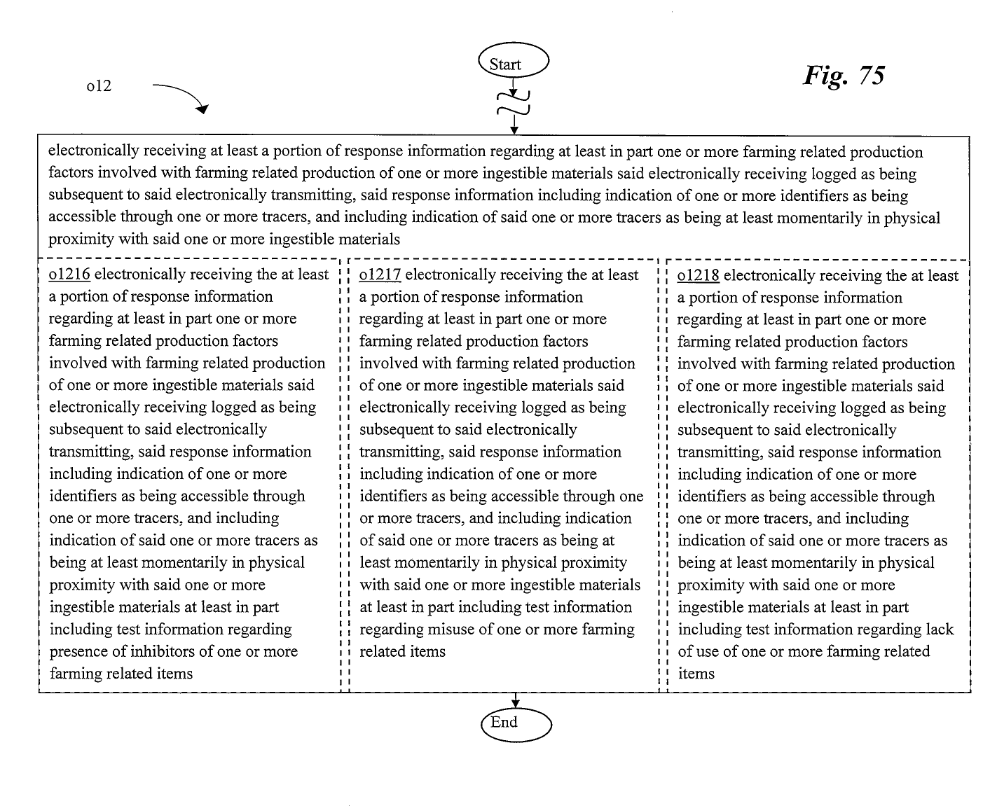

In one or more implementations, as shown in FIG. 75, operation o12 includes an operation o1216 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including test information regarding presence of inhibitors of one or more farming related items. Origination of an illustratively derived receiving response inhibitors component group can be accomplished through skilled in the art design choice selection of one or more of the above depicted components from one or more of the above depicted subsystems shown in FIG. 12. Components from the receiving response inhibitors component group can be used in implementing execution of the one or more receiving response inhibitors instructions i1216 of FIG. 33, can be used in performance of the receiving response inhibitors electrical circuitry arrangement e1216 of FIG. 26, and/or can be used in otherwise fulfillment of the operation o1216. An exemplary non-transitory signal bearing medium version of the information storage subsystem s200 is depicted in FIG. 33 as bearing the one or more receiving response inhibitors instructions i1216 that when executed will direct performance of the operation o1216. Furthermore, the receiving response inhibitors electrical circuitry arrangement (“elec circ arrange”) e1216, when activated, will perform the operation o1216. Also, the receiving response inhibitors module m1216, when executed and/or activated, will direct performance of and/or perform the operation o1216. For instance, in one or more exemplary implementations, the one or more receiving response inhibitors instructions i1216, when executed, direct performance of the operation o1216 in the illustrative depiction as follows, and/or the receiving response inhibitors electrical circuitry arrangement e1216, when activated, performs the operation o1216 in the illustrative depiction as follows, and/or the receiving response inhibitors module m1216, when executed and/or activated, directs performance of and/or performs the operation o1216 in the illustrative depiction as follows, and/or the operation o1216 is otherwise carried out in the illustrative depiction as follows: electronically receiving (e.g. website, etc.) the at least a portion of response information (e.g. testing for soil contaminants, etc.) regarding at least in part (e.g. presuppose, etc.) one or more farming related production factors (e.g. livestock fertility, etc.) involved with (e.g. presuppose, etc.) farming related production of (e.g. oat harvesting, etc.) one or more ingestible materials (e.g. ground chicken, etc.) said electronically receiving logged as being subsequent to said electronically transmitting, (e.g. via application records, etc.) said response information including indication of one or more identifiers (e.g. article number, etc.) as being accessible through (e.g. through electromagnetic reception, etc.) one or more tracers, (e.g. low frequency RFID, etc.) and including indication of said one or more tracers (e.g. via DVD-ROM storage, etc.) as being at least momentarily (e.g. shipping time from vessel to factory, etc.) in physical proximity (e.g. riveted to container, etc.) with said one or more ingestible materials (e.g. goat cheese, etc.) at least in part including test information regarding presence of inhibitors of one or more farming related items (e.g. fungus levels in peanut crops, etc.).

In one or more implementations, as shown in FIG. 75, operation o12 includes an operation o1217 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including test information regarding misuse of one or more farming related items. Origination of an illustratively derived receiving response misuse component group can be accomplished through skilled in the art design choice selection of one or more of the above depicted components from one or more of the above depicted subsystems shown in FIG. 12. Components from the receiving response misuse component group can be used in implementing execution of the one or more receiving response misuse instructions i1217 of FIG. 33, can be used in performance of the receiving response misuse electrical circuitry arrangement e1217 of FIG. 26, and/or can be used in otherwise fulfillment of the operation o1217. An exemplary non-transitory signal bearing medium version of the information storage subsystem s200 is depicted in FIG. 33 as bearing the one or more receiving response misuse instructions i1217 that when executed will direct performance of the operation o1217. Furthermore, the receiving response misuse electrical circuitry arrangement (“elec circ arrange”) e1217, when activated, will perform the operation o1217. Also, the receiving response misuse module m1217, when executed and/or activated, will direct performance of and/or perform the operation o1217. For instance, in one or more exemplary implementations, the one or more receiving response misuse instructions i1217, when executed, direct performance of the operation o1217 in the illustrative depiction as follows, and/or the receiving response misuse electrical circuitry arrangement e1217, when activated, performs the operation o1217 in the illustrative depiction as follows, and/or the receiving response misuse module m1217, when executed and/or activated, directs performance of and/or performs the operation o1217 in the illustrative depiction as follows, and/or the operation o1217 is otherwise carried out in the illustrative depiction as follows: electronically receiving (e.g. cellphone entry, etc.) the at least a portion of response information (e.g. monitoring herbicide use, etc.) regarding at least in part (e.g. related to, etc.) one or more farming related production factors (e.g. livestock breeding schedule, etc.) involved with (e.g. related to, etc.) farming related production of (e.g. carrot harvesting, etc.) one or more ingestible materials (e.g. goat milk, etc.) said electronically receiving logged as being subsequent to said electronically transmitting, (e.g. via operating system records, etc.) said response information including indication of one or more identifiers (e.g. GS1 databar, etc.) as being accessible through (e.g. through search terms, etc.) one or more tracers, (e.g. ultrasonic tracker, etc.) and including indication of said one or more tracers (e.g. via food composition database, etc.) as being at least momentarily (e.g. time spent on conveyor belt in factory, etc.) in physical proximity (e.g. burned into container, etc.) with said one or more ingestible materials (e.g. potato, etc.) at least in part including test information regarding misuse of one or more farming related items (e.g. cage time for poultry hens, etc.).

In one or more implementations, as shown in FIG. 75, operation o12 includes an operation o1218 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including test information regarding lack of use of one or more farming related items. Origination of an illustratively derived receiving response lack component group can be accomplished through skilled in the art design choice selection of one or more of the above depicted components from one or more of the above depicted subsystems shown in FIG. 12. Components from the receiving response lack component group can be used in implementing execution of the one or more receiving response lack instructions i1218 of FIG. 33, can be used in performance of the receiving response lack electrical circuitry arrangement e1218 of FIG. 26, and/or can be used in otherwise fulfillment of the operation o1218. An exemplary non-transitory signal bearing medium version of the information storage subsystem s200 is depicted in FIG. 33 as bearing the one or more receiving response lack instructions i1218 that when executed will direct performance of the operation o1218. Furthermore, the receiving response lack electrical circuitry arrangement (“elec circ arrange”) e1218, when activated, will perform the operation o1218. Also, the receiving response lack module m1218, when executed and/or activated, will direct performance of and/or perform the operation o1218. For instance, in one or more exemplary implementations, the one or more receiving response lack instructions i1218, when executed, direct performance of the operation o1218 in the illustrative depiction as follows, and/or the receiving response lack electrical circuitry arrangement e1218, when activated, performs the operation o1218 in the illustrative depiction as follows, and/or the receiving response lack module m1218, when executed and/or activated, directs performance of and/or performs the operation o1218 in the illustrative depiction as follows, and/or the operation o1218 is otherwise carried out in the illustrative depiction as follows: electronically receiving (e.g. satellite transmission, etc.) the at least a portion of response information (e.g. monitoring water availability, etc.) regarding at least in part (e.g. relationship, etc.) one or more farming related production factors (e.g. livestock slaughter schedule, etc.) involved with (e.g. relationship, etc.) farming related production of (e.g. silk production, etc.) one or more ingestible materials (e.g. goat cheese, etc.) said electronically receiving logged as being subsequent to said electronically transmitting, (e.g. via database records, etc.) said response information including indication of one or more identifiers (e.g. bokode, etc.) as being accessible through (e.g. through storage retrieval, etc.) one or more tracers, (e.g. high capacity color barcode, etc.) and including indication of said one or more tracers (e.g. via body information, etc.) as being at least momentarily (e.g. time spent unpackaged in home environment, etc.) in physical proximity (e.g. burned into material, etc.) with said one or more ingestible materials (e.g. whole lobster, etc.) at least in part including test information regarding lack of use of one or more farming related items (e.g. worm density in soil, etc.).

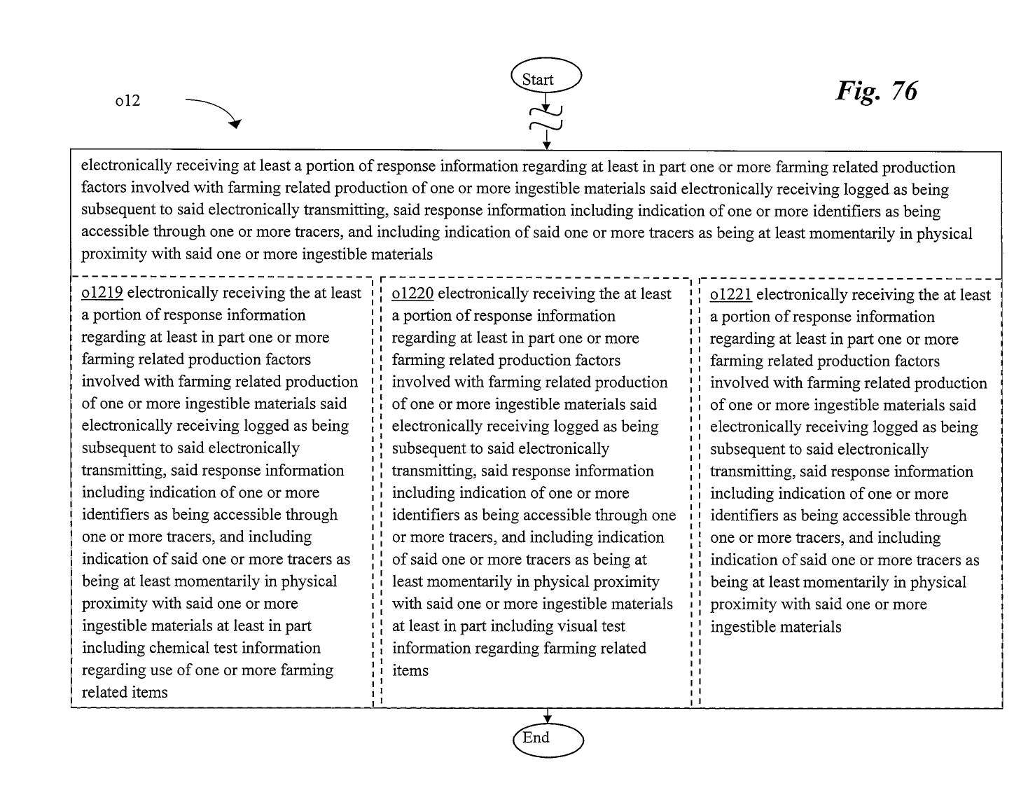

In one or more implementations, as shown in FIG. 76, operation o12 includes an operation o1219 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including chemical test information regarding use of one or more farming related items. Origination of an illustratively derived receiving response chemical test component group can be accomplished through skilled in the art design choice selection of one or more of the above depicted components from one or more of the above depicted subsystems shown in FIG. 12. Components from the receiving response chemical test component group can be used in implementing execution of the one or more receiving response chemical test instructions i1219 of FIG. 33, can be used in performance of the receiving response chemical test electrical circuitry arrangement e1219 of FIG. 26, and/or can be used in otherwise fulfillment of the operation o1219. An exemplary non-transitory signal bearing medium version of the information storage subsystem s200 is depicted in FIG. 33 as bearing the one or more receiving response chemical test instructions i1219 that when executed will direct performance of the operation o1219. Furthermore, the receiving response chemical test electrical circuitry arrangement (“elec circ arrange”) e1219, when activated, will perform the operation o1219. Also, the receiving response chemical test module m1219, when executed and/or activated, will direct performance of and/or perform the operation o1219. For instance, in one or more exemplary implementations, the one or more receiving response chemical test instructions i1219, when executed, direct performance of the operation o1219 in the illustrative depiction as follows, and/or the receiving response chemical test electrical circuitry arrangement e1219, when activated, performs the operation o1219 in the illustrative depiction as follows, and/or the receiving response chemical test module m1219, when executed and/or activated, directs performance of and/or performs the operation o1219 in the illustrative depiction as follows, and/or the operation o1219 is otherwise carried out in the illustrative depiction as follows: electronically receiving (e.g. pull-based, etc.) the at least a portion of response information (e.g. monitoring presence of fertilizer ratios in irrigation water, etc.) regarding at least in part (e.g. suggest, etc.) one or more farming related production factors (e.g. egg storage temperature, etc.) involved with (e.g. suggest, etc.) farming related production of (e.g. wool production, etc.) one or more ingestible materials (e.g. oyster shell, etc.) said electronically receiving logged as being subsequent to said electronically transmitting, (e.g. via internet communication records, etc.) said response information including indication of one or more identifiers (e.g. number, etc.) as being accessible through (e.g. through barcode scanning, etc.) one or more tracers, (e.g. expressed sequence tag, etc.) and including indication of said one or more tracers (e.g. via index information, etc.) as being at least momentarily (e.g. shipping time on truck from distribution center to market, etc.) in physical proximity (e.g. snapped onto container, etc.) with said one or more ingestible materials (e.g. cow heart, etc.) at least in part including chemical test information regarding use of one or more farming related items (e.g. arsenic levels in soil, etc.).

In one or more implementations, as shown in FIG. 76, operation o12 includes an operation o1220 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including visual test information regarding farming related items. Origination of an illustratively derived receiving response visual test component group can be accomplished through skilled in the art design choice selection of one or more of the above depicted components from one or more of the above depicted subsystems shown in FIG. 12. Components from the receiving response visual test component group can be used in implementing execution of the one or more receiving response visual test instructions i1220 of FIG. 34, can be used in performance of the receiving response visual test electrical circuitry arrangement e1220 of FIG. 27, and/or can be used in otherwise fulfillment of the operation o1220. An exemplary non-transitory signal bearing medium version of the information storage subsystem s200 is depicted in FIG. 34 as bearing the one or more receiving response visual test instructions i1220 that when executed will direct performance of the operation o1220. Furthermore, the receiving response visual test electrical circuitry arrangement (“elec circ arrange”) e1220, when activated, will perform the operation o1220. Also, the receiving response visual test module m1220, when executed and/or activated, will direct performance of and/or perform the operation o1220. For instance, in one or more exemplary implementations, the one or more receiving response visual test instructions i1220, when executed, direct performance of the operation o1220 in the illustrative depiction as follows, and/or the receiving response visual test electrical circuitry arrangement e1220, when activated, performs the operation o1220 in the illustrative depiction as follows, and/or the receiving response visual test module m1220, when executed and/or activated, directs performance of and/or performs the operation o1220 in the illustrative depiction as follows, and/or the operation o1220 is otherwise carried out in the illustrative depiction as follows: electronically receiving (e.g. POP3 server, etc.) the at least a portion of response information (e.g. testing chlorophyll levels in plant matter, etc.) regarding at least in part (e.g. tangle, etc.) one or more farming related production factors (e.g. animal byproduct inventory, etc.) involved with (e.g. tangle, etc.) farming related production of (e.g. lentil harvesting, etc.) one or more ingestible materials (e.g. abalone shell, etc.) said electronically receiving logged as being subsequent to said electronically transmitting, (e.g. via local area network records, etc.) said response information including indication of one or more identifiers (e.g. text, etc.) as being accessible through (e.g. through radiation detection, etc.) one or more tracers, (e.g. retrograde neuronal tracer, etc.) and including indication of said one or more tracers (e.g. via server information, etc.) as being at least momentarily (e.g. time since introduction of oxygen absorber, etc.) in physical proximity (e.g. stapled to container, etc.) with said one or more ingestible materials (e.g. green algae, etc.) at least in part including visual test information regarding farming related items (e.g. visual appearance quality of crop, etc.).

In one or more implementations, as shown in FIG. 76, operation o12 includes an operation o1221 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials. Origination of an illustratively derived receiving response forbidden use component group can be accomplished through skilled in the art design choice selection of one or more of the above depicted components from one or more of the above depicted subsystems shown in FIG. 12. Components from the receiving response forbidden use component group can be used in implementing execution of the one or more receiving response forbidden use instructions i1221 of FIG. 34, can be used in performance of the receiving response forbidden use electrical circuitry arrangement e1221 of FIG. 27, and/or can be used in otherwise fulfillment of the operation o1221. An exemplary non-transitory signal bearing medium version of the information storage subsystem s200 is depicted in FIG. 34 as bearing the one or more receiving response forbidden use instructions i1221 that when executed will direct performance of the operation o1221. Furthermore, the receiving response forbidden use electrical circuitry arrangement (“elec circ arrange”) e1221, when activated, will perform the operation o1221. Also, the receiving response forbidden use module m1221, when executed and/or activated, will direct performance of and/or perform the operation o1221. For instance, in one or more exemplary implementations, the one or more receiving response forbidden use instructions i1221, when executed, direct performance of the operation o1221 in the illustrative depiction as follows, and/or the receiving response forbidden use electrical circuitry arrangement e1221, when activated, performs the operation o1221 in the illustrative depiction as follows, and/or the receiving response forbidden use module m1221, when executed and/or activated, directs performance of and/or performs the operation o1221 in the illustrative depiction as follows, and/or the operation o1221 is otherwise carried out in the illustrative depiction as follows: electronically receiving (e.g. hardware based encryption, etc.) the at least a portion of response information (e.g. testing for banned pesticide presence, etc.) regarding at least in part (e.g. exclude, etc.) one or more farming related production factors (e.g. cost of tractor rental, etc.) involved with (e.g. exclude, etc.) farming related production of (e.g. flax growing, etc.) one or more ingestible materials (e.g. lamb meat, etc.) said electronically receiving logged as being subsequent to said electronically transmitting, (e.g. via database records, etc.) said response information including indication of one or more identifiers (e.g. document discriminator, etc.) as being accessible through (e.g. through isotope identification, etc.) one or more tracers, (e.g. macromolecule marker, etc.) and including indication of said one or more tracers (e.g. via digital linear tape storage, etc.) as being at least momentarily (e.g. shipping time from farm to restaurant, etc.) in physical proximity (e.g. tied to container, etc.) with said one or more ingestible materials (e.g. cat fish at least in part including test information regarding forbidden farming related item use involved with farming related creation of biologically based substances (e.g. chemicals not approved by USDA to be used to grow organic strawberries, etc.).

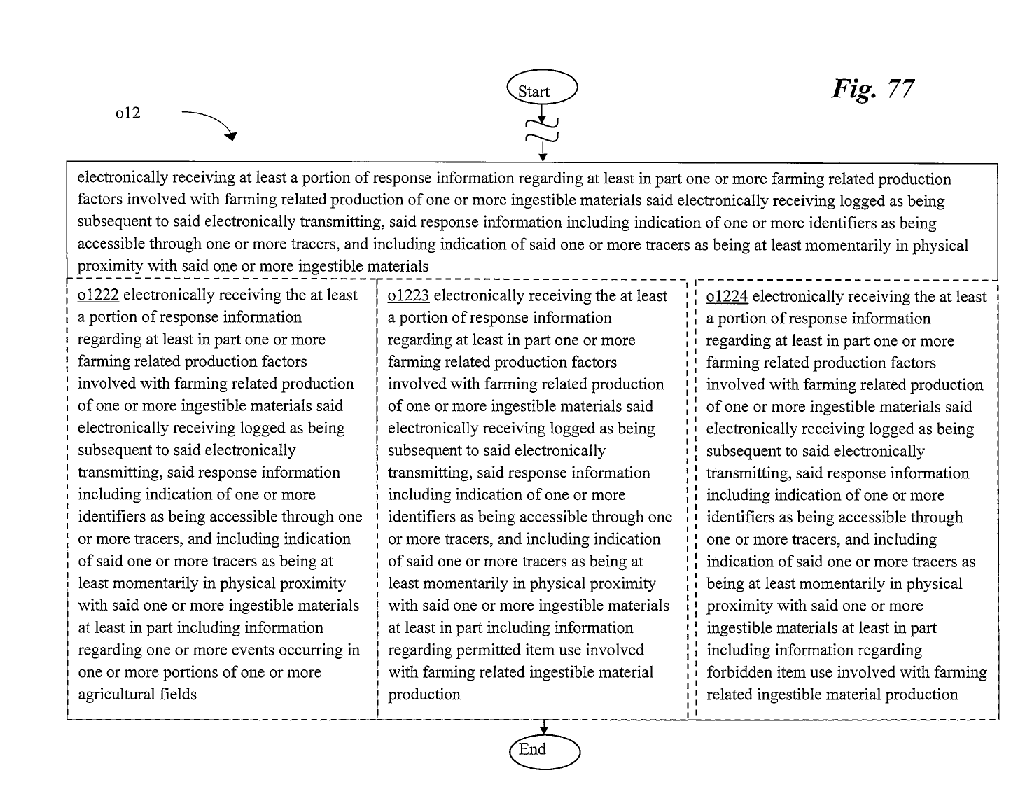

In one or more implementations, as shown in FIG. 77, operation o12 includes an operation o1222 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including information regarding one or more events occurring in one or more portions of one or more agricultural fields. Origination of an illustratively derived receiving response event fields component group can be accomplished through skilled in the art design choice selection of one or more of the above depicted components from one or more of the above depicted subsystems shown in FIG. 12. Components from the receiving response event fields component group can be used in implementing execution of the one or more receiving response event fields instructions i1222 of FIG. 34, can be used in performance of the receiving response event fields electrical circuitry arrangement e1222 of FIG. 27, and/or can be used in otherwise fulfillment of the operation o1222. An exemplary non-transitory signal bearing medium version of the information storage subsystem s200 is depicted in FIG. 34 as bearing the one or more receiving response event fields instructions i1222 that when executed will direct performance of the operation o1222. Furthermore, the receiving response event fields electrical circuitry arrangement (“elec circ arrange”) e1222, when activated, will perform the operation o1222. Also, the receiving response event fields module m1222, when executed and/or activated, will direct performance of and/or perform the operation o1222. For instance, in one or more exemplary implementations, the one or more receiving response event fields instructions i1222, when executed, direct performance of the operation o1222 in the illustrative depiction as follows, and/or the receiving response event fields electrical circuitry arrangement e1222, when activated, performs the operation o1222 in the illustrative depiction as follows, and/or the receiving response event fields module m1222, when executed and/or activated, directs performance of and/or performs the operation o1222 in the illustrative depiction as follows, and/or the operation o1222 is otherwise carried out in the illustrative depiction as follows: electronically receiving (e.g. software based encryption, etc.) the at least a portion of response information (e.g. testing for natural insect predator population, etc.) regarding at least in part (e.g. bound, etc.) one or more farming related production factors (e.g. equipment maintenance schedule, etc.) involved with (e.g. bound, etc.) farming related production of (e.g. squash cultivation, etc.) one or more ingestible materials (e.g. cow liver, etc.) said electronically receiving logged as being subsequent to said electronically transmitting, (e.g. via computer clock, etc.) said response information including indication of one or more identifiers (e.g. hologram, etc.) as being accessible through (e.g. through beacon signal reception, etc.) one or more tracers, (e.g. carbon-12 marker, etc.) and including indication of said one or more tracers (e.g. via database object information, etc.) as being at least momentarily (e.g. time in storage and display after unpacking, etc.) in physical proximity (e.g. stamped onto container, etc.) with said one or more ingestible materials (e.g. kangaroo meat, etc.) at least in part including information regarding one or more events occurring in one or more portions of one or more agricultural fields (e.g. irrigation, etc.).

In one or more implementations, as shown in FIG. 77, operation o12 includes an operation o1223 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including information regarding permitted item use involved with farming related ingestible material production. Origination of an illustratively derived receiving response permitted use component group can be accomplished through skilled in the art design choice selection of one or more of the above depicted components from one or more of the above depicted subsystems shown in FIG. 12. Components from the receiving response permitted use component group can be used in implementing execution of the one or more receiving response permitted use instructions i1223 of FIG. 34, can be used in performance of the receiving response permitted use electrical circuitry arrangement e1223 of FIG. 27, and/or can be used in otherwise fulfillment of the operation o1223. An exemplary non-transitory signal bearing medium version of the information storage subsystem s200 is depicted in FIG. 34 as bearing the one or more receiving response permitted use instructions i1223 that when executed will direct performance of the operation o1223. Furthermore, the receiving response permitted use electrical circuitry arrangement (“elec circ arrange”) e1223, when activated, will perform the operation o1223. Also, the receiving response permitted use module m1223, when executed and/or activated, will direct performance of and/or perform the operation o1223. For instance, in one or more exemplary implementations, the one or more receiving response permitted use instructions i1223, when executed, direct performance of the operation o1223 in the illustrative depiction as follows, and/or the receiving response permitted use electrical circuitry arrangement e1223, when activated, performs the operation o1223 in the illustrative depiction as follows, and/or the receiving response permitted use module m1223, when executed and/or activated, directs performance of and/or performs the operation o1223 in the illustrative depiction as follows, and/or the operation o1223 is otherwise carried out in the illustrative depiction as follows: electronically receiving (e.g. SD card, etc.) the at least a portion of response information (e.g. monitoring crop growth over time span, etc.) regarding at least in part (e.g. requiring, etc.) one or more farming related production factors (e.g. tool requirement for repairs, etc.) involved with (e.g. requiring, etc.) farming related production of (e.g. strawberry picking, etc.) one or more ingestible materials (e.g. cow heart, etc.) said electronically receiving logged as being subsequent to said electronically transmitting, (e.g. via network protocol time indicator, etc.) said response information including indication of one or more identifiers (e.g. color code, etc.) as being accessible through (e.g. through image scanning, etc.) one or more tracers, (e.g. scintillation counter, etc.) and including indication of said one or more tracers (e.g. via database table information, etc.) as being at least momentarily (e.g. shipping time across Pacific Ocean, etc.) in physical proximity (e.g. magnetically attached to container, etc.) with said one or more ingestible materials (e.g. emu meat, etc.) at least in part including information regarding permitted item use involved with farming related ingestible material production (e.g. sanitized tongs, etc.).

In one or more implementations, as shown in FIG. 77, operation o12 includes an operation o1224 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including information regarding forbidden item use involved with farming related ingestible material production. Origination of an illustratively derived receiving response forbidden use component group can be accomplished through skilled in the art design choice selection of one or more of the above depicted components from one or more of the above depicted subsystems shown in FIG. 12. Components from the receiving response forbidden use component group can be used in implementing execution of the one or more receiving response forbidden use instructions i1224 of FIG. 34, can be used in performance of the receiving response forbidden use electrical circuitry arrangement e1224 of FIG. 27, and/or can be used in otherwise fulfillment of the operation o1224. An exemplary non-transitory signal bearing medium version of the information storage subsystem s200 is depicted in FIG. 34 as bearing the one or more receiving response forbidden use instructions i1224 that when executed will direct performance of the operation o1224. Furthermore, the receiving response forbidden use electrical circuitry arrangement (“elec circ arrange”) e1224, when activated, will perform the operation o1224. Also, the receiving response forbidden use module m1224, when executed and/or activated, will direct performance of and/or perform the operation o1224. For instance, in one or more exemplary implementations, the one or more receiving response forbidden use instructions i1224, when executed, direct performance of the operation o1224 in the illustrative depiction as follows, and/or the receiving response forbidden use electrical circuitry arrangement e1224, when activated, performs the operation o1224 in the illustrative depiction as follows, and/or the receiving response forbidden use module m1224, when executed and/or activated, directs performance of and/or performs the operation o1224 in the illustrative depiction as follows, and/or the operation o1224 is otherwise carried out in the illustrative depiction as follows: electronically receiving (e.g. SIM card, etc.) the at least a portion of response information (e.g. monitoring threshing speed of wheat, etc.) regarding at least in part (e.g. enveloped, etc.) one or more farming related production factors (e.g. local regulations, etc.) involved with (e.g. enveloped, etc.) farming related production of (e.g. rice planting, etc.) one or more ingestible materials (e.g. intestine casing, etc.) said electronically receiving logged as being subsequent to said electronically transmitting, (e.g. via server clock, etc.) said response information including indication of one or more identifiers (e.g. visual pattern, etc.) as being accessible through (e.g. through audio reception, etc.) one or more tracers, (e.g. light emitting diode, etc.) and including indication of said one or more tracers (e.g. via ROM storage, etc.) as being at least momentarily (e.g. time in holding bay, etc.) in physical proximity (e.g. snapped onto container, etc.) with said one or more ingestible materials (e.g. water, etc.) at least in part including information regarding forbidden item use involved with farming related ingestible material production (e.g. DDT insecticide, etc.).

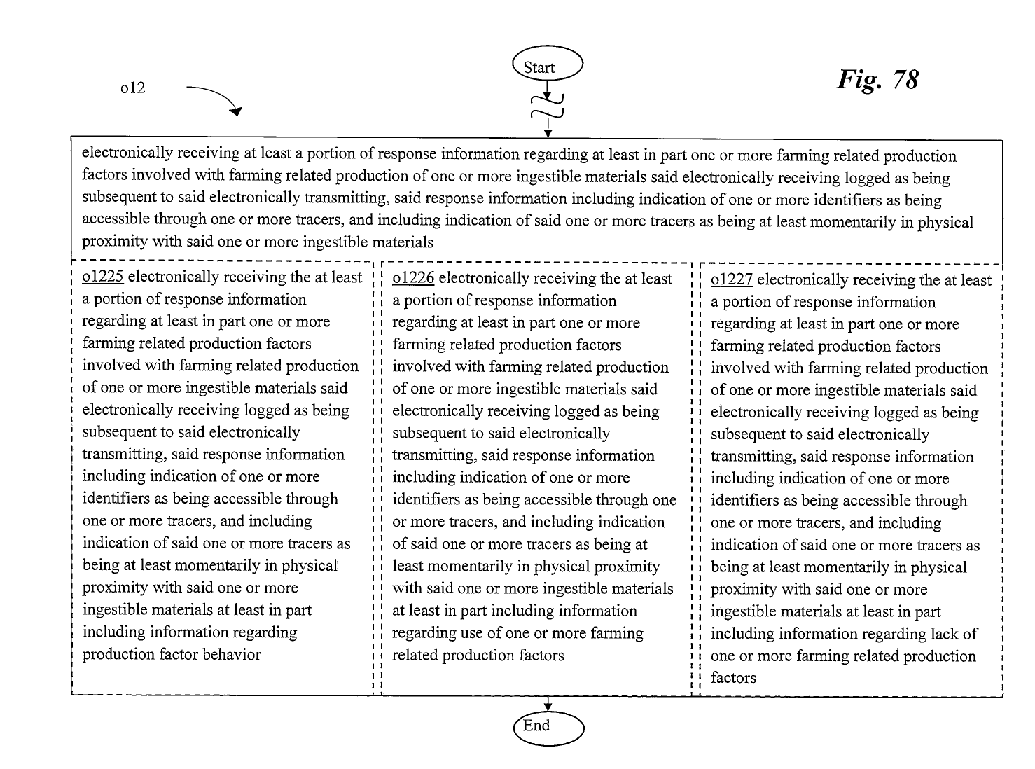

In one or more implementations, as shown in FIG. 78, operation o12 includes an operation o1225 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including information regarding production factor behavior. Origination of an illustratively derived receiving response factor behavior component group can be accomplished through skilled in the art design choice selection of one or more of the above depicted components from one or more of the above depicted subsystems shown in FIG. 12. Components from the receiving response factor behavior component group can be used in implementing execution of the one or more receiving response factor behavior instructions i1225 of FIG. 34, can be used in performance of the receiving response factor behavior electrical circuitry arrangement e1225 of FIG. 27, and/or can be used in otherwise fulfillment of the operation o1225. An exemplary non-transitory signal bearing medium version of the information storage subsystem s200 is depicted in FIG. 34 as bearing the one or more receiving response factor behavior instructions i1225 that when executed will direct performance of the operation o1225. Furthermore, the receiving response factor behavior electrical circuitry arrangement (“elec circ arrange”) e1225, when activated, will perform the operation o1225. Also, the receiving response factor behavior module m1225, when executed and/or activated, will direct performance of and/or perform the operation o1225. For instance, in one or more exemplary implementations, the one or more receiving response factor behavior instructions i1225, when executed, direct performance of the operation o1225 in the illustrative depiction as follows, and/or the receiving response factor behavior electrical circuitry arrangement e1225, when activated, performs the operation o1225 in the illustrative depiction as follows, and/or the receiving response factor behavior module m1225, when executed and/or activated, directs performance of and/or performs the operation o1225 in the illustrative depiction as follows, and/or the operation o1225 is otherwise carried out in the illustrative depiction as follows: electronically receiving (e.g. email, etc.) the at least a portion of response information (e.g. testing for fungicide levels, etc.) regarding at least in part (e.g. envelope, etc.) one or more farming related production factors (e.g. land terrain, etc.) involved with (e.g. envelope, etc.) farming related production of (e.g. rice harvesting, etc.) one or more ingestible materials (e.g. chicken feet, etc.) said electronically receiving logged as being subsequent to said electronically transmitting, (e.g. via operating system time, etc.) said response information including indication of one or more identifiers (e.g. Morse code, etc.) as being accessible through (e.g. through visual identification, etc.) one or more tracers, (e.g. asset tag, etc.) and including indication of said one or more tracers (e.g. via relational database, etc.) as being at least momentarily (e.g. time held in port for inspection period, etc.) in physical proximity (e.g. embossed on container, etc.) with said one or more ingestible materials (e.g. pork meat, etc.) at least in part including information regarding production factor behavior (e.g. production speed, etc.).

In one or more implementations, as shown in FIG. 78, operation o12 includes an operation o1226 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including information regarding use of one or more farming related production factors. Origination of an illustratively derived receiving response factor use component group can be accomplished through skilled in the art design choice selection of one or more of the above depicted components from one or more of the above depicted subsystems shown in FIG. 12. Components from the receiving response factor use component group can be used in implementing execution of the one or more receiving response factor use instructions i1226 of FIG. 34, can be used in performance of the receiving response factor use electrical circuitry arrangement e1226 of FIG. 27, and/or can be used in otherwise fulfillment of the operation o1226. An exemplary non-transitory signal bearing medium version of the information storage subsystem s200 is depicted in FIG. 34 as bearing the one or more receiving response factor use instructions i1226 that when executed will direct performance of the operation o1226. Furthermore, the receiving response factor use electrical circuitry arrangement (“elec circ arrange”) e1226, when activated, will perform the operation o1226. Also, the receiving response factor use module m1226, when executed and/or activated, will direct performance of and/or perform the operation o1226. For instance, in one or more exemplary implementations, the one or more receiving response factor use instructions i1226, when executed, direct performance of the operation o1226 in the illustrative depiction as follows, and/or the receiving response factor use electrical circuitry arrangement e1226, when activated, performs the operation o1226 in the illustrative depiction as follows, and/or the receiving response factor use module m1226, when executed and/or activated, directs performance of and/or performs the operation o1226 in the illustrative depiction as follows, and/or the operation o1226 is otherwise carried out in the illustrative depiction as follows: electronically receiving (e.g. peer to peer, etc.) the at least a portion of response information (e.g. testing oxygen levels in blood, etc.) regarding at least in part (e.g. associate with, etc.) one or more farming related production factors (e.g. range area, etc.) involved with (e.g. associate with, etc.) farming related production of (e.g. pear picking, etc.) one or more ingestible materials (e.g. octopus, etc.) said electronically receiving logged as being subsequent to said electronically transmitting, (e.g. indicating electronically receiving sent as response to electronically transmitting, etc.) said response information including indication of one or more identifiers (e.g. tertiary code, etc.) as being accessible through (e.g. through light reception, etc.) one or more tracers, (e.g. cylindrical, etc.) and including indication of said one or more tracers (e.g. via flat database, etc.) as being at least momentarily (e.g. time on train between two terminals, etc.) in physical proximity (e.g. bolted to container, etc.) with said one or more ingestible materials (e.g. wheat flour, etc.) at least in part including information regarding use of one or more farming related production factors (e.g. labor force scheduling, etc.).

In one or more implementations, as shown in FIG. 78, operation o12 includes an operation o1227 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including information regarding lack of one or more farming related production factors. Origination of an illustratively derived receiving response factor lack component group can be accomplished through skilled in the art design choice selection of one or more of the above depicted components from one or more of the above depicted subsystems shown in FIG. 12. Components from the receiving response factor lack component group can be used in implementing execution of the one or more receiving response factor lack instructions i1227 of FIG. 34, can be used in performance of the receiving response factor lack electrical circuitry arrangement e1227 of FIG. 27, and/or can be used in otherwise fulfillment of the operation o1227. An exemplary non-transitory signal bearing medium version of the information storage subsystem s200 is depicted in FIG. 34 as bearing the one or more receiving response factor lack instructions i1227 that when executed will direct performance of the operation o1227. Furthermore, the receiving response factor lack electrical circuitry arrangement (“elec circ arrange”) e1227, when activated, will perform the operation o1227. Also, the receiving response factor lack module m1227, when executed and/or activated, will direct performance of and/or perform the operation o1227. For instance, in one or more exemplary implementations, the one or more receiving response factor lack instructions i1227, when executed, direct performance of the operation o1227 in the illustrative depiction as follows, and/or the receiving response factor lack electrical circuitry arrangement e1227, when activated, performs the operation o1227 in the illustrative depiction as follows, and/or the receiving response factor lack module m1227, when executed and/or activated, directs performance of and/or performs the operation o1227 in the illustrative depiction as follows, and/or the operation o1227 is otherwise carried out in the illustrative depiction as follows: electronically receiving (e.g. 10-key, etc.) the at least a portion of response information (e.g. testing for proper organ function in animal, etc.) regarding at least in part (e.g. embroil, etc.) one or more farming related production factors (e.g. range schedule, etc.) involved with (e.g. embroil, etc.) farming related production of (e.g. peanut harvesting, etc.) one or more ingestible materials (e.g. squid, etc.) said electronically receiving logged as being subsequent to said electronically transmitting, (e.g. via textual input, etc.) said response information including indication of one or more identifiers (e.g. model number, etc.) as being accessible through (e.g. through color spectrum identification, etc.) one or more tracers, (e.g. checkered, etc.) and including indication of said one or more tracers (e.g. via database object information, etc.) as being at least momentarily (e.g. partial time spent on retail display, etc.) in physical proximity (e.g. welded onto container, etc.) with said one or more ingestible materials (e.g. corn on cob, etc.) at least in part including information regarding lack of one or more farming related production factors (e.g. future market demands, etc.).

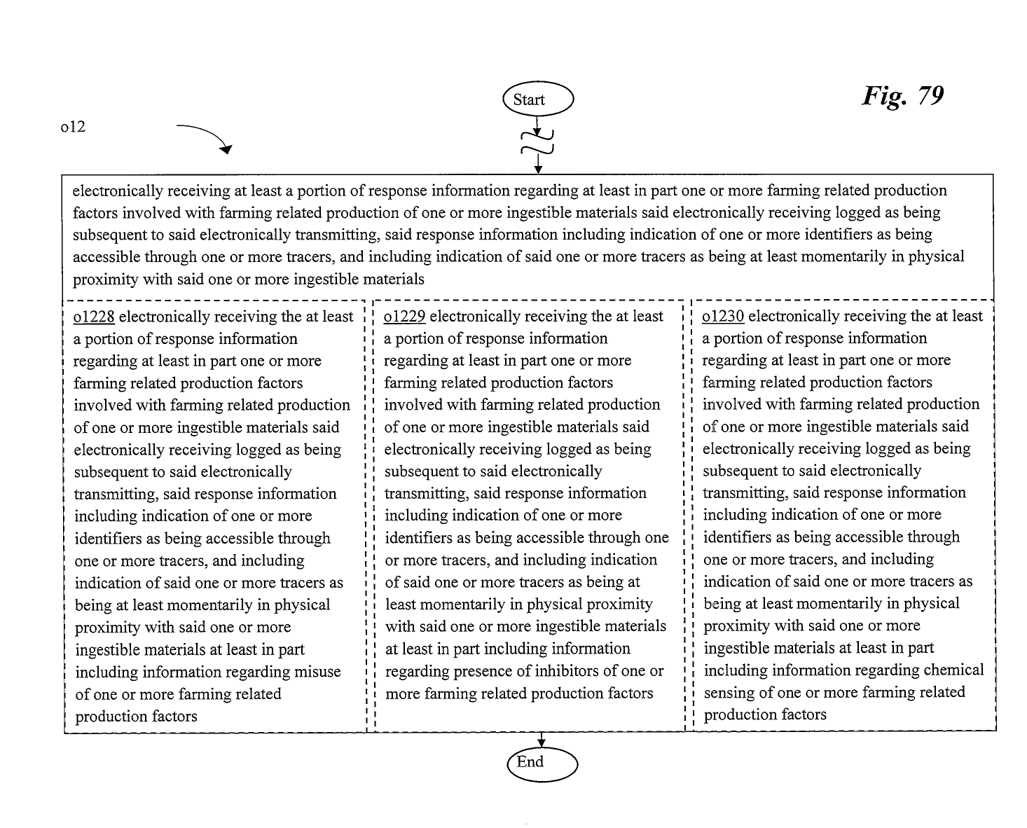

In one or more implementations, as shown in FIG. 79, operation o12 includes an operation o1228 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including information regarding misuse of one or more farming related production factors. Origination of an illustratively derived receiving response factor misuse component group can be accomplished through skilled in the art design choice selection of one or more of the above depicted components from one or more of the above depicted subsystems shown in FIG. 12. Components from the receiving response factor misuse component group can be used in implementing execution of the one or more receiving response factor misuse instructions i1228 of FIG. 34, can be used in performance of the receiving response factor misuse electrical circuitry arrangement e1228 of FIG. 27, and/or can be used in otherwise fulfillment of the operation o1228. An exemplary non-transitory signal bearing medium version of the information storage subsystem s200 is depicted in FIG. 34 as bearing the one or more receiving response factor misuse instructions i1228 that when executed will direct performance of the operation o1228. Furthermore, the receiving response factor misuse electrical circuitry arrangement (“elec circ arrange”) e1228, when activated, will perform the operation o1228. Also, the receiving response factor misuse module m1228, when executed and/or activated, will direct performance of and/or perform the operation o1228. For instance, in one or more exemplary implementations, the one or more receiving response factor misuse instructions i1228, when executed, direct performance of the operation o1228 in the illustrative depiction as follows, and/or the receiving response factor misuse electrical circuitry arrangement e1228, when activated, performs the operation o1228 in the illustrative depiction as follows, and/or the receiving response factor misuse module m1228, when executed and/or activated, directs performance of and/or performs the operation o1228 in the illustrative depiction as follows, and/or the operation o1228 is otherwise carried out in the illustrative depiction as follows: electronically receiving (e.g. USB port, etc.) the at least a portion of response information (e.g. monitoring feed consumption of livestock, etc.) regarding at least in part (e.g. take in, etc.) one or more farming related production factors (e.g. livestock inventory, etc.) involved with (e.g. take in, etc.) farming related production of (e.g. parsnip growing, etc.) one or more ingestible materials (e.g. green algae, etc.) said electronically receiving logged as being subsequent to said electronically transmitting, (e.g. via audio input, etc.) said response information including indication of one or more identifiers (e.g. phonetic alphabet, etc.) as being accessible through (e.g. through RF reception, etc.) one or more tracers, (e.g. speaker, etc.) and including indication of said one or more tracers (e.g. via database table information, etc.) as being at least momentarily (e.g. time spent in laboratory for testing, etc.) in physical proximity (e.g. embossed on material, etc.) with said one or more ingestible materials (e.g. carp, etc.) at least in part including information regarding misuse of one or more farming related production factors (e.g. improper data calculation, etc.).

In one or more implementations, as shown in FIG. 79, operation o12 includes an operation o1229 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including information regarding presence of inhibitors of one or more farming related production factors. Origination of an illustratively derived receiving response factor inhibitors component group can be accomplished through skilled in the art design choice selection of one or more of the above depicted components from one or more of the above depicted subsystems shown in FIG. 12. Components from the receiving response factor inhibitors component group can be used in implementing execution of the one or more receiving response factor inhibitors instructions i1229 of FIG. 34, can be used in performance of the receiving response factor inhibitors electrical circuitry arrangement e1229 of FIG. 27, and/or can be used in otherwise fulfillment of the operation o1229. An exemplary non-transitory signal bearing medium version of the information storage subsystem s200 is depicted in FIG. 34 as bearing the one or more receiving response factor inhibitors instructions i1229 that when executed will direct performance of the operation o1229. Furthermore, the receiving response factor inhibitors electrical circuitry arrangement (“elec circ arrange”) e1229, when activated, will perform the operation o1229. Also, the receiving response factor inhibitors module m1229, when executed and/or activated, will direct performance of and/or perform the operation o1229. For instance, in one or more exemplary implementations, the one or more receiving response factor inhibitors instructions i1229, when executed, direct performance of the operation o1229 in the illustrative depiction as follows, and/or the receiving response factor inhibitors electrical circuitry arrangement e1229, when activated, performs the operation o1229 in the illustrative depiction as follows, and/or the receiving response factor inhibitors module m1229, when executed and/or activated, directs performance of and/or performs the operation o1229 in the illustrative depiction as follows, and/or the operation o1229 is otherwise carried out in the illustrative depiction as follows: electronically receiving (e.g. FTP, etc.) the at least a portion of response information (e.g. monitoring improper hand sanitation of workers, etc.) regarding at least in part (e.g. comprised of, etc.) one or more farming related production factors (e.g. labor laws, etc.) involved with (e.g. comprised of, etc.) farming related production of (e.g. cow milking, etc.) one or more ingestible materials (e.g. corn on cob, etc.) said electronically receiving logged as being subsequent to said electronically transmitting, (e.g. via e-mail record, etc.) said response information including indication of one or more identifiers (e.g. Arabic alphabet, etc.) as being accessible through (e.g. through scanning, etc.) one or more tracers, (e.g. UHF emitter, etc.) and including indication of said one or more tracers (e.g. via food composition database, etc.) as being at least momentarily (e.g. shipping time from grocery store to home, etc.) in physical proximity (e.g. debossed on material, etc.) with said one or more ingestible materials (e.g. barley, etc.) at least in part including information regarding presence of inhibitors of one or more farming related production factors (e.g. infestation, etc.).

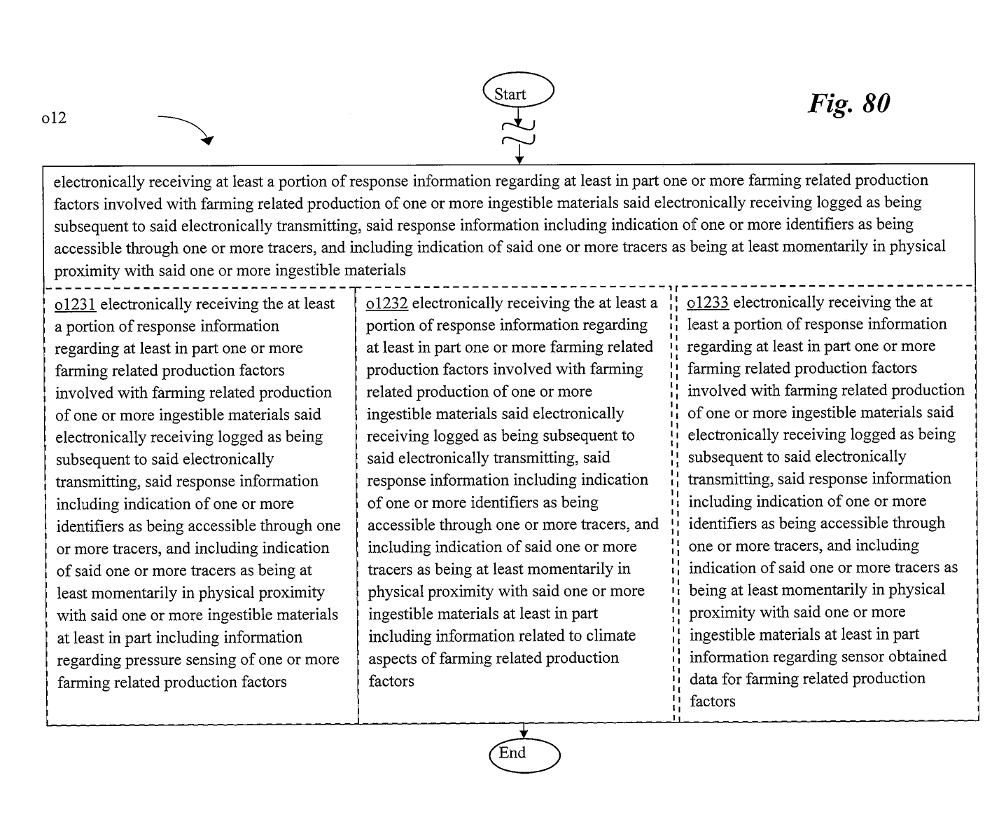

In one or more implementations, as shown in FIG. 80, operation o12 includes an operation o1231 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including information regarding pressure sensing of one or more farming related production factors. Origination of an illustratively derived receiving response pressure sensing component group can be accomplished through skilled in the art design choice selection of one or more of the above depicted components from one or more of the above depicted subsystems shown in FIG. 12. Components from the receiving response pressure sensing component group can be used in implementing execution of the one or more receiving response pressure sensing instructions i1231 of FIG. 34, can be used in performance of the receiving response pressure sensing electrical circuitry arrangement e1231 of FIG. 27, and/or can be used in otherwise fulfillment of the operation o1231. An exemplary non-transitory signal bearing medium version of the information storage subsystem s200 is depicted in FIG. 34 as bearing the one or more receiving response pressure sensing instructions i1231 that when executed will direct performance of the operation o1231. Furthermore, the receiving response pressure sensing electrical circuitry arrangement (“elec circ arrange”) e1231, when activated, will perform the operation o1231. Also, the receiving response pressure sensing module m1231, when executed and/or activated, will direct performance of and/or perform the operation o1231. For instance, in one or more exemplary implementations, the one or more receiving response pressure sensing instructions i1231, when executed, direct performance of the operation o1231 in the illustrative depiction as follows, and/or the receiving response pressure sensing electrical circuitry arrangement e1231, when activated, performs the operation o1231 in the illustrative depiction as follows, and/or the receiving response pressure sensing module m1231, when executed and/or activated, directs performance of and/or performs the operation o1231 in the illustrative depiction as follows, and/or the operation o1231 is otherwise carried out in the illustrative depiction as follows: electronically receiving (e.g. bittorent, etc.) the at least a portion of response information (e.g. testing for visual clues in livestock health status, etc.) regarding at least in part (e.g. associated, etc.) one or more farming related production factors (e.g. neighbor's crop harvest, etc.) involved with (e.g. associated, etc.) farming related production of (e.g. blueberry cultivation, etc.) one or more ingestible materials (e.g. domestic goose, etc.) said electronically receiving logged as being subsequent to said electronically transmitting, (e.g. as being immediately thereafter, etc.) said response information including indication of one or more identifiers (e.g. binary sequence, etc.) as being accessible through (e.g. through electromagnetic reception, etc.) one or more tracers, (e.g. microwave emitter, etc.) and including indication of said one or more tracers (e.g. via portion of packet information, etc.) as being at least momentarily (e.g. time spent exposed to air before packaging, etc.) in physical proximity (e.g. riveted to container, etc.) with said one or more ingestible materials (e.g. ground beef, etc.) at least in part including information regarding pressure sensing of one or more farming related production factors (e.g. mbar, etc.).

In one or more implementations, as shown in FIG. 80, operation o12 includes an operation o1232 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part including information related to climate aspects of farming related production factors. Origination of an illustratively derived receiving response climate aspects component group can be accomplished through skilled in the art design choice selection of one or more of the above depicted components from one or more of the above depicted subsystems shown in FIG. 12. Components from the receiving response climate aspects component group can be used in implementing execution of the one or more receiving response climate aspects instructions i1232 of FIG. 34, can be used in performance of the receiving response climate aspects electrical circuitry arrangement e1232 of FIG. 27, and/or can be used in otherwise fulfillment of the operation o1232. An exemplary non-transitory signal bearing medium version of the information storage subsystem s200 is depicted in FIG. 34 as bearing the one or more receiving response climate aspects instructions i1232 that when executed will direct performance of the operation o1232. Furthermore, the receiving response climate aspects electrical circuitry arrangement (“elec circ arrange”) e1232, when activated, will perform the operation o1232. Also, the receiving response climate aspects module m1232, when executed and/or activated, will direct performance of and/or perform the operation o1232. For instance, in one or more exemplary implementations, the one or more receiving response climate aspects instructions i1232, when executed, direct performance of the operation o1232 in the illustrative depiction as follows, and/or the receiving response climate aspects electrical circuitry arrangement e1232, when activated, performs the operation o1232 in the illustrative depiction as follows, and/or the receiving response climate aspects module m1232, when executed and/or activated, directs performance of and/or performs the operation o1232 in the illustrative depiction as follows, and/or the operation o1232 is otherwise carried out in the illustrative depiction as follows: electronically receiving (e.g. gnutella, etc.) the at least a portion of response information (e.g. monitoring audible clues in livestock chatter, etc.) regarding at least in part (e.g. affected, etc.) one or more farming related production factors (e.g. crop rotation demands, etc.) involved with (e.g. affected, etc.) farming related production of (e.g. raspberry harvesting, etc.) one or more ingestible materials (e.g. edible frog, etc.) said electronically receiving logged as being subsequent to said electronically transmitting, (e.g. as being thereafter due to server delay, etc.) said response information including indication of one or more identifiers (e.g. ASCII string, etc.) as being accessible through (e.g. through search terms, etc.) one or more tracers, (e.g. laser ranging tracker, etc.) and including indication of said one or more tracers (e.g. via header information, etc.) as being at least momentarily (e.g. portion of time spent on shipping vessel, etc.) in physical proximity (e.g. placed inside container, etc.) with said one or more ingestible materials (e.g. chicken feet, etc.) at least in part including information related to climate aspects of farming related production factors (e.g. humidity, etc.).

In one or more implementations, as shown in FIG. 80, operation o12 includes an operation o1233 for electronically receiving the at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials at least in part information regarding sensor obtained data for farming related production factors. Origination of an illustratively derived receiving response sensor factors component group can be accomplished through skilled in the art design choice selection of one or more of the above depicted components from one or more of the above depicted subsystems shown in FIG. 12. Components from the receiving response sensor factors component group can be used in implementing execution of the one or more receiving response sensor factors instructions i1233 of FIG. 34, can be used in performance of the receiving response sensor factors electrical circuitry arrangement e1233 of FIG. 27, and/or can be used in otherwise fulfillment of the operation o1233. An exemplary non-transitory signal bearing medium version of the information storage subsystem s200 is depicted in FIG. 34 as bearing the one or more receiving response sensor factors instructions i1233 that when executed will direct performance of the operation o1233. Furthermore, the receiving response sensor factors electrical circuitry arrangement (“elec circ arrange”) e1233, when activated, will perform the operation o1233. Also, the receiving response sensor factors module m1233, when executed and/or activated, will direct performance of and/or perform the operation o1233. For instance, in one or more exemplary implementations, the one or more receiving response sensor factors instructions i1233, when executed, direct performance of the operation o1233 in the illustrative depiction as follows, and/or the receiving response sensor factors electrical circuitry arrangement e1233, when activated, performs the operation o1233 in the illustrative depiction as follows, and/or the receiving response sensor factors module m1233, when executed and/or activated, directs performance of and/or performs the operation o1233 in the illustrative depiction as follows, and/or the operation o1233 is otherwise carried out in the illustrative depiction as follows: electronically receiving (e.g. TCP/IP, etc.) the at least a portion of response information (e.g. monitoring livestock feeding behavior, etc.) regarding at least in part (e.g. affecting, etc.) one or more farming related production factors (e.g. government subsidy status, etc.) involved with (e.g. affecting, etc.) farming related production of (e.g. corn growing, etc.) one or more ingestible materials (e.g. catfish, etc.) said electronically receiving logged as being subsequent to said electronically transmitting, (e.g. as being thereafter due in part to database retrieval times, etc.) said response information including indication of one or more identifiers (e.g. alpha-numeric, etc.) as being accessible through (e.g. through storage retrieval, etc.) one or more tracers, (e.g. ultrasonic emitter, etc.) and including indication of said one or more tracers (e.g. via footer information, etc.) as being at least momentarily (e.g. time spent in cold storage, etc.) in physical proximity (e.g. placed inside material, etc.) with said one or more ingestible materials (e.g. bison meat, etc.) at least in part information regarding sensor obtained data for farming related production factors (e.g. oxygen sensor, etc.).

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The one or more instructions discussed herein may be, for example, computer executable and/or logic-implemented instructions. In some implementations, signal-bearing medium as articles of manufacture may store the one or more instructions. In some implementations, the signal bearing medium may include a computer-readable medium. In some implementations, the signal-bearing medium may include a recordable medium. In some implementations, the signal-bearing medium may include a communication medium.

Those having skill in the art will recognize that the state of the art has progressed to the point where there is little distinction left between hardware and software implementations of aspects of systems; the use of hardware or software is generally (but not always, in that in certain contexts the choice between hardware an d software can become significant) a design choice representing cost vs. efficiency tradeoffs. Those having skill in the art will appreciate that there are various vehicles by which processes and/or systems and/or other technologies described herein can be effected (e.g., hardware, software, and/or firmware in one or more machines or articles of manufacture), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation that is implemented in one or more machines or articles of manufacture; or, yet again alternatively, the implementer may opt for some combination of hardware, software, and/or firmware in one or more machines or articles of manufacture (limited to patentable subject matter under 35 USC 101). Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware in one or more machines or articles of manufacture.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof (limited to patentable subject matter under 35 U.S.C. 101). In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure (limited to patentable subject matter under 35 USC 101). In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, (e.g., transmitter, receiver, transmission logic, reception logic, etc.), etc.).

### Electro-Mechanical System Support

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

### Electrical Circuitry Support

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

### Image Processing System Support

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

### Data Processing System Support

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

### Software as Patentable Subject Matter Support

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

### Mote System Support

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

### Licensing System Support Language

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

### Extraterritorial Use Language

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

### Residual Incorporation Language

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

### Not Limited to Implementations Described Language

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

### Not Limited to Human User Language

Although user XXX is shown/described herein as a single illustrated figure, those skilled in the art will appreciate that user XXX may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

### Plural Terms Language

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

### Operably-Coupled Language

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

### Active/Inactive Component Language

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

### Cloud Computing Standard Language

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scalable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

### Use of Trademarks in Specification Language

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

### Caselaw-Driven Clarification Language

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1. A computationally-implemented method comprising:
electronically transmitting one or more queries regarding at least in part one or more farming related production factors involved with farming related production of one or more ingestible materials; and
electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials.

2. The computationally-implemented method of claim 1, wherein the electronically transmitting one or more queries regarding at least in part one or more farming related production factors involved with farming related production of one or more ingestible materials comprises:
the electronically transmitting one or more queries regarding at least in part one or more farming related production factors involved with farming related production of one or more ingestible materials via at least in part one or more wireless communication protocols.

3. (canceled)

4. The computationally-implemented method of claim 1, wherein the electronically transmitting one or more queries regarding at least in part one or more farming related production factors involved with farming related production of one or more ingestible materials comprises:
the electronically transmitting one or more queries regarding at least in part one or more farming related production factors involved with farming related production of one or more ingestible materials through at least in part one or more radio frequency identification (RFID) response signals.

5. (canceled)

6. The computationally-implemented method of claim 1, wherein the electronically transmitting one or more queries regarding at least in part one or more farming related production factors involved with farming related production of one or more ingestible materials comprises:
the electronically transmitting one or more queries regarding at least in part one or more farming related production factors involved with farming related production of one or more ingestible materials from at least in part one or more bar code scanning actions.

7. (canceled)

8. The computationally-implemented method of claim 1, wherein the electronically transmitting one or more queries regarding at least in part one or more farming related production factors involved with farming related production of one or more ingestible materials comprises:
the electronically transmitting one or more queries regarding at least in part one or more farming related production factors involved with farming related production of one or more ingestible materials as least in part cell phone system traffic.

9. (canceled)

10. The computationally-implemented method of claim 1, wherein the electronically transmitting one or more queries regarding at least in part one or more farming related production factors involved with farming related production of one or more ingestible materials comprises:
the electronically transmitting one or more queries regarding at least in part one or more farming related production factors involved with farming related production of one or more ingestible materials as at least in part contained on one or more memory cards.

11. (canceled)

12. The computationally-implemented method of claim 1, wherein the electronically transmitting one or more queries regarding at least in part one or more farming related production factors involved with farming related production of one or more ingestible materials comprises:
the electronically transmitting one or more queries regarding at least in part one or more farming related production factors involved with farming related production of one or more ingestible materials from at least in part one or more e-mail entries.

13. (canceled)

14. The computationally-implemented method of claim 1, wherein the electronically transmitting one or more queries regarding at least in part one or more farming related production factors involved with farming related production of one or more ingestible materials comprises:
electronically transmitting the one or more queries regarding at least in part one or more farming related production factors involved with farming related production of one or more ingestible materials at least in part as audio content information.

15. (canceled)

16. The computationally-implemented method of claim 1, wherein the electronically transmitting one or more queries regarding at least in part one or more farming related production factors involved with farming related production of one or more ingestible materials comprises:
electronically transmitting the one or more queries regarding at least in part one or more farming related production factors involved with farming related production of one or more ingestible materials at least in part including information regarding human behavior.

17. (canceled)

18. The computationally-implemented method of claim 1, wherein the electronically transmitting one or more queries regarding at least in part one or more farming related production factors involved with farming related production of one or more ingestible materials comprises:
electronically transmitting the one or more queries regarding at least in part one or more farming related production factors involved with farming related production of one or more ingestible materials at least in part including information regarding one or more occurrences of animal behavior with respect to one or more guidelines as logged.

19. (canceled)

20. The computationally-implemented method of claim 1, wherein the electronically transmitting one or more queries regarding at least in part one or more farming related production factors involved with farming related production of one or more ingestible materials comprises:
electronically transmitting the one or more queries regarding at least in part one or more farming related production factors involved with farming related production of one or more ingestible materials at least in part including information regarding animal behavior with respect to one or more standards as logged.

21. (canceled)

22. The computationally-implemented method of claim 1, wherein the electronically transmitting one or more queries regarding at least in part one or more farming related production factors involved with farming related production of one or more ingestible materials comprises:
electronically transmitting the one or more queries regarding at least in part one or more farming related production factors involved with farming related production of one or more ingestible materials at least in part including information regarding farming related production factor handling of farming related production factors.

23. (canceled)

24. The computationally-implemented method of claim 1, wherein the electronically transmitting one or more queries regarding at least in part one or more farming related production factors involved with farming related production of one or more ingestible materials comprises:
electronically transmitting the one or more queries regarding at least in part one or more farming related production factors involved with farming related production of one or more ingestible materials at least in part including information regarding one or more events occurring in one or more portions of one or more agricultural fields.

25. (canceled)

26. The computationally-implemented method of claim 1, wherein the electronically transmitting one or more queries regarding at least in part one or more farming related production factors involved with farming related production of one or more ingestible materials comprises:
electronically transmitting the one or more queries regarding at least in part one or more farming related production factors involved with farming related production of one or more ingestible materials at least in part including chemical test information regarding farming related items.

27. (canceled)

28. The computationally-implemented method of claim 1, wherein the electronically transmitting one or more queries regarding at least in part one or more farming related production factors involved with farming related production of one or more ingestible materials comprises:
electronically transmitting the one or more queries regarding at least in part one or more farming related production factors involved with farming related production of one or more ingestible materials at least in part including test information regarding health status of one or more biological creatures.

29. (canceled)

30. The computationally-implemented method of claim 1, wherein the electronically transmitting one or more queries regarding at least in part one or more farming related production factors involved with farming related production of one or more ingestible materials comprises:
electronically transmitting the one or more queries regarding at least in part one or more farming related production factors involved with farming related production of one or more ingestible materials at least in part including test information with respect to forbidden human behavior as associated with one or more standards as logged.

31. (canceled)

32. The computationally-implemented method of claim 1, wherein the electronically transmitting one or more queries regarding at least in part one or more farming related production factors involved with farming related production of one or more ingestible materials comprises:
electronically transmitting the one or more queries regarding at least in part one or more farming related production factors involved with farming related production of one or more ingestible materials at least in part including test information regarding human observation.

33. (canceled)

34. The computationally-implemented method of claim 1, wherein the electronically transmitting one or more queries regarding at least in part one or more farming related production factors involved with farming related production of one or more ingestible materials comprises:
electronically transmitting the one or more queries regarding at least in part one or more farming related production factors involved with farming related production of one or more ingestible materials at least in part as video content test information.

35. (canceled)

36. The computationally-implemented method of claim 1, wherein the electronically transmitting one or more queries regarding at least in part one or more farming related production factors involved with farming related production of one or more ingestible materials comprises:
electronically transmitting one or more queries regarding at least in part the one or more farming related production factors involved with farming related production of one or more ingestible materials including at least in part one or more pesticide use factors involved with farming related ingestible material production.

37. (canceled)

38. The computationally-implemented method of claim 1, wherein the electronically transmitting one or more queries regarding at least in part one or more farming related production factors involved with farming related production of one or more ingestible materials comprises:
electronically transmitting one or more queries regarding at least in part the one or more farming related production factors involved with farming related production of one or more ingestible materials including at least in part one or more plant variety factors involved with farming related ingestible material production.

39. (canceled)

40. The computationally-implemented method of claim 1, wherein the electronically transmitting one or more queries regarding at least in part one or more farming related production factors involved with farming related production of one or more ingestible materials comprises:
electronically transmitting one or more queries regarding at least in part the one or more farming related production factors involved with farming related production of one or more ingestible materials including at least in part one or more animal byproduct factors involved with farming related ingestible material production.

41. (canceled)

42. The computationally-implemented method of claim 1, wherein the electronically transmitting one or more queries regarding at least in part one or more farming related production factors involved with farming related production of one or more ingestible materials comprises:
electronically transmitting one or more queries regarding at least in part the one or more farming related production factors involved with farming related production of one or more ingestible materials including at least in part one or more harvesting factors involved with farming related ingestible material production.

43. (canceled)

44. The computationally-implemented method of claim 1, wherein the electronically transmitting one or more queries regarding at least in part one or more farming related production factors involved with farming related production of one or more ingestible materials comprises:
electronically transmitting one or more queries regarding at least in part the one or more farming related production factors involved with farming related production of one or more ingestible materials including at least in part one or more production support factors involved with farming related ingestible material production.

45. (canceled)

46. The computationally-implemented method of claim 1, wherein the electronically transmitting one or more queries regarding at least in part one or more farming related production factors involved with farming related production of one or more ingestible materials comprises:
electronically transmitting one or more queries regarding at least in part the one or more farming related production factors involved with farming related production of one or more ingestible materials including at least in part one or more weather related factors involved with farming related ingestible material production.

47. (canceled)

48. The computationally-implemented method of claim 1, wherein the electronically transmitting one or more queries regarding at least in part one or more farming related production factors involved with farming related production of one or more ingestible materials comprises:
electronically transmitting one or more queries regarding at least in part the one or more farming related production factors involved with farming related production of one or more ingestible materials including at least in part one or more soil associated factors involved with farming related ingestible material production.

49. (canceled)

50. The computationally-implemented method of claim 1, wherein the electronically transmitting one or more queries regarding at least in part one or more farming related production factors involved with farming related production of one or more ingestible materials comprises:
electronically transmitting one or more queries regarding at least in part the one or more farming related production factors involved with farming related production of one or more ingestible materials including at least in part one or more weed related factors involved with farming related ingestible material production.

51. (canceled)

52. The computationally-implemented method of claim 1, wherein the electronically transmitting one or more queries regarding at least in part one or more farming related production factors involved with farming related production of one or more ingestible materials comprises:
electronically transmitting one or more queries regarding at least in part the one or more farming related production factors involved with farming related production of one or more ingestible materials including at least in part one or more genetics factors involved with farming related ingestible material production.

53. (canceled)

54. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with the farming related production of one or more ingestible materials including at least in part one or more harvesting related activities involved with farming related ingestible material production.

55. (canceled)

56. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with the farming related production of one or more ingestible materials including at least in part one or more orchard related activities involved with farming related ingestible material production.

57. (canceled)

58. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with the farming related production of one or more ingestible materials including at least in part one or more tree culturing activities involved with farming related ingestible material production.

59. (canceled)

60. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with the farming related production of one or more ingestible materials including at least in part one or more seafood acquiring activities involved with farming related ingestible material production.

61. (canceled)

62. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with the farming related production of one or more ingestible materials including at least in part one or more microorganism culturing activities involved with farming related ingestible material production.

63. (canceled)

64. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with the farming related production of one or more ingestible materials including at least in part one or more butchering related activities involved with farming related ingestible material production.

65. (canceled)

66. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with the farming related production of one or more ingestible materials including at least in part one or more birthing related activities involved with farming related ingestible material production.

67. (canceled)

68. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with the farming related production of one or more ingestible materials including at least in part one or more poultry related activities involved with farming related ingestible material production.

69. (canceled)

70. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with the farming related production of the one or more ingestible materials including at least in part one or more materials that will be ingested by a biological organism.

71. (canceled)

72. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with farming related production of the one or more ingestible materials including at least in part one or more materials that are produced from one or more biological organisms.

73. (canceled)

74. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with farming related production of the one or more ingestible materials including at least in part one or more animal based materials.

75. (canceled)

76. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with farming related production of the one or more ingestible materials including at least in part one or more intact plant items.

77. (canceled)

78. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with farming related production of the one or more ingestible materials including at least in part one or more intact seafood items.

79. (canceled)

80. The computationally-implemented method of claim 1, wherein the electronically transmitting one or more queries regarding at least in part one or more farming related production factors involved with farming related production of one or more ingestible materials comprises:
electronically transmitting one or more queries regarding at least in part one or more farming related production factors involved with farming related production of the one or more ingestible materials including at least in part one or more processed animal materials.

81. (canceled)

82. (canceled)

83. (canceled)

84. The computationally-implemented method of claim 1, wherein the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials comprises:
the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials as at least in part textual input through one or more keyboard entries.

85. (canceled)

86. The computationally-implemented method of claim 1, wherein the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials comprises:
the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials by at least in part one or more local area network (LAN) implementations.

87. (canceled)

88. The computationally-implemented method of claim 1, wherein the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials comprises:
the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials via at least in part one or more internet communication protocols.

89. (canceled)

90. The computationally-implemented method of claim 1, wherein the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials comprises:
the electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials through at least in part decryption of encrypted data.

91.-115. (canceled)

116. A computationally-implemented system comprising:
means for electronically transmitting one or more queries regarding at least in part one or more farming related production factors involved with farming related production of one or more ingestible materials; and
means for electronically receiving at least a portion of response information regarding at least in part one or more farming related production factors involved with farming related production of one or more ingestible materials said electronically receiving logged as being subsequent to said electronically transmitting, said response information including indication of one or more identifiers as being accessible through one or more tracers, and including indication of said one or more tracers as being at least momentarily in physical proximity with said one or more ingestible materials.

117. (canceled)

118. A computationally-implemented system comprising:
an interrogating electronically electrical circuitry arrangement operable for interrogating electronically through electronic communication associated with at least in part one or more agricultural output aspects concerning agricultural output for one or more food items; and
an electronically displaying electrical circuitry arrangement operable for electronically displaying at least some of queried information resulting from said interrogating through electronic communication associated with at least in part one or more agricultural output aspects concerning agricultural output for one or more food items said electronically displaying being associated with indication as being subsequent to said interrogating through electronic communication said electronic displaying including one or more identifying characteristics as being linked by one or more labeling mechanisms and including one or more identifying characteristics as being at least temporarily in a local area with said one or more food items.
